(19) United States
(12) Patent Application Publication
(10) Pub. No.: US 2008/0097847 A1
(43) Pub. Date: Apr. 24, 2008

(54) Internet-based brand marketing communication network for managing and delivering choreographed brand marketing communications to consumers using mutli-mode virtual kiosks (MMVKS)

(75) Inventors: Thomas J. Perkowski, Darien, CT (US); Vaibhava Muchhal, Stamford, CT (US); Kathleen O'Hara, Norwalk, CT (US); Fernando Ulloa JR., Norwalk, CT (US); Scott Lawrence, Woodbridge, CT (US); Katherine Kennedy, New York, NY (US)

Correspondence Address: Thomas J. Perkowski, Esq., P.C.;Soundview Plaza, 1266 East Main Street, Stamford, CT, 06902, US

(73) Assignee: IPF, Inc.

(21) Appl. No.: 11/809,215

(22) Filed: May 31, 2007

Related U.S. Application Data
(63) Continuation of application No. 10/876,261, filed on Jun. 24, 2004.
Application No. 10/876,261 is a continuation-in-part of application No. 10/812,341, filed on Mar. 29, 2004.
Application No. 10/812,341 is a continuation-in-part of application No. 10/693,856, filed on Oct. 24, 2003.
Application No. 10/693,856 is a continuation-in-part of application No. 10/602,990, filed on Jun. 24, 2003.
Application No. 10/602,990 is a continuation-in-part of application No. 09/716,848, filed on Nov. 17, 2000.
Application No. 09/716,848 is a continuation-in-part of application No. 09/695,744, filed on Oct. 24, 2000.
Application No. 09/695,744 is a continuation-in-part of application No. 09/641,908, filed on Aug. 18, 2000, now abandoned.
Application No. 09/641,908 is a continuation-in-part of application No. 09/599,690, filed on Jun. 22, 2000, now abandoned.
Application No. 09/599,690 is a continuation-in-part of application No. 09/483,105, filed on Jan. 14, 2000, now abandoned.
Application No. 09/599,690 is a continuation-in-part of application No. 09/465,859, filed on Dec. 17, 1999, now abandoned.
Application No. 09/465,859 is a continuation-in-part of application No. 09/447,121, filed on Nov. 22, 1999, now Pat. No. 6,625,581.
Application No. 09/465,859 is a continuation-in-part of application No. 09/441,973, filed on Nov. 17, 1999, now Pat. No. 6,961,712.
Application No. 09/441,973 is a continuation-in-part of application No. 09/284,917, filed on Apr. 21, 1999, now abandoned.
Application No. 09/441,973 is a continuation-in-part of application No. 08/736,798, filed on Oct. 25, 1996, now Pat. No. 5,918,214.
Application No. 09/441,973 is a continuation-in-part of application No. 08/752,136, filed on Nov. 19, 1996, now Pat. No. 6,064,979.
Application No. 09/441,973 is a continuation-in-part of application No. 08/826,120, filed on Mar. 27, 1997, now abandoned.
Application No. 09/441,973 is a continuation-in-part of application No. 08/854,877, filed on May 12, 1997, now Pat. No. 5,950,173.
Application No. 09/441,973 is a continuation-in-part of application No. 08/871,815, filed on Jun. 9, 1997, now Pat. No. 7,143,055.
Application No. 09/441,973 is a continuation-in-part of application No. 08/936,375, filed on Sep. 24, 1997, now abandoned.

(51) Int. Cl. G06Q 30/00

(52) U.S. Cl. 705/14

(57) ABSTRACT

An Internet-based brand marketing communication network for managing and delivering brand marketing communications to consumers using server-side driven multi-mode virtual kiosks (MMVKs) that are created, deployed, and managed using a novel suite of Web-based marketing communication services. For each consumer product registered on the network, a MMVK is created, deployed and installed, so as to establish a virtual brand marketing communication channel between brand management team members and consumers present in e-commerce (EC) enabled market space at the point of MMVK installation in EC-enabled market space, including EC-enabled WWW-sites, EC-enabled stores, EC-enabled online product catalogs, and wherever else consumers are considering the purchase of products on the World Wide Web (WWW). By virtue of the network of the present invention, consumer product brand management teams can choreograph and control the delivery of brand experience consumers have with their products in EC-enabled market space, so as to communicate brand value, deliver service and provide decision support, while helping retailers build their brands, reduce overhead, and drive sales.

### RELATED CASES

This application is a Continuation of U.S. application Ser. No. 10/876,261 filed Jun. 24, 2004; which is a Continuation-in-Part of application Ser. No. 10/812,341 filed Mar. 29, 2004, which is a Continuation-in-Part of application Ser. No. 10/693,856 filed Oct. 24, 2003, which is a Continuation-in-Part of application Ser. No. 10/602,990 filed Jun. 24, 2003, which is a Continuation-in-Part of application Ser. No. 09/716,848 filed Nov. 17, 2000; which is a Continuation-in-Part of application Ser. No. 09/695,744 filed Oct. 24, 2000 which is a Continuation-in-Part of application Ser. No. 09/641,908, filed Aug. 18, 2000 which is a Continuation-in-Part of copending application Ser. No. 09/599,690 filed Jun. 22, 2000; which is Continuation-in-Part of copending application Ser. No. 09/483,105, filed Jan. 14, 2000; application Ser. No. 09/465,859 filed Dec. 17, 1999, now abandoned; which is a Continuation-in-Part of copending application Ser. No. 09/447,121 filed Nov. 22, 1999; copending application Ser. No. 09/441,973 filed Nov. 17, 1999; which is a Continuation-in-Part of application Ser. No. 09/284,917 filed Oct. 27, 1999, now abandoned, which is a National Stage Entry Application from International Application No. PCT/US97/19227 filed Oct. 27, 1997, published as WIPO Publication No. WO 98/19259 on May 7, 1998; as well as a Continuation-in-Part of the following U.S. Applications: No. 08/736,798 filed Oct. 25, 1996, now U.S. Pat. No. 5,918,214; No. 08/752,136 filed Nov. 19, 1996, now U.S. Pat. No. 6,064,979; No. 08/826,120 filed Mar. 27, 1997, now abandoned; No. 08/854,877 filed May 12, 1997, now U.S. Pat. No. 5,950,173; Ser. No. 08/871,815 filed Jun. 9, 1997; and Ser. No. 08/936,375 filed Sep. 24, 1997, now abandoned, each said Application is commonly owned by IPF, Inc., and is incorporated herein by reference in its entirety as if fully set forth herein.

### BACKGROUND OF INVENTION

1. Technical Field

The present invention generally relates to a novel Internet-based method of and system for educating consumers and marketing branded products and services thereto within both electronic physical and retail environments.

2. Brief Description of the Prior Art

Presently, an enormous amount of time, money and effort is expended daily by thousands of manufacturers and retailers to market, brand, advertise and sell their products and services to consumer in both regional and global markets. Prior to the creation of the World Wide Web (WWW), based on the Hypertext Markup Language (HTML) and the Hypertext Transmission Protocol (HTTP) invented by Tim Berners-Lee, et al., conventional marketing and advertising systems and methods used print, radio, and television based communication mediums to communicate messages to consumers in the marketplace.

Since the development of the WWW and its enabling information file formats and communication protocols, a number of Internet-based advertising systems and networks have been developed and deployed in the world of consumer product and service advertising and promotion. Examples of commercially-available Internet-based advertising and promotion systems include: the Open Ad Stream™ (5.0) Internet Advertising Sales, Advertising-Management Software Technology And Media Services Network by RealMedia, Inc. (http://www.realmedia.com); the DoubleClick™ Internet Advertising Sales, Advertising-Management And Media Services Network by DoubleClick, Inc. (http://www.doubleclick.com) which employ its proprietary DART™ technology for collecting and analyzing audience behavior, predicting which ads will be most effective, measures ad effectiveness, and providing data for Web publishers and advertisers; the Adfusion™ Integrated Advertising Marketing, Sales and Management System by Adfusion, Inc. (http://www.adfusion.com) which integrates all phases of the media buying process including media research and planning, media inventory and yield management, secure online negotiation, the transaction execution, and tracking and post-campaign reporting; and the Promotions.com™ On-Line Promotion System by Promotions.com, Inc. (http://www.promotions.com) formerly Webstakes.com, which develops customized online promotions for clients providing technology and consulting services necessary to run the promotions on clients' own Web sites, and offering direct marketing e-mail services using a database of customer profiles.

Recently, two principally different methods have been proposed for providing product information to consumers over the Internet.

U.S. Pat. No. 5,640,193 to Wellner discloses a system and method for accessing and displaying Web-based consumer product related information to consumers using a Internet-enabled compute system, whereby in response to reading a URL-encoded bar code symbol on or associated with a product the information resource specified by the URL is automatically accessed and displayed on the Internet enabled computer system. While this system and method enables access of consumer product information related information resources on the WWW by reading URL-encoded bar code symbols, it requires that custom URL-encoded bar code symbols be created, printed and applied to each and every physical product in the stream of commerce.

U.S. Pat. No. 5,978,773 to Hudetz, et al discloses a solution to the problem presented by the system and method of U.S. Pat. No. 5,640,193. This solution involves the use of a UPC/URL database in order to translate UPC numbers (and other unique codes) read from consumer products by a bar code scanner, into the URLs of published information resources on the WWW relating to the UPC-labeled consumer product.

Like U.S. Pat. No. 5,978,773 to Hudetz, et al, WIPO Publication No. WO 98/03923 discloses the use of a UPC/URL database in order to translate UPC numbers read from consumer products by a bar code scanner, into the URLs of published information resources on the WWW relating to the UPC-labeled consumer product. Current commercial realizations of this general information access technique include: the PaperClick™ Print-To-Web Information Access System by Neomedia Technologies, Inc., of Fort Meyers, Fla. (http://www.paperclick.com); and the AirClic™ Wireless Print-to-Web Media Consumer Product and Service Information Access System by Airclic, Inc. of Blue Bell, Pa. (http://www.airclic.com).

While U.S. Pat. No. 5,978,773 and WIPO Publication No. WO 98/03923 both provide and effective solution to the problem presented by U.S. Pat. No. 5,640,193 to Wellner, et al., these prior art references and systems completely fail to recognize or otherwise address the myriad of problems relating to UPC/URL-link collection, management, delivery, access and display along the retail supply and demand chain, which must be first solved in order deliver a technically feasible, globally-extensive, UPC-driven consumer product information system for the benefit of consumers worldwide.

For over a decade, several years before the development of the WWW, both General Electric Information Services (GEIS) formerly a division of General Electric (GE) Corporation, and Quick Response Services (QRS), Inc. of Richmond, Calif. have maintained independent consumer product information databases based on the retail industry standard Universal Product Code (UPC) numbering system. These consumer product information databases, branded as the GEIS UPC Express® Product Catalog (recently renamed the GPC Express™ UPC Product Catalog), and the QRS Keystone™ UP Product Catalog, are each maintained as a large-scale RDBMS that is connected to secure value-added networks, referred to as VANs, as well as the infrastructure of the Internet, as shown in FIGS. 2B1 through 2B4, and thus are easily accessible by retailers using Internet-enabled client computers. These UPC Product Catalogs contain “supply-side related” information records on millions of consumer products from thousands of manufacturers selling their products to retailers along the retail chain, at wholesale prices, terms conditions. The supply-side related information contained in these centralized UPC Product Catalogs are locally maintained by the manufacturers (i.e. vendors) using conventional UPC management software, as developed by Intercoastal Data Corporation (IDC) of Carrollton, Ga., and BarCode World, Inc. These manufacturer-managed UPC Product Catalogs are then periodically uploaded to GEIS's and/or QRS's centralized UPC Product Catalogs, using electronic data interchange (EDI) processes carried out between each manufacturer's UPC Product Catalog and the centralized UPC Product Catalog. The purpose of such uploading operations is to update these centralized UPC Product Catalogs with current and accurate pricing and shipping information required by retailers who visit these centralized UPC Product Catalogs, download the UPC Product Catalogs of their manufacturer trading partners (or portions thereof), to review current product offerings and wholesale prices, terms and conditions, and thereafter purchase desired products from the downloaded manufacturer's UPC Product Catalog using conventional EDI-enabled electronic-commerce (EC) transaction techniques. In essence, the primary function of these centralized UPC Product Catalogs is to enable B-2-B EC transactions between retailers and manufacturers (i.e. vendors) so that retailers can maintain a supply of products in their inventories sufficient to meet the demand for such products by consumers along the retain chain.

In addition to such centralized UPC Product Catalogs described above, these network administrators (GEIS and QRS) use information collected from B-2-B EC-transactions enabled by their centralized UPC Product Sales Catalogs, to provide a number of other solutions to problems relating to electronic commerce (EC) merchandising and logistics within the global supply chain. Such ancillary information services include, for example: Sales, Analysis and Forecasting Services providing retailers with information about what products consumers are buying; Collaborative Replenishment Services for determining what products retailers can buy in order to satisfy consumer demand at any given point of time; and Transportation and Logistics Information Services for providing retailers with information about when products purchased by them (at wholesale) will be delivered to their stores. Such information services are offered to retailers on a global basis through VANs and the Internet.

While the above-described supply-chain information management and delivery systems and services collectively cooperate to optimize the process of moving raw materials into finished products and into the hands of consumers, such supply-side information systems fail to address the information needs of the consumers of retail products who require and desire product-related information prior to, as well after, the purchase of consumer-products. Moreover, such systems and services fail altogether to address the problems facing manufacturer marketing, brand and product managers, and their advertising and promotion agents, as well as retailer marketing and product managers and their advertising and promotion agents working along the demand-side of the retail chain.

In many respects, the Brand Marketing Communications industry has come a long way over the past twenty years. Advances in cognitive psychology and technology have helped to drive the industry forward at a very fast rate. Also, the development of Internet and the World Wide Web (WWW) has also played a major role in redefining the structure of the global marketplace and how Consumers can learn about and make their product and service purchases.

Brand managers increasingly regard the Internet as the potential ‘holy grail’ to communicate personalized messages to target audiences, and monitor their responses in real time. However no one has yet found online tools that capitalize on the Internet's interactivity, and allow marketers to communicate powerful, consistent brand messages and images to shoppers throughout the web.

Solutions remain elusive because marketers have a complex set of online needs. First, they must be able to collaborate with e-tailers and other Internet trading partners on marketing campaigns in order to ensure that shoppers receive consistent messages that reinforce the brand at every turn.

Unfortunately, the Internet's built-in frictions between brand managers and their trading partners often prevent this important collaboration from taking place. Because e-tailers control the amount of space and type of information the consumer views on the e-tail site, brand managers cannot present unique brand experience to shoppers at the Internet's most critical points-of-sale. E-tailers may also discourage links to a brand's own Website that provide a shopper with more in-depth information, because they may risk losing the sale when the shopper leaves their sites. Finally, the retailer's multi-channel strategy, which caters to consumers whether they are shopping online or offline in traditional retail stores, works against the interests of pureplay e-tailers. These e-tailers receive the online traffic, but may lose sales to brick-and-mortar retail stores.

The Internet is anything but collaborative in this tense climate. Communication among trading partners is poor. Consumers may receive conflicting promotional offers from different agents, and resellers may receive outdated pricing about various products. Worse, the marketing industry lacks the dedicated technology to connect the brand manager, e-tailer and other online trading partners in a collectively beneficial network that would facilitate comprehensive changes in marketing campaigns.

Another difficult challenge brand managers face is communicating with the Internet's price-driven, task-oriented shopper who has long since tuned out the clutter and noise in the Internet marketplace. E-tailers have also worked very hard to engage the online shopper, with improved product information, site design and overall user experience. Unfortunately, shopping cart abandonment continues to be one of the most enduring problems facing e-tailers and brand managers, with unfinished online transactions projected to reach an estimated $6.3 billion in losses in 2004.

Clearly, the Internet still lacks the compelling shopping experiences that would make an impatient consumer feel a product was worth the hassle of following the checkout process through to purchase Marketers continue to search and experiment with ways to fully engage the savvy, price-driven shopper a the point-of-sale.

Finally, brand marketers must contend with technology like comparison sites, which have rapidly grown in popularity in just the past year. These shopping tools convert brands to commodities and inhibit the marketer's brand building efforts with consumers on the Internet.

The result is that the savvy, aggressive online consumer rules a price-driven Internet marketplace, where e-tailers and brand managers are reactive. In order to gain traction in the online sales channel brand managers and e-tailers must engage this shopper in an information-rich shopping experience that motivates the online shopper to consider purchases based on compelling brand information as well price and promotion deals.

Current dynamics in the Internet marketplace present several major challenges to brand managers in their efforts to build strong brands online:

Building Online Brands in Real Time with Consistent Messages Across Multiple Touch Points

To build a strong brand presence, consumers must receive consistent messages and images about a brand, and this is extremely difficult for brand managers to control on the Web. Brand building assets created by manufacturers are commonly arranged and presented by a range of trading partners on e-tail sites and other Web touch points to deliver inconsistent brand messages and images to consumers. As a result, consumers often receive conflicting promotional offers from different agents, and resellers may receive outdated pricing about various products.

Building Collaboration Among Partners in an Inherently Divisive Environment

Brand managers must collaborate with their agents and retailer trading partners to ensure that shoppers receive consistent messages that reinforce the brand at every turn. The Internet's built-in friction between brand managers and their trading partners compounds their difficulties.

E-tailers control the amount of space and type of information the consumer views on the e-tail site, and brand managers cannot present a unique brand experience to shoppers at the point of sale. They must communicate their brands predominantly through the space they rent on e-tail sites, which is cluttered with other brands. Consumers have limited access to the information they seek before purchasing certain products on these sites, but e-tailers frequently also discourage links to a brand's own with in-depth information, because they may lose the sale when the shopper leaves their site. Finally, the retailer's multi-channel strategy, which encourages the shopper to buy the brand in a variety of sale channels, works against the interests of pureplay e-tailers. These e-tailers receive the traffic, but lose the sales to brick-and-mortar retail stores.

The Internet is anything but collaborative in this tense climate, and communication among trading partners is poor. Marketers often lack the technology that would enable them to communicate effectively with these partners. There are no specific processes and/or dedicated technology in place connecting the brand manager, the agency, and the e-tailer to make any major, comprehensive changes in marketing campaigns. As a result, outdated product information, conflicting promotional offers or other incorrect brand information are frequently circulated among trading partners.

Communicating with Savvy, Impatient Online Shopper to Develop Brand Loyalty Although brand managers invested $7.2 billion in 2003 in online advertising, shoppers continue to gravitate to the brands they interact with offline; the bulk of the year's retail sales remained with the top brands with a strong offline presence. According to the Gartner Group, the average shopper decides what s/he wants before going online, then starts and finishes a session within fifteen minutes. Despite continual lack of success influencing the online shopper, however, 70% of brand managers in a recent Forrester study said that they would increase their marketing budgets another 5% in 2004.

E-tailers, too, have been working very hard to engage the online shopper in the last two years with improved site design and overall user experience. Yet studies still say the second major reason online shoppers abandoned their carts, after prohibitive shipping costs, is because they changed their minds. Clearly, sites still lack the compelling shopping experience that would make an impatient consumer feel a product was worth the hassle of following the checkout process through to purchase.

Guarding Against Brand Erosion in Price-Comparison Environments

Finally, brand marketers must contend with online technology like price comparison sites that threaten to erode brand value. Consumer shopping tools such as Yahoo!'s comparison shopping site, inhibit marketers in their efforts to build brand value with consumers on the Internet, by encouraging consumers to shop for products in a category by price.

Given these major challenges, it is no surprise that brand managers have been generally unsuccessful to date building strong brands online.

Brand managers and e-tailers must create an information-rich shopping experience that motivate the online shopper to consider purchases based on compelling brand information as well price and promotion deals. Current online advertising and systems integration players in the marketplace serve various portions of this need, but no one has considered or developed a way of and a means for giving the brand manager effective online advertising tools that build brand, and the collaborative technology that enables them to communicate consistent brand building images and messaging to consumers anywhere along the WWW.

In short, brand owners need a new way of and means for addressing several problems in bot electronic and physical streams of commerce, namely:

(1) Brands are frequently misrepresented or weakened online because online trading partners usually control or manage the representation of brand images and messaging;

(2) Communication between online trading partners and brand owners is frequently poor;

3 Technology that promotes communication and collaboration between brand owners and trading partners is limited and cost-prohibitive; and

4 Online price comparison environments erode brand value.

Thus, it is clear that there is great need in the art for an improved method of and apparatus for enabling brand owners to manage (command) and tightly control product and service related brand marketing communications to consumers anywhere along the World Wide Web (WWW) in both physical and electronic retail shopping environments, while avoiding the shortcomings and drawbacks of prior art systems and methodologies.

### OBJECTS AND SUMMARY OF THE PRESENT INVENTION

Accordingly, a primary object of the present invention is to provide a novel method of and apparatus for enabling brand owners to manage (command) and tightly control product and service related brand marketing communications to consumers anywhere along the World Wide Web (WWW) in both physical and electronic retail shopping environments, while overcoming the shortcomings and drawbacks of prior art systems and methodologies.

Another object of the present invention is to provide such apparatus in the form of a novel Enterprise-Level Brand Management And Marketing Communication Network based on an innovative brand command, control and communication architecture (BC3), which gives brand owners complete command and control over the wide range of brand-building assets, messaging and promotions scattered throughout the Web, and how they are communicated to directly consumers at diverse Web touch points with the efficiency and automation of supply-chain management solutions.

Another object of the present invention is to provide an Internet-based Brand Management And Marketing Communication Instrumentation network for deploying, installing and remotely programming brand-building server-side driven Multi-Mode Virtual Kiosks on the World Wide Web (WWW).

An object of the present invention is to provide an enterprise-level collaborative communication solution that will give brand managers and their online trading partners the power to build strong online brands, drive sales and eliminate existing friction in the retail chain through a collaborative e-marketing network.

Another object of the present invention is to provide an Internet-based Brand Management And Marketing Communication Instrumentation Network which provides brand managers, their agents and e-retail trading partners with a technology-based solution that will be able them to drive more sales online through a collaborative e-marketing communication network that delivers rich brand experiences to consumers anywhere on the Web.

Another object of the present invention is to provide an Internet-based Brand Management And Marketing Communication Instrumentation Network that will satisfy four basic needs of bran management teams in today's Internet marketplace:

1. To build strong brands online with consistent messaging and images across multiple touch points on the Web

2. To build collaboration among partners in an inherently divisive environment

3. To communicate with consumers anywhere on the Internet and build brand loyalty

4. To guard against brand erosion in price-comparison environments.

Another object of the present invention is to provide an Internet-based brand management and marketing communication instrumentation network which, for the first time, ensures brand owners that consumers receive consistent rich-media brand experiences anywhere they happen to be on the Web, in both physical and electronic streams of commerce.

Another object of the present invention is to provide an Internet-based Brand Management And Marketing Communication Instrumentation Network which enables brand management teams to communicate consistent brand messages to consumers in real-time, along with their agents and e-tailer trading partners during online brand campaigns, and also to monitor consumer activity as well throughout the Internet.

Another object of the present invention is to provide an Internet-based Brand Management And Marketing Communication Instrumentation Network which brand owners operate in-house, on an hosted application basis, to create, control, deliver and monitor the brand experience delivered to consume throughout the Web.

Another object of the present invention is to provide an Internet-based Brand Management And Marketing Communication Instrumentation Network which enables brand owners to display rich media advertisements, the day's promotions, in-depth product information and other brand assets of their choice in online vehicles (i.e. interactive communication instruments) called “Multi-Mode Virtual Kiosks” which deliver quick, information-rich shopping (i.e. brand) experiences to consumers at the point of sale and other critical Web touch points when they are making a buying decision. Using a Web browser and mouse, these Multi-Mode Virtual Kiosks can be quickly and inexpensively created, deployed, installed and modified in real-time anywhere on the Web.

Another object of the present invention is to provide an Enterprise-Level Brand Management And Marketing Communication Network that is synchronized with ones supply-chain information management operations, and is capable of bringing about supply-chain efficiencies to demand chain management operations within an enterprise.

Another object of the present invention is to provide an Enterprise-Level Brand Management and Marketing Communication Network, in which Multi-Mode Virtual Kiosks are programmable through the Brand Management and marketing Communication Network, and wherein the network delivers revolutionary ensemble of Web-based instruments that enables brand management teams to orchestrate, build and communicate intended brand images to consumers at any Internet-enabled consumer touchpoint via Multi-Mode Virtual Kiosks installed along electronic streams of commerce.

Another object of the present invention is to provide an Internet-based Brand Management And Marketing Communication Instrumentation Network which, by providing the instruments for rapidly building powerful Brand Information Networks and Advertising and Promotional Campaigns for delivery to consumers over highly controlled channels of communication less immune to destructive power of clutter, enables brand management teams to create stronger, more distinctive brands in the marketplace-translating into premium prices, greater levels of channel influence, improved levels of customer loyalty and retention, and increased profits.

Another object of the present invention is to provide an Internet-based Brand Management And Marketing Communication Instrumentation Network which provides an increased level of control over Internet-based brand marketing communications that enables brand managers and their agents to effectively manage consumers' experienced perceptions developed before, during and after consumer purchases. This improved management of consumer perception will allow consumers to have more meaningful purchase experiences and will influence their perception of a brand's value and strength.

Another object of the present invention is to provide an enterprise-level Internet-based (online Brand Management and Marketing Communication Network that enables brand management team perform real-time integration and delivery of complex, richly-associated networks of brand building assets, advertisements and promotions, to consumers anytime and anywhere on the Internet.

Another object of the present invention is to provide an enterprise-level Internet-based online Brand Management and Marketing Communication Network which, by supporting advanced management of Brand Information Networks and real-time generation, installation and programming of Multi-Mod Virtual Kiosks, enables brand management teams to effectively collaborate and establish bran information dominance in the mental space of consumer minds.

Another object of the present invention is to provide an enterprise-level Internet-based (online Brand Management and Marketing Communication Network which enables brand marketers to deliver rich brand experiences to consumers consistently across all retail distribution channels over the Internet in a highly-controlled and cost-efficient manner.

Another object of the present invention is to provide an enterprise-level Internet-based (online) Brand Management and Marketing Communication Network, offering the following benefits and advantages:
(i) a Brand Management and Marketing Communication Network that empowers brand-driven enterprises, by providing their brand marketing executives and managers with a remarkable degree of command and control over their brand building information resources, wherever they may be hosted on the infrastructure of the Internet;
(ii) a Brand Management and Marketing Communication Network that provides information management and communication superiority which allows brand marketing planners to better shape the brand knowledge and images held by consumers in the marketplace, and positively influence consumer perceptions and behavior—wherever consumer brand purchases might be contemplated on the Internet; and
(iii) a Brand Management and Marketing Communication Network that enables brands to more effectively compete for a dominant position in the minds of consumers who might be considering a purchase at home, at work, on the road, or in brick and mortar retail stores.

Another object of the present invention is to provide an Enterprise-Level Brand Management And Marketing Communication Network that gives brand managers the tools to positively influence price-driven online shoppers and effectively communicate the essence of their brands through a quick, information-rich shopping experiences at the e-tail point of sale and other Web touch points.

Another object of the present invention is to provide an Enterprise-Level Brand Management And Marketing Communication Network, wherein brand management team members display richly-associated brand-building information resources, including ad and promo messages, during the choreographed display modes of a “Multi-Mode Virtual Kiosk” which consumers can launch anywhere on the Web to obtain in-depth information about a brand, as well as rich media images and the latest promotions on real-time basis.

Another object of the present invention is to provide an Enterprise-Level Brand Management And Marketing Communication Network that enables brand management teams with a unique ability to choreograph and deliver an engaging, unprecedented rich brand experience to consumers anywhere on the WWW, with the efficiency and automation of supply chain management solutions.

Another object of the present invention is to provide an Enterprise-Level Brand Management And Marketing Communication Network that provides brand managers with a new way of and means for reaching and influencing the brand perceptions of the online shopper.

Another object of the present invention is to provide an Enterprise-Level Brand Management And Marketing Communication Network that enables brand managers to efficiently deliver and measure online brand marketing communications across all channels in an automated and highly efficient manner with a measurable ROI.

Another object of the present invention is to provide an Enterprise-Level Brand Management And Marketing Communication Network which, as a centralized hosted solution, allows brand managers to link seemingly disparate online assets—rich media, promotional messages and product specifications, for example—and bring them directly to online shoppers at the point-of-purchase and any touch point on the World Wide Web, through a new interactive online shopping vehicle called a Multi-Mode Virtual Kiosk.

Another object of the present invention is to provide an Enterprise-Level Brand Management And Marketing Communication Network, wherein brand owners can place Multi-Mode Virtual Kiosks anywhere on the Web they wish to deliver an information-rich brand experience or present a multi-faceted view of their brands directly to consumers. They can place Virtual Kiosks on e-retail sites and portals the consumer visits while in a transactional mindset (e.g., shopping search engine results pages), on partner websites or any point on the Web where they wish to create or reinforce brand awareness in the mind of the consumer.

Another object of the present invention is to provide an Enterprise-Level Brand Management And Marketing Communication Network, wherein the Multi-Mode Virtual Kiosks function as the presentation layer of thereof, and which the brand owner operates in-house to tightly control and manage brand assets anywhere on the Web, and collaborative in real-time with retail trading partners, as well as advertising and promotion agents, to program the Multi-Mode Virtual Kiosks so as to ensure timely, consistent delivery of online brand marketing messages and drive sales.

Another object of the present invention is to provide an Enterprise-Level Brand Management And Marketing Communication Network which enables brand management team members to effectively and efficiently define, refine and measure online brand communication activities with a few mouse click from a Web-enabled browser program.

Another object of the present invention is to provide an Enterprise-Level, Industrial-Strength Brand Management And Marketing Communication Network that is sufficiently scalable to support the brand marketing communications industry in much the same way as AT&T's public telephone switching network (PTSN) serves millions of companies throughout the world.

Another object of the present invention is to provide an Enterprise-Level Brand Management And Marketing Communication Network which can be used by Brand managers and their team member (including ad and promo agents) and retail trading partners as well, with minimal technical knowledge to that they can easily create, install and modify Multi-Mode Virtual Kiosks from their own computers using five simple suites of tools, namely: the Brandkey Manage™ Subsystem which supports information services that allow brand owners to manage accounts, brands and user rights on the BKS Network for organizations having any kind of collaborative arrangement; the Brandkey Create™ Subsystem which supports information services that allow users to choose the content, arrangement and “look and feel” of Brand Information Networks; the Brandkey Deliver™ Subsystem which supports information services that enable users to create and deploy Multi-Mode Virtual Kiosks anywhere on the Web; the Brandkey Advertise™ Subsystem which supports information services that provide brand managers and their advertising agents with a collaborative online network to build, track and modify Multi-Mode Virtual Kiosk based advertising campaigns in real-time; and the Brandkey Promote™ Subsystem which supports information services that, similar to Brandkey Advertise, enables brand managers to create, monitor and modify their ever-changing promotional campaigns on subnetworks of Multi-Mode Virtual Kiosks, with promotional agents in real-time.

Another object of the present invention is to provide an Enterprise-Level Brand Management And Marketing Communication Network which provides a suite of tools that enable brand management teams and their trading partners to deploy and install Multi-Mode Virtual Kiosks at points of display and purchase on the Web. With a few mouse clicks, brand managers regulate the rights and privileges of team members and trading partners on the Network.

Another object of the present invention is to provide an Enterprise-Level Brand Management And Marketing Communication Network, wherein brand management team members and trading partners build and install Multi-Mode Virtual Kiosks; then brand management team members, as well as their agents and trading partners, simply program the multiple display modes of installed Virtual Kiosks, so that rich media advertising spots, promotional spots, and brand building resources are delivered to shoppers where it counts, creating information-rich brand experiences as intended by brand owners developing more consistent brand images across all e-tail marketing channels, while simultaneously creating great value and benefits for e-tailer trading partners, consumers and brand owners alike.

Another object of the present invention is to provide an enterprise-level brand management and marketing communication network, wherein brand management team members create a Bran Information Network (BIN) for each product, service or corporate brand, which serves as an invisible, but critical foundation for all activities on the Brand Management and Marketing Communication Network of the present invention, and a storehouse of links for the digital brand-building information assets that consumers view during the operation of each remotely-programmed Multi-Mode Virtual Kiosk.

Another object of the present invention is to provide an Enterprise-Level Brand Management And Marketing Communication Network, wherein each Brand Information Network is, in essence, a set of data comprised of the following items: (i) basic information about the product/service which function as Brand Information Search Keys: Universal Product Number (USN) or Universal Service Number (USN); Trademark (TM) or Servicemark (SM); Product Descriptor (PD) or Service Descriptor (SD); Product of Service Brand Name; and Product or Service Category; (ii) Web location or address (URL) of bran assets/content at the brand owner's disposal (e.g., product video, audio, product image, etc.—in multiple languages if applicable); and (iii) basic, practical display attributes of the brand assets (i.e., text for clickable links, icons displayed next to the links, sound files associated with the links, types of links, etc.) located at each node in the Web-based Brand Information Network of the present invention.

Another object of the present invention is to provide an Enterprise-Level Brand Management And Marketing Communication Network, wherein brand owners use combinations of these data links (e.g. UPN/TM/PD/URLs for product brands or UPS/SM/SD/URLs for service brands) to build and manage Brand Information Networks anywhere using a Web-enabled computer. Brand owners can quickly access, shift or change these components when seasonality, pre-purchase/post-purchase considerations and different target audiences require them to modify Brand Information Networks.

Another object of the present invention is to provide an Enterprise-Level Brand Management And Marketing Communication Network, wherein the same brand-related information keys (e.g., Universal Product Numbers, Trademarks, Product Descriptors, Universal Service Numbers, Servicemarks, Brand Names, etc.) are used to index each rich media advertising spot, promotional spot, and other brand asset associated with a created Brand Information Network, and these brand-related information keys represent basic building blocks of networks brand information management and communication system architecture.

Another object of the present invention is to provide an Enterprise-Level Brand Management And Marketing Communication Network, wherein once Brand Information Networks are in place, brand owners can decide how and where to showcase their brands by building and deploying Multi-Mode Virtual Kiosks.

Another object of the present invention is to provide an Enterprise-Level Brand Management And Marketing Communication Network, wherein brand images and messages can be communicated t shoppers through one or more of the three distinct display modes in each Multi-Mode Virtual Kiosk namely: Advertising Display Mode (e.g., rich media spots intended to create emotional connection with the brand); Promotional Display Mode (e.g., for displaying time-limited offers in the form of price-base messaging, media-based offers, etc.); and a Brand Information Network Display Mode (e.g. a set of categorized links providing a wide range of information about the product or service, along with search capabilities for the brand's other offerings).

Another object of the present invention is to provide an Enterprise-Level Brand Management And Marketing Communication Network, wherein when the user clicks on a Multi-Mode Virtual Kiosk installed along the fabric of the WWW, a combination of the three display modes will play automatically for the consumer, in a sequence determined by the brand owner or trading partner who creates and deploys the Multi-Mode Virtual Kiosk to deliver an effectively choreographed brand experience to the consumer. For example, a Multi-Mode Virtual Kiosk could open with a rich media advertisement, followed by a promotional offer and finally lead the consumer to a custom set of additional bran information—all in a seamless progression.

Another object of the present invention is to provide an Enterprise-Level Brand Management And Marketing Communication Network, wherein brand marketers can rise above the clutter, by virtue of the fact that the same brand-related information keys (e.g., Universal Product Numbers, Trademarks, Product Descriptors, Universal Service Numbers, Servicemarks, Brand Names, etc.) used to index rich media advertising spots, promotional spots, and other brand assets associated with creating Brand Information Networks, are also used to program “virtual brand communication channels” in each Multi-Mode Virtual Kiosk installed on the BKS Network. These brand-related information keys enable consumers to easily search for and access brand information from Multi-Mode Virtual Kiosks at diverse consumer touchpoints.

Another object of the present invention is to provide an Enterprise-Level Brand Management And Marketing Communication Network, wherein the three different modes of marketing communication and display can be either temporally or spatially multiplexed within the graphical user interface (GUI) of the Multi-Mode Virtual Kiosk so as to be able to deliver three different kinds of brand marketing communication content (i.e. Ad Spots, Promo Spots, and Brand Information Networks) at either (i) three different moments (frames) in time on the GUI (i.e. referred to as “temporal multiplexing”), and/or (ii) at three different places in space on the GUI (i.e. referred to as “spatial multiplexing).

Another object of the present invention is to provide an Enterprise-Level Brand Management And Marketing Communication Network, wherein each and every Ad Spot, Promo Spot and Bran Information Network (i.e. “brand marketing communication”) is indexed with Brand-related Information Keys (“BRANDKEYS”) such as (i) the UPN, TM and PD of the branded product to which such bran marketing communications relate, or (ii) the UPS, SM and SD of the branded service to which such bran marketing communications relate. Thus, all “brand marketing communications” (e.g. Ad Spots, Prom Spots and Brand Information Networks) communicated through the Network are indexed using Brand related Information Keys (“brandkeys”).

Another object of the present invention is to provide an enterprise-level brand management and marketing communication network, wherein each different type of Multi-Mode Virtual Kiosk is characterized (and thus defined) in terms of a different class of Brand-Related Information Keys (brandkeys). For example, a Product-Specific (PS) Multi-Mode Virtual Kiosk is defined (classified) by single, unique UPN (i.e. UPC) of a particular Vendor/Brand-Owner. A Vendor-Specific (VS) Multi Mode Virtual Kiosk is defined (classified) by a set or family of UPNs (i.e. UPCs) marketed by particular Vendor/Brand-Owner (e.g. under one or more different Trademarks (TMs) or Brand Entities). A Service-Specific (SP) Multi-Mode Virtual Kiosk is defined (classified) by a single, unique USN of particular Service-Provider/Brand-Owner. A Service-Provider-Specific (SPS) Multi-Mode Virtual Kiosk by a set or family of USNs marketed by a particular Service-Provider/Brand-Owner (e.g. under one of more different Servicemarks (Sms) or Brand Entities). A Retailer-Specific (RS) Multi-Mode Virtual Kiosk is defined (classified) by a set or family of UPNs (i.e. UPCs) marketed by a particular set of Vendors/Brand-Owners carried by a particular Retailer.

Another object of the present invention is to provide an Enterprise-Level Brand Management And Marketing Communication Network, wherein the Brand-Related Information Keys (i.e. brandkeys) imposed on Multi-Mode Virtual Kiosks server as virtual brand marketing communication channels (i.e. brand-related filters of sorts) for brandkey-indexed brand marketing communications conducted through the network.

Another object of the present invention is to provide an Enterprise-Level Brand Management And Marketing Communication Network, wherein all “brand marketing communications” (e.g. Ad Spots, Promo Spots and Brand Information Networks) conducted through the network are indexed using Brand-related Information Keys (“brandkeys”), only specific brand-related content gets communicated over Multi-Mode Virtual Kiosks characterized with the same Brand-Related Information Keys (brandkeys). Such indexing of brand building information resources and Multi-Mode Virtual Kiosks on the network helps to ensure that only brand marketing communications related to a particular product, service or brand gets delivered to consumers over Multi-Mode Virtual Kiosks that are brand-keyed to such branded products and services. This reduces clutter, and delivers clearer brand image building communications with greater efficiency—increasing ROI on brand marketing communication expenditures.

Another object of the present invention is to provide an Enterprise-Level Brand Management And Marketing Communication Network, wherein brand owners have multiple options to customize every Multi-Mode Virtual Kiosk, from selecting its look-and-feel variables (including ‘skin type’ defined by surface texture, color, button style, etc.) and placement of the brand logo, to the type and arrangement of links in each Brand Information Network.

Another object of the present invention is to provide an Enterprise-Level Brand Management And Marketing Communication Network, wherein brand management teams can easily and inexpensively test consumer reception to the arrangement and sequence of these brand-building assets in specific Multi Mode Virtual Kiosks, because they can create and modify these Multi-Mode Virtual Kiosks in-house.

Another object of the present invention is to provide an Enterprise-Level Brand Management And Marketing Communication Network, wherein sophisticated search capabilities are supported within the Multi-Mode Virtual Kiosk for multiple products and services from a brand owner.

Another object of the present invention is to provide an Enterprise-Level Brand Management And Marketing Communication Network, which has been designed to cater to virtually any level of bran portfolio complexity, and provides the capability for consumers to search for an unlimited number of products or services through the Multi-Mode Virtual Kiosk, as determined by the brand owner.

Another object of the present invention is to provide an Enterprise-Level Brand Management And Marketing Communication Network, wherein by experimenting with various different display schemas for Brand Information Networks as well as their presentation, brand managers can create powerful new vehicles that convey the value of their product or service brands more effectively than ever before—creating new forms of intellectual property.

Another object of the present invention is to provide an Enterprise-Level Brand Management And Marketing Communication Network, wherein once the brand owner has built the Multi-Mode Virtual Kiosk, s/he can instantly install it on the Web by placing a ‘trigger point’ (tag) on an online retail partner's site.

Another object of the present invention is to provide an Enterprise-Level Brand Management And Marketing Communication Network, wherein Multi-Mode Virtual Kiosks can then be ‘brought to life’ (launched and opened within a Web Browser program) by the user in four simple, intuitive ways: Launch button on an e-tail site or other Web touch point; Clickable image on a website; Image embedded in a document; and an Icon on a computer desktop.

Another object of the present invention is to provide an Enterprise-Level Brand Management And Marketing Communication Network, wherein the brand owner can activate/deactivate any Multi-Mode Virtual Kiosk with one click of the mouse, through the Network's easy-to-use Web-based system management interface.

Another object of the present invention is to provide an Enterprise-Level Brand Management And Marketing Communication Network, whereinonce brand owners or their trading partners have place Multi-Mode Virtual Kiosks on the Web, they can easily manipulate the way their Multi-Mode Virtual Kiosks deliver brand communications. For example, they can create an advertising campaign (with Advertising Display Mode as the dominant user experience) for a certain length of time and monitor it outcome. They can then shift the focus of the communication to a more promotionally-oriented experience (emphasizing the Promotional Display Mode), without having to recreate the whole set-up process from scratch and spend additional time, money and resources. When important new information about the product or service changes or fresh information becomes available, they can easily add one of more links to the Brand Information Display Mode, with a maximum of ten links.

Another object of the present invention is to provide an Enterprise-Level Brand Management And Marketing Communication Network, brand management team members can collaborate with their advertising and promotional agents as well as retail trading partners, in programming deployed Multi Mode Virtual Kiosks with brand-building marketing communications, with an unprecedented level of efficiency and accountability.

Another object of the present invention is to provide an Enterprise-Level Brand Management And Marketing Communication Network, wherein using a Web browser and a mouse, for example, brand managers can simply set and adjust the rights and responsibilities of their associates and/or agency and retail trading partners ‘on the fly’.

Another object of the present invention is to provide an Enterprise-Level Brand Management And Marketing Communication Network, wherein brand owners are provided with the ability to tightly control their online brand assets, effectively collaborate with their advertising and promotional agents and e-tail trading partners during online brand marketing campaigns, as well as directly communicate with online shoppers across multiple e-tail channels, both at points-of-sale and other places on the Web. The result is that consumers have information-rich brand experiences as intended by brand owners and develop more consistent brand images across all e-tail marketing channels, while great value and benefits are simultaneously created for e-tailer trading partners.

Another object of the present invention is to provide an Enterprise-Level Brand Management And Marketing Communication Network, wherein Multi-Mode Virtual Kiosks can be deployed and installed on emerging e-commerce platforms offline as well as online, including a home computer, interactive television, mobile phone or ATM machine.

Another object of the present invention is to provide an Enterprise-Level Brand Management And Marketing Communication Network, wherein user interfaces on Multi-Mode Virtual Kiosks (MMVK) are translatable so that marketers can communicate consistent brand messages and images across all Web-enabled offline platforms, independent of the footprint of the MMVK-supporting computing platform.

Another object of the present invention is to provide an Enterprise-Level Brand Management And Marketing Communication Network, wherein Multi-Mode Virtual Kiosks can be deployed and installed on any emerging e-commerce platform because its basic architecture runs on TCP/IP, the most basic communication layer of the Internet, and all technology of the future will be built on the TCP/IP layer.

Another object of the present invention is to provide an Enterprise-Level Brand Management And Marketing Communication Network, which is compatible with developing technologies like RFID and WIFI, for example, that extend the Internet to the physical world.

Another object of the present invention is to provide an Enterprise-Level Brand Management And Marketing Communication Network, wherein Multi-Mode Virtual Kiosks can be deployed and installed on various e-commerce mediums, such as for example: Multi-Mode Virtual Kiosks on Physical Retailer-Based Bar Code-Driven Kiosks (in multiple retail store locations and showrooms) in which retailers can measure Web metrics of in-store kiosk shoppers to manage displays and shelf space, and brand manufacturers can compare metrics of in-store shoppers vs. online shoppers to determine mindset and type of brand information sought for purchase; Multi-Mode Virtual Kiosks on Interactive TV (i.e. Web-enabled television or DTV) in which marketers can target and deliver brand messages tailored to specific audiences, and Multi-Mode Virtual Kiosks provide a ready-made “storefront” for retailers to quickly and inexpensively ramp up in this medium, with marketers interacting with shoppers on their websites and monitoring and measuring their activities in their Multi-Mode Virtual Kiosk, or ‘virtual store’; Multi-Mode Virtual Kiosks on Interactive Home Appliances, such as kitchen appliances (e.g refrigerators) allowing people to automatically inventory and order what they need by way of its Internet screen, which could easily feature recipes, e-coupons and other helpful links (e.g. showcasing coupons, recipes and other relevant information, and where marketers could arrange links between content sites (recipe and household care items) and direct purchases through online grocery stores; Multi-Mode Virtual Kiosks on M-Commerce Devices, such as Internet-enabled mobile phones and advanced third generation broadband technology (3G), which can support personalization, location-based services, and the integration of offline and online shopping experiences.

Another object of the present invention is to provide an Enterprise-Level Brand Management And Marketing Communication Network, wherein Multi-Mode Virtual Kiosks are launched on a small mobile screen at an opportune time, and brand managers and retailers can provide the real-time, targeted brand experiences to consumers who look to Multi-Mode Virtual Kiosks for quick and easy help deciding about a product or service on the road, by offering colorful, enticing brand images and messages which feature links in displayed Brand Information Networks on which users can click to enlarge.

Another object of the present invention is to provide an Enterprise-Level Brand Management And Marketing Communication Network, for deploying, installing and remotely programming brand-building server-side driven Multi-Mode Virtual Kiosks on the World Wide Web (WWW), so as to provide improved methods of brand marketing communication between brand marketers and consumers, a virtually any Web-enabled touchpoint.

Another object of the present invention is to provide an Enterprise-Level Brand Management And Marketing Communication Network that is synchronized with the supply-side information management operations of product manufacturer's enterprise.

Another object of the present invention is to provide brand managers with a revolutionary new brand management and marketing communication media designed to serve as a central control center for managing and marketing their brands everywhere on the Internet, over all Web-based consumer touch points, now and into the future.

Another object of the present invention is to provide an Enterprise-Level Brand Management And Marketing Communication Network, wherein brand managers can visualize the Brand Images projected by Brand Information Networks created by brand management team members, by automatically previewing brand assets in the brand information networks in an automated manner.

Another object of the present invention is to provide an Enterprise-Level Brand Management And Marketing Communication Network, which gives marketers complete control over the myriad of brand assets, messaging and promotions scattered throughout the Web. For the first time, they can ensure that consumers receive consistent brand experiences anywhere on the Internet.

Another object of the present invention is to provide an Enterprise-Level Brand Management And Marketing Communication Network, wherein brand managers or authorized agents can manage the design and implementation of online interactive marketing campaigns rather than employ costly third parties. Because the technology is easy to use, anyone on the brand management team can create or update a Multi-Mode Virtual Kiosk in real time. There is no need to outsource the Multi-Mode Virtual Kiosk when changes are needed.

Another object of the present invention is to provide an Enterprise-Level Brand Management And Marketing Communication Network, wherein brand managers can deliver more effective brand-building experiences to consumers by deploying Multi-Mode Virtual Kiosks that provide non-intrusive, engaging online experiences that consumers launch when they are seeking more information about a brand. Multi-Mode Virtual Kiosks are activated by launch buttons that brand owners can strategically place at any Web touchpoint when consumers are likely to be open to information about a brand.

Another object of the present invention is to provide an Enterprise-Level Brand Management And Marketing Communication Network, which helps to increase online shopper conversion rates by providing consumers with collaboratively-programmed Multi-Mode Virtual Kiosks that provide consumers with a well-designed and easy-to-use research source, requiring a only a few clicks to find in depth information rather than a search through endless web pages. Because a Multi-Mode Virtual Kiosk enables online shoppers to quickly find all of the information for the buying decision in one place, the are more likely to move quickly through the buying cycle and proceed to checkout. E-tailers are likely to note an increase in shopper conversions.

Another object of the present invention is to provide an Enterprise-Level Brand Management And Marketing Communication Network, which helps increase customer retention by delivering to consumers, Multi-Mode Virtual Kiosks that can be easily changed (e.g. programmed), so that customers are more likely to revisit the same products on e-tail sites, drawn by the promise of fresh, up to date, interesting information or the latest promotions about their desired products in the Kiosks. This provides another key benefit for e-tailers.

Another object of the present invention is to provide an Enterprise-Level Brand Management And Marketing Communication Network, which enables consistent brand messaging across all marketing communication and retail distribution channels on the WWW, by enabling cooperation (i.e. collaboration) of brand management team members, their agents and e-tailers and trading partners. This incents trading partners to collaborate and deliver a uniform brand experience to consumers online.

Another object of the present invention is to provide an Enterprise-Level Brand Management And Marketing Communication Network, wherein Multi-mode Virtual Kiosks are interactive online tools that marketers can use to track, test and monitor consumer behavior and attitudes toward a particular brand campaign. Brand owners can test advertising and promotional messaging and identify ideal path for purchase behavior. This market research about the brand can be extremely valuable to the brand's television and print media advertising as well.

These and other objects of the present invention will become apparent hereinafter and in the Claims to Invention.

### BRIEF DESCRIPTION OF THE DRAWINGS

For a more complete understanding of how to practice the Objects of the Present Invention, the following Detailed Description of the Illustrative Embodiments can be read in conjunction with the accompanying Drawings, briefly described below.

FIG. 1A sets forth a table describing features and benefits of the server-side driven, brand-building Multi-Mode Virtual Kiosks and the Internet-based Brand Management and Marketing Communication Instrumentation Network of the illustrative embodiment work in accordance with the principles of the present invention;

FIGS. 1B1 through 1B7, taken together, show a flow chart describing a method of building MMVK-Powered Brand Marketing Communication Network in accordance with the principles of the present invention;

FIG. 2A is a high-level schematic representation of the Internet-based Brand Management and Marketing Communication Instrumentation Network of the present invention, realized as an industrial strength, carrier-class Internet-based brand management and marketing communications network of object-oriented system design (OOD), implemented on a Java-based object-oriented integrate development environment (IDE) such as WebObjects 5.2 by Apple Computer Inc, Websphere IDE by IBM, or Weblogic IDE by BEA;

FIGS. 2B1 through 2B4 set forth a systems block diagram of the Internet-Based Bran Management and Marketing Communication Network of the present invention (i.e. “BKS Network”), deployed on the globally-extensive packet-switched information network supporting numerous industries on the planet Earth, comprising diverse kinds of subsystems and network components thereon, as shown;

FIGS. 3A and 3B are schematic representations of two alternative implementations of the enterprise-level Brand Management and Marketing Communications Network of the present invention using the WebObjects IDE and Java Application Server;

FIGS. 4A and 4B, taken together, show a table setting forth definitions of terms used throughout the present detailed description of the Brand Management and Marketing Communication Network of the present invention;

FIGS. 5A through 5D, taken together, set forth a schematic diagram of the relational database management system (RDBMS) used to store the persistent enterprise objects associated with the Brand Management and Marketing Communication Network of the illustrative embodiment;

FIG. 6A is the home-page located GUI panel of the Internet-based Brand Management and Marketing Communication Network of the present invention which, as shown, comprises five separate Subsystems that support User Services, namely, Brandkey Manage™ Subsystem, the Brandkey Create™ Subsytem, Brandkey Deliver™ Subsystem, the Brandkey Advertise™ Subsystem, and the Brandkey Promote™ Subsystem;

FIGS. 6B1 through 6B10, taken together, sets forth a table listing the numerous marketing information service suites and instruments supported by the Brand Management and Marketing Communication Network of the present invention;

FIGS. 7A through 7H set forth a select group of GUI panels and marketing information service supported by the Brandkey Manage™ Subsystem;

FIGS. 8A through 8I set forth GUI panels and marketing information services supported by the Brandkey Create™ Subsytem;

FIGS. 9A through 9K set forth GUI panels and marketing information services supported by the Brandkey Deliver™ Subsystem;

FIGS. 10A through 10H set forth GUI panels and marketing information services supported by the Brandkey Advertise™ Subsystem; and

FIGS. 11A through 11G set forth GUI panels and marketing information services supported by the Brandkey Promote™ Subsystem;

FIG. 11H illustrates an exemplary process describing how a vendor brand manager can work with a retailer brand manager to use the Brand Management and Marketing Communications Network of the present invention in order to deploy and install Product-Specific Multi-Mode Virtual Kiosks on the etailers WWW site at points of virtual product display;

FIGS. 12A through 12G, taken collectively, set forth GUI panels supported by a Product-Specific (PS) Multi-Mode Virtual Kiosk (MMKV) deployed and remotely programmed by the enterprise-level, collaboration-enabling Brand Management and Marketing Communication Network of the present invention;

FIG. 13 is schematic state diagram of the Product-Specific (PS) Multi-Mode Virtual Kiosk (MMKV) shown in FIGS. 12A through 12G, illustrating the various states of operation thereof in response to interaction by a consumer with the GUIs of the MMVK;

FIG. 14 is a schematic state diagram illustrating the operation of the automatic client browser and media player detection subsystem of the present invention, embodied with both the client side (i.e. MMVK) and server side of the Brand Management and Marketing Communication Network;

FIG. 15A is a first implementation of a Multi-Mode Virtual Kiosk of the present invention, employing HTML, and an Embedded Media Player;

FIG. 15B is a second implementation of a Multi-Mode Virtual Kiosk of the present invention, employing HTML, Flash and an Embedded Media Player;

FIG. 15C is a third implementation of a Multi-Mode Virtual Kiosk of the present invention, employing D/HTML, and an Embedded Media Player;

FIG. 15D is a fourth implementation of a Multi-Mode Virtual Kiosk of the present invention, employing an Applet; and

FIG. 15E is a fifth implementation of a Multi-Mode Virtual Kiosk of the present invention, employing Scalable Vector Graphics (SVG).

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

In general, the Detailed Description set forth below discloses a detailed specification of a illustrative embodiment of the enterprise-level brand management and marketing communications network of the present invention, supporting the creation, configuration, deployment, installation and programming of server-side driven brand-building Multi-Mode Virtual Kiosks (MMVKs) of various types, in accordance with the principles of the present invention. In general this illustrative embodiment employs many of the inventive principles disclosed in Applicants' International Patent Application Publication Nos. WO 98/19259 published on May 7, 1998, and WO 01/37540 A2 published on May 25, 2001, both of which are incorporated herein by reference in their entirety as if set forth fully herein.

Internet-Based Brand Management and Marketing Communication Instrumentation Network of the Present Invention Employing Remotely Programmable Server-Side Driven Brand-Building Multi-Mode Virtual Kiosks

The Internet-based (inter-) enterprise-level Brand Management and Marketing Communication Instrumentation Network of the present invention will now be described in detail as a robust solution to the online brand management and marketing communication problems experienced by product, service and corporate brand marketers, world-over.

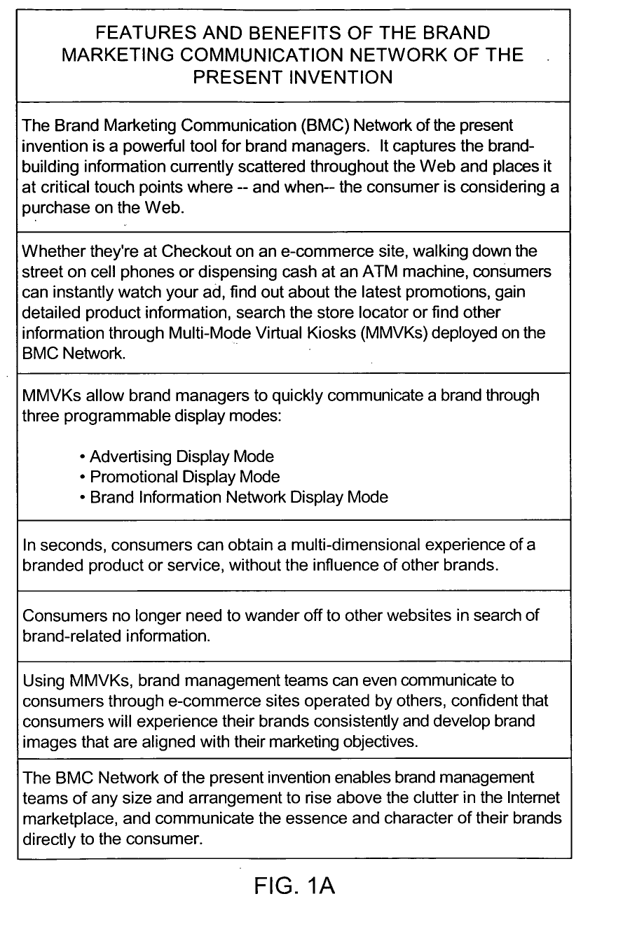

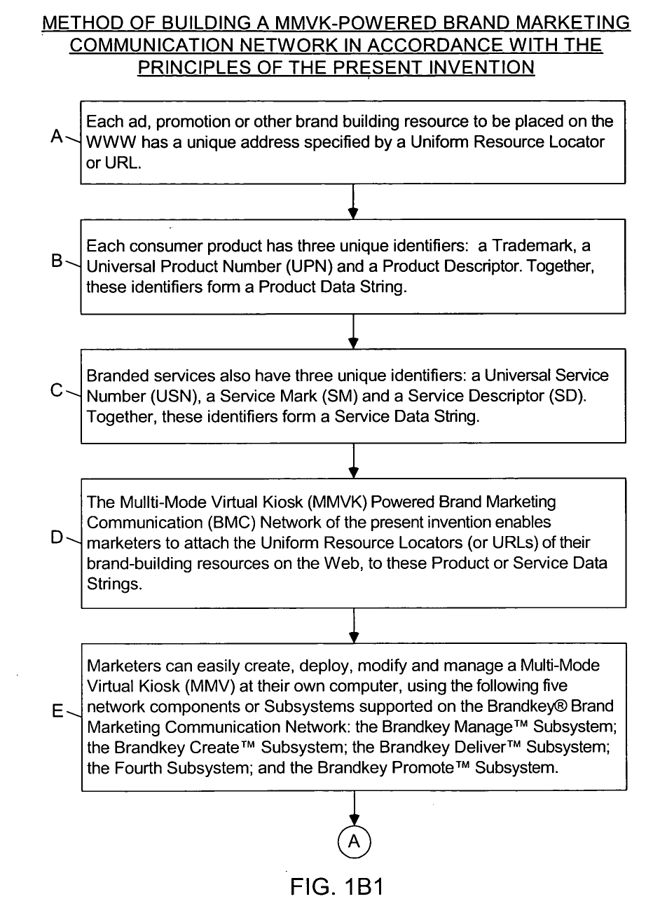

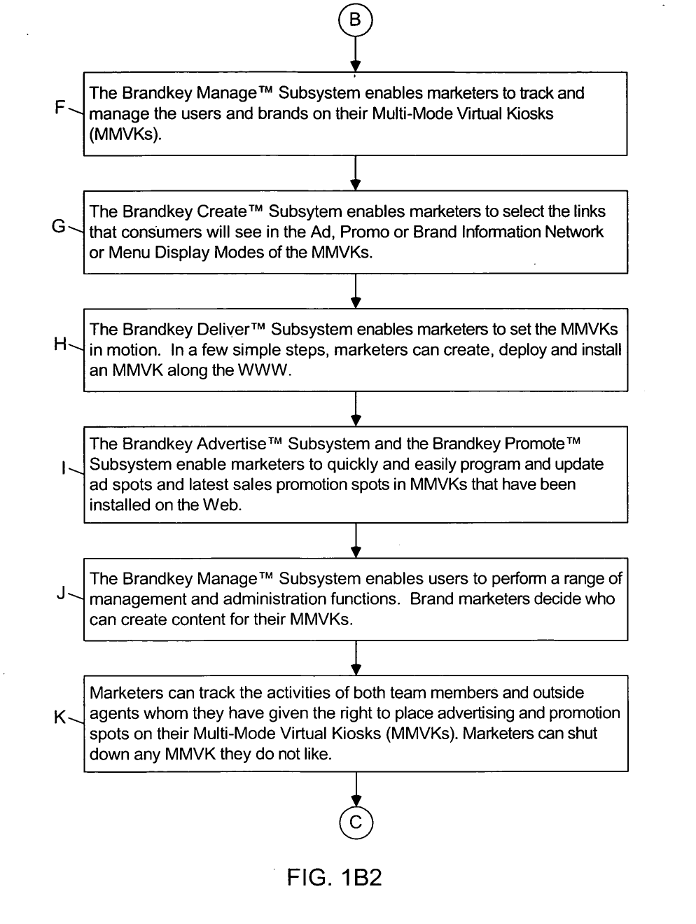

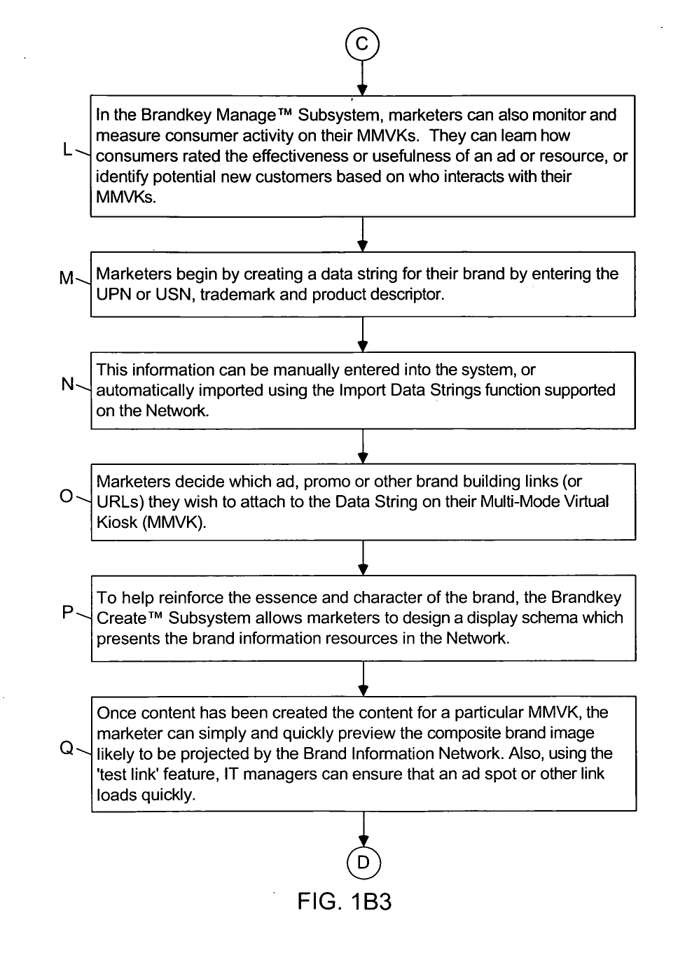

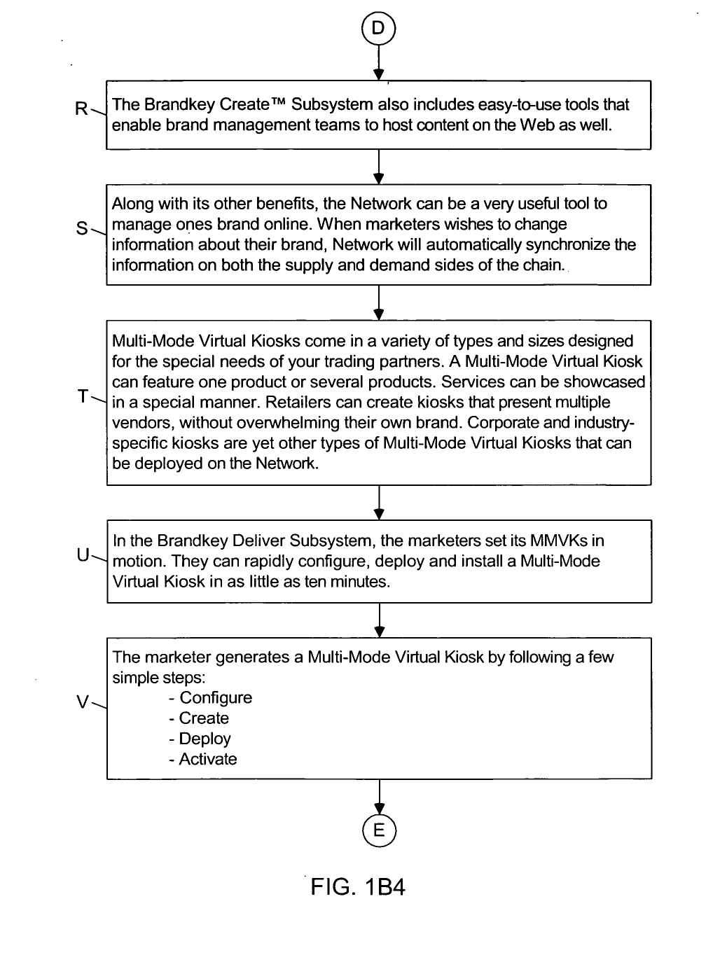

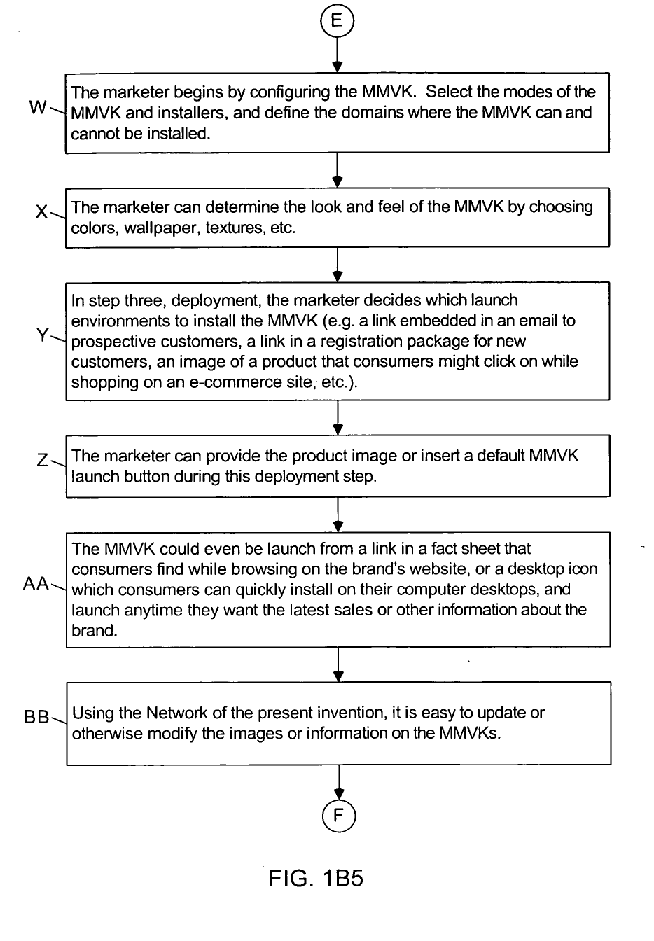

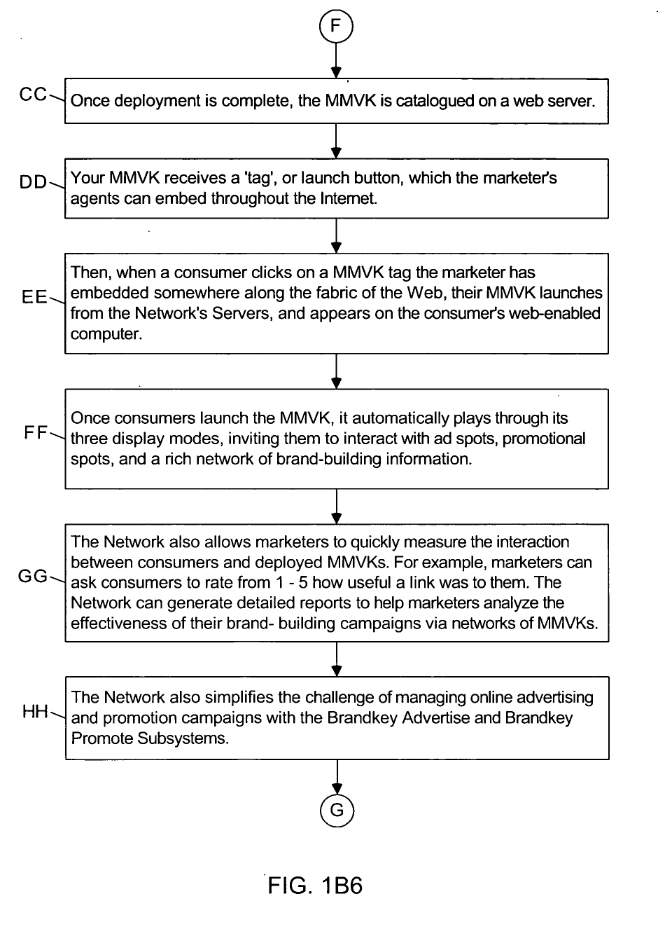

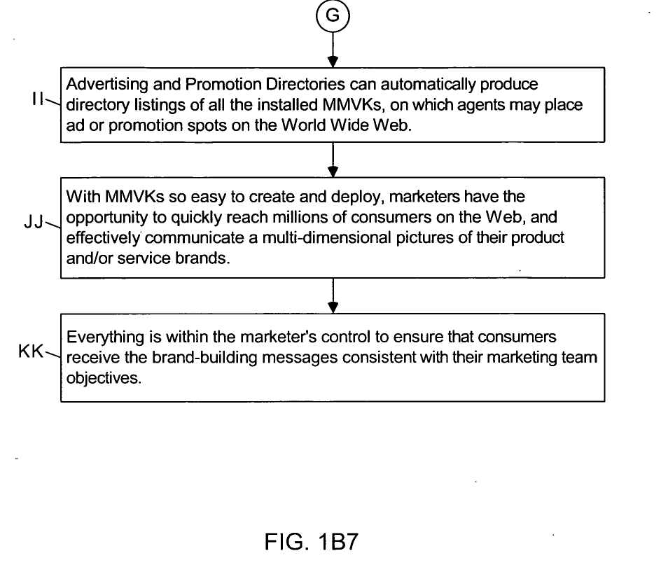

As indicated in FIG. 1A1 1A, the Brand Management and Marketing Communication Network of the present invention is a powerful tool for brand managers. It captures the brand-building information currently scattered throughout the Web and places it at critical touch points where and when the consumer is considering a purchase on the Web.

Whether they are at a checkout on an e-commerce site, walking down the street on cell phones of dispensing cash at an ATM machine, consumers can instantly watch your ad, find out about the latest promotions, gain detailed product information, search the store locator or find other information through something called a “Multi-Mode Virtual Kiosk (MMVK)”.

Multi-Mode Virtual Kiosks (MMVKs) allow brand managers to quickly communicate a brand through three programmable display modes: Advertising Display Mode; Promotional Display Mode; and Brand Information Network Display Mode

In seconds, consumers can obtain a multi-dimensional experience of a branded product or service without the influence of other brands, and consumers no longer need to wander off to other websites in search of brand-related information.

Using Multi-Mode Virtual Kiosks, brand management teams can even communicate to consumer through e-commerce sites operated by others confident that consumers will experience their brand consistently and develop brand images that are aligned with their marketing objectives.

The Brand Management and Marketing Communication Instrumentation Network of the present invention enables brand management teams of any size and arrangement to rise above the clutter in the Internet marketplace, and communicate the essence and character of their brands directly to the consumer.

Referring to FIGS. 1B1 through 1B7, a method of building a MMVK-powered brand marketing communication network will be described in accordance with the principles of the present invention.

As indicated at Block A in FIG. 1B1, each ad, promotion or other brand building resource that is placed on the WWW, has a unique address thereon specified by a Uniform Resource Locator (URL).

As indicated at Block B in FIG. 1B1, each product has three unique identifiers: a Trademark (TM), a Universal Product Number (UPN) and a Product Descriptor (PD). Together, they form a Product Data String (UPN/TM/PD).

As indicated at Block C in FIG. 1B1, branded services also have three unique identifiers: a Universal Service Number (USN), a Service Mark (SM) and a Service Descriptor (SD). Together, the form a Service Data String (USN/SM/SD).

The network enables brand management team members to attach the Uniform Resource Locators (or URLs) to brand-building information resources on the Web, to these Product Data Strings (UPN/TM/PD) or Service Data Strings (USN/SM/SD), to produce Product Data Links (UPN/TM/PD/URL) or Service Data Links (USN/SM/SD/URL), as the case may be.

As indicated at Block E in FIG. 1B1, using the Brand Management and Marketing Communication Instrumentation Network of the present invention, brand management team members can easily create, deploy, modify and manage a Multi-Mode Virtual Kiosk (MMVK) at any Web-enabled computer, using the following five network components, namely: the Brandkey Manage™ Subsystem; the Brandkey Create™ Subsystem; the Brandkey Deliver™ Subsystem; the Brandkey Advertise™ Subsystem; and the Brandkey Promote™ Subsystem, as shown in FIG. 1C1.

As indicated at Block F in FIG. 1B2, the Brandkey Manage Subsystem enables brand management team members to track and manage the users and brands on their brand's Multi-Mode Virtual Kiosks.

As indicated at Block G in FIG. 1B2, the Brandkey Create Subsystem enables brand management team members to select and set the links that consumers will see in the Ad, Promo or Brand Information Network Display modes of Multi-Mode Virtual Kiosks deployed on the Network.

As indicated at Block H in FIG. 1B3, the Brandkey Deliver Subsystem provides tools which enable brand management team members, trading partners (and even consumers), to deploy and install Multi-Mode Virtual Kiosks and set these interactive Web-based in motion. In a few simple steps, one can create, deploy and install the Multi-Mode Virtual Kiosk.

As indicated at Block I in FIG. 1B2, the Brandkey Advertise and Brandkey Promote Subsystem enable brand management team members, as well as their advertising and their promotional agents, t program and update their brand's ad spots and latest sales promotions on the Web quickly and easily.

As indicated at Blocks J, K and L in FIGS. 1B2 and 1B3, the Brandkey Manage Subsystems enables users to perform a range of management and administration functions. The brand manager, chief marketing officer (CMO), or the like can decide who can create content for its brand's Multi-Mode Virtual Kiosks. The brand manager can track the activities of both team members and outside agent whom s/he has given the right to place advertising and promotion spots on the brand's Multi-Mode Virtual Kiosks. Using Brandkey Deliver Subsystem, the brand manager can also shut down any Multi Mode Virtual Kiosk s/he desires. In the Brandkey Manage System, one can also monitor and measure consumer activity on the Multi-Mode Virtual Kiosks. One can find out how consumers rated the effectiveness or usefulness of an ad or resource, or identify potential new customers based on who downloads one's Multi-Mode Virtual Kiosks.

As indicated at Blocks M and N in FIG. 1B3, the brand manager (or its designated staff member) begins by creating a Product Data String for the branded product by entering the UPN, Trademark and Product Descriptor, or Service Data String for the branded service by entering the USN, Servicemark and Service Descriptor. This information can be entered manually, or automatically imported from a UPC Product Sales Catalogue on the product brand's supply-chain information management system, using the Import Data Strings Function supported in the Brandkey Create Subsystem.

As indicated at Block O in FIG. 1B3, the brand management team decides which ad, promo of other brand building links (or URLs) they wish to attach to the Data String on their Multi-Mode Virtual Kiosk.

As indicated at Block P in FIG. 1B3, to help reinforce the essence and character of the brand, the Brandkey Create Subsystem allow a brand management team member to select a Display Schema for visually presenting to consumers, a selected arrangement of brand information resources (i.e. nodes) in the Brand Information Network that is supported by an underlying set of Product Data Links (UPN/TM/PD/URLs) or Service Data Links (USN/SM/SD/URLs).

As indicated at Block Q in FIG. 1B3, once the content that will appear on the Multi-Mode Virtual Kiosk has been created and integrated within a richly-associated Brand Information Network (formed by Product or Service Data Links with a selected Display Schema, etc), the brand management team can then simply and quickly preview the composite brand image likely to be projected by the created Brand Information Network. Using the ‘test link’ feature, IT managers can ensure that an ad spot or other link in the Brand Information Network loads quickly.

As indicated at Block R in FIG. 1B4, the Brandkey Create Subsystem also includes easy-to-use tools that enable brand management teams to host content on the Web as well, e.g. on the networks own Internet information servers, or on the content data network of an affiliated global CDN such as provided by Akamai. Along with its other benefits, the Brandkey Create Subsystem can be a very useful tool to manage one online brand information resources, to ensure consistent brand image communication across all brand marketing communication channels on the Internet.

As indicated at Block S in FIG. 1B4, when the brand management team wishes to change information about their product, service or corporate brand, the Brand Management and Marketing Communication Network can be used modify brand building information resources linked to brand-information keys (e.g. Product Data Strings or Service Data Strings) that are automatically synchronized with the brand's information maintained on the supply side of the retail value chain.

As indicated at Block T in FIG. 1B4, Multi-Mode Virtual Kiosks come in a variety of types and sizes designed for the special needs of your trading partners. Multi-Mode Virtual Kiosks (MMVKs) can feature one product or several products using Product-Specific MMVKs or Vendor-Specific MMVKs, respectively. Services can be showcased in a special manner using Service-Specific MMVKs, and Service-Provider-Specific MMVKs. Retailers can create Multi-Mode Virtual Kiosks that present multiple vendors, without overwhelming their own brand, using Retailer-Specific MMVKs. Corporate Specific and Industry-Specific MMVKS are yet other types of Multi-Mode Virtual Kiosks that are supported by the Brand Management and Marketing Communication Network of the present invention.

As indicated at Blocks U, V, W and X in FIGS. 1B4 and 1B5, using the Brandkey Deliver Subsystem, the brand management team sets the Multi-Mode Virtual Kiosk in motion. They can rapidly configure, deploy and install a Multi-Mode Virtual Kiosk in as little as ten minutes. One can generate a Multi-Mode Virtual Kiosk by following a few simple steps: Configure; Create; Deploy; and Activate. One begins by configuring the Multi-Mode Virtual Kiosk. Select the modes and installers, and define the domains where the Multi-Mode Virtual Kiosk can and cannot be installed. Here one can ensure that Multi-Mode Virtual Kiosks will not appear on a brand-damaging site, for example. Then, one can determine the look and feel of the Multi-Mode Virtual Kiosk by choosing colors, wallpaper, textures, etc.

As indicated at Blocks Y, Z, AA and BB in FIG. 1B5, one decides during MMVK deployment which launch environments are needed or desired. Relevant questions asked at this stage include, for example: Will the Multi-Mode Virtual Kiosk (MMVK) be a link embedded in an email to prospective customers? A link in a registration package for new customers? Or an image of a product that consumers might click on while shopping on an e-commerce site? The brand management team member can provide this image or s/he can insert the Default BKS button when they do not have an image. The Multi-Mode Virtual Kiosk could even be a link in a fact sheet that consumers find while browsing on the brand's website or a desktop icon which consumers can quickly install on their computer desktops, and launch anytime they want the latest sales or other information about the product, service or corporate brand. It id easy to update or otherwise modify the images or information on the Multi-ModeVirtual Kiosks.

As indicated at Blocks CC, DD and EE in FIG. 1B6, once deployment is complete, the Multi-Mode Virtual Kiosk (MMVK) is catalogued on a Web information server associated with the network. Each Multi-Mode Virtual Kiosks receives a ‘tag’, or launch button, which the brand management team member, or it agent, can embed throughout the fabric of the Internet. Then, when a consumer clicks on a MMVK tag that has been embedded somewhere along the fabric of the Web, the Multi-Mode Virtual Kiosk launches from the Network Server, and appears on the consumer's web-enabled computer.

As indicated at Blocks FF and GG in FIG. 1B6, once consumers launch the Multi-Mode Virtual Kiosk, it automatically plays through its three display modes, inviting them to interact with ad spots, promotional spots, and a richly-associated network of brand-building information. The Network also allows one to quickly measure the interaction between consumers and Multi-Mode Virtual Kiosks. For example, one can ask consumers to rate from 1-5 how useful a link, presented during the Brand Information Network Display Mode, was to them. The Brand Management And Marketing Communication Network of the present invention can generate detailed reports to help brand management team members analyze the effectiveness of their online brand-building campaigns.

As indicated at Blocks HH and II in FIG. 1B7, the Brand Management and Marketing Communication Network of the present invention also simplifies the challenge of managing online advertising and promotion campaigns with the Brandkey Advertise and Brandkey Promote Subsystems. Using these subsystems, Advertising and Promotion Directories can automatically produce directory listings of all the installed Multi-Mode Virtual Kiosks, on which agents may place ad or promotion spots on the World Wide Web. Authorized agents can quickly start, stop or modify campaigns.

As indicated at Blocks JJ and KK in FIG. 1B7, with the Brand Management and Marketing Communication Network of the present invention, Multi-Mode Virtual Kiosks are easy to create and deploy, and brand management teams have the opportunity to quickly reach millions of consumers on the Web, and effectively communicate a multi-dimensional picture of ones brand. Everything is within the brand manager's control to ensure that consumers receive consistent brand-building messages and images in accordance with the brand marketing objectives of the team.

The Vision behind the Brand Management and Marketing Communication Network of the present invention is to enable the creation of a global marketplace in which all brand marketers of products and services, large and small, have equal access to a relatively inexpensive, simple-to-use, yet extremely powerful set of Web-based marketing instruments that allow them to communicate directly and freely with consumers anywhere along the World Wide Web, while creating value for consumers and their retail trading partners alike. Such new forms of brand marketing communication will occur without adversely affecting the brand marketer's trading partners, while enabling the reliable delivery of the best and most valuable brand building information resources to consumers wherever they might be needed most, and regardless of where such brand building information resources may actually be hosted on the Internet, e.g. Akamia® Global Content Delivery Network (CDN), or elsewhere.

New value will be simultaneously created in the marketplace for consumers, brand owners, their agents and retail trading partners alike by providing widespread distribution of brand-building Multi Mode Virtual Kiosks, in which their Multiple Display Modes are (i) remotely programmable through a industrial-strength carrier-class Internet-based Brand Marketing Communication Instrumentation Network, and (ii) are capable of displaying rich-media advertising spots, promotional spots, and Bran Information Networks (BINS) composed of virtually any form information media on the Internet simple indexed using brand-related information keys, e.g. Universal Product Numbers (UPNs), Trademarks, (TMs) Product Descriptors (PDs), Universal Service Numbers (USNs), Servicemarks (SMs), Brand Names, etc.—so that Brand Managers are provided complete control over their brand marketing communications on the Internet, while improving collaboration among brand management team members within and outside of the Brand's enterprise.

In general, such an Internet-based Brand Marketing Communication Instrumentation Network of the present invention should be capable of deploying server-side driven brand-building Multi-Mod Virtual Kiosks at any point along the World Wide Web, and remotely programming the display modes thereof so as to deliver advertising and promotional campaigns and brand knowledge Building Information Networks (of links) to consumers whenever and wherever they may be on the WWW. The stakeholders associated with this object-oriented system are brand managers, their advertising and promotional agents, the brand entities which the represent, and their primary interests are to build brand equity in the minds and hearts of consumers, while protecting Brands by maintaining the highest possible system integrity and security—trustworthiness. The minimal guarantees sought by the Network are to provide brand management teams, large and small, and of any possible arrangement, with the ability to simply and rapidly program and deliver brand-building information content through the multiple display modes of server-side driven Multi-Mode Virtual Kiosks launchable from numerous types of environments at virtually any touchpoint on the World Wide Web-using only simple mouse-clicks and data entry operations and without the assistance of Java programmers. By ensuring the delivery of valuable brand-building information resources to consumers through Multi-Mode Virtual Kiosks, the strength of Brand Entities in the lives of consumers should be increased—making such “Brands Come to Mind^{SM}”.

The Brand Management and Marketing Communication Network of the present invention provides an advanced ensemble of revolutionary Internet-based Brand-Marketing Instruments (i.e. tools) which enable brand management teams (including chief brand officers, marketing officers, brand managers, staff members and their advertising and promotional agents, brand consultants, etc) to provide consumers with rich, multimedia brand experiences, based on advertisements, promotions and other information about their specific Products and Services at specific Internet-enabled point-of-sale consumer touch-points. These marketing instruments also to help brand management teams to manage the bran knowledge that consumers develop about a company's products and services in order to shape and reinforce the desired Brand Image that consumers develop in their minds before, during and after product and service purchases.

The Brand Management and Marketing Communication Network of the present invention enables brand management teams of any size and arrangement to effectively manage and communicate the essence and character of their Brands over the Internet.

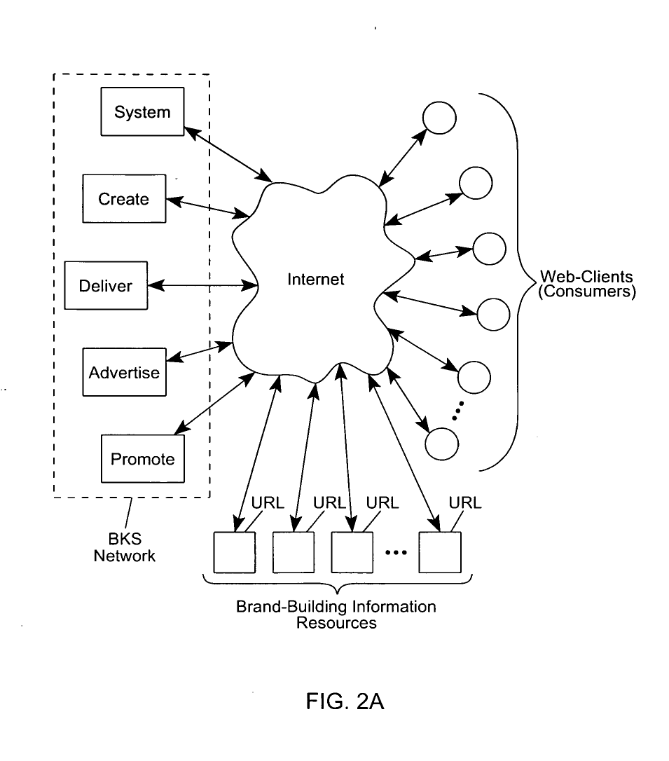

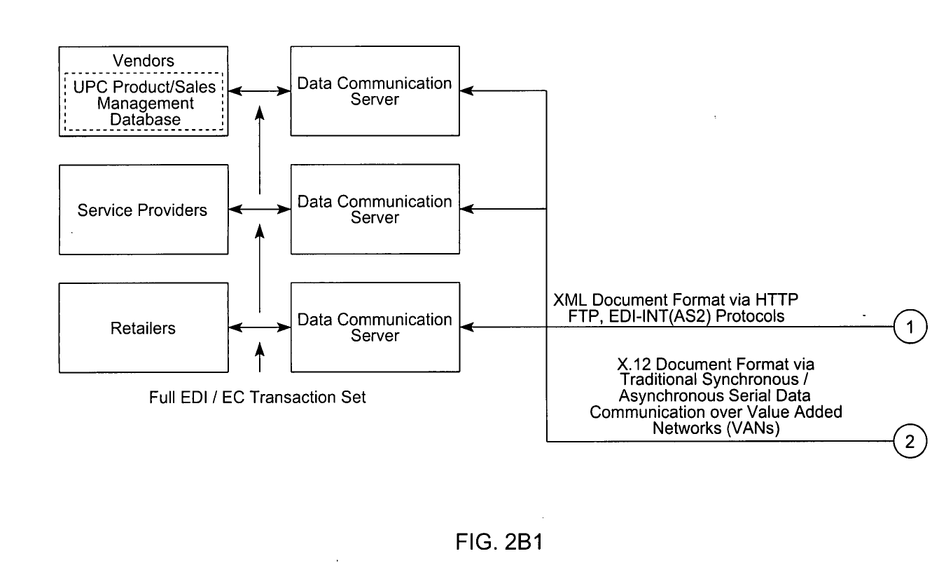

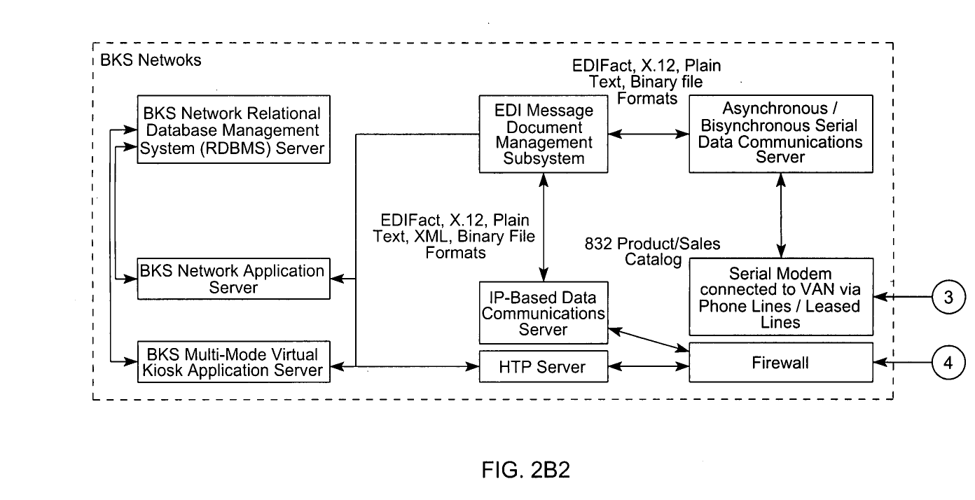

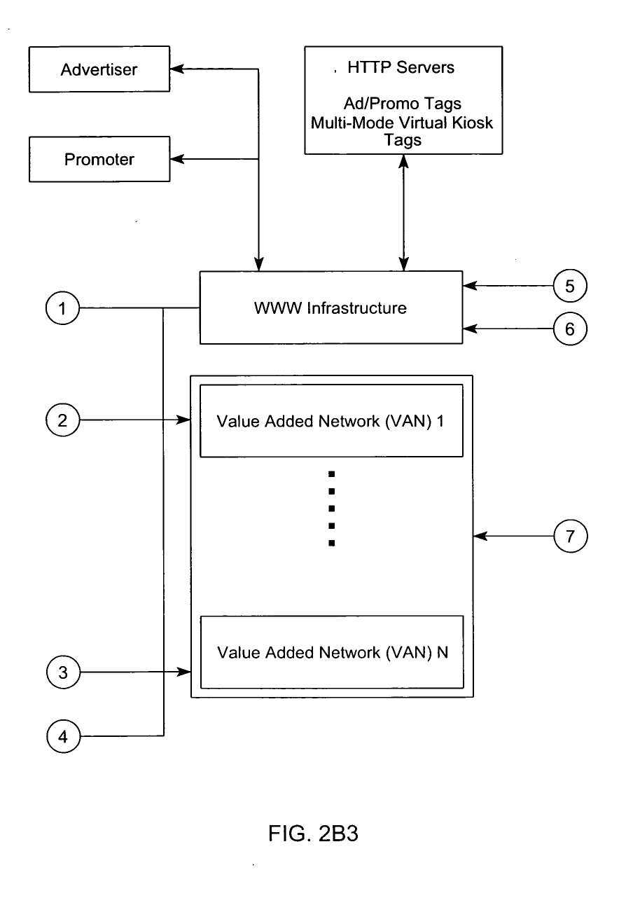

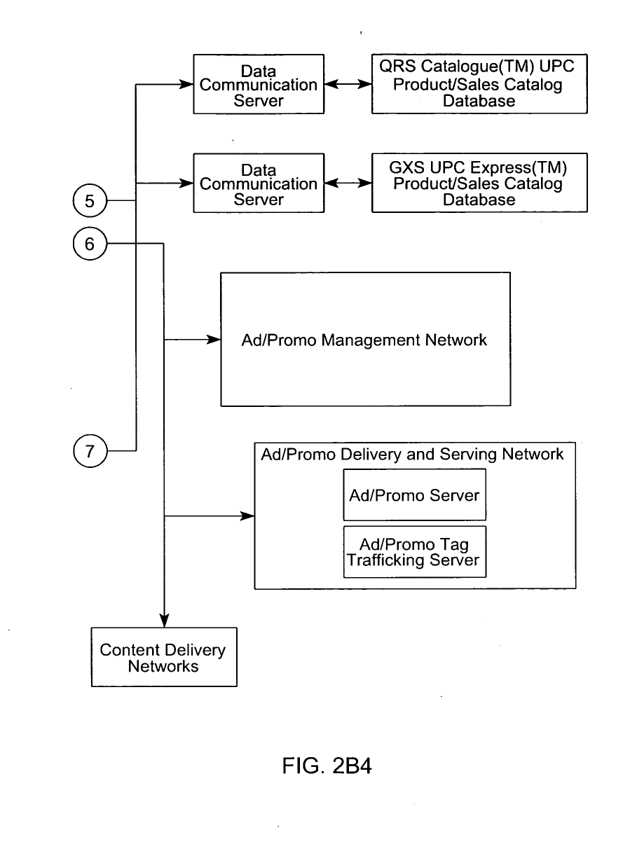

As summarized in FIG. 2A, the Brand Management and Marketing Communication Network of the present invention is composed of five primary Subsystems connected to the infrastructure of the Internet; five of these Subsystems are used by Client users, whereas one Subsystem is used exclusively by BKS Administrators, employees and consultants. Each of these Subsystems supports one or more Service Suites, and each Service Suite contains one or more Control Panels. These Control Panels support the delivery of the BKS Network's Marketing Instruments.

The five BKS Subsystems used by Client users are: Brandkey Systems™ Subsystem; Brandkey Create™ Subsystem; Brandkey Deliver™ Subsystem; Brandkey Advertise™ Subsystem; and Brandkey Promote Subsystem™ Subsystem. The one BKS Subsystem used by BKS Administrators, employees and consultants is the BKS Administration Subsystem. Notably, the BKS Network is supported by a seventh subsystem, entitled the BKS TM Multi-Mode Virtual Kiosk Serving Subsystem, which serves up all Multi-Mode Virtual Kiosks to Consumers anywhere the Internet, but this subsystem does not support any client user GUIs.

The Brand Management and Marketing Communication Network of the present invention allows brand management teams to rapidly configure, deploy and install Brand-Building Multi-Mode Virtual Kiosks at the various consumer touch-points.
These Consumer Touch-points include:
Desktop Computers
WiFi-enabled Portable Devices
Physical Retail Kiosks
ATMs Interactive Television Sets
PDAs and
Cell Phones

At each of these consumer touch-points, brand management teams have the option of delivering their Brands' Multi-Mode Virtual Kiosks through a number of different Launch Environments. Such Launch Environments include:
BKS™ Virtual Kiosk Launch Buttons
HTML-Encoded Documents
HTML-Encoded Images
HTML-Encoded Desktop Icons

These Consumer Touch-points and Launch Environments allow Brand Management Teams t reach a broad range of Consumer markets over the Internet.

Multi-Mode Virtual Kiosks of the present invention support three independently programmable modes of display: (1) Advertising Spot Display Mode, in which the Multi-Mode Virtual Kiosk display Ad Spots programmed by the Brand Management Team or their Agents; (2) Promotional Spot Display Mode during which the Multi-Mode Virtual Kiosk displays Promo Spots programmed by the Brand Management Team or their Agents; and (3) Brand Information Network Display Mode in which the Multi-Mode Virtual Kiosk displays a menu of Brand-Building Information Resource Links consistent with the Team's brand marketing objectives.

These modes of marketing communication and display cooperate with the purpose of allowing consumers to experience any product, service or corporate brand without the influence of other Brands as well as marketplace clutter (i.e. pop-ups and banner ads). Brand Management Teams may select any combination of these Modes to be displayed in their Multi-Mode Virtual Kiosks.

Multi-Mode Virtual Kiosks come in a variety of types and sizes designed for the special needs of trading partners:
Product-Specific and Vendor-Specific Virtual Kiosks can feature one product or several products, respectively.
Services can be showcased in a special manner in Service-Specific and Service-Provider-Specific Virtual Kiosks.
Retailers can create Retailer-Specific Multi-Mode Virtual Kiosks that present multiple vendors, without overwhelming their own brand.
Corporate-Specific and Industry-Specific Virtual Kiosks are yet other types of Multi-Mode Virtual Kiosks.
   System Architecture of the Brand Management and Marketing Communication Network of the Present Invention Deployed on the Global Data Packet Information Network

As shown in FIGS. 2B1 through 2B4, the Internet-based Enterprise-Level Brand Management and Marketing Communication Instrumentation Network of the present invention (i.e. BKS Network) is realized as an industrial-strength, carrier-class Internet-based multi-media communications network of object-oriented system design, deployed on the global data packet information network comprising numerous information subsystems and systems and network components, as shown.

As shown in FIGS. 2B1 through 2B4, the Brand Management and Marketing Communication Network of the present invention (BKS Network) is uniquely situation so as to tie into two separate networks currently used to propagate Supply-Side marketing and Demand-Side marketing. EDI is a well established technology and is widely used by manufacturing concerns and their trading partners to pass information from one to the other. The BKS Network harnesses the capabilities of the EDI Network and its VANs to be able to capture the basic information required to identify Products and Services. The BKS Networks also synchronized with such EDI systems to as to keep updated with any changes in the universe of Products and Services offered. Via the infrastructure of the Internet, the BKS Network is also connected via the Internet to the Ad/Promo Delivery Networks (Doubleclick, etc.), Content Delivery Networks (Akamai, etc.) and Ad/Promo Management Networks (MSN, etc.) to use their services to place and monitor Virtual Kiosks throughout the Internet. Advertisers and Promoters are able to access the BKS Network to place Ads and Promos on Multi-Mode Virtual Kiosks, which will then be placed on HTTP Servers over the Internet. Throughout this process, the Vendors, Service Providers and Retailers will by able to monitor and manage this process over the internet and be able to hook into their Content Management Systems (CMS) to select which brand-building assets to deliver to consumers at what point on the Internet through the installed Multi-Mode Virtual Kiosks.

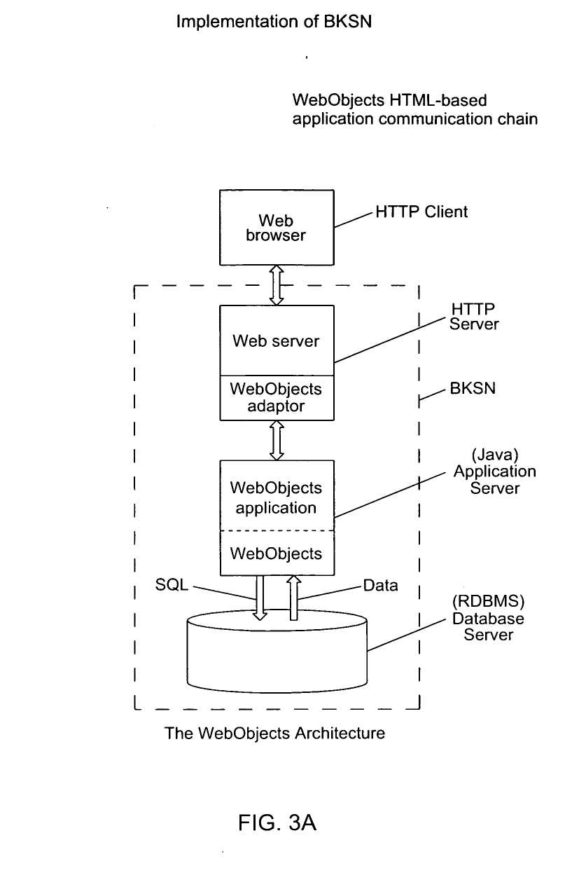

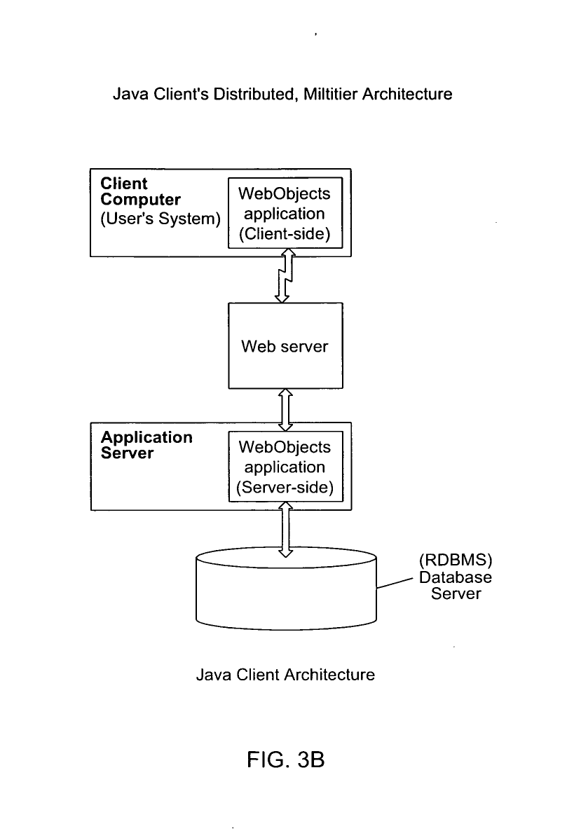

In general, the Internet-based Brand Management and Marketing Communication Instrumentation Network of the present invention can be implemented on any Java-based object-oriented integrated development environment (IDE) such as WebObjects 5.2 by Apple Computer Inc, Websphere IDE by IBM, or Weblogic IDE by BEA, or even an non-Java IDE such as Microsoft's.NET IDE. Two different Network implementations using the WebObjects IDE are illustrated in FIGS. 3A and 3B using Web-based and Java-client technology, respectively. The entire Brand Management and Marketing Communication Instrumentation Network of the present invention is designed according to object-oriented systems engineering (OOSE) methods using UML-based modeling tools such as ROSE by Rational Software, Inc. or Together by Borland Software, using the industry-standard Rational Unified Process (RUP) or Enterprise Unified Process (EUP), both well known in the art. A three-tier server architecture with double-firewall would provide a preferred deployment platform on the Internet.

In the illustrative embodiment, the Brand Management and Marketing Communication Instrumentation Network is realized as a hosted service using an application service provider (ASP) model, but is understood that some or all of the services provided by the subsystems of the Brand Management and Marketing Communication Instrumentation Network can be realized as Java clients, running behind a client/brand's enterprise firewall, and the RDBMS associated with a given client/brand can be maintained locally within the client/brand's enterprise, and synchronized with the centralized RDBMS of the Brand Management and Marketing Communication Instrumentation Network using XML and EDI techniques described in great detail in Applicant's PCT International Patent Application Publication Nos. WO 98/19259 published on May 7, 1998, and WO 01/37540 A2 published on May 25, 2001, incorporated herein by reference.

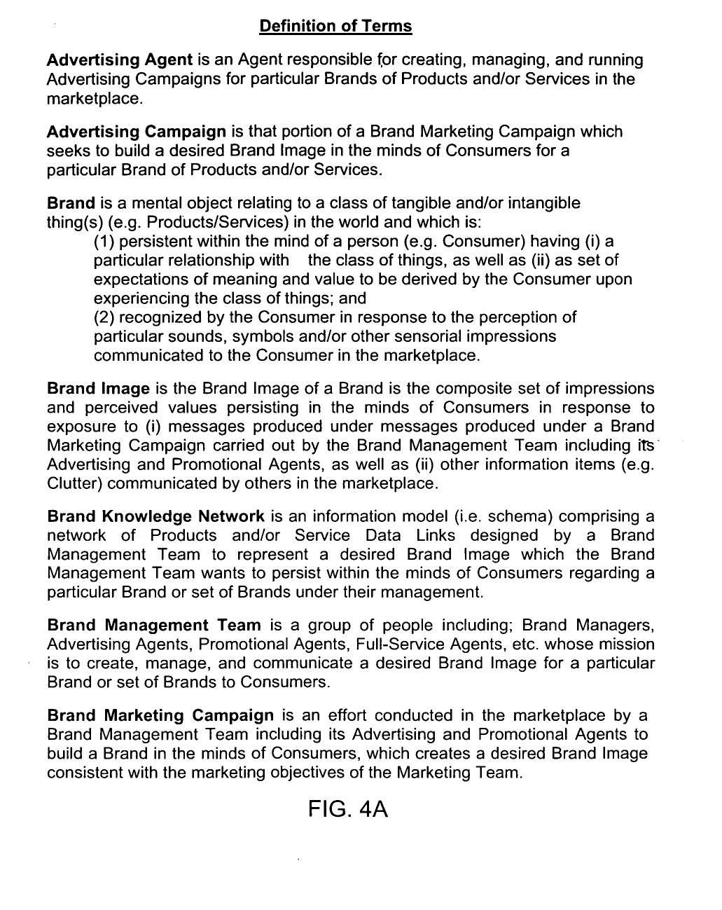

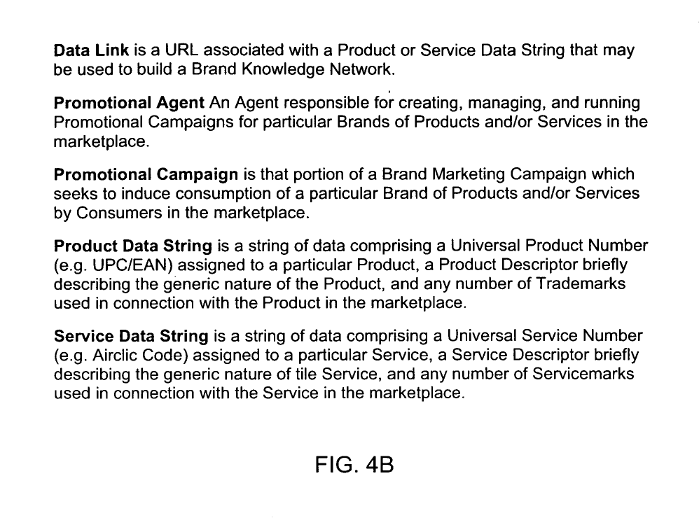

Precise definition of terms used in the analysis, design and development of the Brand Management and Marketing Communication Instrumentation Network of the present invention are set forth in the table of FIG. 4 shown in FIGS. 4A and 4B, and should be carefully considered while reading the present Specification.

Advantages and Benefits of the Brand Management and Marketing Communication Network of the Present Invention

The Brand Management and Marketing Communication Network of the present invention enables brand management teams of any size and arrangement to rise above the clutter in the Internet marketplace and communicate the essence and character of their brands directly to the consumer. In seconds, consumers can obtain a multi-dimensional experience of a branded product or service without the influence of other brands.

With Multi-Mode Virtual Kiosks so simple and easy to access, consumers can be more effectively educated about brands than ever before online and gain a full experience of a brand so that they develop strong preferences for them. Consumer brand images are now aligned with the team's intended brand marketing objectives. And consumers no longer need to wander off to other websites in search of brand-related information. Online brand marketers can now create and deliver high-impact brand marketing campaigns. Retailers can build e-commerce sites, which communicate its vendors' intended brand images while preserving their own. Retailers can more efficiently use the virtual shelf-space on their Websites. By more efficiently using Brand Building Information Resources, marketing costs decrease, as Brand Value and Equity increase, thereby improving Profits. By creating new levels of Brand Value and Experience, the durability of all serviced Brands can be extended. By providing such benefits, the Brand Management and Marketing Communication Network helps build more distinctive, valuable, and stronger Brands in the marketplace.

Brand managers can now take full control of their online marketing communication process and direct it exactly as they wish, as their team members collaborate with each other to carry out their brand marketing objectives.

The Brand Management and Marketing Communication Network of the present invention enables Brand Management Teams to bring supply side efficiencies and process to the demand side of their businesses, and increase the accountability of dollars spent on advertising for individual products, services, and brands alike.

The Brand Management and Marketing Communication Network of the present invention provides a solution to the myriad of problems facing both the Consumers on the Internet and the Brand Manager whose message is not getting relayed effectively.

The Brand Management and Marketing Communication Network of the present invention provides a collection of finely-tuned Internet-based services that help Brand Managers manage their brand building information from the supply side to the demand side of their operations, while harnessing the power of the Brand Building Information Resources available on the Internet. With Brand Information Networks that are synchronized with their brand's supply side information management operations, Brand Managers are now be able to track each campaign for each product with up to date information on where each campaign is placed as well as how well utilized it is.

The Brand Management and Marketing Communication Network of the present invention provides brand managers with powerful tools that enable them to capture brand building information, currently scattered throughout the Web, and place it at critical touch-points not only where, and when, the consumer is considering a purchase on the Web, but also in places that can initiate the consumer purchase experience. Brand marketing communication technology of the present invention can be made available at eCommerce sites, the Checkout, cell phones or at ATM machines.

The Brand Management and Marketing Communication Network of the present invention provides consumers with a new tool for gathering the best and most accurate information about any Product or Service over the Internet at any consumer touch-point. Consumers can watch an ad, find out about the latest promotions, gain detailed product information, search the store locator or find other information through Multi-Mode Virtual Kiosks.

The Brand Management and Marketing Communication Network of the present invention is based on a revolutionary new communication system and network architecture design that allows brand managers and their agents, using point and click technology, to simply:

1. Build Brand Information Networks for their branded products and services by linking the URLs of Brand Building Information Resources on the Internet (e.g. product video, audio and consumer information) to their Product and Service Data Strings (e.g. UPNs, TMs, PDs, USNs, SMs, Brand Names, etc.) which are Synchronized with the Product's Supply Chain information operations

2. Generate and install Brand-Building Multi-Mode Virtual Kiosks Having Multiple Display Modes Of Operation and

3. Remotely-Program the Display Modes of these Multi-Mode Virtual Kiosks with Rich-Media Advertising Spots, Promotional Spots, and Brand Information Networks, using the Web-based programming network of the present invention.

The revolutionary set of tools supported by the Brand Management and Marketing Communication Network of the present invention provides brand marketing teams of all sizes with the ability to design top-grade Web-based Brand Information Networks (BINs) that may be easily placed, via Multi-Mode Virtual Kiosks, at any Web-enabled consumer touch-point, in response to immediate feedback from Consumers regarding the Brand Building Information Networks that have been placed on the Internet.

The Brand Management and Marketing Communication Network of the present invention brings value to the interactive marketing field in the following ways:

Creating Value for the Brand Management Team
Control. The technology is easy to use. It allows Brand Managers to manage the design and implementation of the interactive marketing campaigns. The control is there for the brand manager from assigning the Product or Service Data Strings to formatting the look of the Multi-Mode Virtual Kiosk to placement of the Virtual Kiosk to running the metrics gathering tools for Consumer interaction reports and basic Product/Service information gathering. Brand Management and Marketing Communication Network has engineered the engineers out of the process. The brand manager has complete control, while collaboration among brand marketing team members is improved within and outside of the Brand's Enterprise.
Variety of Content. There is no other product out there that feeds consumers eyes and ears with messages of video and sound through the delivery of rich brand-building media, to deeply burn the clients brand message in the consumer's mind while at the same time providing an avenue for research and purchase of a product.
Savings. It takes approximately ten minutes to implement a campaign under the B Brand Management and Marketing Communication Network. Traditional interactive marketing campaigns take an average of three days. The savings of time, effort and resources are clearly defined under this revolutionary system.
Image Protection. These channels are less immune to the destructive power of clutter. Therefore, the Brand Management and Marketing Communication Network enables brand management teams to create stronger, more distinctive brands in the marketplace translating into premium prices, greater levels of channel influence, improved levels of customer loyalty and retention, as well as increased profits.
Scalability. The system provides the scalability Brand Managers are looking for. The network may be used within all aspects of the Brand Managers relationship channel and will always present the same message with the same “feel”. The Multi-Mode Virtual Kiosks are accessible through the manufacturer's website, a retailers website or any other linkable items on the Web.
   Creating Value for Consumers
Easy for Consumers. The Brand Management and Marketing Communication Network is easy for the consumer to use. Consumers want to research and shop for goods and services online, but find it cumbersome and frustrating. With BKS Networks, the consumer has a well-designed and easy to use research source. Enter a brand-related search key, such as a Product Descriptor, UPC Code or Brand Name and the consumer is lead directly to the brand building information network for the product or service. A few clicks verses searching through endless number of web pages. The consumer is guaranteed quality information.
Depth. Via the Advertising & Promotion Display Modes as well as the Brand Information Display Mode the consumer receives audio, video and detailed product information to present a three dimensional view of the product.
Availability. The BKS Network is available at any Internet enabled touchpoint. It is there and it is available when the consumer needs it.
   Creating Value for Retailer/E-Tailer Trading Partners

In summary, the Brand Management and Marketing Communication Network of the present invention gives brand managers the tools to positively influence price-driven online shoppers and effectively communicate the essence of their brands through a quick, information-rich shopping experience at the e-tail point of sale and other Web touch points. The brand manager displays this information in something called a “Multi-Mode Virtual Kiosk” which consumers can launch anywhere on the Web to obtain in-depth information about a brand, as well as rich media images and the latest promotions on a real-time basis.

A primary advantage of the Brand Management and Marketing Communication Network of the present invention lies in its unique ability to choreograph and deliver an engaging, unprecedented brand experience with the efficiency and automation of supply chain management solutions.

In the illustrative embodiment, the Brand Management and Marketing Communication Network of the present invention is realized as a centralized application allows brand managers to link seemingly disparate online assets: rich media, promotional messages and product specifications, for example, and bring them directly to online shoppers at the point-of-purchase and any touch point on the World Wide Web, through a new interactive online shopping vehicle called a “Multi-Mode Virtual Kiosk”.

Brand owners can place Multi-Mode Virtual Kiosks anywhere on the Web they wish to deliver and information-rich brand experience or present a multi-faceted view of their brands directly to consumers. They can place Virtual Kiosks on e-retail sites and portals the consumer visits while in a transactional mindset (e.g., shopping search engine results pages), on partner websites or any point on the Web where they wish to create or reinforce brand awareness in the mind of the consumer.

The Multi-Mode Virtual Kiosks are the presentation layer of a highly sophisticated Brand Management and Marketing Communication Network that the brand owner operates in-house to tightly control and manage brand assets anywhere on the Web, and collaborate in real-time with retail trading partners, as well as advertising and promotion agents in order to ensure timely, consistent delivery of online brand marketing messages and drive sales. The Network also enables brand managers to effectively and efficiently define, refine and measure online brand communication activities with a few mouse clicks.

Preferrably, the Brand Management and Marketing Communication Network of the present invention is realized as an industrial-strength brand management and marketing communication network that is sufficiently scalable to support the brand marketing communications industry in much the same way as AT&T's public telephone switching network (PTSN) serves millions of companies throughout the world. This way the Brand Management and Marketing Communication Network functions as an “inter-enterprise level” brand management and marketing communication network for the entire global brand marketing communications industry.

Detailed Description of the Enterprise Brand Management and Marketing Communication

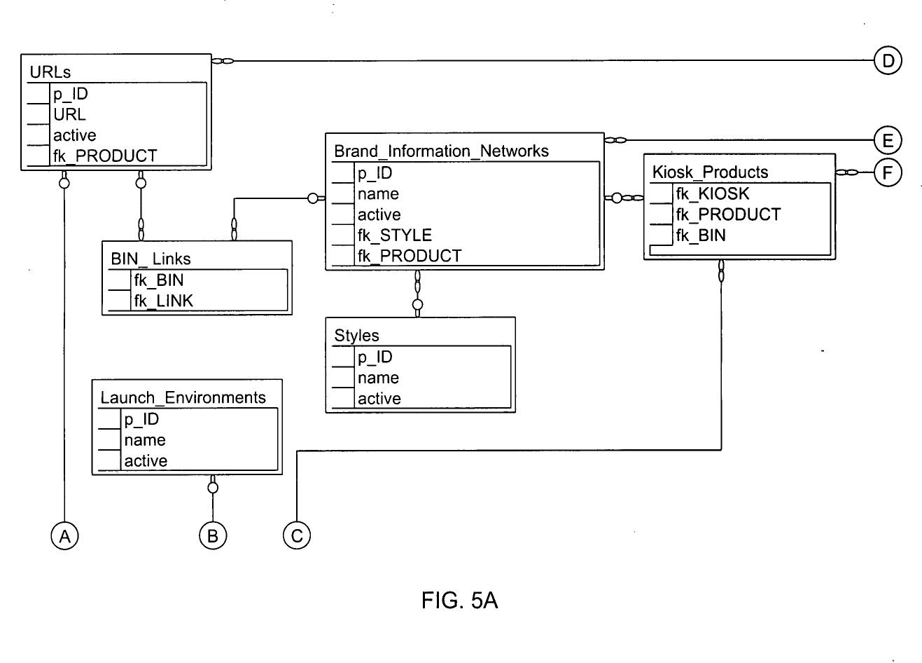

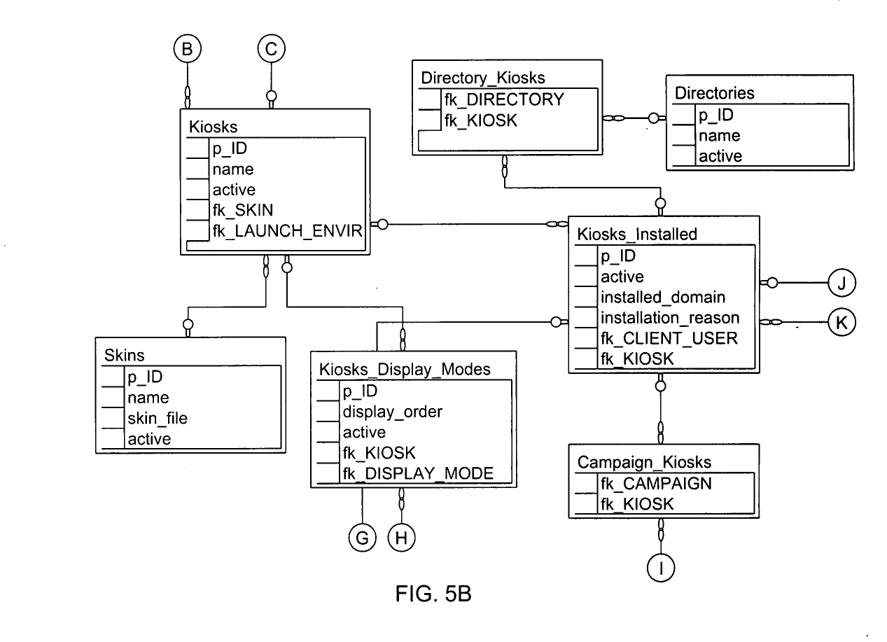

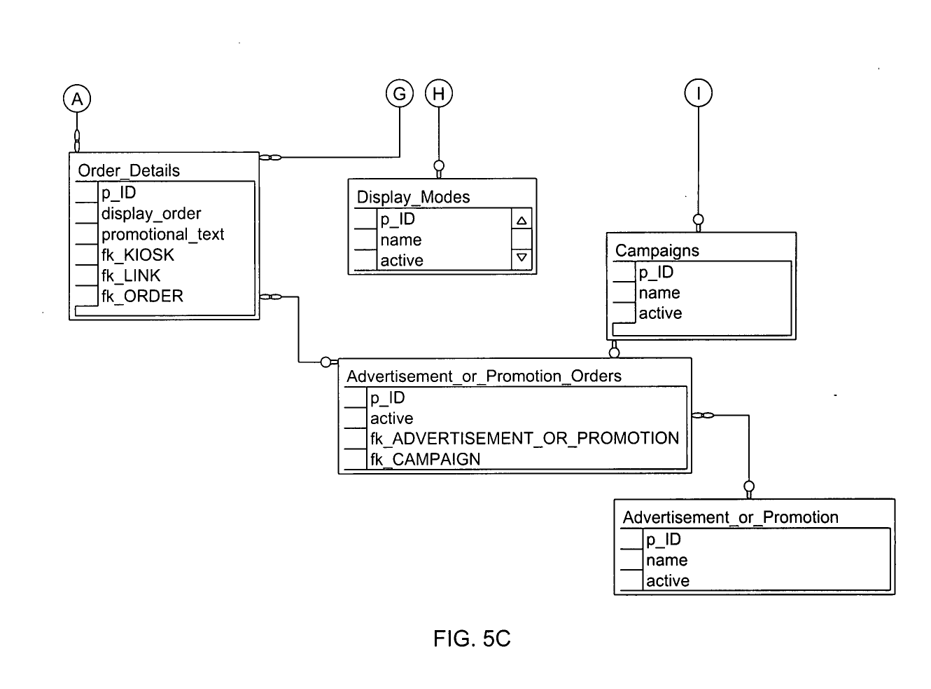

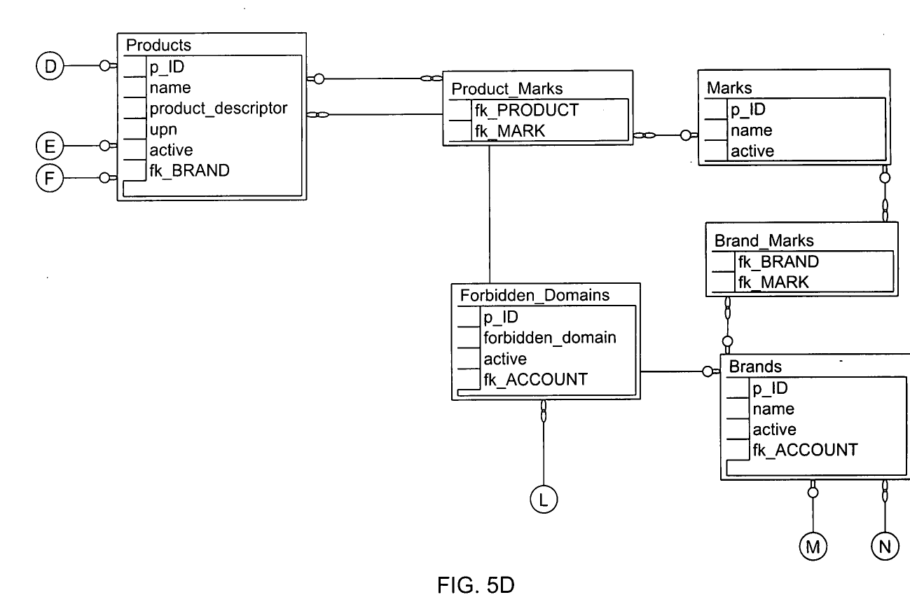

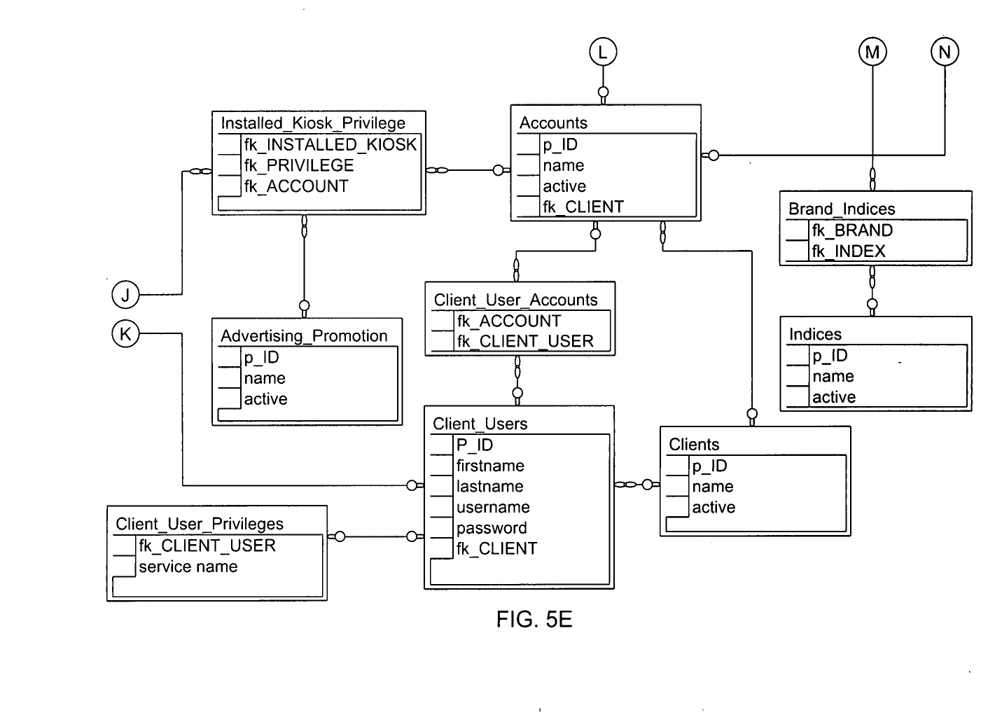

Instrumentation Network of the Illustrative Embodiment of the Present Invention In FIGS. 5A through 5E, a basic database schema diagram is shown for the RDBMS used to implement the Brand Management and Marketing Communication Instrumentation Network of the illustrative embodiment. Any SQL database program compatible with the WebObject 5.2 Java Application Server can be used to implement this network component. Notably, during object-oriented design (OOD) and system developed, the tables and relationships in the RDBMS are ultimately converted to Java class based Enterprise Object (EO) model within the WebObject 5.2 Java Application Server, whereas the GUI components for the Network are converted to a Java class based Web Objects (WO) model therewithin.

As shown in FIGS. 5A through 5E, the tables in the RDBMS comprise the following attributes and relationships:

Description of the Database Layer of the Brand Management and Marketing Communication Network of the Illustrative Embodiment (BKS Network)

Account

Attributes:

p_ID→Primary Key

name→Account Name

active→Denotes whether the Account is active or not

fk_CLIENT→Foreign Key. Holds relationship to the Client table

Relationships:

clients→1-to-1 relationship. Each Account must be assigned to a single Client.

Advertisement_or_Promotion

Attributes:

p_ID→Primary Key

name→name of the item. In this case there will be two items in the table (‘Promotion’ and ‘Advertisement’)

active→Denotes whether the item is active or not

Relationships:

toAdvertisement_or_PromotionOrder→1-to-many relationship. Each Advertisement_or_Promotion Order must be assigned an advertisement or promotion Type.

Advertisement_or_PromotionOrders

Attributes:

p_ID→Primary Key

active→Denotes whether the item is active or not

fk_ADVERTISEMENT_OR_PROMOTION→Foreign Key. Holds relationship to the Advertisement_or_Promotion table

fk_CAMPAIGN→Foreign Key. Holds relationship to the Campaign table

Relationships:

advertisement_or_promotions 1-to-1 relationship. Each Order must be assigned an advertisement or promotion Type.

campaigns→1-to-1 relationship. Each Order must be assigned to a specific Campaign.

Advertising Promotional Privileges

Attributes:

p_ID→Primary Key

name→Holds the value of the Type of Privilege. (In this case there will be only three types; ‘Exclusive’, ‘Shared’, or ‘Not Allowed’)

active→Denotes whether the item is active or not

Relationships:

toInstalledKioskPrivileges→1-to-many relationship. The allowed Privileges for placing Advertisements and Promotions on any installed Retailer-Specific Virtual Kiosk are controlled through this relationship

BIN_Links

Attributes:

fk_BIN→Foreign Key. Holds relationship to the Brand Information Networks table. The links assigned to that Brand Information Network are stored in this table.

fk_LINK→Foreign Key. Holds relationship to the Link table. Which Links are to be assigned to the Brand Information Network are stored in this table

Relationships:

BINs→1-to-1 relationship. Denotes which Brand Information Network is being populated by the stored Links

Links→1-to-1 relationship. Denotes which Links are to be assigned to the Brand Information Networks

Brand_Indices

Attributes:

fk_BRAND→Foreign Key. Holds relationship to the Brand table. Denotes which Brand is assigned to the stored Indices

fk_INDEX→Foreign Key. Holds relationship to the Index table. Denotes which Indices are assigned to the Brand

Relationships:

Brands→1-to-1 relationship. Denotes which Brand is assigned to the stored Indices Indices 1-to-1 relationship. Denotes which Indices are assigned to the Brand.

Brand_Information_Networks

Attributes:

p_ID→Primary Key

name→The name of the Brand Information Network

active→Denotes whether the Brand Information Network is active or not

fk_STYLE→Foreign Key. Holds relationship to the Style table. Denotes which Style is assigned to the Brand Information Network

fk_PRODUCT→Foreign Key. Holds relationship to the Product table. Denotes to which Product the Brand Information Network is assigned

Relationships:

Styles→1-to-1 relationship. Denotes which Style is assigned to the Brand Information Network

Products→1-to-1 relationship. Denotes to which Product the Brand Information Network is assigned

Brand Marks

Attributes:

fk_BRAND→Foreign Key. Holds relationship to the Brand table. Denotes to which Brand the Marks are assigned

fk_MARK→Foreign Key. Holds relationship to the Mark table. Denotes which Marks are assigned to the Brand

Relationships:

Brands→1-to-1 relationship. Denotes to which Brand the Marks are assigned

Marks→1-to-1 relationship. Denotes which Marks are assigned to the Brand

Brands

Attributes:

p_ID→Primary Key

name→Name of the Brand

active→Denotes whether the Brand is active or not

fk_ACCOUNT→Foreign Key. Holds relationship to the Account table. Denotes to which Account does the Brand belong

Relationships:

Accounts 1-to-1 relationship. Denotes to which Account does the Brand belong

Campaign_Kiosks

Attributes:

fk_CAMPAIGN→Foreign Key. Holds relationship to the Campaign table. Denotes to which Campaign do the Kiosks belong

fk_KIOSK→Foreign Key. Holds relationship to the Kiosk table. Denotes which Kiosks belong to the Campaign

Relationships:

Campaigns 1-to-1 relationship. Denotes to which Campaign do the Kiosks belong

Kiosks→1-to-1 relationship. Denotes which Kiosks belong to the campaign

Campaign

Attributes:

p_ID→Primary Key

name→Name of the Campaign

active→Denotes whether the Campaign is active or not

Relationships:

toCampaign_Kiosks→1-to-many relationship. Denotes Kiosks are assigned to which Campaigns

toAdvertisement_or_PromotionOrders→1-to-many relationship. Denotes which Order belong to which Campaigns

Client_User_Accounts

Attributes:

fk_ACCOUNT→Foreign Key. Holds relationship to the Account table. Denotes to which Account does the Client User belong

fk_CLIENT_USER→Foreign Key. Holds relationship to the Client_User table. Denotes which Client Users belong to the Account

Relationships:

Accounts→1-to-many relationship. Denotes to which Account does the Client User belong

Client_Users→1-to-many relationship. Denotes which Client Users belong to the Account

Client_User_Privileges

Attributes:

fk_CILIENT_USER→Foreign Key. Holds relationship to the Client User table. Denotes which Client User has this privilege in the System

service_name→The Service to which the Client User has the privilege

Relationships:

Client_Users ˜1-to-many relationship. Denotes which Client User has this privilege in the System

Client Users

Attributes:

p_ID→Primary Key

firstname→The First Name of the Client User

lastname→The Last Name of the Client User

username→The username the Client User uses to enter the System

password→The password the Client User uses to enter the System

active→Denotes whether the Client User is active or not

fk_CLIENT→Foreign Key. Holds relationship to the Client table. Denotes to which Client does the Client User belong

Relationships:

Clients→1-to-1 relationship. Denotes to which Client does the Client User belong

toClient_User_Accounts→1-to-many relationship. Denotes to which Accounts does the Client User have access

toClient_User_Privileges→1-to-many relationship. Denotes which Privileges the Client User has

toKiosks_Installed→1-to-many relationship. Denotes which Kiosks the Client User has installed

Clients

Attributes:

p_ID→Primary Key

name→Name of the Client

active→Denotes whether the Client is active or not

Relationships:

toClient_Users 1-to-many relationship. Denotes which Client Users are assigned to the Client

toAccounts→1-to-many relationship. Denotes which Accounts are assigned to the Client

Directories

Attributes:

p_ID→Primary Key

name→Name of the Directory

active→Denotes whether the Directory is active or not

Relationships:

toDirectory_Kiosks→1-to-many relationship. Denotes which Virtual Kiosks are assigned to the Directory

Directory_Kiosks

Attributes:

fk_DIRECTORY→Foreign Key. Holds relationship to the Directory table. Denotes to which Directory the Kiosks are assigned

fk_KIOSK→Foreign Key. Holds relationship to the Kiosk table. Denotes which Kiosks are assigned to the Directory

Relationships:

Directories→1-to-1 relationship. Denotes to which Directory the Virtual Kiosks are assigned

Kiosks→1-to-1 relationship. Denotes which Kiosks are assigned to the Directory

Display_Modes

Attributes:

p_ID→Primary Key

name→Name of the Display Mode

active→Denotes whether the Display Mode is active or not

Relationships:

toKioskDisplayModes→1-to-many relationship. Denotes which Display Modes are assigned to the Kiosk

Forbidden_Domains

Attributes:

p_ID→Primary Key

forbidden_domain→The URL of the Domain that is forbidden

active→Denotes whether the Forbidden Domain is active or not

fk_ACCOUNT→Foreign Key. Holds relationship to the Account table. Denotes to which Account does this Forbidden Domain apply

Relationships:

Accounts→1-to-1 relationship. Denotes to which Account does this Forbidden Domain apply

Indices

Attributes:

p_ID→Primary Key

name→Name of the Index

active→Denotes whether this Index is active or not

Relationships:

toBrandindices→1-to-many relationship. Denotes which Indices are assigned to a Brand

Installed_Kiosk_Privileges

Attributes:

fk_INSTALLED_KIOSK→Foreign Key. Holds relationship to the Installed Kiosk table. Denotes which Installed Kiosks have which Privileges for which Accounts

fk_PRIVILEGES→Foreign Key. Holds relationship to the Privileges table. Denotes which Privileges are assigned to which Installed Kiosks for which Accounts

fk_ACCOUNTS→Foreign Key. Holds relationship to the Accounts table. Denotes which Accounts have which Installed Kiosks with which Privileges assign to them

Relationships:

InstalledKiosks→1-to-1 relationship. Denotes which Installed Kiosks have which Privileges for which Accounts

Privileges→1-to-1 relationship. Denotes which Privileges are assigned to which Installed Kiosks for which Accounts

Accounts→1-to-1 relationship. Denotes which Accounts have which Installed Kiosks with which Privileges assigned to them

Kiosk_Display_Modes

Attributes:

p_ID→Primary Key

display_order→Denotes in which Order are the Display Modes presented when the Kiosk is launched

active→Denotes whether the Display Mode for this Kiosk is active or not

fk_KIOSK→Foreign Key. Holds relationship to the Kiosk table. Denotes which Kiosk is assigned the Display Mode and Order

fk_DISPLAY_MODE→Foreign Key. Holds relationship to the Display Mode table. Denotes which Display Mode is assigned to the Kiosk

Relationships:

toKiosks→1-to-1 relationship. Denotes which Kiosk is assigned the Display Mode and Order

toDisplayMode→1-to-1 relationship. Denotes which Display Modes are assigned to the Kiosk

Kiosk_Products

Attributes:

fk_KIOSK→Foreign Key. Holds relationship to the Kiosk table. Denotes to which Kiosk are the Products assigned

fk_PRODUCT→Foreign Key. Holds relationship to the Product table. Denotes which Products are assigned to the Kiosk

fk_BIN→Foreign Key. Holds relationship to the Brand information Network table. Denotes which Brand Information Network is assigned to each Product in each Kiosk

Relationships:

Kiosks→1-to-1 relationship. Denotes to which Kiosk are the Products assigned

Products→1-to-1 relationship. Denotes which Products are assigned to the Kiosk

BINs→1-to-1 relationship. Denotes which Brand Information Network is assigned to each Product in each Kiosk

Kiosks

Attributes:

p_ID→Primary Key

name→Name of the Kiosk

active→Denotes whether the Kiosk is active or not

fk_SKIN→Foreign Key. Holds relationship to the Skin table. Denotes the Skin to be applied to the Kiosk

fk_LAUNCH_ENVIRONMENT→Foreign Key. Holds relationship to the Launch Environment table. Denotes in which Launch Environment the Kiosk shall launch.

Relationships:

Skins→1-to-1 relationship. Denotes which Skin is to be applied to the Kiosk

LaunchEnvironments→1-to-1 relationship. Denotes in which Launch Environment shall the Kiosk be launched

toKioskDisplayModes→1-to-many relationship. Denotes to which Kiosk the Display Modes are assigned

toKioskProducts→1-to-many relationship. Denotes to which Kiosk the Products are assigned

toKiosksInstalled→1-to-many relationship. Denotes which Kiosk have been installed

Kiosks_Installed

Attributes:

p_ID→Primary Key

active→Denotes whether the Installed Kiosk is active or not

installed_domain→Records the Domain on which the Kiosk shall be placed

installation_reason→Records the reason for the installation of the Kiosk

fk_CLIENT_USER→Foreign Key. Holds relationship to the Client User table. Denotes which Client User installed the Kiosk

fk_KIOSK→Foreign Key. Holds relationship to the Kiosk table. Denotes which Kiosk has been installed

Relationships:

ClientUsers→1-to-1 relationship. Denotes which Client User has installed the Kiosk

Kiosks→1-to-1 relationship. Denotes which Kiosks have been installed

toCampaignKiosks→1-to-many relationship. Denotes which Installed Kiosks are assigned to the Campaign

toDirectoryKiosks→1-to-many relationship. Denotes which Installed Kiosks are assigned to the Directory

tolnstalledKioskPrivileges→1-to-many relationship. Denotes which Privileges are assigned to the Installed Kiosk

toOrderDetails→1-to-many relationship. Denotes which Installed Kiosk holds the Order Details

Launch_Environments

Attributes:

p_ID→Primary Key

name→Name of the Launch Environment

active→Denotes whether the Launch Environment is active or not

Relationships:

toKiosks→1-to-many relationship. Denotes from which Launch Environment the Kiosk will be launched

Marks

Attributes:

p_ID→Primary Key

name→Name of the Trademark

active→Denotes whether the Trademark is active or not

Relationships:

toBrandMarks→1-to-many relationship. Denotes which Marks are assigned to Brands

toProducts→1-to-many relationship. Denotes which Marks are assigned to Products

Order Details

Attributes:

p_ID→Primary Key

display_order→Denotes in which Order will the Advertisements or Promotions be displayed

promotional_text→The Promotional Text to be displayed under the Promotion

fk_KIOSK→Foreign Key. Holds relationship to Kiosk table. Denotes on which Kiosk will the Advertisements or Promotions play

fk_LINK→Foreign Key. Holds relationship to Link table. Denotes which Link is to be used as the Advertisement_or Promotion

fk_ORDER→Foreign Key. Holds relationship to Order table. Denotes to which Order this Detail item belongs

Relationships:

Kiosks→1-to-1 relationship. Denotes on which Kiosk will the Advertisement or Promotion play

Links→1-to-1 relationship. Denotes which Link is to be used as the Advertisement or Promotion

Orders→1-to-1 relationship. Denotes to which Order this Detail item belongs

Product Marks

Attributes:

fk_PRODUCT→Foreign Key. Holds relationship to Product table. Denotes which Product holds which Marks

fk_MARK→Foreign Key. Holds relationship to Mark table. Denotes which Marks are assigned to which Products

Relationships:

Products→1-to-1 relationship. Denotes which Products hold which Marks

Marks→1-to-1 relationship. Denotes which Marks are assigned to which Products

Products

Attributes:

p_ID→Primary Key

name→Name of the Product

product_descriptor→Assigned Product Descriptor

upn→Universal Product Number assigned to the Product

active→Denotes whether the Product is active or not

fk_BRAND→Foreign Key. Holds relationship to Brand table. Denotes to which Brand the Product is assigned

Relationships:

Brands 1-to-1 relationship. Denotes to which Brand the Products are assigned

toBrandInformationNetworks→1-to-many relationship. Denotes which Products are assigned to the Brand Information Network

toKioskProducts→1-to-many relationship. Denotes which Products are assigned to the Kiosk

toProductMarks→1-to-many relationship. Denotes which Products are assigned which Marks

toURLs→1-to-many relationship. Denotes which URLs are assigned to which Products

Skins

Attributes:

p_ID→Primary Key

name→Name of the Skin

skin_file→File location of the Configuration File as well as the sample skin image

active→Denotes whether the Skin is active or not

Relationships:

toKiosks→1-to-many relationship. Denotes which Kiosks are assigned which Skins

Styles

Attributes:

p_ID→Primary Key

name→Name of the Style

active→Denotes whether the Style is active or not

Relationships:

toBrandInformaionNetworks→1-to-many relationship. Denotes what Styles are assigned to which Brand

Information Networks

URLs

Attributes:

p_ID→Primary Key

URL→The URL string

active→Denotes whether the URL is active or not

fk_PRODUCT→Foreign Key. Holds relationship to Product table. Denotes to which Product the URL is assigned

Relationships:

Products→1-to-1 relationship. Denotes to which Product the URL is assigned

toBINLinks→1-to-many relationship. Denotes which URLs make up the Links on which Brand information Networks

toOrderDetails→1-to-many relationship. Denotes which URLs make up the Advertisements or Promotions in the Order Detail record

Description of the Presentation and Control Layers of the Brand Management and Marketing Communication Network of the Illustrative Embodiment (BKS Network)

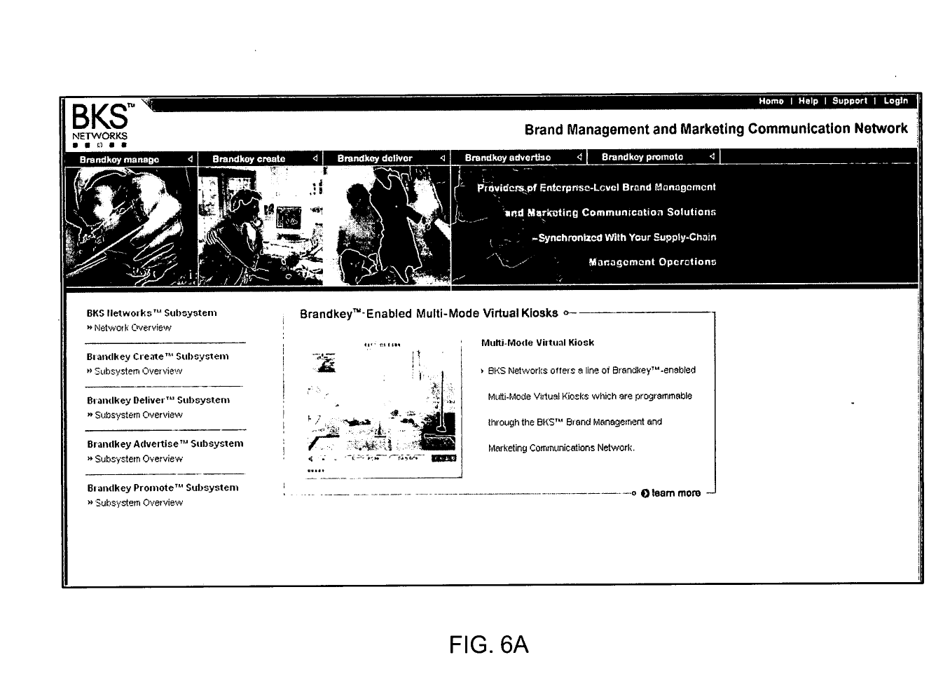

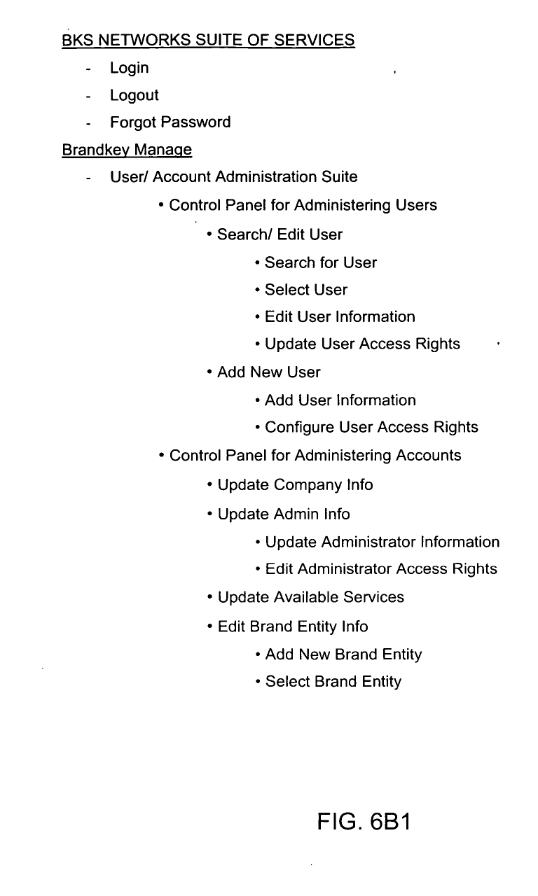

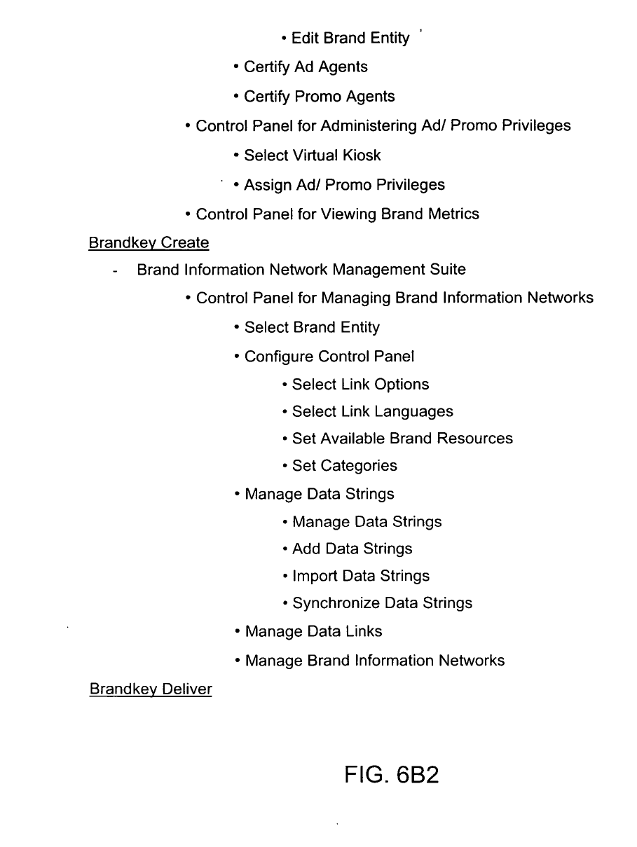

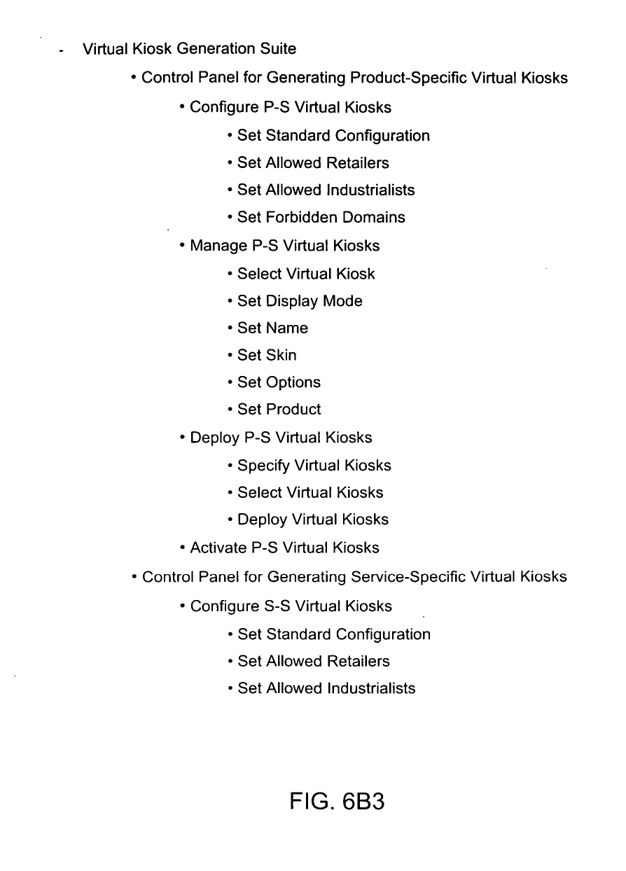

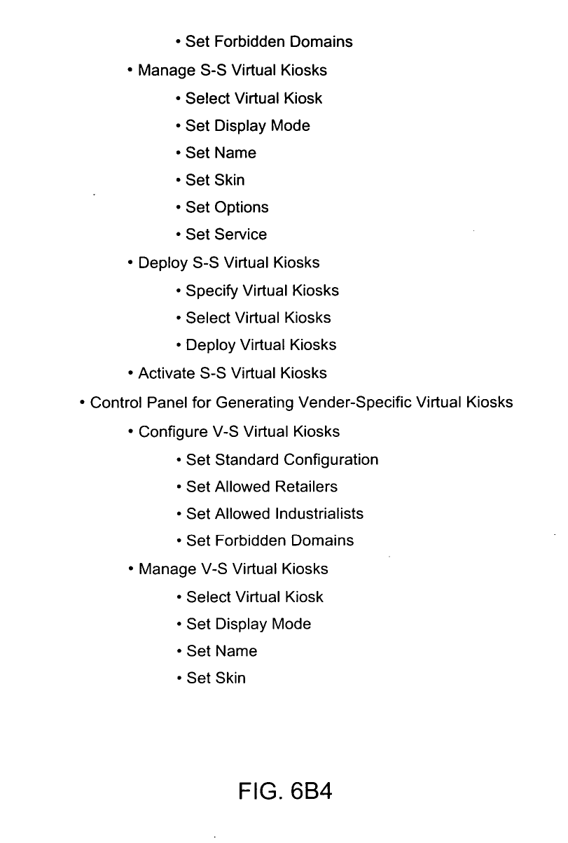

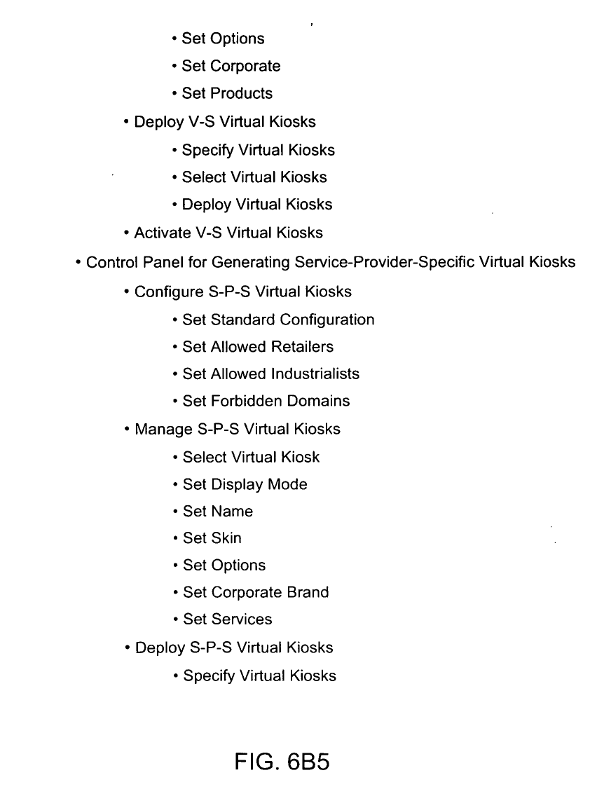

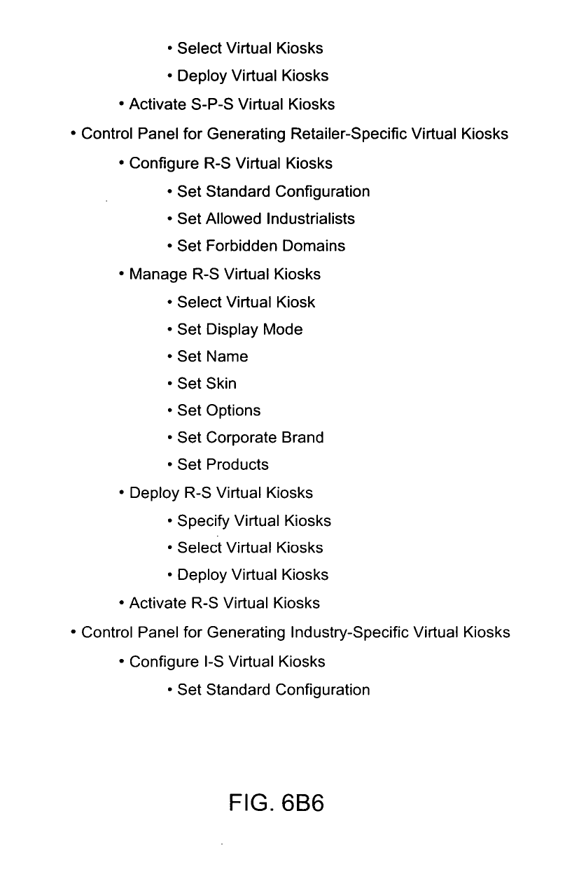

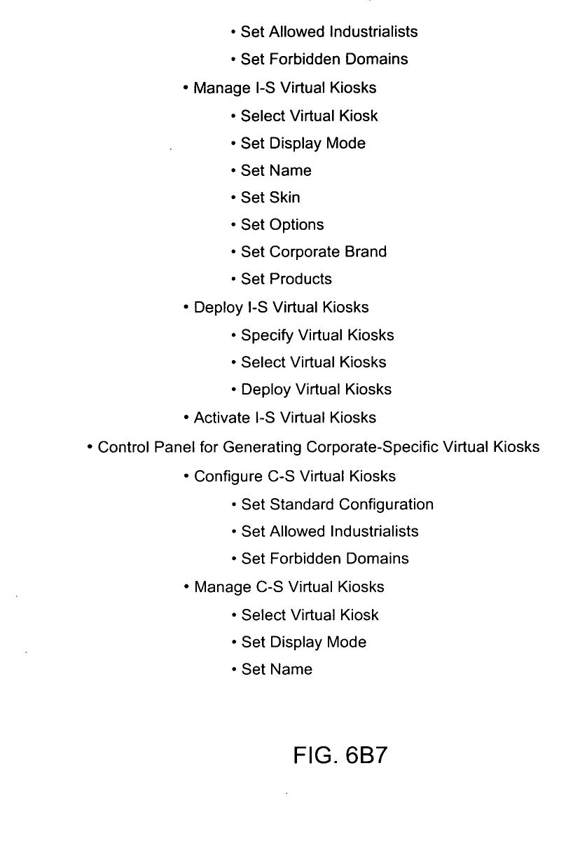

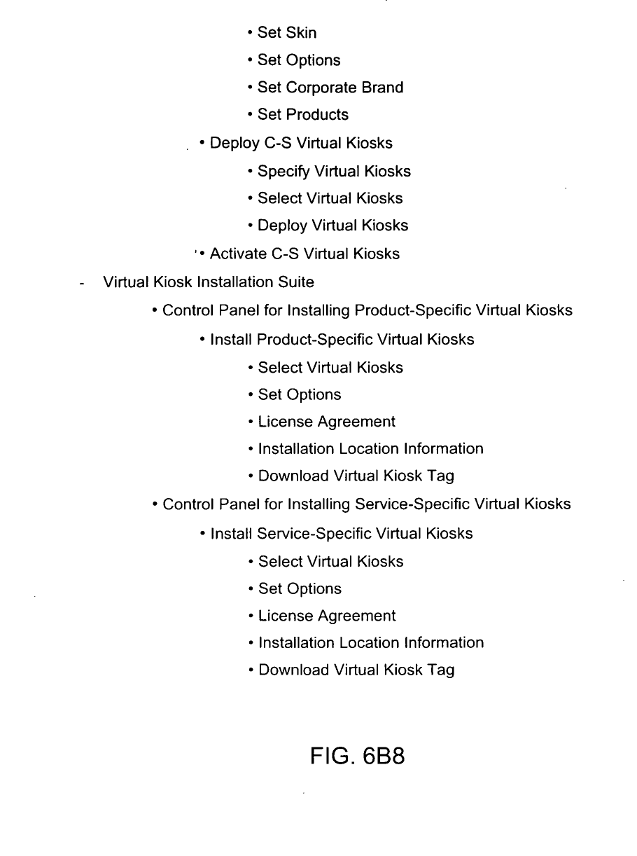

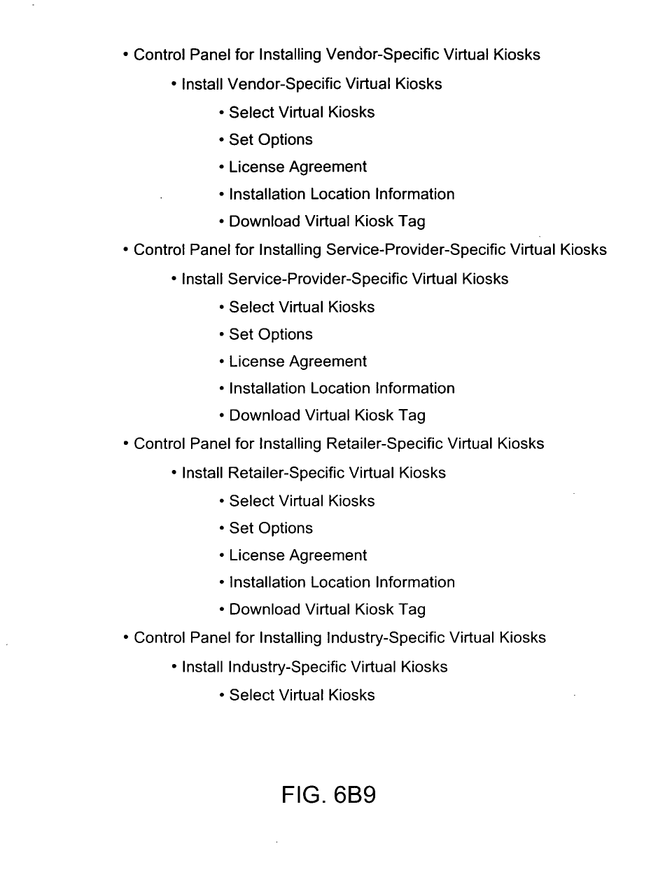

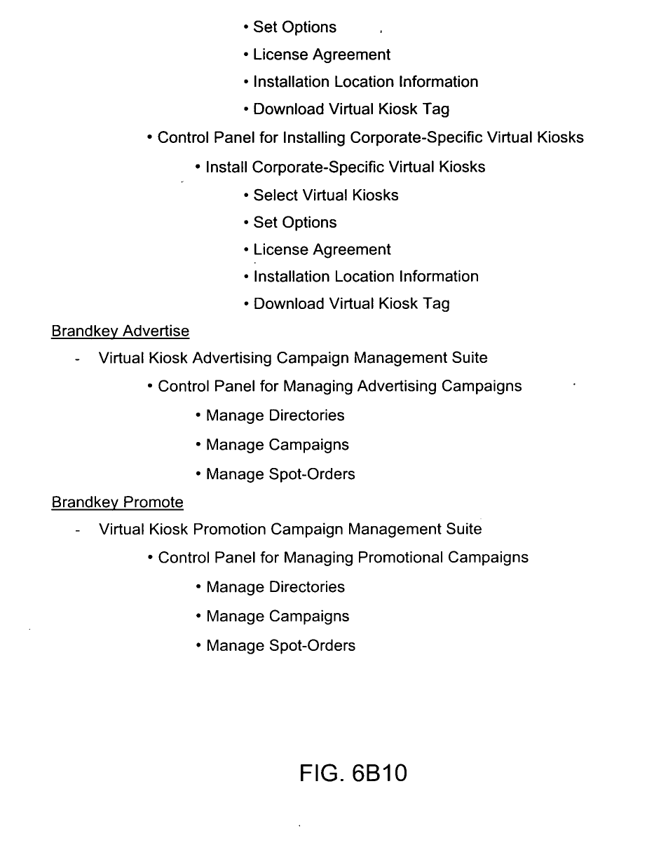

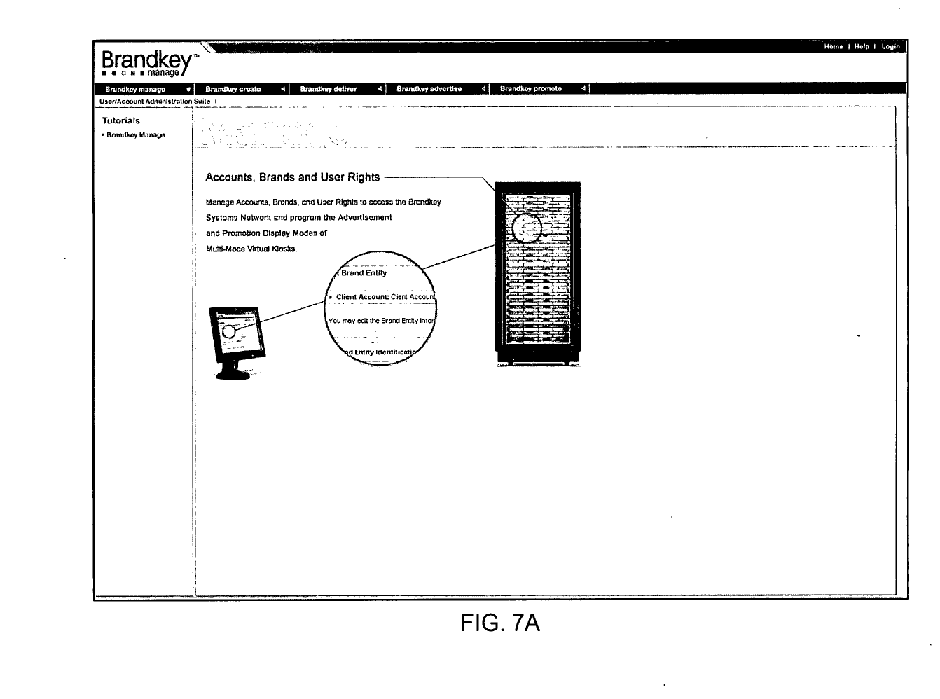

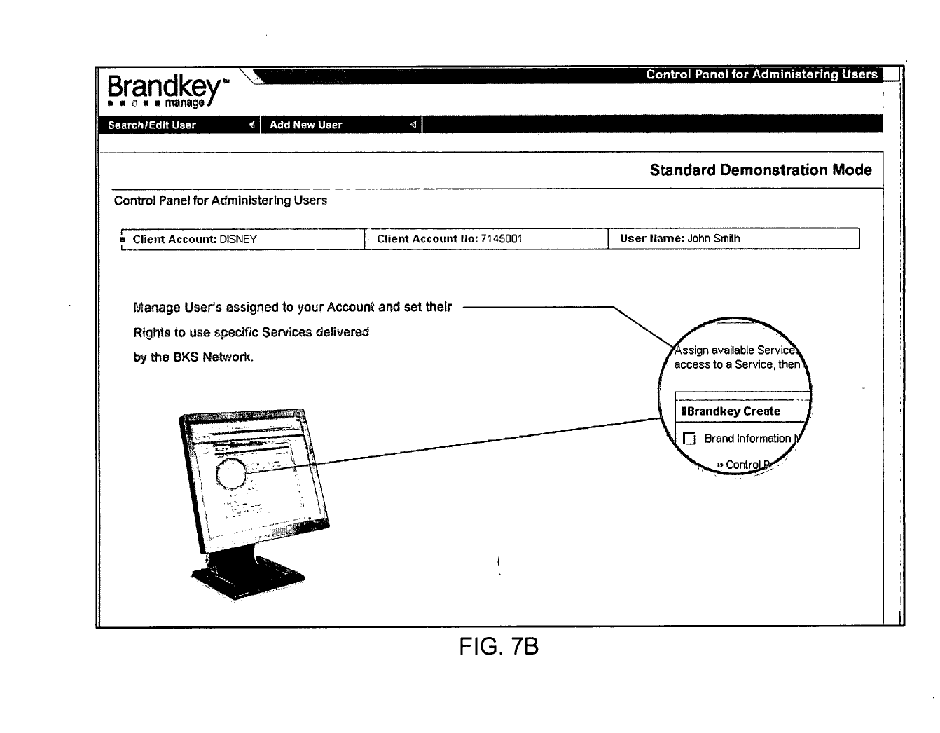

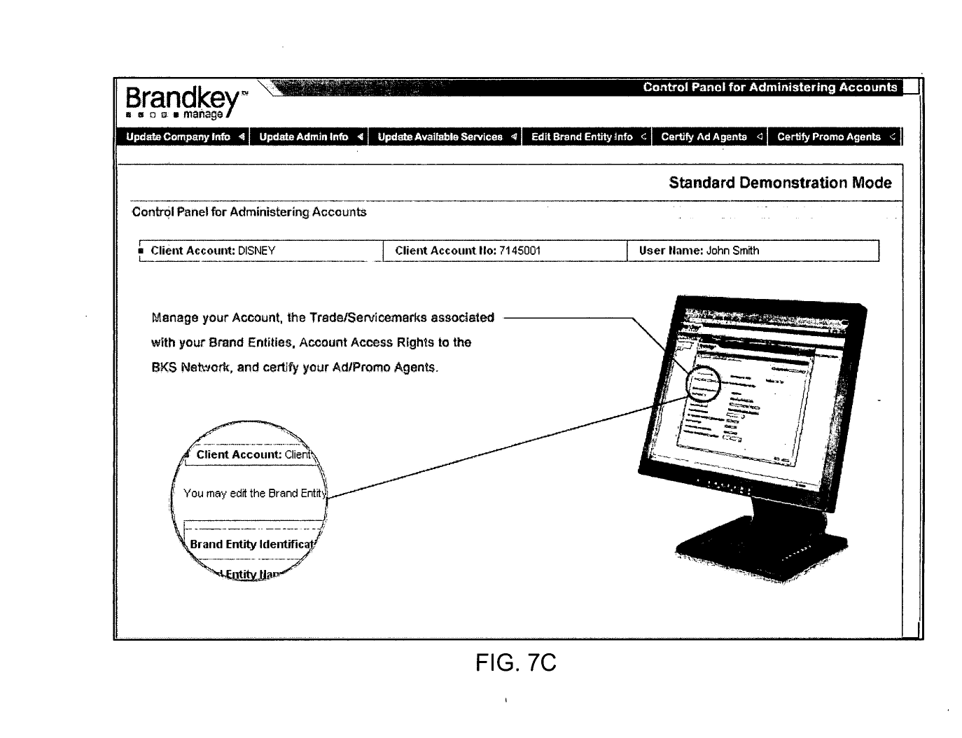

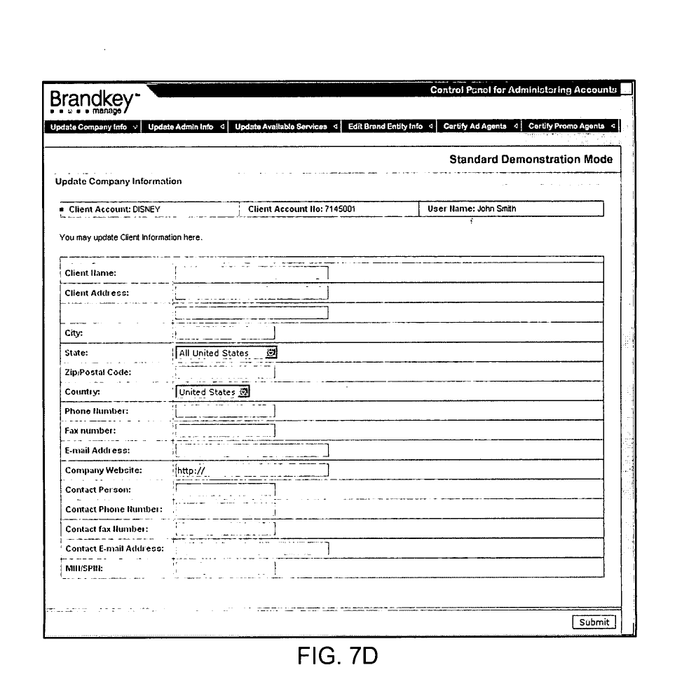

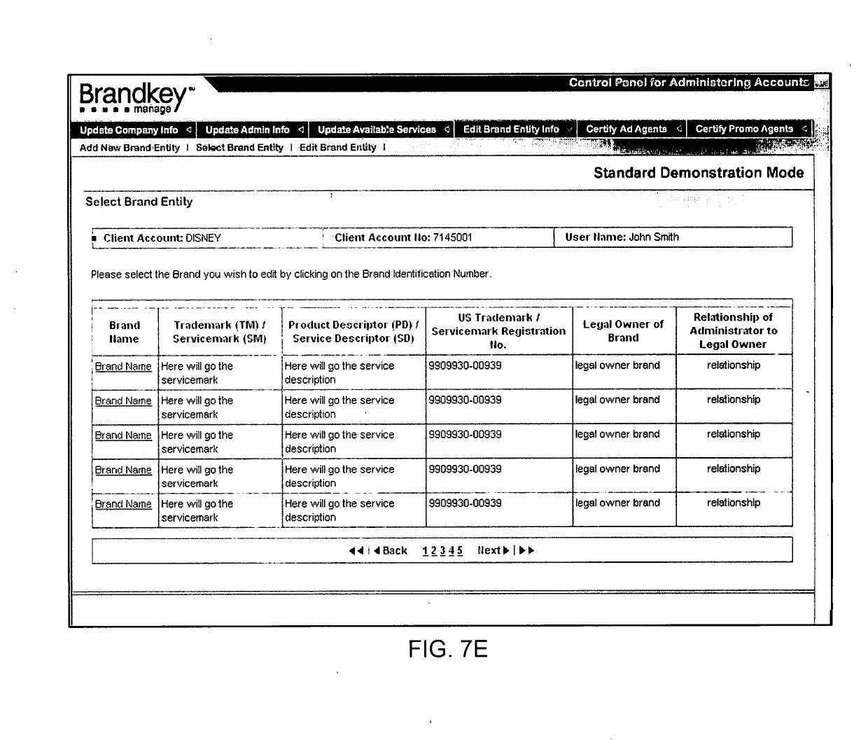

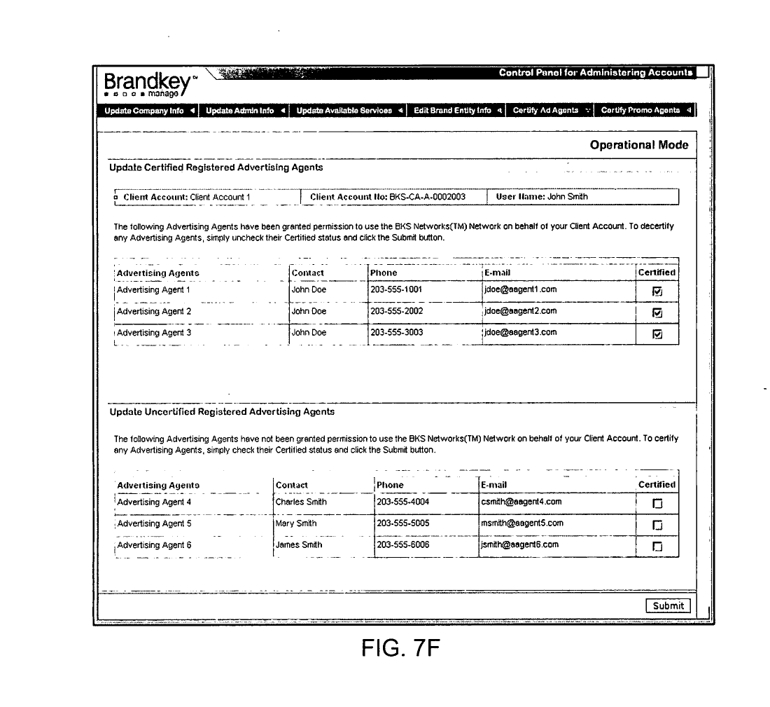

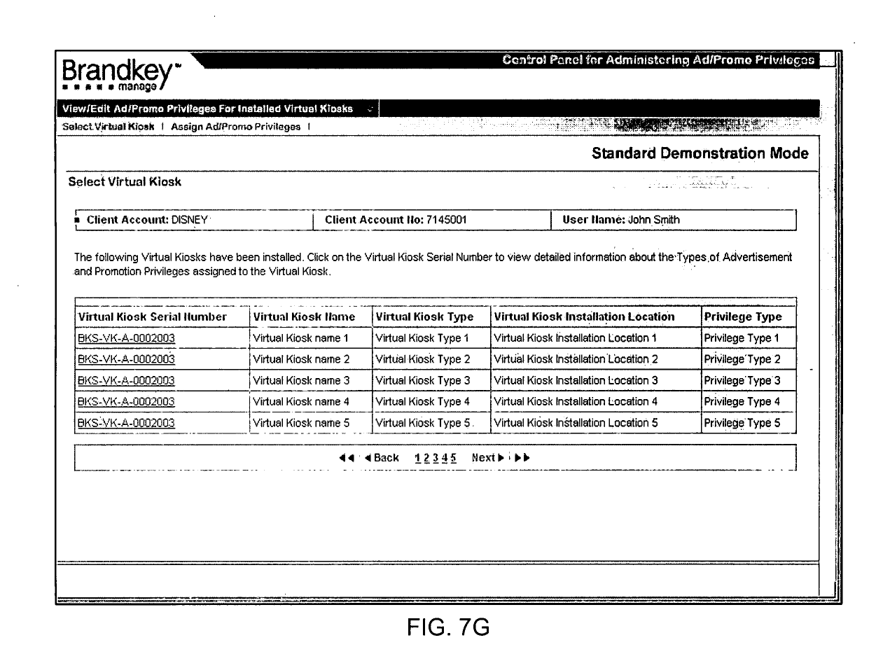

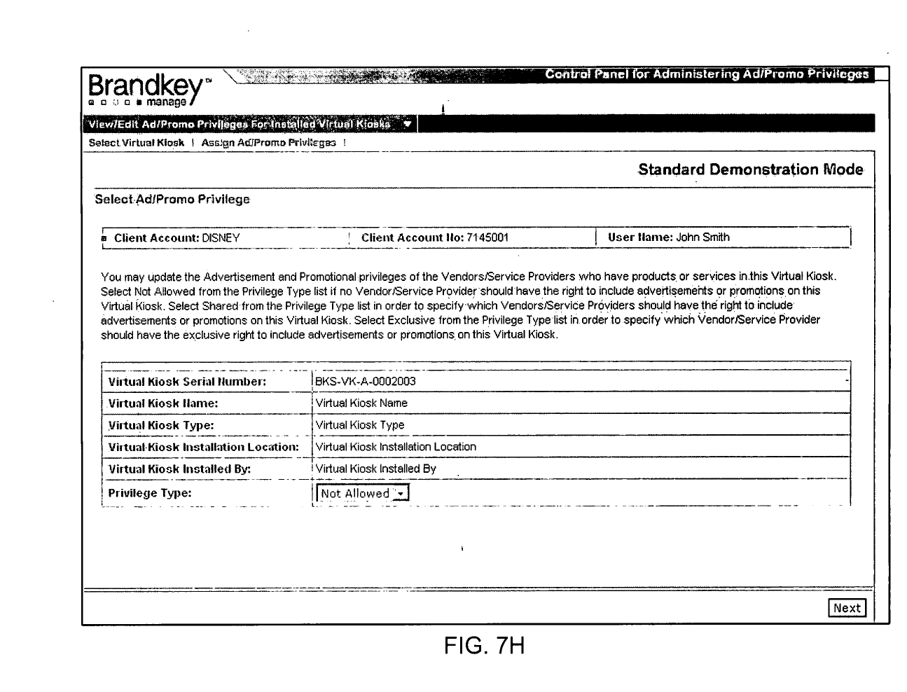

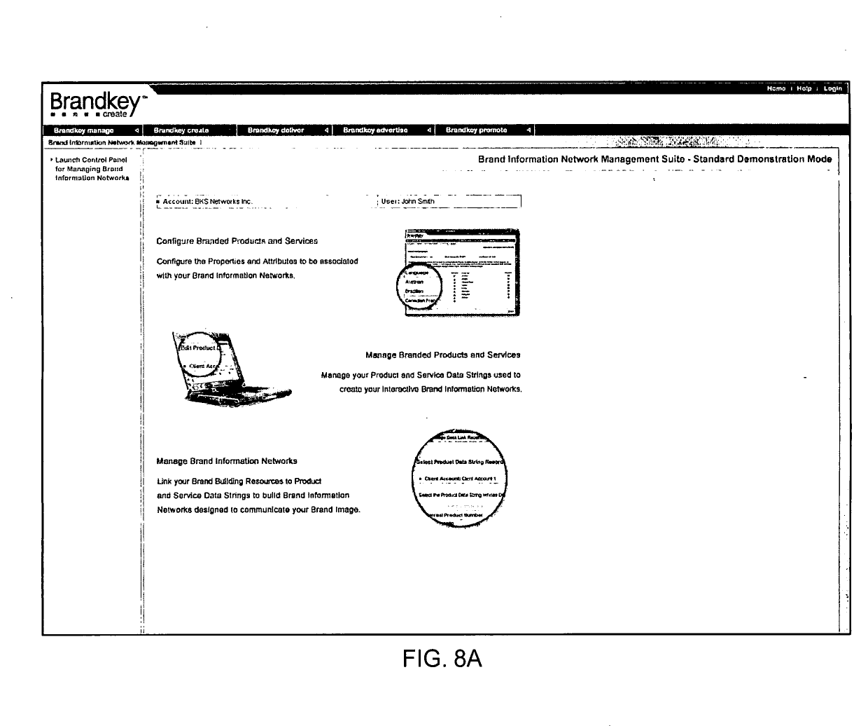

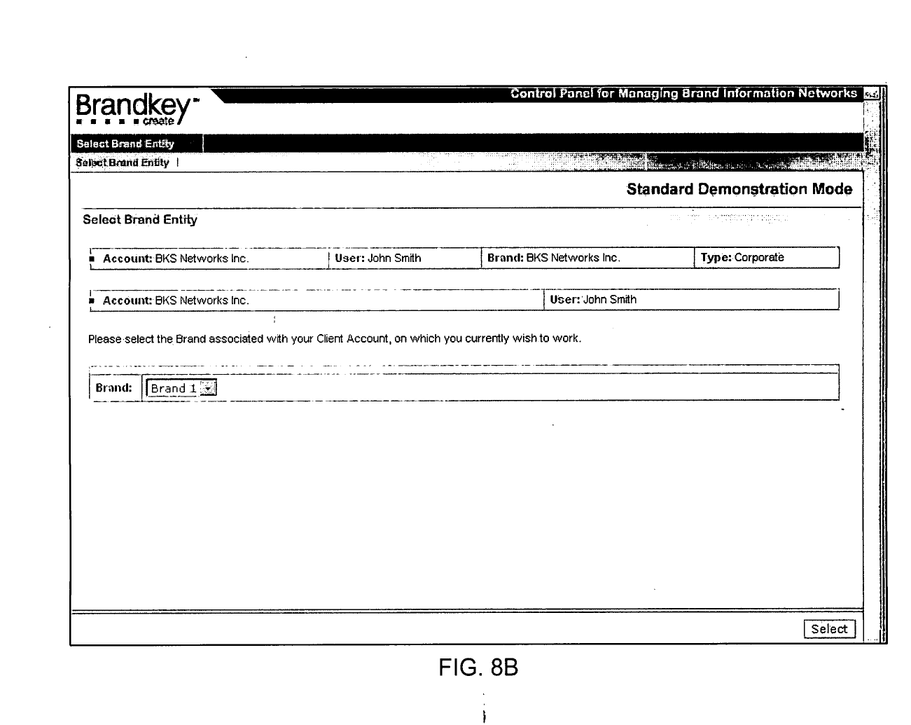

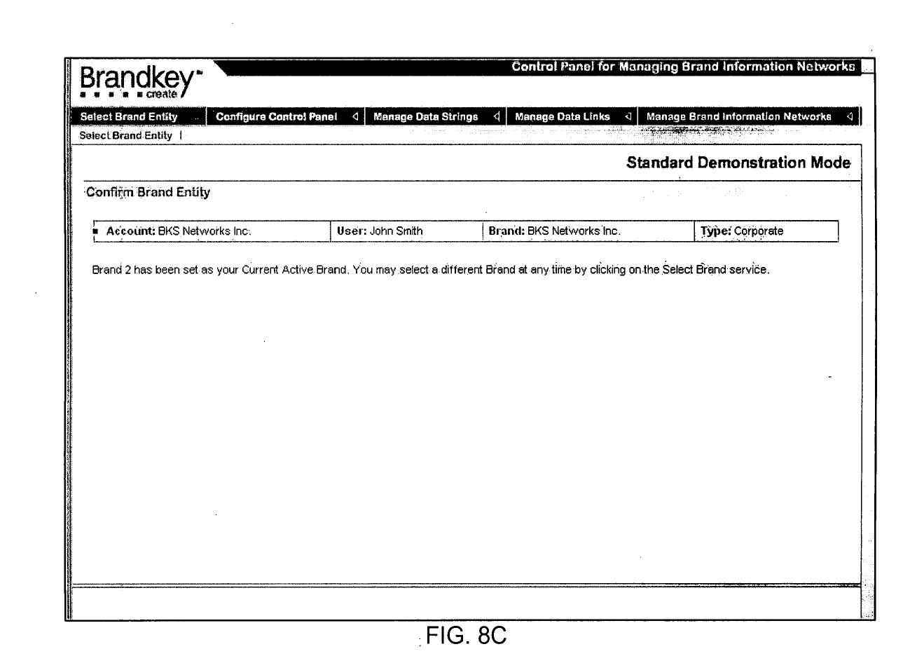

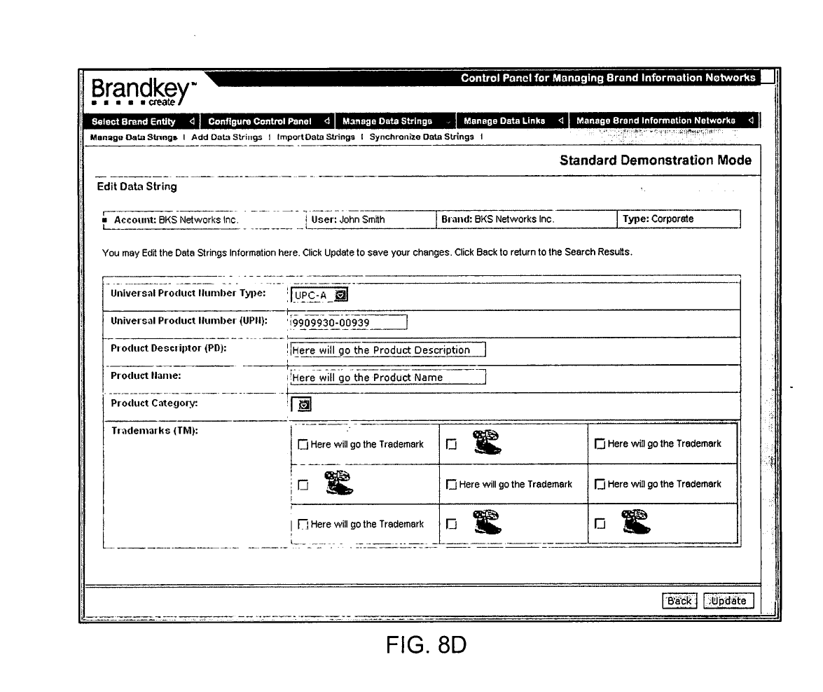

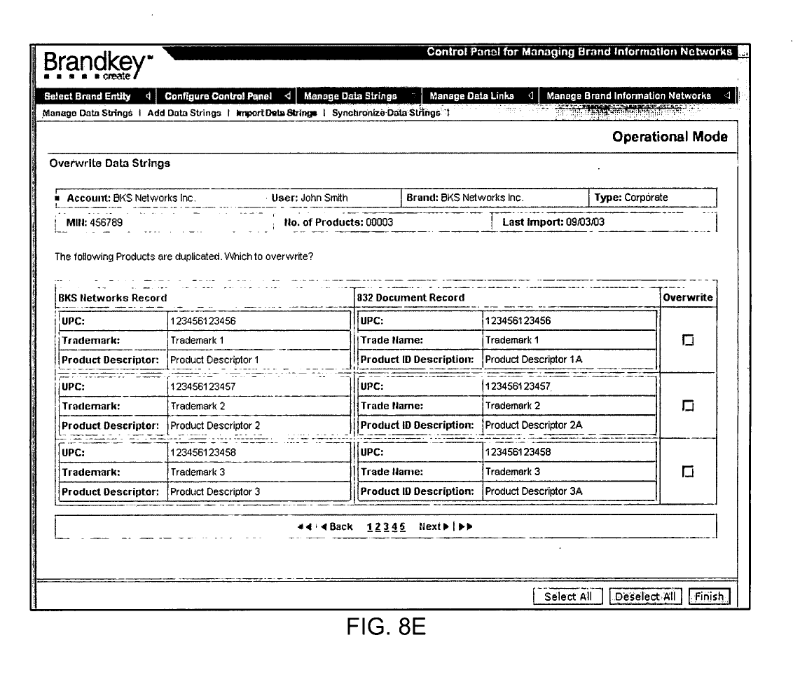

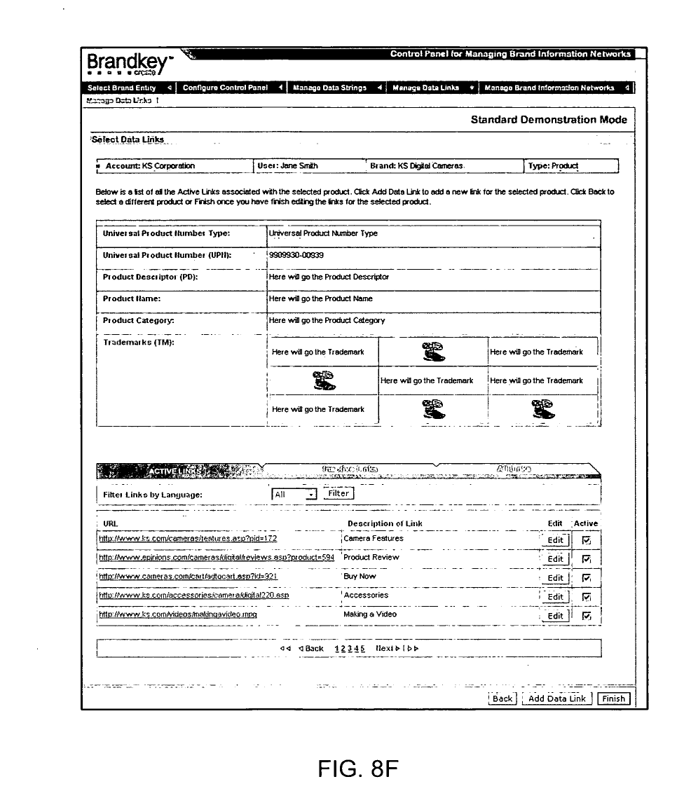

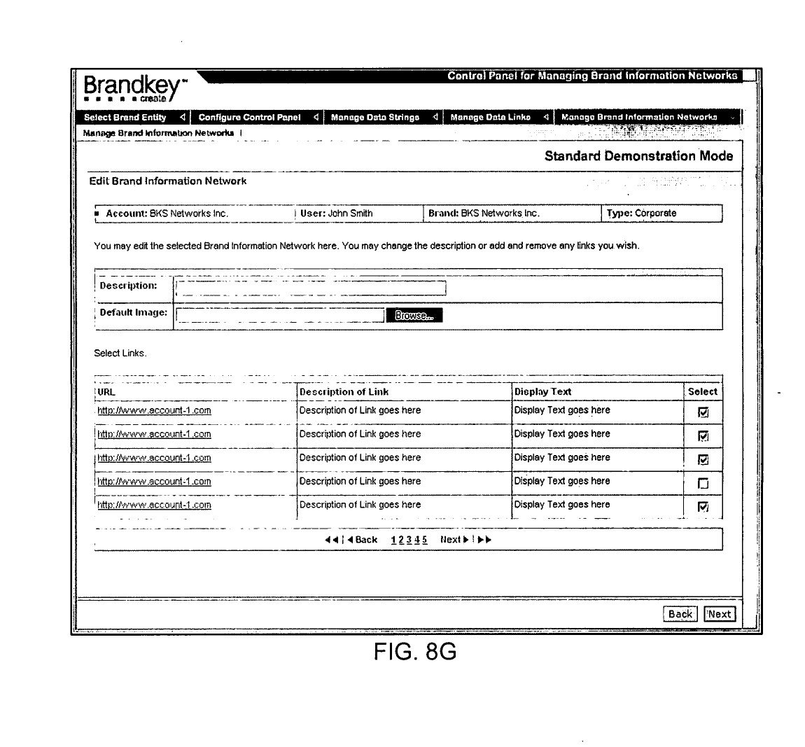

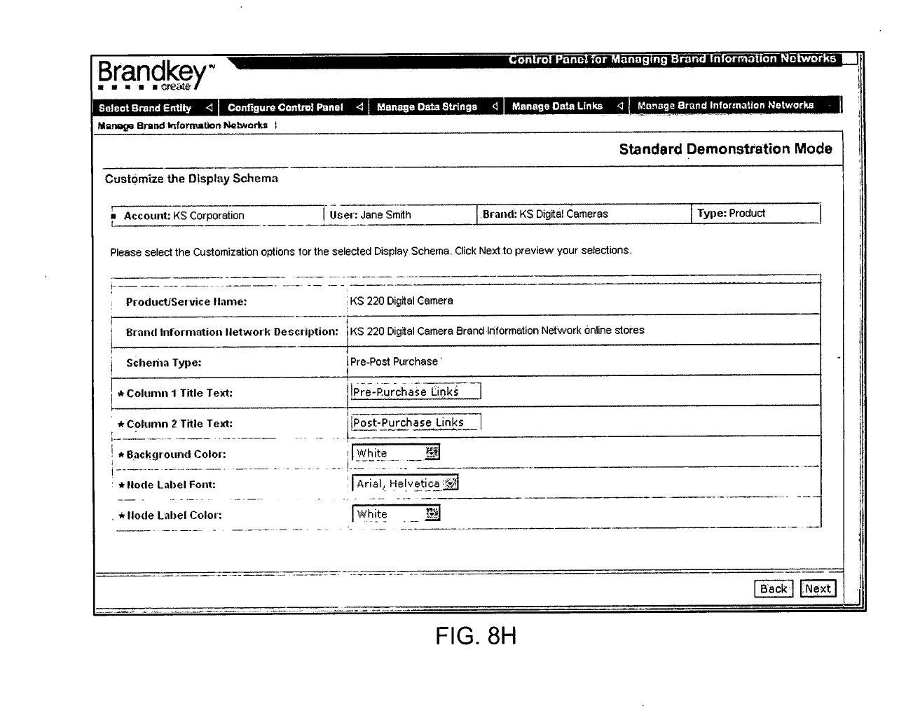

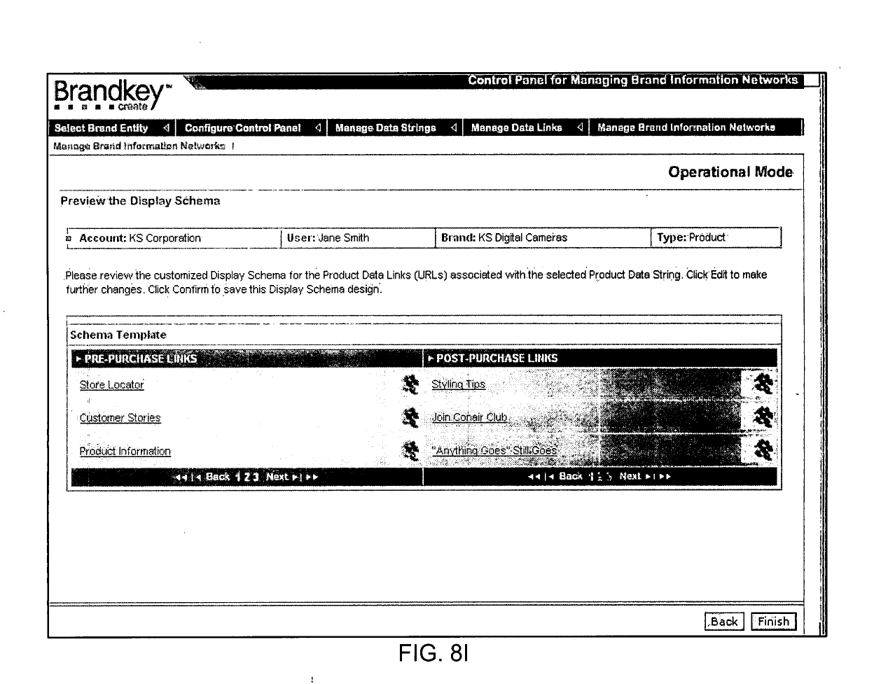

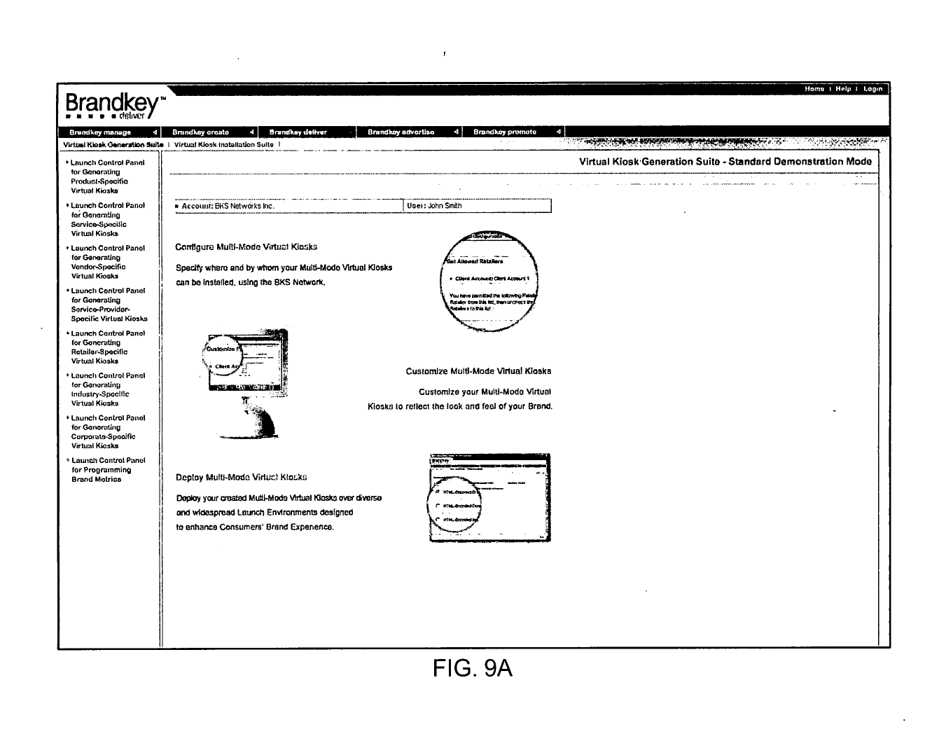

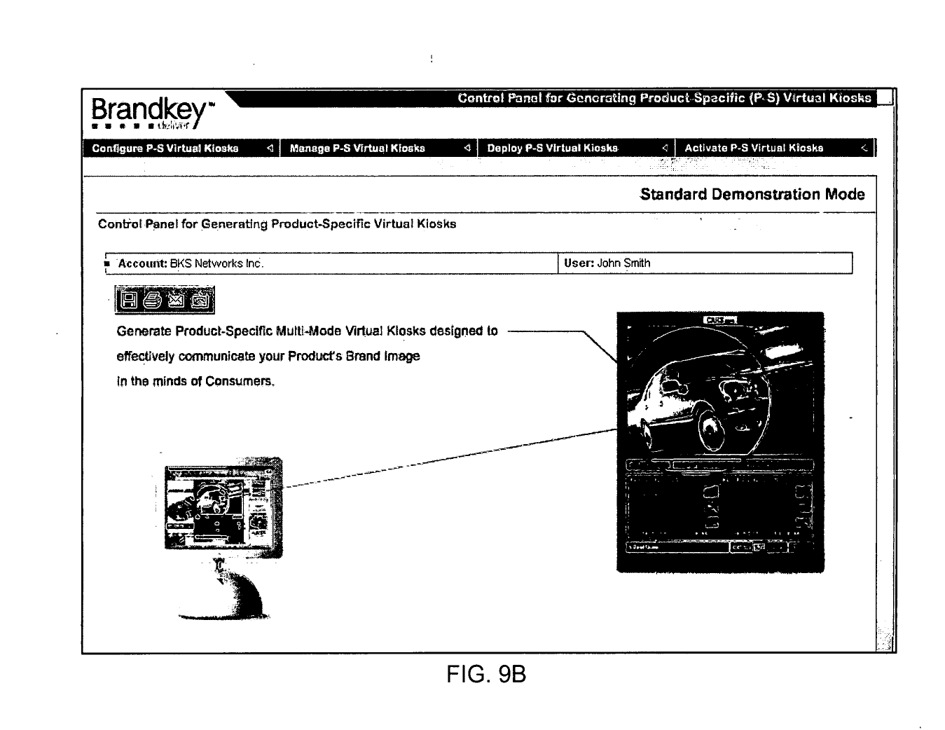

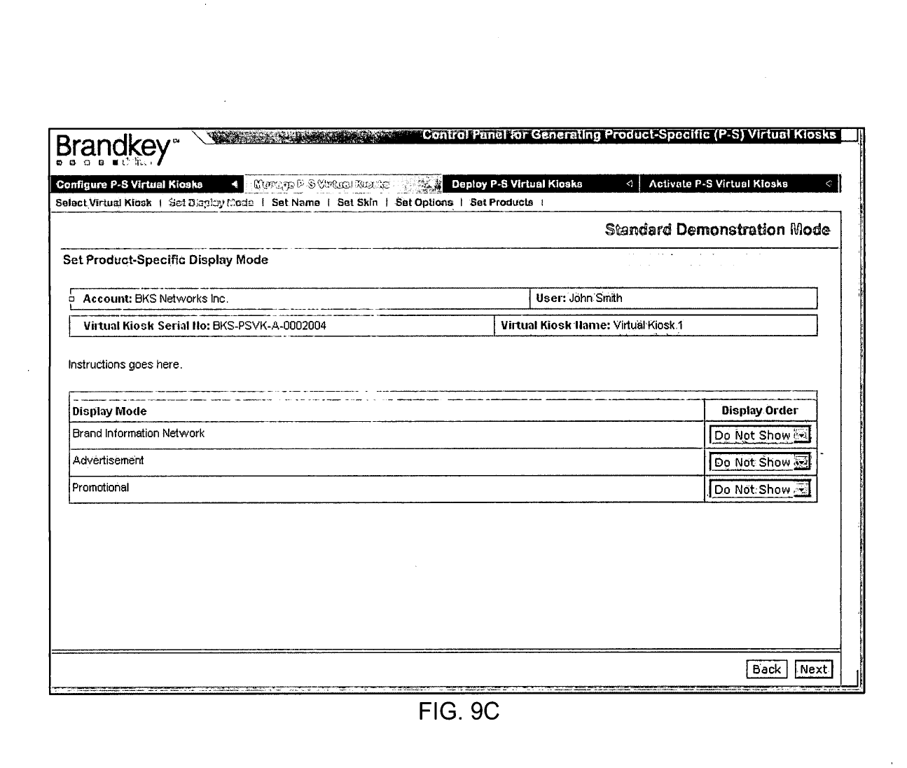

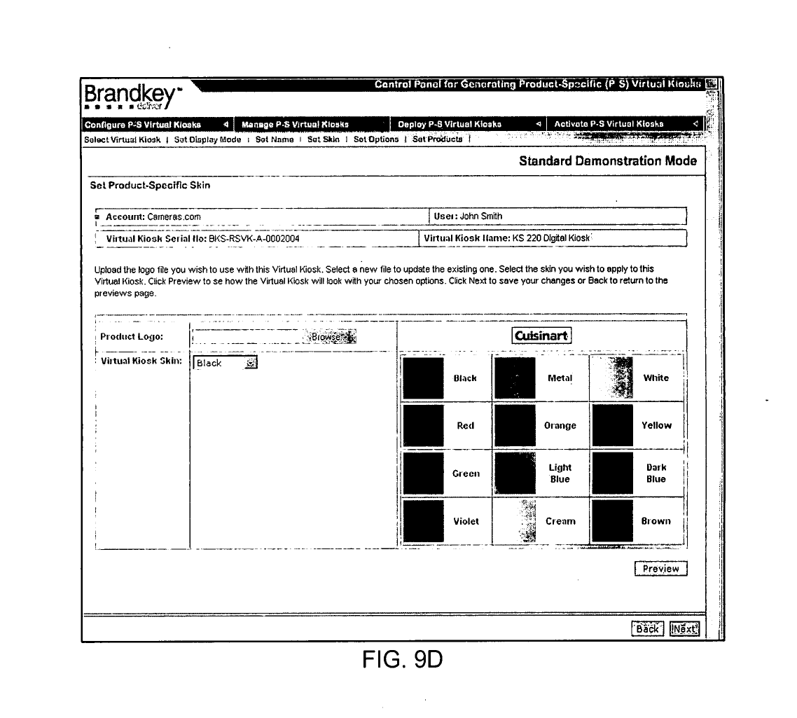

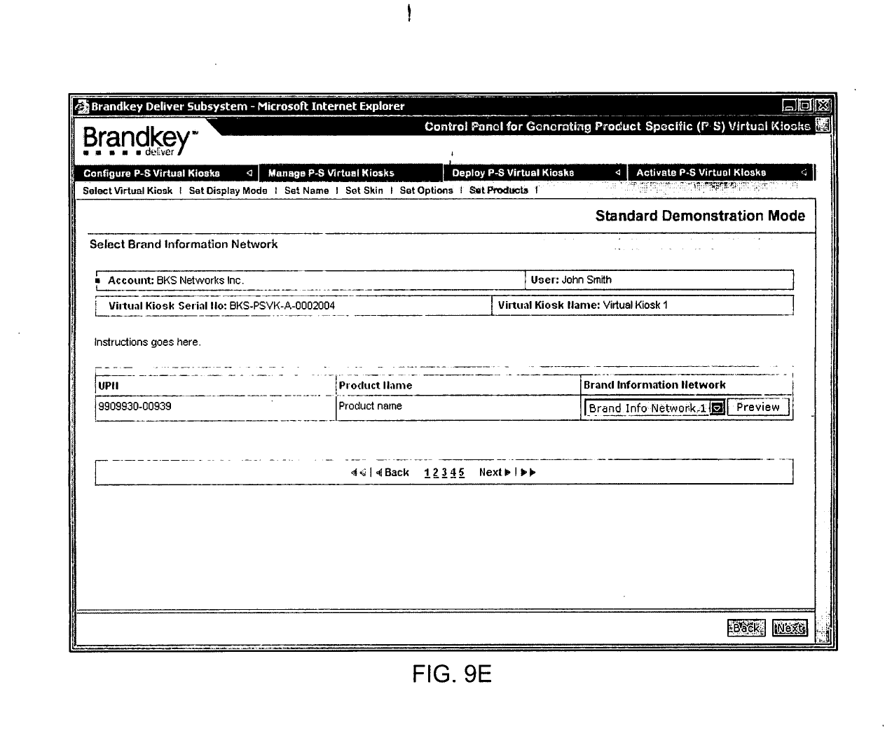

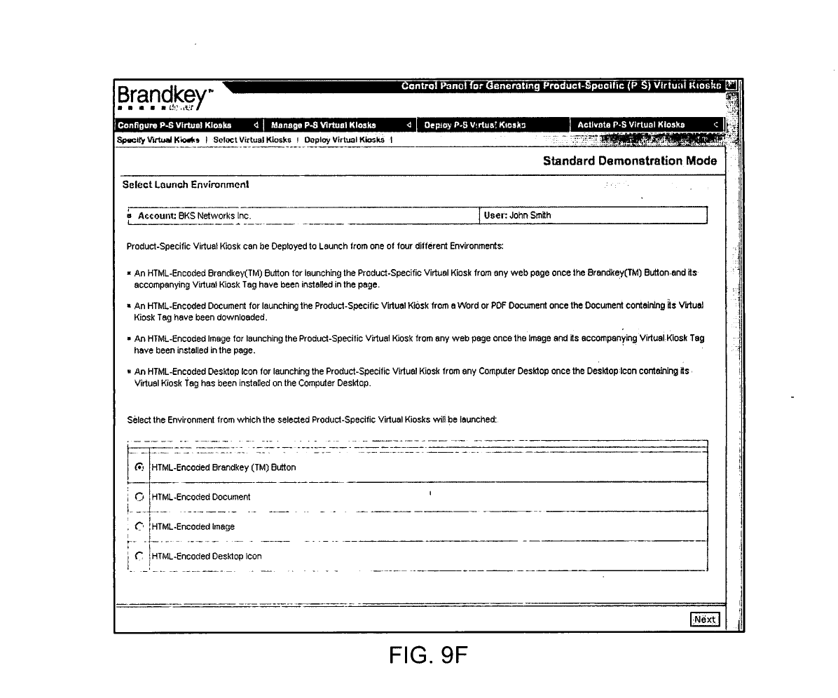

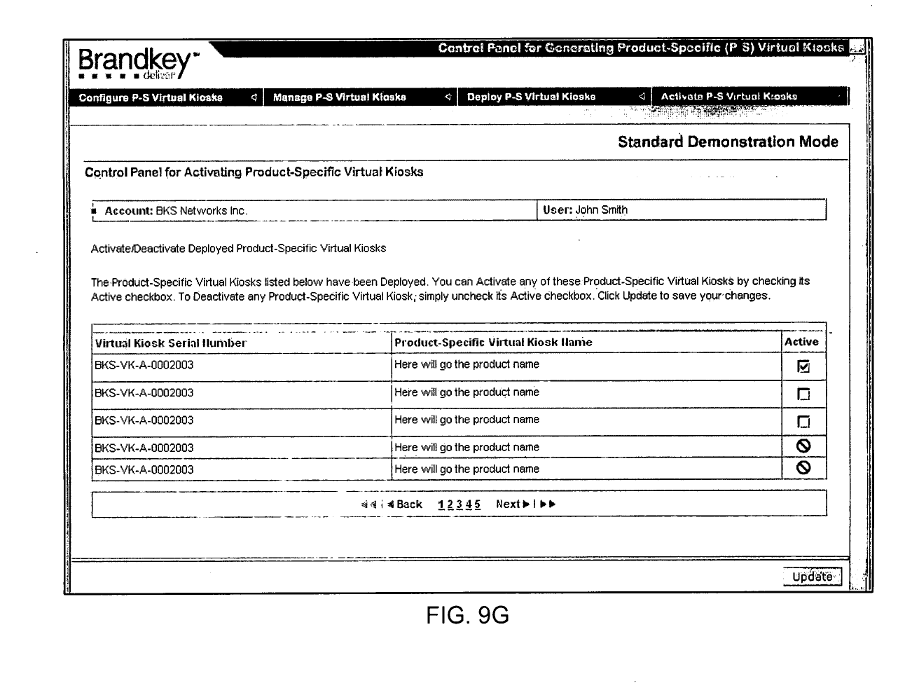

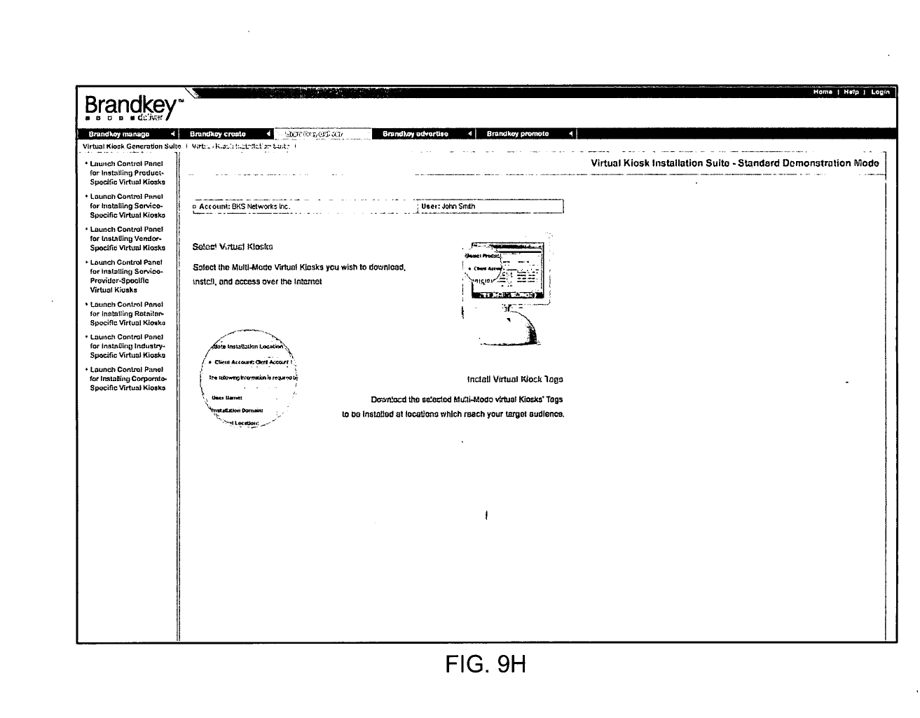

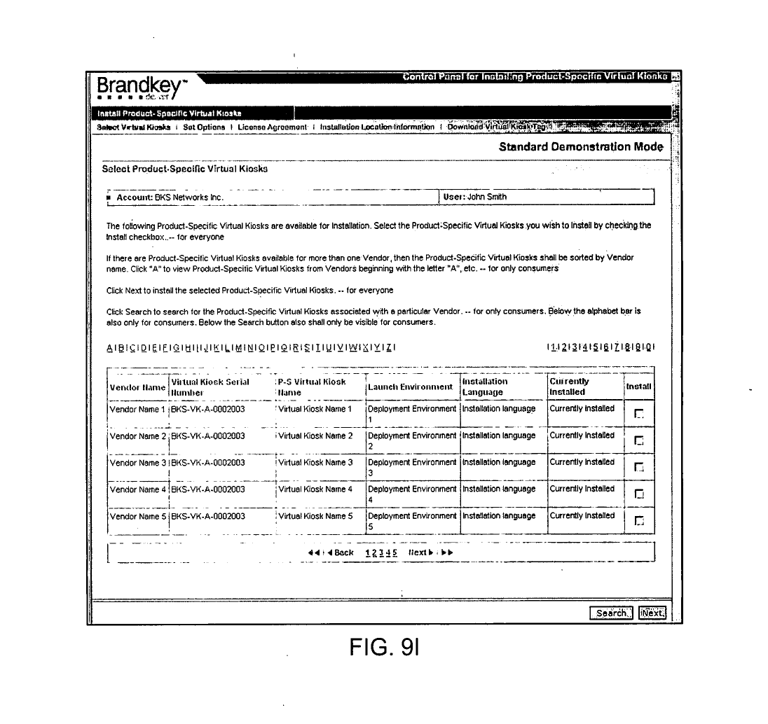

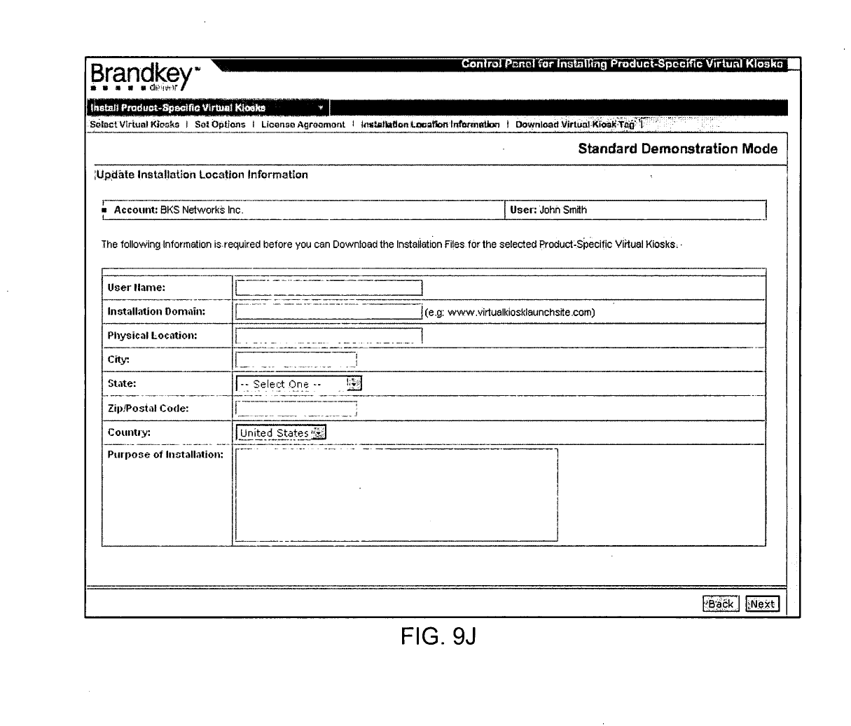

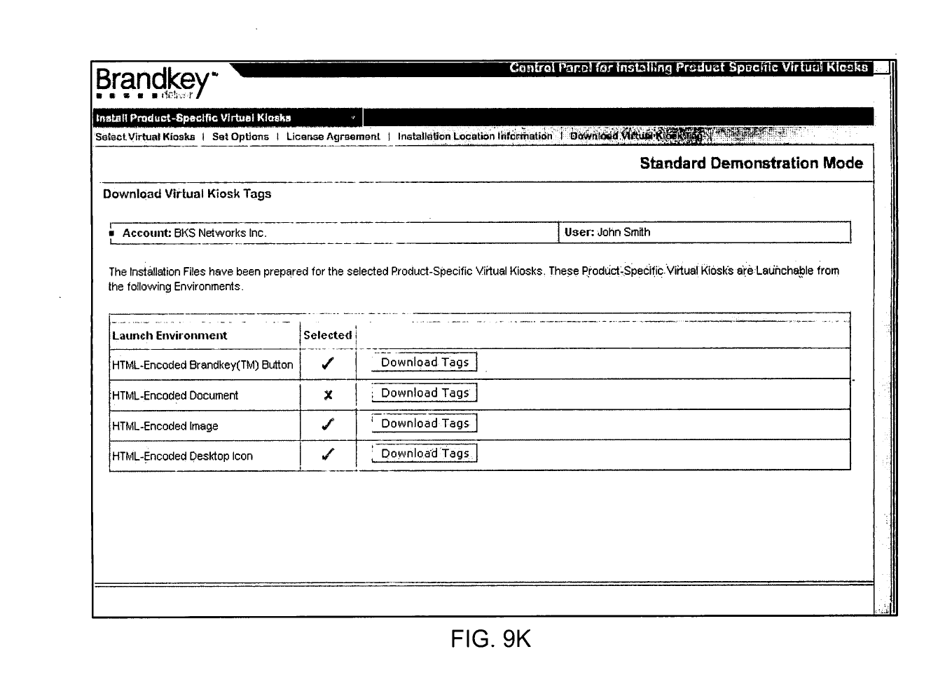

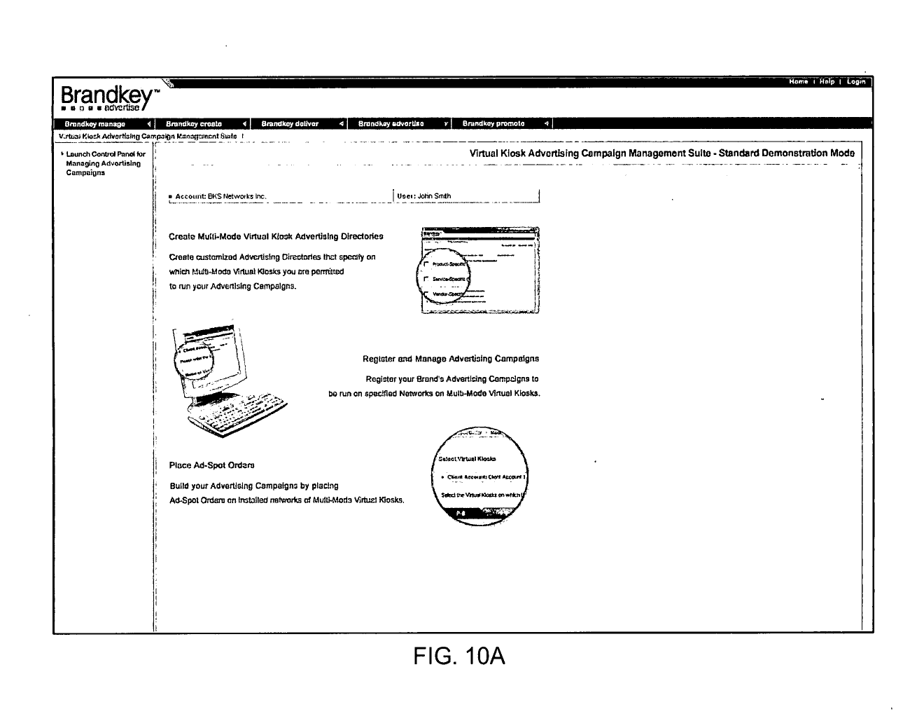

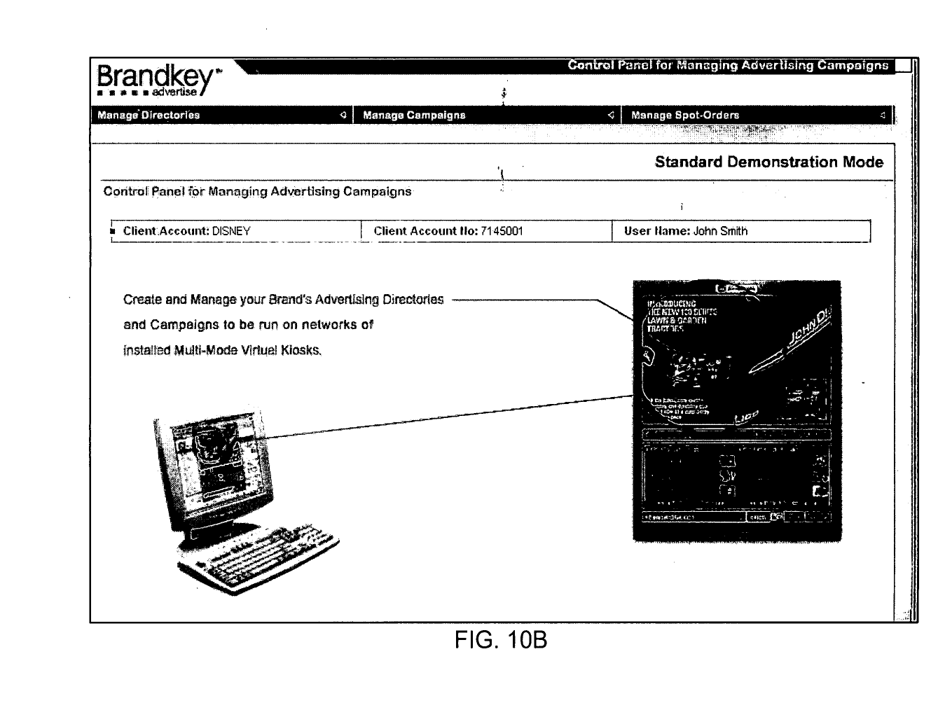

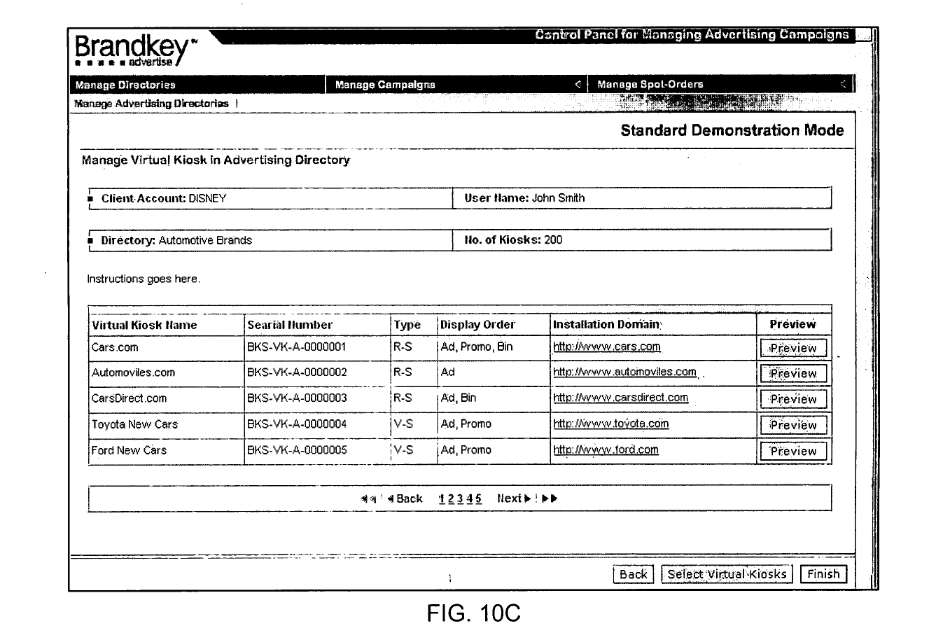

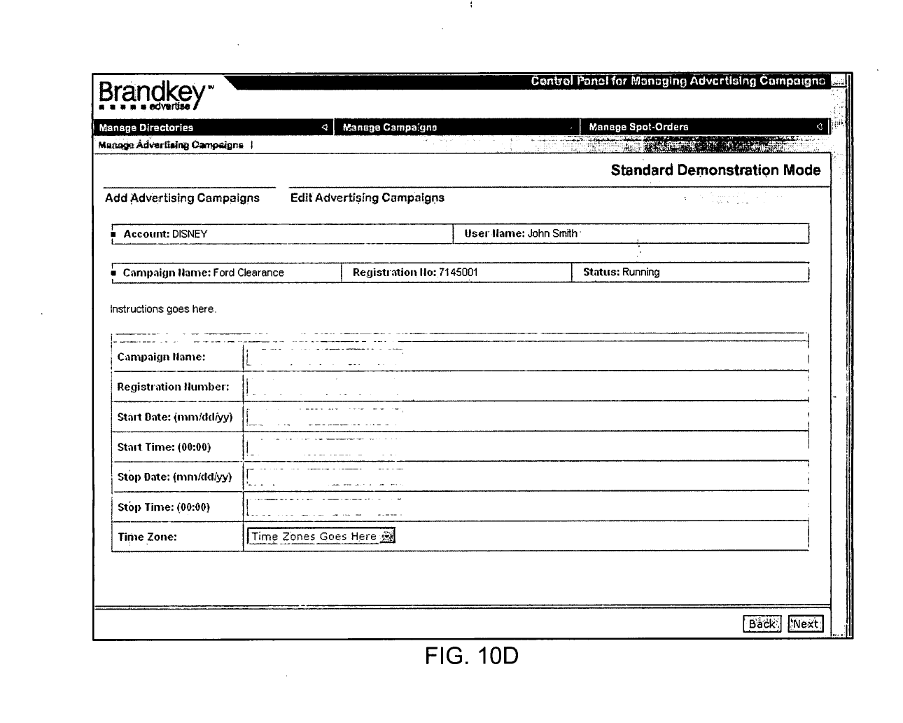

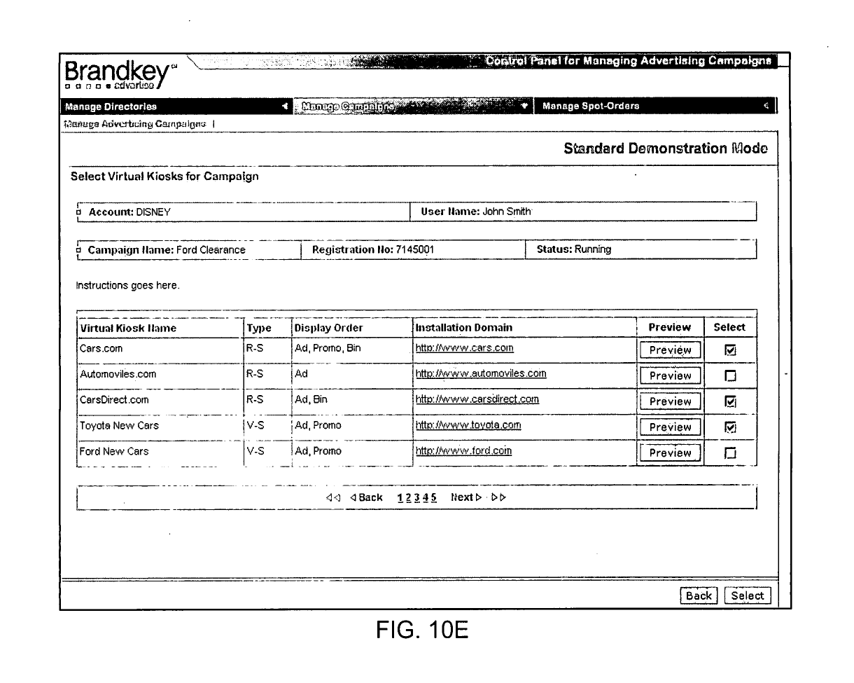

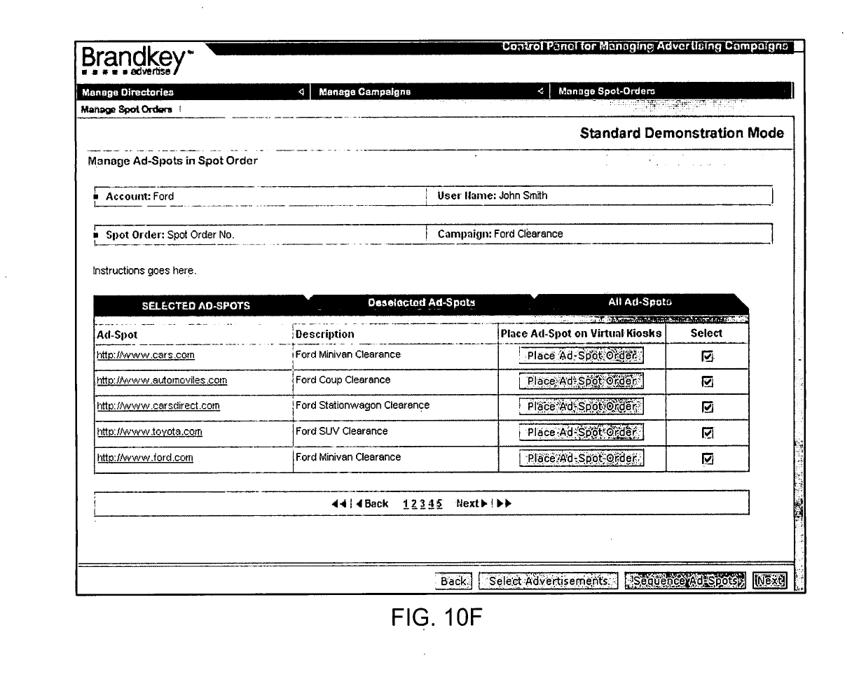

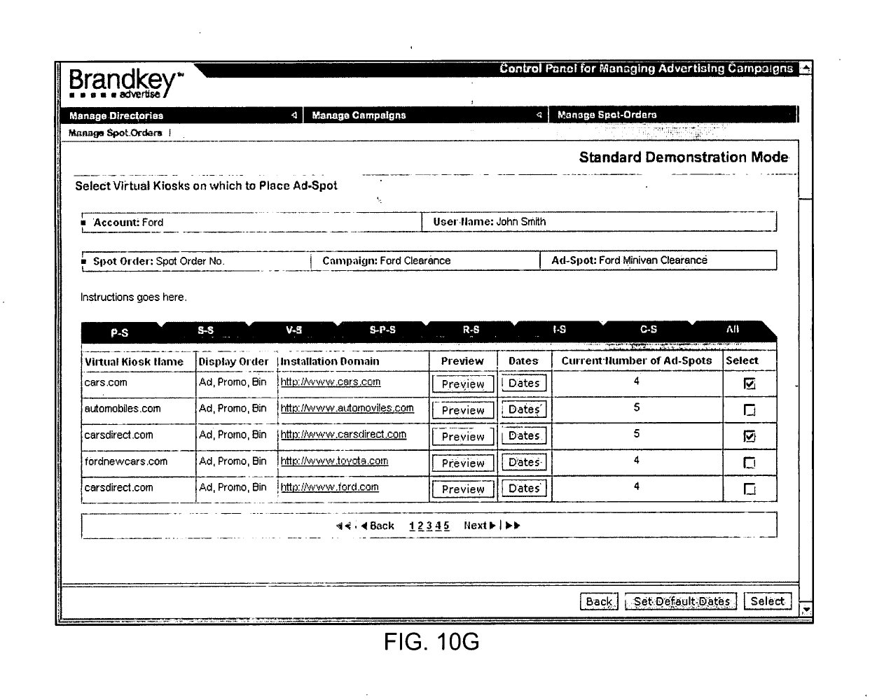

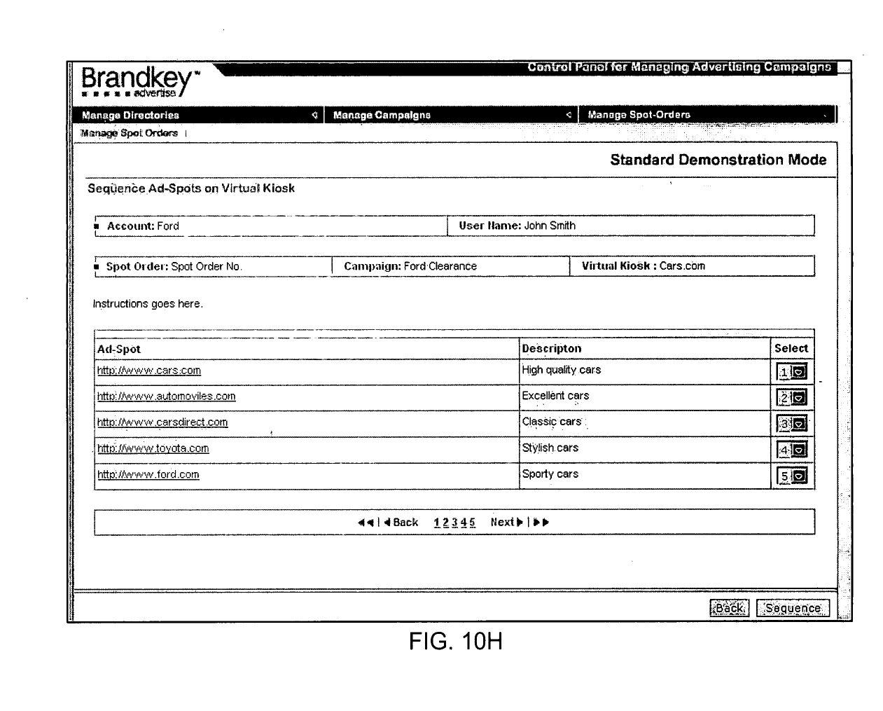

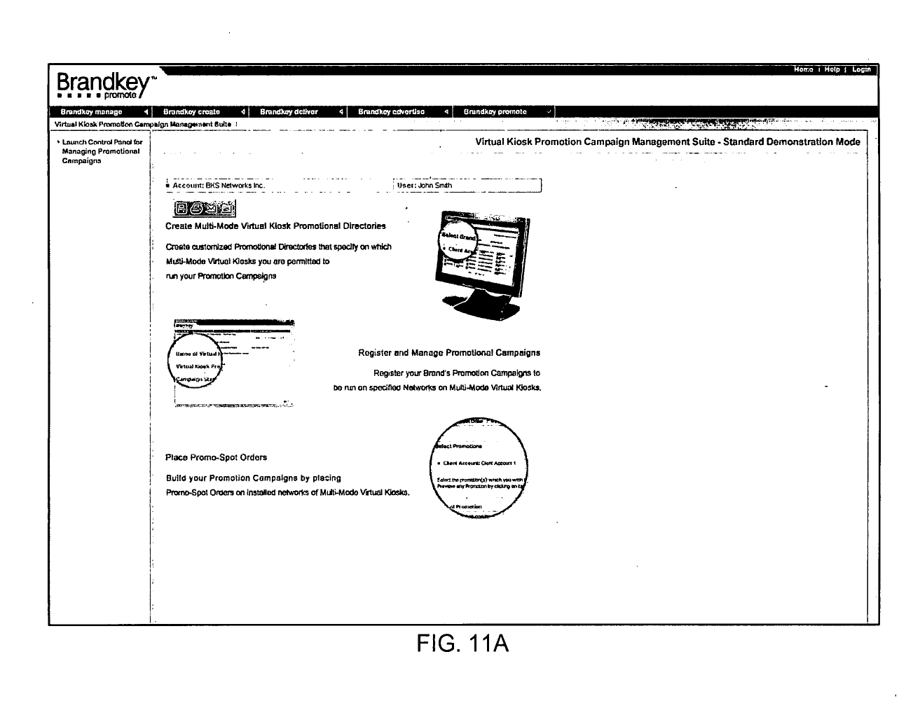

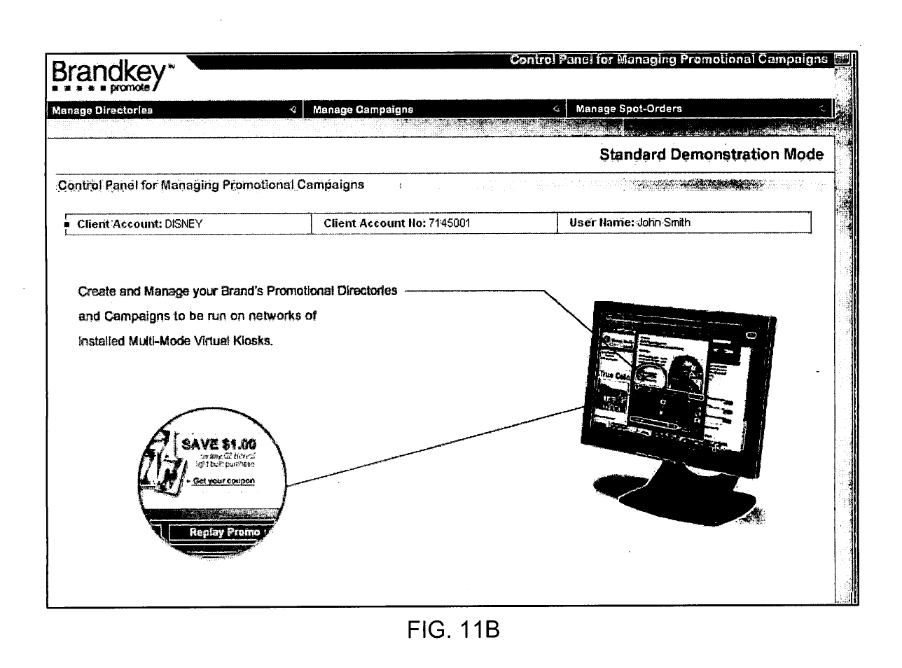

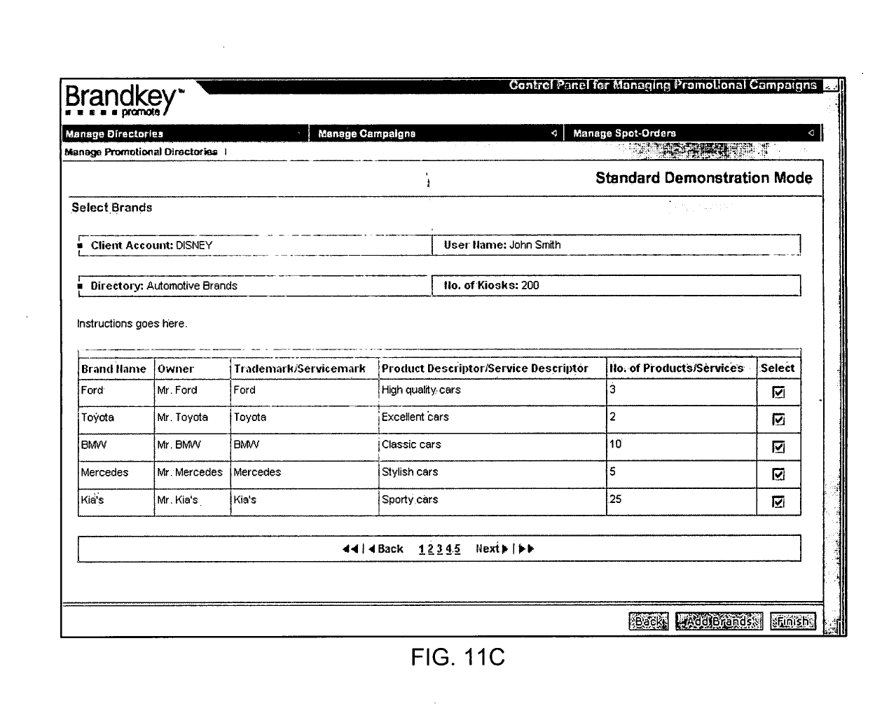

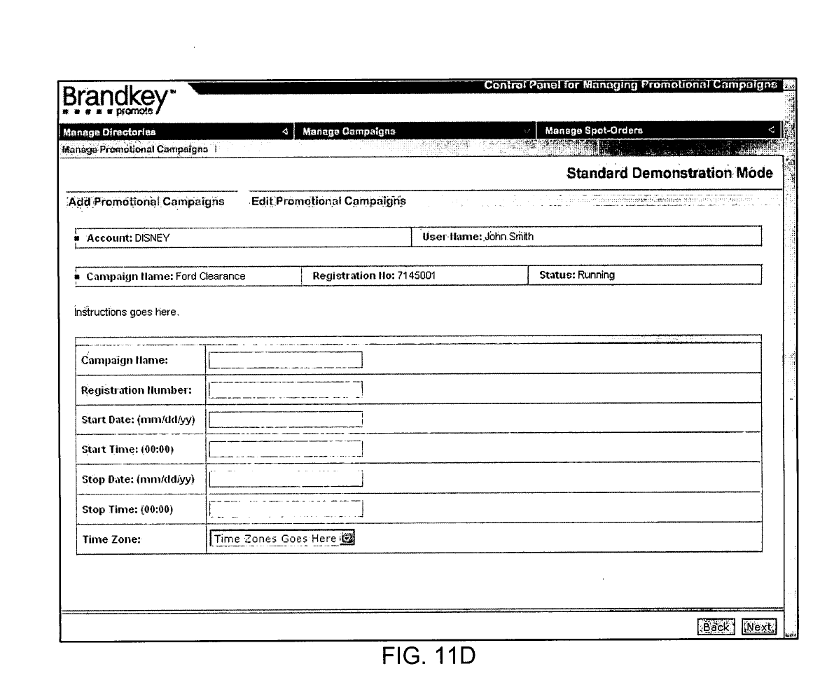

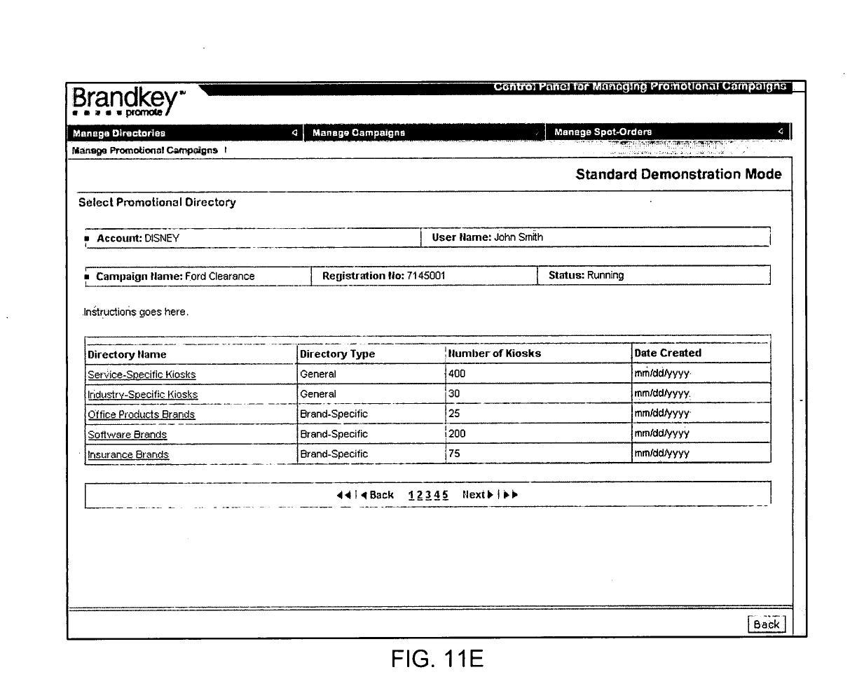

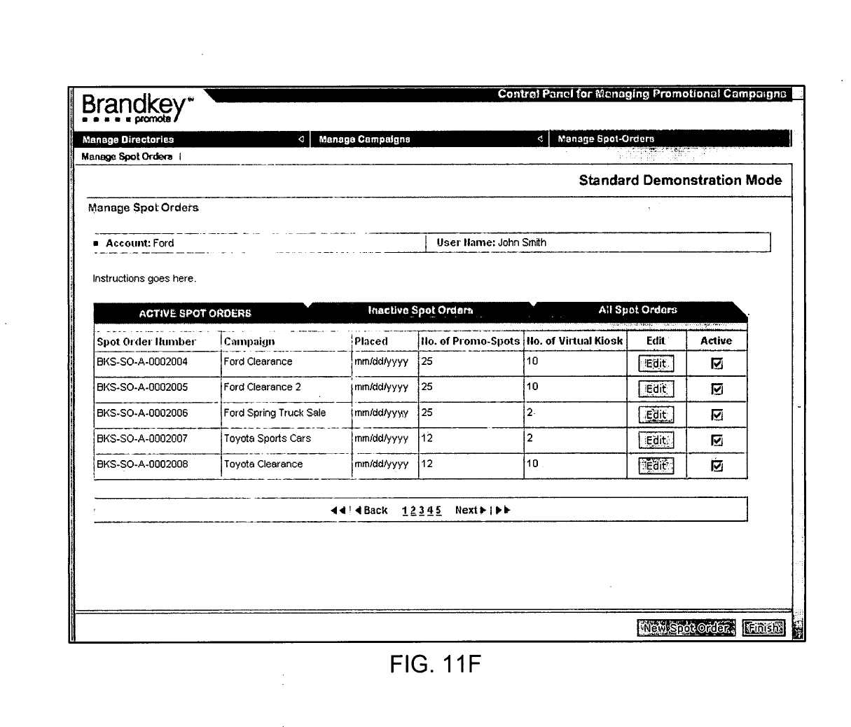

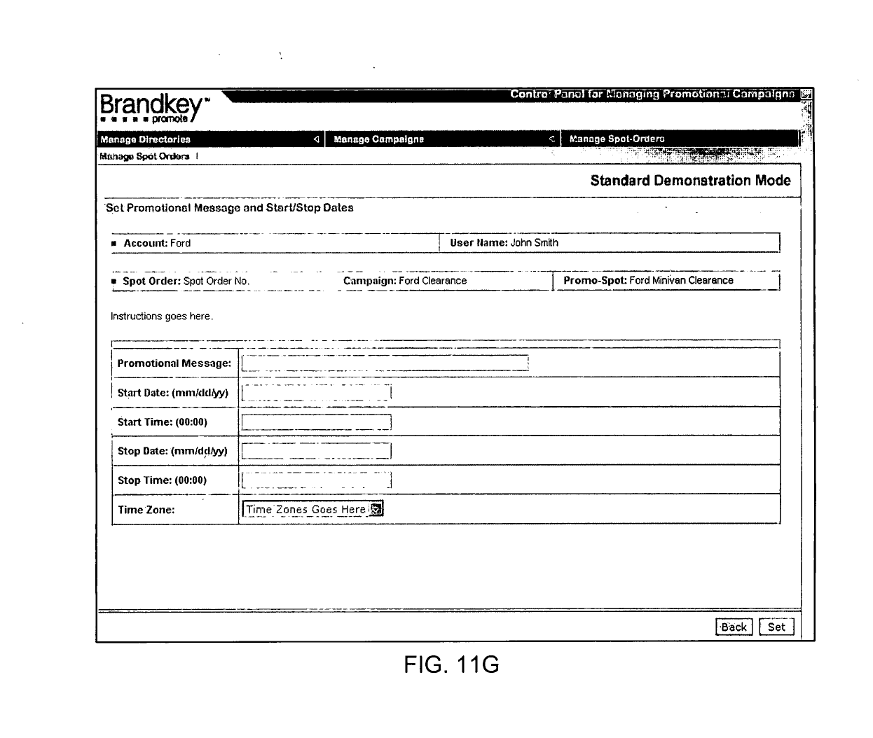

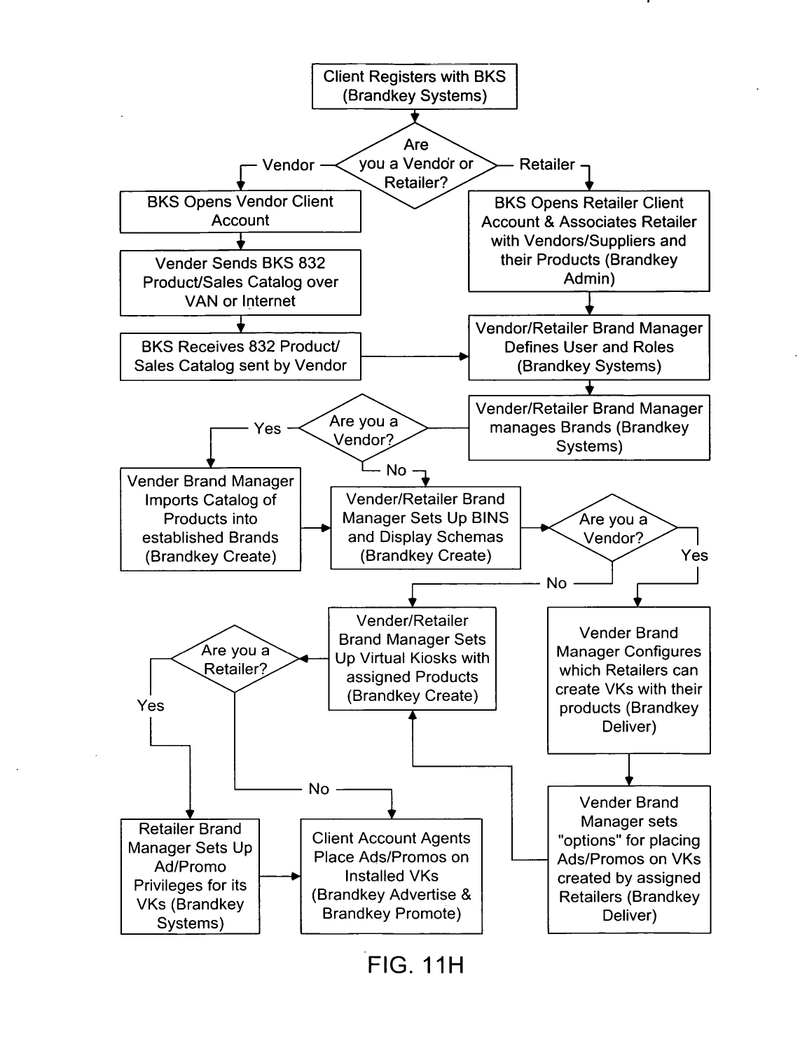

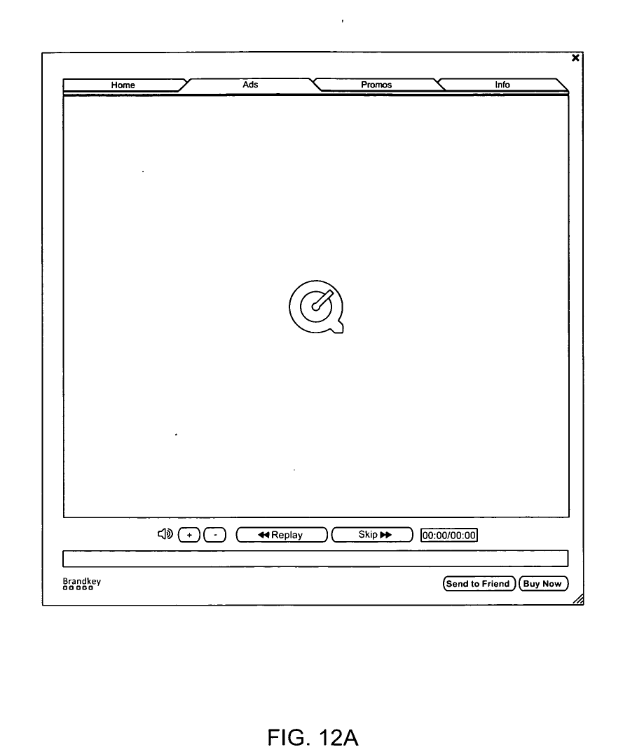

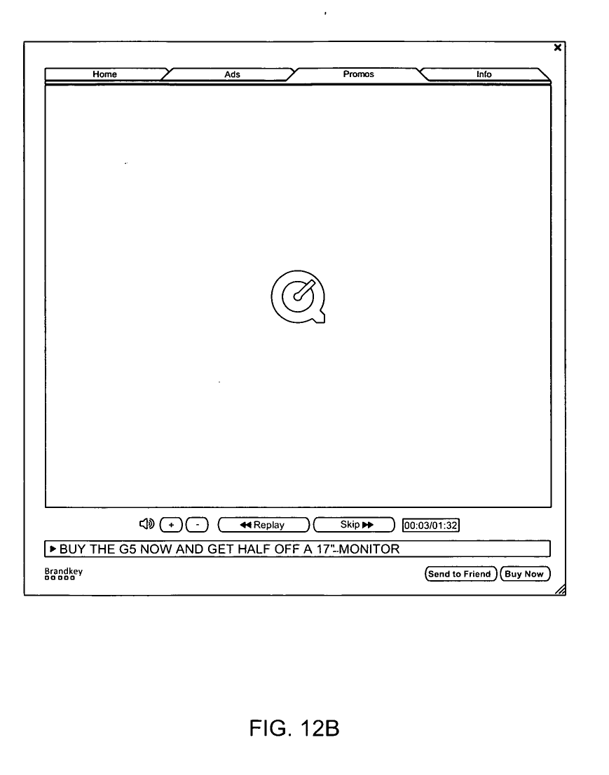

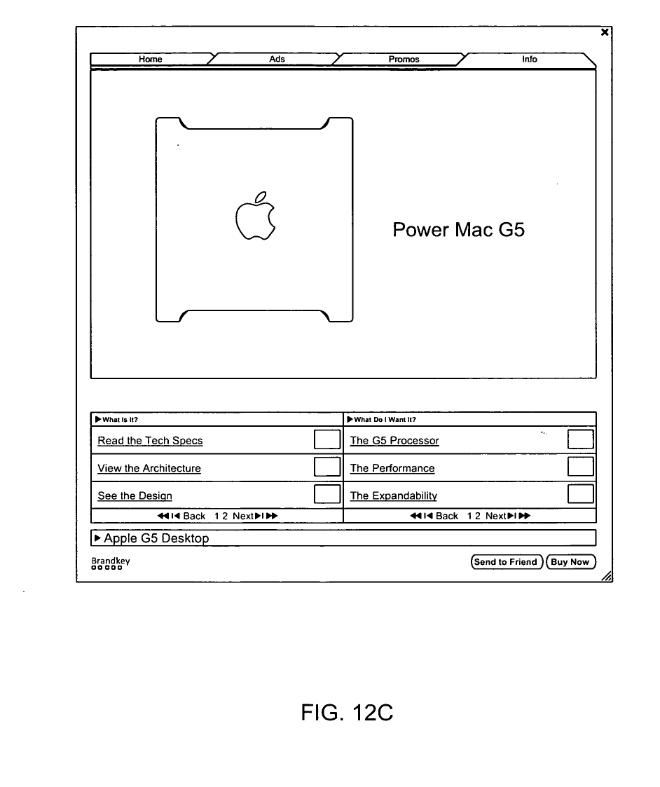

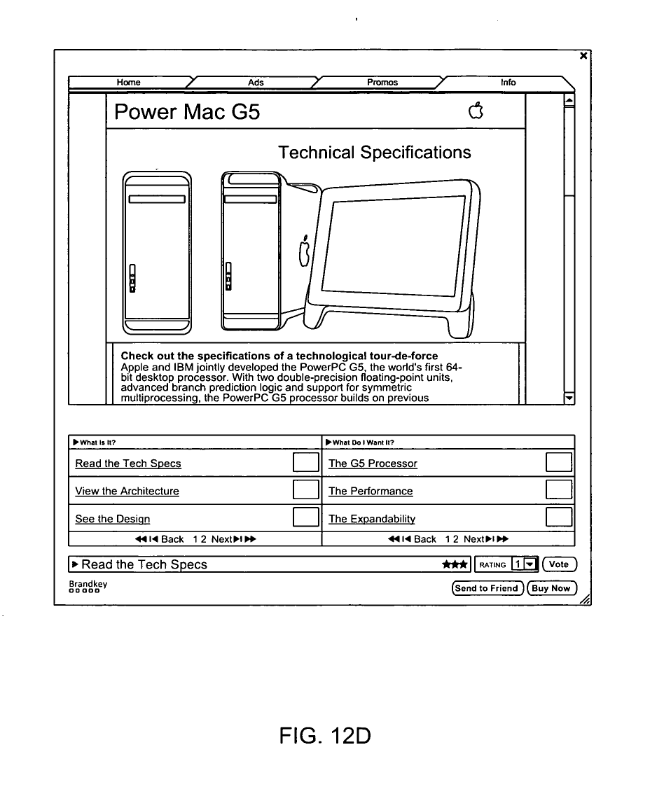

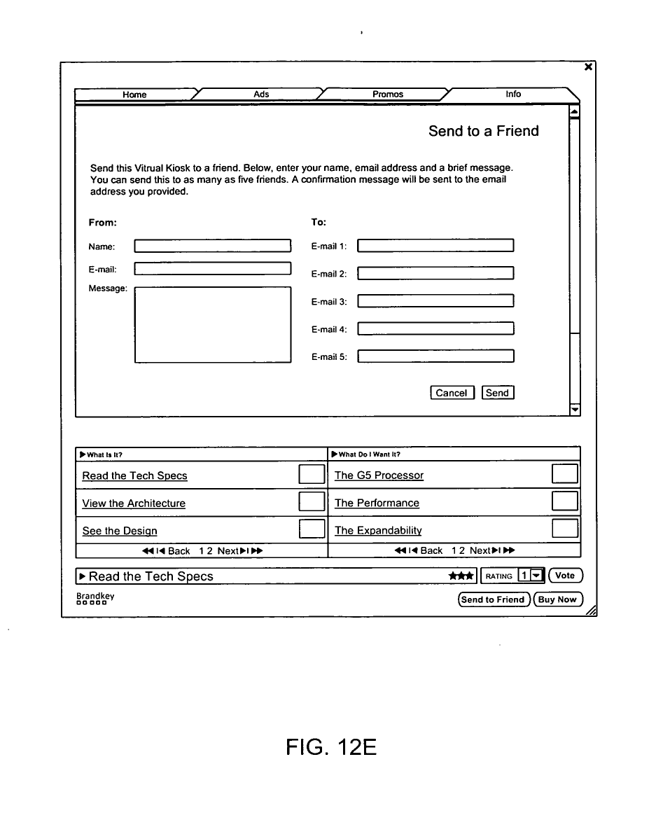

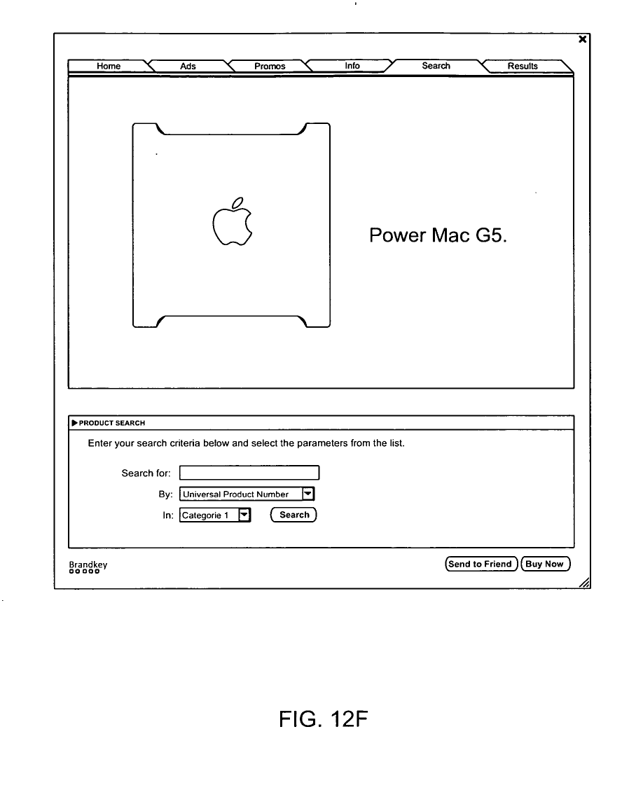

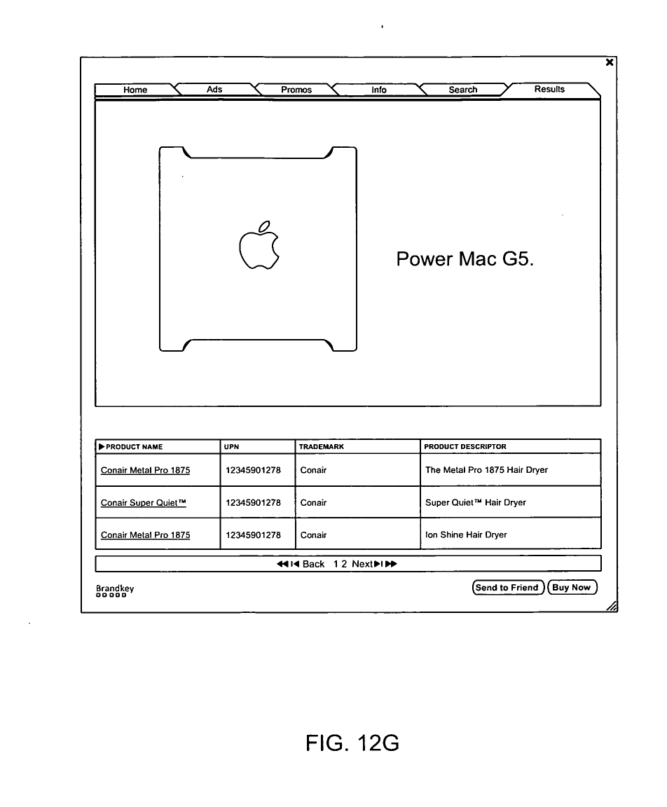

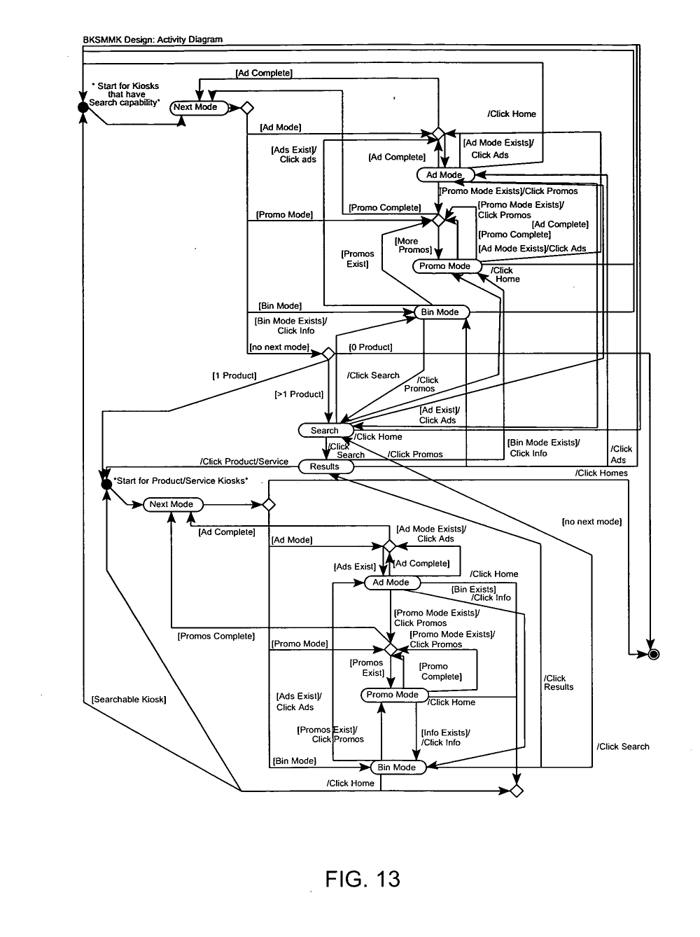

As illustrated in the GUI panel shown in FIG. 6A, the Brand Management and Marketing Communication Instrumentation Network of the present invention is divided into five customer-based Subsystems, identified by the following intent-to-use (ITU) trademarks: Brandkey Manage™ Subsystem whose GUI panels and services are illustrated in FIGS. 7A through 7H; Brandkey Create™ Subsystem whose GUI panels and services are illustrated in FIGS. 8A through 8I; Brandkey Deliver Subsystem whose GUI panels and services are illustrated in FIGS. 9A through 9K; Brandkey Advertise™ Subsystem whose GUI panels and services are illustrated in FIGS. 10A through 10H; Brandkey Promote™ Subsystem whose GUI panels and services are illustrated in FIGS. 11A through 11G; and Brandkey Admin™ Subsystem whose GUI panels and services are described below.

The Brandkey Deliver™ Subsystem provides Brand Management Teams the ability to rapidly configure, deploy, and install Multi-Mode Virtual Kiosks anywhere on the Internet.

The Brandkey Advertise™ Subsystem enable Brand Managers and their Agents to program the Advertising Spot Display Mode of their Multi-Mode Virtual Kiosks in a simple an convenient manner. These operations are carried out by creating, executing and managing Advertising Campaigns designed to run on networks of Multi-Mode Virtual Kiosks.

Using the Brandkey Promote™ Subsystem, Brand Managers and their Agents can program the Promotional Spot Display Mode of their Multi-Mode Virtual Kiosks. These programming operations are carried out by creating, executing and managing Promotional Campaigns designed to run on networks of Multi-Mode Virtual Kiosks.

The Brandkey Create™ Subsystem enables Brand Managers and their Agents to program the Brand Information Network Display Mode of their Multi-Mode Virtual Kiosks using simple mouse-clicks and data-entry operations. Programming operations are carried out by creating and deploying interactive models of Product and Service Brands represented in the form of richly-associated Brand-Building Information Networks. These Information Networks create and reinforce the intended Brand Image of Products and Services within the minds of Consumers.

As discussed above, Web-based Brand-Building Information Networks (BINs) can be constructed for Product-type Brands by linking the Uniform Resource Locators (URLs) of Brand Building Information Resources to Product Data Strings (UPN/TM/PD) consisting of the Universal Product Number (UPN), Trademark (TM) and Product Descriptor (PD) of branded products. For Service-type Brands, these Brand Information Networks can be created by linking the Uniform Resource Locators (URLs) to Service Data Strings (USN/SM/SD) consisting of the Universal Service Number (USN), Servicemark (SM) and Service Descriptor (SD) of branded services. Similarly, for Corporate-type Brands, these Brand Information Networks can be created by linking the Uniform Resource Locators (URLs) to Service Data Strings (USN/SM/SD) consisting of the Universal Service Number (USN), Servicemark (SM) and Service Descriptor (SD) of branded services.

The Brandkey Systems™ Administration Subsystem enable Users to perform basic management and administration functions relating to Client Accounts, Brands, and User Rights and Privileges.

Using the Multi-Mode Virtual Kiosks supported by the Network, consumers can learn about brands in a more effective and enjoyable manner, and develop strong preferences for them.

As will be described in detail below, each of these Subsystems has one or more service suites, and each suite supports one or more Control Panels, which may be realized as either Web-based clients or Java clients. As shown in FIGS. 6B1 through 6B10, these Control Panels and related services (i.e. Marketing Instruments) are identified in hierarchical order as they are provided within the Brand Management and Marketing Network of the illustrative embodiment, namely.

The purpose of these Control Panels is to perform specific operations that support the revolutionary ensemble of brand marketing communication instruments of the present invention, in a manner quite independent of the other Subsystems. The back-end relational database management subsystem (RDBMS) used by the BKSN Network, schematically depicted in FIG. 4, is the common item that integrates together the subsystems of the entire the Brand Management and Marketing Communication Instrumentation Network.

The Brandkey Admin Subsystem

In the illustrative embodiment, the Brandkey Admin Subsystem is reserved for use by Brandkey Systems (BKS) Employees, and preferably is realized as a standalone WebObjects Application on and Application Server, as is the Multi-Mode Virtual Kiosk (MMVK) Serving Subsystem shown in FIGS. 2B1 through 2B4. The Admin Subsystem will contain all the back-end functionality network service providers will use to maintain the network and the accounts that make up the BKS Network. The Admin Subsystem shall be divided into six Service Suites; the BKS Administrator Management Suite, the Marketing Management Suite, the Account Management Suite, the Revenue Management Suite and the Technical Management Suite.

All Brandkey Employee administration will occur in the BKS Administrator Management Suite. There will be six (6) levels of BKS Employees; SuperUsers, Account Supervisors, Marketing Managers, Account Managers, Revenue Managers and Technical Managers. SuperUsers have full access throughout the system. Account Supervisors report to SuperUsers and are responsible for certain assigned Accounts. Account Manager. Account Managers, Revenue Managers and Technical Managers report to Account Supervisors and are responsible for certain aspects of assigned Accounts.

The primary marketing functions for Prospective Client Accounts occur in the Marketing Management Suite. Only SuperUsers, Account Supervisors and Marketing Managers have access to this Suite.

The primary management functions for BKS Accounts occurs in the Account Management Suite. Only SuperUsers, Account Supervisors and Account Managers have access to this Suite.

The primary revenue management functions for BKS Accounts occur in the Revenue Management Suite. Only SuperUsers, Account Supervisors and Revenue Managers have access to this Suite.

The primary technical and user-support management function for BKS Accounts occur in the Technical Management Suite. Only SuperUsers, Account Supervisors and Technical Managers have access to this Suite.

The following describes briefly the functions provided in each of the five core Subsystems of the Brand Marketing Communication Instrumentation Network of the present invention.

The Brandkey Manage Subsystem

The Brandkey Manage™ Subsystem, illustrated in FIGS. 7A through 7H, is the central location where Brand Managers and Client Account Administrators can manage their Client Accounts and Brands, set User Rights to access the BKS Network as well as program the Advertisement and Promotion Display modes of Multi-Mode Virtual Kiosks.
This Subsystem allows the Brand Managers to:
Register with BKS Networks to set up client Accounts
Manage users assigned to the account as well as their rights to use specific services delivered by the BKS Network
Manage Accounts, the Trade/Servicemarks associated with the Brand Entities, account Access rights to the BKS Network and certify Ad/Promo Agents.
Assign business associates privileges to place Ad/Promo Spots on the installed Multi-Mode Virtual Kiosks
View Brand Metrics relating to services delivered by the BKS Network.

The Brandkey Manage™ Subsystem is an extension of the overall BKS Network from the front page of its Web-based GUI. There are Administrative instruments as well as Demonstration and Tutorial instruments designed to instruct and illuminate the User in the workings of the BKS Network as a whole.

The Brandkey Manage™ Subsystem is divided into the following Suites; the Demonstration Suite, the Tutorial Suite, the Registration Suite, and the User/Account Administration Suite.

The Demonstration Suite contains Flash and other types of Demonstration materials for the various parts of the BKS Network. These demonstrations are designed to give the User a bird's eye (10,000 foot) view of the System and its capabilities.

The Tutorial Suite contains Flash Tutorials for every part of the BKS Network. These tutorials are designed to give the User an in-depth understanding of the functionality of the every aspect of the BKS Network and how to best utilize its revolutionary Brand Marketing Communications Instruments.

The Registration Suite contains the Registration Control Panel, which new Users use to register with the BKS Network. Generally these Registrants will be Brand Managers, Advertising or Promotional Agents, etc., or those people with certain high-level responsibilities for Brands. The Registration Process asks the Registrant for their Personal Information, then their Brand Entity Information, then their relationship with the Owner of the Brand. Once this information is filled in, it is recorded to the database and sent to the BKS Administrators to verify. If the Registrant is a Consumer, they will be given immediate access to the System. However, they will only have access to the Virtual Kiosk Installation Suite in the Brandkey Deliver™ Subsystem.

Once a User's Registration has been approved, they will gain access to the User/Account Administration Suite. This Suite is accessible only to those Users who are the Administrators of their Client Account. By default the Registrant is initially set as the default Administrator of the Client Account. This can be changed with a request to the Client Account's Brandkey Administrator.

In the User/Account Administration Suite, there are three Control Panels for the User to select; the Control Panel for Administering Users, the Control Panel for Administering Accounts, and the Control Panel for Administering Ad/Promo Privileges.

The Control Panel for Administering Users allows the Administrator to edit the personal information for any User associated with their Client Account and to mange that User's Access Rights for the Network. The Administrator can also add new Users and configure their Access Rights for the Network.

The Control Panel for Administering Accounts allows Administrators to manage their Client Account Information. They may update their Company Information, their own personal information and access rights; they may also edit the list of Brand Entities associated with their Client Account or add new Brand Entities to their Client Account. Along with these Brand Entities the Administrator is allowed to manage or add new Trademarks or Servicemarks associated with those Brand Entities. Finally in this Control Panel, the Administrator is also able to Certify or Decertify any Advertising and Promotional Agents associated with their Client Account. When an Advertising or Promotional Agent signs up with the BKS Network, they are asked which Brands they work for. Once that information is received from the Agent, they are put into the queue of pending Agents for certification by the Administrator of those Brands. If the Administrator certifies those Agents, then they are added to the Certified Agents list. If the Administrator does not certify those Agents, then they are deleted from the Database for that relationship. Likewise, if a Certified Agent is then decertified, their relationship with that Client Account is deleted from the Database.

The third Control Panel is the Control Panel for Administering Ad/Promo Privileges for installed Virtual Kiosks. Each Multi-Mode Virtual Kiosk can support Advertisements and/or Promotions. It is up to the Virtual Kiosk owner to decide which Vendors, Service Providers, etc. have access to which Virtual Kiosks containing their Products, Services, or Brands. The Administrator will select a Virtual Kiosk from the list and see which Vendors, Service provider, etc. have Products, Services, and Brands associated with that Multi-Mode Virtual Kiosk. They may then assign Shared privileges or Exclusive privileges for that Client to place Advertising or Promotional spots on that Virtual Kiosk. If the Administrator chooses a Shared privilege for a Client on a Virtual Kiosk, this means that the Administrator may add other Clients to share the Advertising space on that Virtual Kiosk. However, if the Administrator chooses an Exclusive privilege for a Client on a Virtual Kiosk, then that Virtual Kiosk is blocked for any other Client to place Advertising or Promotional spots on it. If a Virtual Kiosk had Shared privileges, then a Client gains Exclusive privileges, then that Exclusive privilege trumps any Shared privilege previously configured for the Virtual Kiosk.

By using these Control Panels and Suites, the Administrator and other Users can safely navigate the BKS Network and set up accurate representations of their Brand Account and access rights and ad/Promo spot placement privileges for their Multi-Mode Virtual Kiosks.

The Brandkey Create Subsystem

The Brandkey Create™ Subsystem, illustrated in FIGS. 8A through 8I, employs the latest advances in cognitive science and learning theory to enable Brand Managers and their team members to create and deploy multi-level interactive audio-visual models of product, service and corporate brands represented in the form of Brand Information Networks supported by brand-building information resources on the Internet (e.g. WWW, ftp sites, etc).

These Brand Information Networks are constructed upon a network of Brand-Building Information Links located at the nodes of the Brand Information Network. Each node in the Network can be encoded with brand-identifying graphics and audio clips selected by the Brand Manager's team and build and reinforce the Brand Image intended by the Brand Managers.

By strengthening the intended Brand Image associated with their Brand Entity, Brand Managers can effectively combat the forces of brand-related confusion, erosion, and dilution created by marketplace clutter.

The results of delivering Brand Information Networks to Consumers at Internet-based touchpoints before, during and after purchases are consumers learn about and remember what is relevant and important about the particular Brand Entities represented by the delivered Brand Information Network; brand managers build stronger, more powerful Brands in the minds and hearts of Consumers; and stronger, more powerful Brands increase the level of influence brand managers have along their distribution channels.

The Brandkey Create™ Subsystem enable Brand Managers to manage their list of Products and Services and to create the networks of richly associated Brand-Building Resources used on the Multi-Mode Virtual Kiosks to build stronger, more powerful Brands in the minds and hearts of Consumers. The Brandkey Create™ Subsystem consists of one Suites; the Brand Information Network Management Suite.

Brandkey Create Subsystem also supports a mechanism for visualizing brand images projected by brand information networks created by brand management team members, as described below.

A first illustrative embodiment of this composite brand image viewing mechanism supports the following steps:

Step 1: Create Brand Information Network based on UPN/TM/PD/URL Data Link Sets;

Step 2: For each node within the Brand Information Network, catalog the URLs referenced therein, and for each Web Page referenced by these URLs, catalog the URLs referenced therein. Perform this for N number of levels of nodes within the Brand Information Network.

Step 3: Based on the Number of Nodes in the Brand Information Network, N, generate an N faceted three-dimensional polytope, and assign the corresponding URL thereto.

For each nth facet, divide the same into a number of subfacets equal to the number of URLs referenced in the URL, and then assign to each subfacet the corresponding URL.

Step 4: The result here is 3-D Polytope-based Model of a Brand Information Network, having as many facets and subfacets as URLs referenced in the nodes of the Brand Information Network. Each facet and subfacet provides a different “aspect” of the composite Brand Image projected by the Brand Information Network, supported on the WWW.

Step 5: Then, sequentially display the Brand Building Information Resources associated with each facet and subfacets of the with 3-D Polytope-based Model of a Brand Information Network. Preferably, this brand image visual process can best occur using a display panel, in which the Trademark (TM) and Product Descriptor associated with the Brand Information Network is displayed on the upper portion of a display panel, simultaneously with the sequential display of the Brand Building Information Resources associated with the Brand Information Network. Notably, during the display of such Brand Building Information Resource associated with a node (or subnode) in the Brand Information Network, the URL corresponding to the node or subnode will be displayed along with the Node Category Label associated with the parent node.

Notably, the display of Brand Building Information Resources associated with the node and subnodes of a Brand Information Network can be automated. Prior to the commencement of a sequential animated display process, the brand management team member will simply selected the Level of nodes within the Brand Information Network to be displayed, and thereafter, the Brand Building Information Resources residing at such nodes and subnodes will be automatically displayed to project a composite Brand Image—that might be experienced or developed within the mind of a consumer interacting with the Brand Information Network during the Brand Information Network Display Mode of a Multi-Mode Virtual Kiosk.

A second illustrative embodiment of this composite brand image viewing mechanism supports the following steps:

Step 1: Create Brand Information Network based on LPN/TM/PD/URL Data Link Sets.

Step 2: For each node within the Brand Information Network, catalog the URLs referenced therein, and for each Web Page referenced by these URLs, catalog the URLs referenced therein. Perform this for N number of levels of nodes within the Brand Information Network (i.e. the subnodes of the Brand Information Network).

Step 3: Then, using the catalog of URLs ascertained above, sequentially display the Brand Building Information Resources associated with each node and subnode in a Brand Information Network. Preferably, this brand image visual process can best occur using a display panel, in which the Trademark (TM) and Product Descriptor associated with the Brand Information Network is displayed on the upper portion of a display panel, simultaneously with the sequential display of the Brand Building Information Resources associated with the Brand Information Network. Notably, during the display of such Brand Building Information Resource associated with a node (or subnode) in the Brand Information Network, the URL corresponding to the node or subnode will be displayed along with the Node Category Label associated with the parent node.

Notably, the display of Brand Building Information Resources associated with the node and subnodes of a Brand Information Network can be automated. Prior to the commencement of a sequential animated display process, the brand management team member will simply selected the Level of nodes within the Brand Information Network to be displayed, and thereafter, the Brand Building Information Resources residing at such nodes and subnodes will be automatically displayed to project a composite Brand Image—that might be experienced or developed within the mind of a consumer interacting with the Brand Information Network during the Brand Information Network Display Mode of a Multi-Mode Virtual Kiosk.

Brandkey Deliver Subsystem

The Brandkey Deliver™ Subsystem, illustrated in FIGS. 9A through 9K, is the component of the Brand Management and Marketing Communication Instrumentation Network where the User is allowed to Create, Customize, Deploy, and Install Brand Building Multi-Mode Virtual Kiosks across various Consumer Touchpoints through a number of different Launch Environments. Generally, the Brand Managers or full-service Agents will be the ones who will use this Subsystem.

Once the Brand Information Networks are programmed in the Brandkey Create™ Subsystem, they need to be associated with Multi-Mode Virtual Kiosks. This will be accomplished in the Brandkey Deliver™ Subsystem.

The Brandkey Deliver™ Subsystem is divided into two Suites; the Virtual Kiosk Generation Suite and the Virtual Kiosk Installation Suite. As the titles represent, the former Suite allows Users to Create, Customize and Deploy Brand Building Multi-Mode Virtual Kiosks while the latter Suite allows Users to Install Brand Building Multi-Mode Virtual Kiosk tags at different Consumer Touchpoints.

There are six Control Panels available in the Virtual Kiosk Generation Suite. Each Control Panel's instruments are specialized for a different type Multi-Mode Virtual Kiosk. In general, no single User will have access to all of these Control Panels. The different types of Multi-Mode Virtual Kiosks supported by the BKS Network are:
Product-Specific (PS)
Service-Specific (SP)
Vendor-Specific (VP)
Service-Provider-Specific (SPS)
Retailer-Specific (RS)
Industry-Specific (IS)
Corporate-Specific (CS)

The Virtual Kiosk Installation Suite of the Brandkey Deliver™ Subsystem contains six similar Control Panels. The difference is that these Control Panels allow Users to install the Tags for the Virtual Kiosks that are created and deployed in the Virtual Kiosk Generation Suite. Only Consumers will have the ability to install all six types of Virtual Kiosk Tags. Other types of Users will only be able to install the Tags for those Virtual Kiosks they are associated with.

Each Control Panel in the Virtual Kiosk Generation Suite allows Users to Create, Customize, Modify, and deploy different types of Multi-Mode Virtual Kiosks.

When a User first enters a Control Panel they will have the opportunity to set the basic configuration of the Virtual Kiosks they create.

User will be asked to specify the following items:
If they wish to have the BKS Network automatically create default Virtual Kiosks for all their registered Products, Services, and Brands.
If they wish to allow Consumers to install the tags for their Multi-Mode Virtual Kiosks.
The list of Retailers and/or Industrialists who have permission to install the tags for their Virtual Kiosks.
The list of Domains that are forbidden from launching their Virtual Kiosks.

Users will be able to update these items whenever they wish by re-entering this area in the Control Panel.

Once the User has set the configuration for the Multi-Mode Virtual Kiosks, they can create the Virtual Kiosks. The creation process for Product-Specific and Service-Specific Virtual Kiosks is different from the rest of the Virtual Kiosks to the degree that Users can create multiple Product-Specific and Service-Specific Virtual Kiosks at one time, whereas they can only create one of all the other types of Virtual Kiosks at a time.

To create a Multi-ModeVirtual Kiosk, the User first must select the display mode that the Virtual Kiosk will run. There are at least three possible display modes for each Multi-Mode Virtual Kiosk, namely; a First Mode, a Second Mode, and a Third-Mode. The First Mode allows the displaying of Advertising Spots, Promotional Spots and the Brand Information Network. The Second Mode allows the displaying of Advertising-Spots and the Brand Information Network. The Third Mode allows the display of only the Brand Information Network. Once the running mode of the Virtual Kiosk is selected, the User must select the Product(s), Service(s), or Brand(s) that will be available in the Virtual Kiosk. Once those have been selected, the User is asked to give the Virtual Kiosk a significant name. The name of the Virtual Kiosk is collected in order to give Users a chance to give their Virtual Kiosks a meaningful identification. With the name taken care of, the User can then customize the Virtual Kiosk. The BKS Network allows for detailed customization of the Virtual Kiosks. Users can change their Logo at the top of the Virtual Kiosk, the geometric shape, surface texture, surface color, button style set, and button set color for the Virtual Kiosk being created. During the customization process the User is able to view a sample of what the Virtual Kiosk may look like with the selected customizations employed.

Customizing the Multi-Mode Virtual Kiosk is the last step in the Virtual Kiosk creation process. With this done, the Virtual Kiosk is ready for either further modification or deployment.

Users are able to modify any created Virtual Kiosk whenever they wish. After selecting the Virtual Kiosk they wish to modify, the User will be able to modify the mode in which the Virtual Kiosk is set to operate. They may also delete the Virtual Kiosk if they wish to. If the Virtual Kiosk is of type; Vendor-Specific, Service-Provider Specific, Retailer Specific, Industry Specific, or Corporate Specific, then the User will also be able to edit the list of Products, Services, or Brands that are associated with the Virtual Kiosk. Users may add new Products, Services, or Brands and remove any that are currently associated.

After creating the Multi-Mode Virtual Kiosk, if the User is satisfied with it, they can deploy it. Deploying a Virtual Kiosk is the process the User goes through to select the Launch Environment and set the Virtual Kiosk up to be downloaded and installed in the Virtual Kiosk Installation Suite.

There are four launch environments for the User to choose from; HTML-Encoded BKS™ Button, HTML-Encoded Document, HTML-Encoded Image, and an HTML-Encoded Desktop Icon. Each of the launch environments have a different setup procedure the User must walk through to set them up.

To set up the HTML-Encoded BKS™ Button, the User simply selects the Virtual Kiosks they wish to deploy and the System does the rest.

To set up the HTML-Encoded Document, the User must first select only one Virtual Kiosk. Once the Virtual Kiosk has been selected, the User must go through the process of creating the Document and encoded the HTML tag for the Virtual Kiosk into it. Once that has been done, the System will prepare the Virtual Kiosk for Deployment.

To set up the HTML-Encoded Image, the User must first select only one Virtual Kiosk. Once the Virtual Kiosk has been selected, the User must go through the process of creating the composite image for the Virtual Kiosk tag. Once that has been done, the System will prepare the Virtual Kiosk for Deployment.

To set up the HTML-Encoded Desktop Icon, the User must first select only one Virtual Kiosk. Once the Virtual Kiosk has been selected, the User must go through the process of setting up the Desktop Icon. Once that has been done, the System will prepare the Virtual Kiosk for Deployment.

Once the Virtual Kiosk has been deployed, the last step to allow Users to install the tags for that Virtual Kiosk is to activate it. Users are also able to deactivate any Virtual Kiosks that have been previously activated, even if they have been installed on the Internet. If the User deactivates any installed Virtual Kiosks, then the next time that Virtual Kiosk is launched, the end-user will get a message saying the selected Virtual Kiosk is no longer available.

With all the Virtual Kiosks created and deployed, the next step is to get them installed on the Internet. The Virtual Kiosk Installation Suite handles this process. Like the Virtual Kiosk Generation Suite, the Virtual Kiosk Installation Suite is also divided up into six Control Panels, one for each type of Virtual Kiosk. Depending on who you are, you will have access to only certain Installation Control Panels, unless you are a Consumer, in that case you will have access to all the Installation Control Panels.

Each Virtual Kiosk Installation Control Panel works in the same manner, just customized for the specific type of Virtual Kiosks to which they cater.

The User first is allowed to select the Virtual Kiosks they wish to download and install. If the User is a Consumer, they may select from a list of all the virtual Kiosks whose owners have designated as being available for Consumers. If the User is a Vendor or Service Provider, they are only allowed to install those Virtual Kiosks belonging to their account. If the User is a Retailer or Industrialist, then they are allowed to install only those Virtual Kiosks whose owners have specified that these Retailers and Industrialists have permission to install their Virtual Kiosks.

Using the Alphabetic and Numeric search bar at the top of the table, the User may search for the Virtual Kiosks of Vendors, Service Providers, etc. beginning with that letter or number. The User also has the ability to search for specific Vendors, Service Providers, etc. by clicking the Search button. This will take them to the Search from where they can search for specific Vendors, Service Providers, Retailers, etc. depending on the Control Panel they are in. From the Search form they will be able to select Vendor, etc. whose listing of Virtual Kiosks they wish to view.

Once the User has selected the Virtual Kiosks to download and install they will be asked where the Virtual Kiosk will be installed. This information is required by the System in order for it to provide the most accurate data to the Brand Managers about where their Virtual Kiosks are being installed. This enables Brand Managers and their Agents to customize the Advertising and Promotions campaigns in the most useful manner.

After the User has entered the installation location information they are able to download the Virtual Kiosk tags along with the accordant instructional files and needed images. The User may download up to four sets of Virtual Kiosks depending on the different launch environments for the Virtual Kiosks selected.

The download file for the Virtual Kiosks contain the full instructions on how to install the Virtual Kiosk tags.

It is then up to the User to place the tags in the appropriate websites or disseminate them via email to propagate the Virtual Kiosks through the Internet.

The Multi-Mode Virtual Kiosks will be downloadable from the Installation Suite in this Subsystem. Once they are downloaded and installed in the appropriate place, they shall be functional for Consumers and other general users to launch.

To launch the Multi-Mode Virtual Kiosk from any launch environment, the user shall click on the Tag that will launch the Multi-Mode Virtual Kiosk. The Tag shall contain information used by the BKS

Network when the request is made for a Multi-Mode Virtual Kiosk to determine the type of the Multi-Mode Virtual Kiosk, the style of the requested Multi-Mode Virtual Kiosk, the layout of the requested Multi-Mode Virtual Kiosk and the Brand Entity(s) that is to be displayed.

When a user clicks on the Multi-Mode Virtual Kiosk Tag a request shall be sent to the BKS Network for the appropriate type of Multi-Mode Virtual Kiosk. When the request comes into the BKS Network, the Network shall respond to the request by launching a new stripped-down browser window on the desktop of the user. This window shall be displayed over the current location of the user, thereby saving that location for the user to return to later on with ease if they so wish.

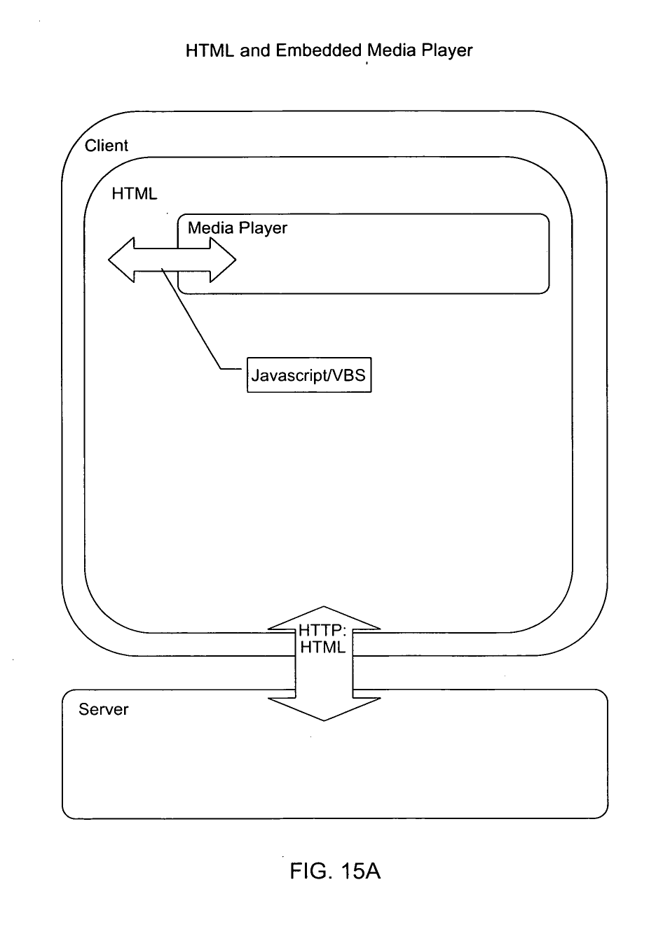

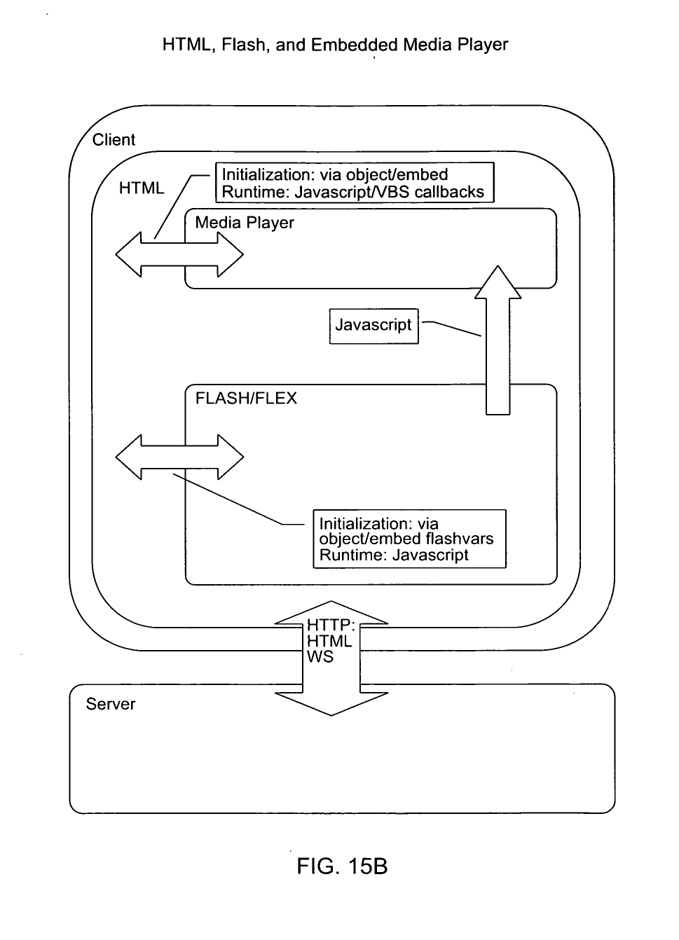

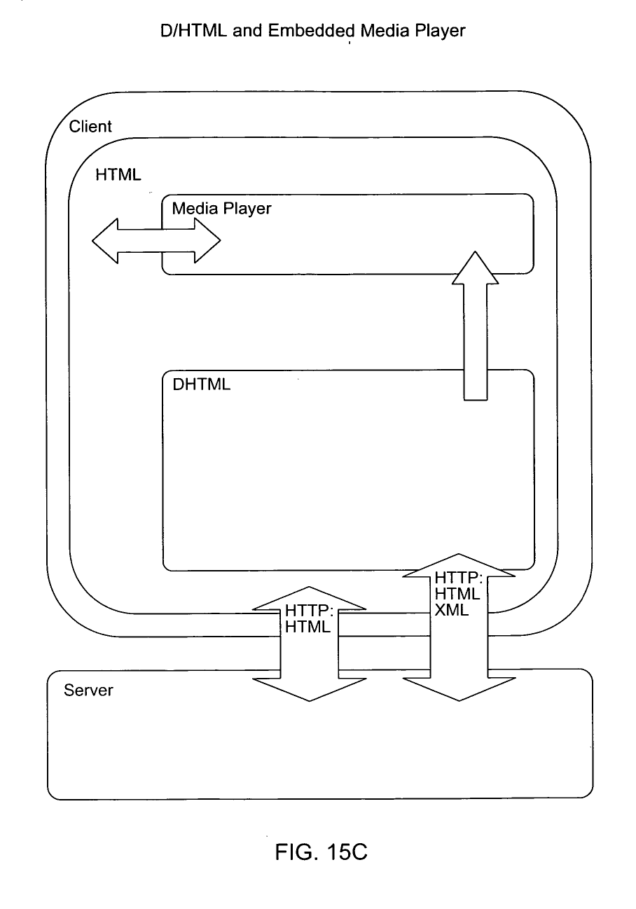

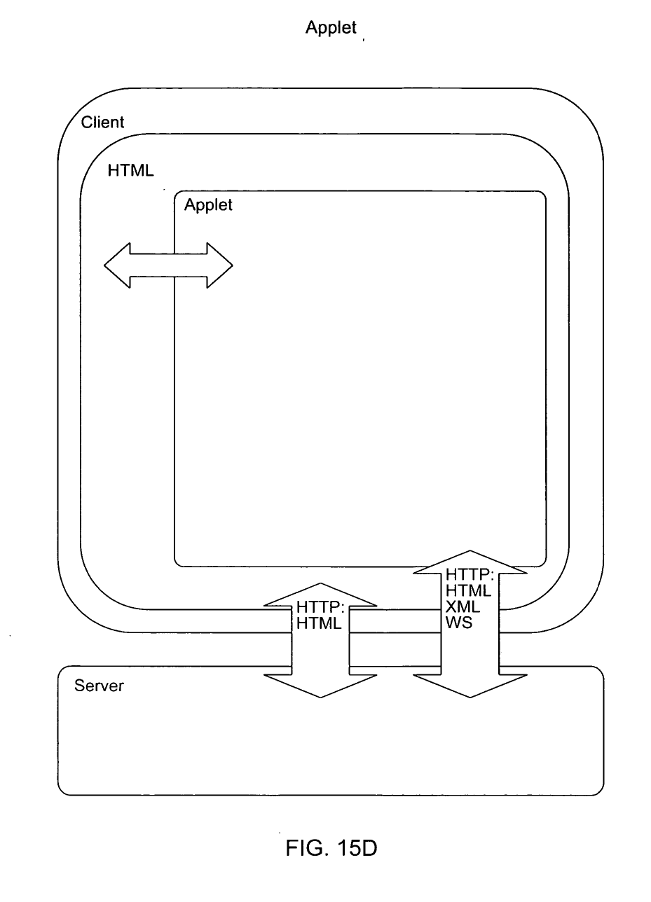

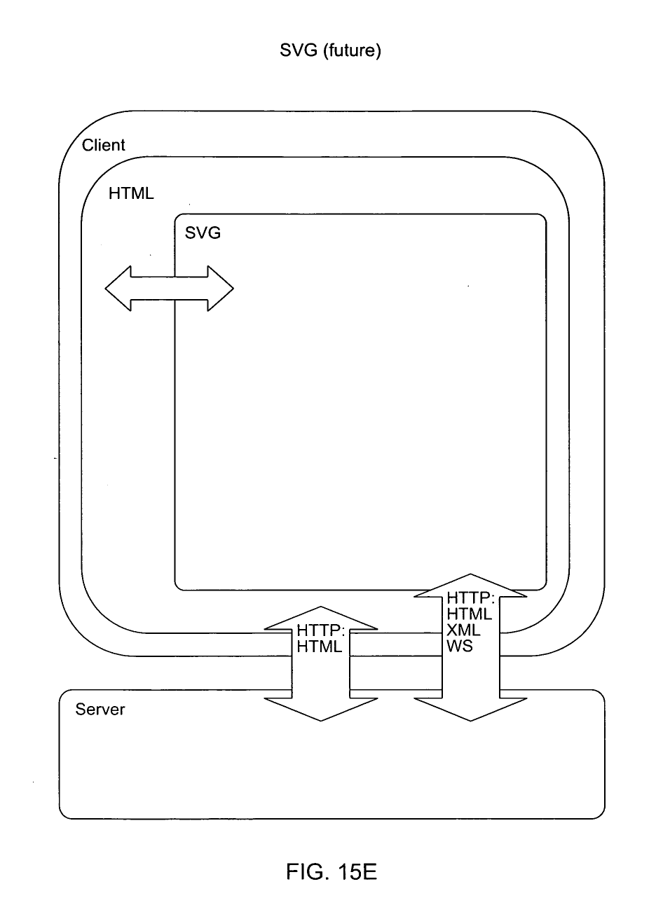

This new window containing the Multi-Mode Virtual Kiosk shall be a completely stripped-down browser. Inside the window the BKS Network shall display graphics having the basic look and feel of one of three formats. The BKS Network shall find and play any relevant advertisements in the Advertisement-Display window of the Multi-Mode Virtual Kiosk. The Multi-Mode Virtual Kiosk shall have a set of buttons to skip the current Advertisement and to replay the current Advertisement. The Multi-Mode Virtual Kiosk shall also have a set of buttons to control the volume for the Advertisement that is currently being played. The Multi-Mode Virtual Kiosk shall also display the time that has lapsed for the current Advertisement. The BKS Network can play Advertisements in the Multi-Mode Virtual Kiosks using the JavaMediaFramework (JMF), from Sun Microsystems, Inc., in an Applet on the Virtual Kiosk. The JavaMediaFramework can take multiple video and audio formats and play them in a customized applet that we program. Different MMVK design implementation are described in FIGS. 15A through 15E. The list of Advertisements shall be processed on the server, possibly using SMIL technology and then passed to the Virtual Kiosk Applet to play in the prescribed order. Details regarding JMF API can be found at http://java.sun.com/products/java-media/jmf/, incorporated herein by reference.

Once the Advertisements have been played, the Multi-Mode Virtual Kiosk shall check to see if there are any Promotions that are associated with this Virtual Kiosk. If there are Promotions that need to be displayed then the Kiosk shall resize itself to show the Promotions Window. The Promotions shall be displayed along with their corresponding videos. The Multi-Mode Virtual Kiosk shall have a set of buttons to skip the current Promotion and to replay the current Promotion. The Multi-Mode Virtual Kiosk shall also have a set of buttons to control the volume for the Promotional video that is currently being played. The Multi-Mode Virtual Kiosk shall also display the time that has lapsed for the current Promotion. The Brandkey Systems Network shall play the Promotions in the Multi-Mode Virtual Kiosks using the JavaMediaFramework in an Applet on the Virtual Kiosk. The JavaMediaFramework can take multiple video and audio formats and play them in a customized applet that we program. The list of Promotions shall be processed on the server, possibly using SMIL technology and then passed to the Virtual Kiosk Applet to play in the prescribed order.

Once the Advertisement and Promotions have completed then the Multi-Mode Virtual Kiosk shall display the related brand knowledge network as described by the Brand Manager in Brandkey Create. One of the three schemas shall be displayed that were specified in Brandkey Create; Pre-Post Purchase Schema, Simplex Schema and Complex Schema. When the user clicks on a specific node in any of the schemas, the system shall display the link from that node within the display window in the frame above the Brand Information Network display window. The system shall provide the user with the ability to enlarge this window causing the entire browser window to enlarge in proportion. The system shall also resize the Brand Information Network in proportion with the link display window. The system shall maintain a nice look-and-feel to the Brand Information Network display during the resizing. A suggested method for achieving this is using Scaling Vector Graphics (SVG). All links from any node in the Brand Information Network shall be displayed in this link display screen, thereby allowing the user to remain inside the Brandkey Virtual Kiosk Environment. There shall be a Search button to allow the User to search for Products/Services/Brands depending on the type of Multi-Mode Virtual Kiosk they are in.

Once the Advertisements and Promotions (if any) have completed, the system shall then resize the existing window to show the Search Screen, if the Virtual Kiosk is a Vendor-Specific, Service-Provider-Specific, Retailer-Specific, Industry-Specific, or Corporate-Specific Virtual Kiosks. Product-Specific and Service-Specific Virtual Kiosks do not have a Search function.

In the Brand Information Network display window, the system shall first display a search screen that provides the user with the ability to search for products/brands for the particular Vendor who is sponsoring the Virtual Kiosk. In this search screen the user shall be able to search for products/brands based on UPN/USN, TM/SM, PD/SD or Product/Service Category. When the user presses the “search” button, the system shall perform a search and display the results list of all products/services/brands that matched the search criteria. Since each Virtual Kiosk shall be associated with a specific language, the search shall only bring back the results of products/brands that have Brand Information Networks with Brandkey Data Links in that language. The user shall click on the UPN/USN in order to have the Brand Information Network displayed for that product/brand.

The system shall also provide a button on the Search Screen to launch a virtual keyboard. When the user presses this button, the system shall launch a virtual keyboard in a small stripped-down browser window on top of the current search window. When the user clicks on any of the keyboard buttons on this screen, the system shall display the corresponding letters or numbers in the search text box on the search window.

When the user selects the product/brand from the Search Results list the system shall first the Advertisements and Promotions associated with the selected Product/Service/Brand Entity. The Advertisements and Promotions shall be displayed in the same manner as the Advertisements and Promotions that were displayed when the Multi-Mode Virtual Kiosk was launched. Once the Advertisement and Promotions have completed then the Multi-Mode Virtual Kiosk shall display the related brand knowledge network as described by the Brand Manager in Brandkey Create. One of the three schemas shall be displayed that were specified in Brandkey Create; Pre-Post Purchase Schema, Simplex Schema and Complex Schema. When the user clicks on a specific node in any of the schemas, the system shall display the link from that node within the display window in the frame above the Brand Information Network display window. The system shall provide the user with the ability to enlarge this window causing the entire browser window to enlarge in proportion. The system shall also resize the Brand Information Network in proportion with the link display window. The system shall maintain a nice look-and-feel to the Brand Information Network display during the resizing. A suggested method for achieving this is using Scaling Vector Graphics (SVG). All links from any node in the Brand Information Network shall be displayed in this link display screen, thereby allowing the user to remain inside the Brandkey Virtual Kiosk Environment.

The system shall maintain a counter for each Virtual Kiosk. The counter shall be updated whenever a user activates a Virtual Kiosk at a consumer touch-point and also whenever a user clicks on a link from the Brand Information Network.

Users shall be able to vote for certain links, rating whether or not they found the link useful. The system shall display a series of radio button numbered 1 through 5 next to the link. The user shall select a radio button based on the usefulness of the link (1 being least useful and 5 being the most useful) and then click on the “submit” button to register their vote. The system shall tally the votes internally to get a “Usefulness Quotient” that is displayed to users of the Brandkey Create subsystem.

Brandkey Advertise Subsystem

The Brandkey Advertise™ Subsystem, illustrated in FIGS. 10A through 10H, is the central location where all Advertising Spots are placed on installed Multi-Mode Virtual Kiosks on the Internet. With The Brandkey Advertise™ Subsystem enables Brand Managers and their Agents to advertise branded products and services by building and managing Advertising Campaigns on Multi-Mode Virtual Kiosks delivered to the consumer this service, the user may customize Advertising Directories that specify which Multi-Mode Virtual Kiosks are sanctioned by the Brand Manager or retail trading partner to run an Advertising Campaign. The user may also register the Brand's Advertising Campaign to be run on specified networks of Multi-Mode Virtual Kiosks, as well as build an Advertising Campaign by placing ad spot orders on installed networks of Multi-Mode Virtual Kiosks. The highlights of this service are that with simple point and click technology the user may:
Register a Campaign to be run on specified networks of Multi-Mode Virtual Kiosks
Flexibly add or delete Multi-Mode Virtual Kiosks at any time to Modify a Campaign
Run/Stop Campaigns in a flexible manner to meet marketing objectives
View up-to-date metrics kept by the BKS Network to Monitor Campaigns

In order for the Advertisement Display Mode of any Virtual Kiosk to be fully enabled, the Advertisements to be played on those Virtual Kiosks need to be configured.

The Brandkey Advertise™ Subsystem provides Users with a central area where they can see where their available Virtual Kiosks have been installed. Users can create Directories of their Virtual Kiosks by Virtual Kiosk type and even Brand. This enables them to locate Virtual Kiosks and create Advertising Campaigns in a more efficient manner.

These Advertising Campaigns are made up of a sub-network of Multi-Mode Virtual Kiosks that the User selects. Users can then place Advertisements on any combination of Virtual Kiosks and order those Advertisements any way they wish for each individual Virtual Kiosk.

Using the Brandkey Advertise™ Subsystem, Users can also monitor, modify, run and stop any of their Advertising Campaigns. These features allow the User to determine which Campaigns are working well for them and what combination of Advertisements and Virtual Kiosks are the most effective and which do not work at all.

The Brandkey Advertise™ Subsystem consists of one Suite; the Virtual Kiosk Advertising Campaign Management Suite. This Suite contains one Control Panel; the Control Panel for Managing Advertising Campaigns.

The three main services offered in the Control Panel for Managing Advertising Campaigns are; Directory Management, Campaign Management, and Ad-Spot Management.

In Directory Management, Users are allowed to create and manage the Virtual Kiosk Advertising Directories they use to populate their Advertising Campaigns with Multi-Mode Virtual Kiosks.

To create an Advertising Directory the User must first select the type of Directory they wish to create. There are two types of Directories that the User can create; the General Type Advertising Directory and the Brand-Specific Advertising Directory.

If the User selects the General Type Advertising Directory then the next step for them is to select the types of Virtual Kiosks they wish to include in this Directory. They may select all the Virtual Kiosks that are available to them. Available Virtual Kiosks means any Virtual Kiosks on which their Product, Services, or Brands are displayed and on which they have permission to place Advertising Spots. Only those types of Virtual Kiosks that are available to the User are displayed.

Once the User has selected the Virtual Kiosk types, they are asked to name the Directory. This gives the User an opportunity to give the Directory a name that will be relevant to them. The System is then ready to generate the Virtual Kiosk Directory for the User. When the User clicks the Generate Directory button, the System will pull together all the information requested by the User into a table of the available Virtual Kiosks and display it to the User. The User will also have the opportunity to download a PDF version of the Directory if they want. The Virtual Kiosk Advertising Directory is now created and ready for use.

The only difference between the General Type Virtual Kiosk Advertising Directory and the Brand-Specific Virtual Kiosk Advertising Directory is that at the start of the creation process, the User is asked to search for and select the Brand Entities they wish to filter for in the Directory. Only those available Virtual Kiosks displaying the selected Brand Entities will be listed in the Directory.

When modifying any Virtual Kiosk Advertising Directory, the User will be able to select different types of Virtual Kiosks to be included in the Directory and different Brand Entities to be filtered for in the Directory.

Once the Virtual Kiosk Advertising Directories have been created, the User can then register the Advertising Campaigns.

After filling out the basic information needed for the Campaign such as; its name, registration number, start date, and end date, the User must select a Virtual Kiosk Directory from where to pull the Virtual Kiosks to include in this Campaign. The User must first select Virtual Kiosk Directory type, General or Brand-Specific. Then the User is presented with the list of Directories for the selected type. The User must select one Directory from the list and the System will pull in all the Virtual Kiosks from that Directory to include in this Campaign.

When modifying an Advertising Campaign, the User will first select the Campaign to modify, and then they will get a chance to modify the list of Virtual Kiosks included in the Campaign. They may remove Virtual Kiosks from the list or include Virtual Kiosks from the list in the Campaign.

All Campaigns that have ever been run or are presently running are stored with Brandkey Systems Network. The User may select any Advertising Campaign that has previously been run to run it again if they wish. They may also select any Advertising Campaign that is currently running to stop it before the due date. They may wish to do this if they feel that the Campaign is not reaching the audience they wanted it to reach, or is not as effective as they thought it would be. This gives the User a better level of control over the Advertising Campaign they put together and propagate through the Multi-Mode Virtual Kiosks.

In order to tell how effective a Campaign is, the User would monitor the Campaign. When monitoring the Campaign, the Subsystem presents the user with a wide variety of data such as; number of Advertisements placed, number of Advertisements run, number of Advertisement-Spot interruptions, and number of Brand Information Networks accessed, etc. This information will give the User a clear picture of the activity behind the Virtual Kiosk and the Advertising Campaign.

The third and arguably the central instrument in this Control Panel is to place Advertising Spot Orders on the Virtual Kiosks in Campaigns. To place these ad-spot orders, the User must first select the Advertising Campaign on whose Virtual Kiosks to place the Advertising Spots.

When the User has selected the Campaign, the list of available Advertisements is displayed for the User to select which Advertisements they want to place on the Campaign. This list of Advertisements is pulled from the list of nodes in the all the Brand Information Networks associated with the selected Virtual Kiosks. The User is also given the opportunity to view the actual Advertisement by clicking on the Advertisement URL in the table.

Once the User has selected the Advertisements to place on the Campaign, the System requires them to configure the Advertisements for each of the Virtual Kiosks they wish to place it on. The User is allowed to select the Virtual Kiosks on which the Advertisement will play, the data on which the Advertisement will become available, and the frequency at which the Advertisement will play when the Virtual Kiosk is left running. Once each Advertisement has been configured, the User will be allowed to set the order in which the Advertisements will play on each of the Virtual Kiosks. Even if there are several Virtual Kiosks, which play the exact same list of Advertisements, they may still play them in different orders, thus allowing for more granular control.

The Order will be placed once the Advertisement order has been set by the User.

When modifying Advertising Spot Orders, the User may modify all aspects of the Order. In this case they move backwards through the section, starting with the Advertisement ordering and going back to the Virtual Kiosk Directory that was selected.

Once an Advertising Spot Order has been placed, then those Advertisements are placed on installed Virtual Kiosks and the full functionality of the Advertisement Display Mode of the Virtual Kiosks is realized.

Brandkey Promote Subsystem

The Brandkey Promote™ Subsystem, illustrated in 11A through 11G, is the central location where all Promotional Spots are placed on installed Multi-Mode Virtual Kiosks on the Internet. With the use of the Brandkey Promote™ Subsystem, Brand Managers and their Agents can program the Promotional Spot Display Mode of their Multi-Mode Virtual Kiosks. Similar to the service offered for Advertisers the user may also register the Brand's Promotional Campaign to be run on specified Networks as well as build a Promotional Campaign by placing promo spot orders on installed networks of Multi-Mode Virtual Kiosks. Also similar to the Brandkey Advertise Subsystem, the highlights of this service are that with simple point and click technology the user may:
Register a Campaign to be run on specified networks of Multi-Mode Virtual Kiosks
Flexibly add or delete Multi-Mode Virtual Kiosks at any time to Modify a Campaign
Run/Stop Campaigns in a flexible manner to meet marketing objectives
View up-to-date metrics kept by the BKS Network to Monitor Campaigns

In order for the Promotion Display Mode of any Virtual Kiosk to be fully enabled, the Promotions to be played on those Virtual Kiosks need to be configured.

The Brandkey Promote™ Subsystem provides Users with a central area where they can see where their available Virtual Kiosks have been installed. Users can create Directories of their Virtual Kiosks by Virtual Kiosk type and even Brand. This enables them to locate Virtual Kiosks and create Promotional Campaigns in a more efficient manner.

These Promotional Campaigns are made up of a sub-network of Multi-Mode Virtual Kiosks that the User selects. Users can then place Promotions on any combination of Virtual Kiosks and order those Promotions any way they wish for each individual Virtual Kiosk.

Using the Brandkey Promote™ Subsystem, Users can also monitor, modify, run and stop any of their Promotional Campaigns. These features allow the User to determine which Campaigns are working well for them and what combination of Promotions and Virtual Kiosks are the most effective and which do not work at all.

The Brandkey Promote™ Subsystem consists of one Suite; the Virtual Kiosk Promotional Campaign Management Suite. This Suite contains one Control Panel; the Control Panel for Managing Promotional Campaigns.

The three main services offered in the Control Panel for Managing Promotional Campaigns are; Directory Management, Campaign Management, and Promo-Spot Management.

In Directory Management, Users are allowed to create and manage the Virtual Kiosk Promotional Directories they use to populate their Promotional Campaigns with Multi-Mode Virtual Kiosks.

To create a Promotional Directory the User must first select the type of Directory they wish to create. There are two types of Directories that the User can create; the General Type Promotional Directory and the Brand-Specific Promotional Directory.

If the User selects the General Type Promotional Directory then the next step for them is to select the types of Virtual Kiosks they wish to include in this Directory. They may select all the Virtual Kiosks that are available to them. Available Virtual Kiosks means any Virtual Kiosks on which their Product, Services, or Brands are displayed and on which they have permission to place Promotional Spots. Only those types of Virtual Kiosks that are available to the User are displayed.

Once the User has selected the Virtual Kiosk types, they are asked to name the Directory. This gives the User an opportunity to give the Directory a name that will be relevant to them. The System is then ready to generate the Virtual Kiosk Directory for the User. When the User clicks the Generate Directory button, the System will pull together all the information requested by the User into a table of the available Virtual Kiosks and display it to the User. The User will also have the opportunity to download a PDF version of the Directory if they want. The Virtual Kiosk Promotional Directory is now created and ready for use.

The only difference between the General Type Virtual Kiosk Promotional Directory and the Brand-Specific Virtual Kiosk Promotional Directory is that at the start of the creation process, the User is asked to search for and select the Brand Entities they wish to filter for in the Directory. Only those available Virtual Kiosks displaying the selected Brand Entities will be listed in the Directory.

When modifying any Virtual Kiosk Promotional Directory, the User will be able to select different types of Virtual Kiosks to be included in the Directory and different Brand Entities to be filtered for in the Directory.

Once the Virtual Kiosk Promotional Directories have been created, the User can then register the Promotional Campaigns.

After filling out the basic information needed for the Campaign such as; its name, registration number, start date, and end date, the User must select a Virtual Kiosk Directory from where to pull the Virtual Kiosks to include in this Campaign. The User must first select Virtual Kiosk Directory type, General or Brand-Specific. Then the User is presented with the list of Directories for the selected type. The User must select one Directory from the list and the System will pull in all the Virtual Kiosks from that Directory to include in this Campaign.

When modifying a Promotional Campaign, the User will first select the Campaign to modify, and then they will get a chance to modify the list of Virtual Kiosks included in the Campaign. They may remove Virtual Kiosks from the list or include Virtual Kiosks from the list in the Campaign.

All Campaigns that have ever been run or are presently running are stored with Brandkey Systems Network. The User may select any Promotional Campaign that has previously been run to run it again if they wish. They may also select any Promotional Campaign that is currently running to stop it before the due date. They may wish to do this if they feel that the Campaign is not reaching the audience they wanted it to reach, or is not as effective as they thought it would be. This gives the User a better level of control over the Promotional Campaign they put together and propagate through the Multi-Mode Virtual Kiosks.

In order to tell how effective a Campaign is, the User would monitor the Campaign. When monitoring the Campaign, the System presents the user with a wide variety of data such as; number of Promotions placed, number of Promotions run, number of Promotion-Spot interruptions, and number of Brand Information Networks accessed, etc. This information will give the User a clear picture of the activity behind the Virtual Kiosk and the Promotional Campaign.

The third and arguably the central instrument in this Control Panel is to place Promotional Spot Orders on the Virtual Kiosks in Campaigns. To place these promo-spot orders, the User must first select the Promotional Campaign on whose Virtual Kiosks to place the Promotional Spots.

When the User has selected the Campaign, the list of available Promotions is displayed for the User to select, which Promotions they want to place on the Campaign. This list of Promotions is pulled from the list of nodes in the all the Brand Information Networks associated with the selected Virtual Kiosks. The User is also given the opportunity to view the actual Promotion by clicking on the Promotion URL in the table.

Once the User has selected the Promotions to place on the Campaign, the System requires them to configure the Promotions for each of the Virtual Kiosks they wish to place it on. The User is allowed to select the Virtual Kiosks on which the Promotion will play, the data on which the Promotion will become available, and the frequency at which the Promotion will play when the Virtual Kiosk is left running. Once each Promotion has been configured, the User will be allowed to set the order in which the Promotions will play on each of the Virtual Kiosks. Even if there are several Virtual Kiosks, which play the exact same list of Promotions, they may still play them in different orders, thus allowing for more granular control.

The Order will be placed once the Promotion order has been set by the User.

When modifying Promotional Spot Orders, the User may modify all aspects of the Order. In this case they move backwards through the section, starting with the Promotion ordering and going back to the Virtual Kiosk Directory that was selected.

Once a Promotional Spot Order has been placed, then those Promotions are placed on installed Virtual Kiosks and the full functionality of the Promotion Display Mode of the Virtual Kiosks is realized.

Detailed Use-Case Based Description of Subsystems Functions and Services Supported within the Internet-Based Brand Management and Marketing Communication Network of the Present Invention (i.e. BKS Network)

BKS Network Level Services (See FIG. 6a)

Login

1. Login

This Use Case allows a User to Login to the System. The User can enter their Username and Password and then select the Client Account they wish to work on.

The User clicks on the Login button in the Corporate Menu.

2. Flow of Events

2.1. Basic Flow

2.1.1. Login

User clicks the Login button in the Corporate Menu. The System returns the user to the Main Page with the Login Form. The User types in a User Name and Password and clicks the Login button. The System checks that the User Name and Password exist in the Database and the User is Active. The System checks what Client Type and User Type the User is and that the User is associated with at least one Client Account that is also Active. Note: If the Client Type is Consumer then the alternate flow 2.2.4 applies. If the User Type is an Administrator then alternate flow 2.2.3 applies. The System displays the Select Client Account Form in the Main Page with the User's associated Active Client Accounts in a Client Account drop-down list. The User selects a Client Account from the drop-down list and clicks the Submit button. The System determines the Mode in which the User should be logged in. There are 2 logged-in modes: “Custom Demonstration Mode” and “Operational Mode”. If the Client Account chosen is a Demonstration Account, then the User will be logged in as Custom Demonstration Mode. If the Client Account chosen is not a Demonstration Account, then the User will be logged in as Operational mode. The system determines whether or not the Client Account is a Demonstration Account by checking the isDemonstration field in the ClientAccount table. If the isDemonstration field is 1, then the Client Account is a Demonstration Account and the user should be logged into the Custom Demonstration Mode. If the isDemonstration field is 0, then the Client Account is a Billable Account and the user should be logged into the Operational Mode. The System logs in the User and changes the Login button to Logout and reloads the original Main Page with the Logged In Confirmation form on it

2.2. Alternate Flows

2.2.1. The User forgot their Password

The User clicks on the Forgot Password link on the Login form. The Forgot Password Use Case is initiated

2.2.2. The User is not Registered with the System

The User clicks on the Register link on the Login form. The Registration Use Case is initiated

2.2.3. The User is a BKS Administrator

The Systems displays an error message saying; “You do not have access to the front-end of the Brandkey Systems Network. Please log into the Administration Application.”

2.2.4. The User is a Consumer

The System checks that the User Name and Password exist in the Database and the User is Active. The System Checks what Type the User is. If the User is a Consumer then the System logs in the User and changes the Login button to Logout and reloads the original Main Page

2.2.5. This is the first time the User has Logged into the System

Once the user has entered their username and password and the System has verified that they are Active and belong to at least one Active Client Account, then the System displays the Security Question and Answer form. The User types in their Security Question and Answer. The System saves their Security Question and Answer to the Database. The System then continues on Login process.

2.2.6. The User Cancels the Login Process at any Time

The System displays the Main page once again without the Login form. Any Login processes that may have occurred are cancelled and the User is not logged into the Network (Note: To be revisited.)

2.3. Exceptions

2.3.1. User does not Enter a User Name or Password

The System displays the Login form with an error message saying, “The Username field is blank. Please enter a value.” Or “The Password field is blank. Please enter a value.”

2.3.2. User Name or Password not Found in the Database

The System displays the Login form with an error message saying, “The Username or Password you entered is not valid.”

2.3.3. User Found in the Database But is not Active

The System displays the Login form with an error message saying, “You are currently not active in the system. Please contact your Administrator.”

2.3.4. User is not a Consumer and is not Associated with any Active Client Accounts

The System displays the Login form with an error message saying, “Your associated Client Accounts are inactive. Please contact your Administrator.”

2.3.5. User does not Select a Client Account and Clicks the Select Button on the Select Client Account Form

The System displays the Select Client Account form with an error message saying “You must select a Client Account to continue logging into the System.” Note: This will become effective if the default Client Account in the dropdown is blank.

2.3.6. The User does not Enter a Security Question or Answer in the Security Question and Answer Form

The System displays the Security Question and Answer form with an error message saying, “The SecurityQuestion field is blank. Please enter a value.” Or “The SecurityAnswer field is blank. Please enter a value.”

2.3.7. The User has Entered an Incorrect Username and Password Three Times in a Row and has not Yet been Logged in

The System will lock out the User for one hour for security purposes. The User will only be allowed to attempt to log in again after one hours time. The System displays an error message saying; “You have attempted to log into the System 3 times unsuccessfully. You are now locked out of the System for one hour. If you have forgotten your Username or Password, please contact your Administrator.”

2.3.8. The User Attempts to Log into the System when they are Locked Out.

The System shall display an error message saying; “You are currently locked out of the System for security reasons. You may attempt to log in again in [xx] minutes time. If you do not remember your password or Username, please contact your Administrator or click the Forgot Password link.”

Forgot Password

1. Forgot Password

This Use Case allows a User to retrieve their User Name and Password from the System in case they have forgotten it.

The User clicks on the Forgot Password link on the Login form.

2. Flow of Events

2.1. Basic Flow

2.1.1. Forgot Password

User clicks the Forgot Password link on the Login form. The System Displays the Forgot Password form. The User enters their email address in the Forgot Password form and clicks the Next button. The System searches for the email address in the Database. If the email address is found in the Database, then the System checks whether the assigned User is a BKS Administrator or other type of User. If the User is a BKS Administrator, then they are not allowed to use the front-end Application. In case they forgot their password, they must use the Forgot Password function in the Administration Application. [See Exception 3.6 if the User is a BKS Administrator]. If the User is not a BKS Administrator, then the System displays the Security Question form. The User enters the Security Answer and clicks the Next button. The System checks the Security Answer against the Database in encrypted format. If the correct Security Answer has been entered, then the System displays the Reset Password form. The User enters the new Password for their account in the appropriate textboxes and clicks the Next button. The System checks that the Password entered matches in both Password fields. See Exception 3.3 if the Passwords do not match. The System checks that the Passwords are at least 6 characters long. See Extension 3.4 if the Passwords are not at least 6 characters long. The System checks that the Passwords do not contain any wildcard characters such as (!@#$%ˆ&*). If the Password passes the above requirements, then the System saves the new password to the Database in encrypted format and the User is taken back to the Login page.

2.2. Alternate Flows—NONE

2.3. Exceptions

2.3.1. Email Address not Found in the Database

The System displays the Forgot Password form with an error message saying, “The Email Address you entered was incorrect. Please try again.”

2.3.2. Security Answer does not Match What is in the Database

The System displays the Security Question form with an error message saying, “You have entered an incorrect Answer to your Security Question. Please try again.”

2.3.3. The Passwords in the Two Fields do not Match

The System displays the Reset Password form with the error message saying; “The Password you entered must match the Confirm Password field. Please enter a Password again.”

2.3.4. The Password is not at Least 6 Characters Long

The System displays the Reset Password form with the error message saying; “The Password you entered must be at least 6 characters in length.”

2.3.5. The Password Contains Wildcard Characters (!@#$%ˆ&*)

The System displays the Reset Password form with the error message saying; “The Password you entered can not contain wildcards such as (!@#$%ˆ&*). Please enter a Password again.”

2.3.6. The User is a BKS Administrator

The System Displays the Enter Email form with the error message saying; “You do not have access to the Front-End Application. Please use the Forgot Password function in the BKS Administration Application to retrieve your forgotten password.”

Logout

1. Logout

This Use Case allows a User to Logout of the System.

The User clicks on the Logout button in the Corporate Menu.

2. Flow of Events

2.1. Basic Flow

2.1.1. Logout

User clicks the Logout button in the Corporate Menu. The System Logs out the User from the System. The System displays the Main Page with the Logout button changed to a Login button. The Logged in Confirmation form also will no longer appear on the home page.

2.2. Alternate Flows—None

2.3. Exceptions—None

Client Account Marquee

1. Client Account Marquee

This Use Case describes how the Client Account Marquee is generated on all appropriate pages in the System.

The User navigates through the System.

2. Flow of Events

2.1. Basic Flow

2.1.1. Client Account Marquee

The User reaches a page where the Client Account Marquee is to be displayed. The System determines if the User is logged in. [See Alternate Flow 2.2.1 if the User is not logged in]. If the User is logged in, the System displays the Client Account Marquee with the following information:

The System pulls the Client Account Name from the Database.

The System pulls the Client Account Number from the Database.

The User pulls the User Name from the Database.

2.2. Alternate Flows

2.2.1. The User is not logged in.

2.2.1.1. The User is in Standard Demonstration Mode.

2.2.1.2. The User displays the Client Account Marquee with the following information:

“BKS Visitor” as the User Name

The System pulls the Client Account Name from the Database.

The System pulls the Client Account Number from the Database.

2.3. Exceptions—None

User Access Rights

1. User Access Rights

This Use Case describes how the System determines the access rights for Users when interacting with the System.

The User is navigating through the site and launches a Control Panel.

2. Flow of Events

2.1. Basic Flow

2.1.1. User Access Rights

The User clicks on a Control Panel to launch it. The System checks in the Database whether or not the User has Access Rights to this Control Panel. [See Extension 3.1 if the User does not have Access Rights to this Control Panel]. If the User has Access rights to this Control Panel, the Control Panel is launched. [See Alternate Flow 2.2.1 for display criteria for the Brandkey Deliver Subsystem's Virtual Kiosk Generation Suite] [See Alternate Flow 2.2.2 for display criteria for the Brandkey Deliver Subsystem's Virtual Kiosk Installation Suite] [See Alternate Flow 2.2.3 for display criteria for the Brandkey Systems Subsystem's User/Account Administration Suite] [See Alternate Flow 2.2.4 for the rules if the User is a Consumer] [See Alternate Flow 2.2.5 for rules in Standard Demonstration Mode] [See Alternate Flow 2.2.6 for rules in Custom Demonstration Mode]

2.2. Alternate Flows

2.2.1. The Generation Suite of the Brandkey Deliver Subsystem

The Users enters the Generation Suite of the Brandkey Deliver Subsystem. The System checks the Control Panel Access Rights for the User in the Database. The list of Control Panels available for the User only are displayed in this Suite.

2.2.2. The Installation Suite of the Brandkey Deliver Subsystem

The Users enters the Installation Suite of the Brandkey Deliver Subsystem. The System checks the Control Panel Access Rights for the User in the Database. The list of Control Panels available for the User only are displayed in this Suite.

2.2.3. The User/Account Administration Suite of the Brandkey Systems Subsystem.

The User clicks on the User/Account Administration Suite link. The System checks in the Database if the User is a Client Account Administrator. [See Extension 3.2 if the User is not a Client Account Administrator]. If the User is a Client Account Administrator, then the System displays the User/Account Administration Suite with the available Control Panels.

2.2.4. The User is a Consumer.

The User has access to only the following areas of the System:

Brandkey Deliver→Installation Suite

The User does not have access to any other Suite or Control Panel in the System. The User's Access Rights will be set up accordingly. They will have access to the following Control Panels:

Control Panel for Installing Product-Specific Virtual Kiosks

Control Panel for Installing Service-Specific Virtual Kiosks

Control Panel for Installing Vendor-Specific Virtual Kiosks

Control Panel for Installing Service-Provider-Specific Virtual Kiosks

Control Panel for Installing Retailer-Specific Virtual Kiosks

Control Panel for Installing Industry-Specific Virtual Kiosks

Control Panel for Installing Corporate-Specific Virtual Kiosks.

All the above Control Panels are in the Installation Suite of the Brandkey Deliver Subsystem.

2.2.5. The User is in Standard Demonstration Mode.

The User is not logged in, therefore we can not determine any Access Rights. By default Users in Standard Demonstration Mode have access to all Control Panels EXCEPT those Control Panels in the Installation Suite of the Brandkey Deliver Subsystem. [See Extension 3.3 if the User attempts to access those Control Panels].

2.2.6. The User is in Custom Demonstration Mode.

The User will have access to ALL Control Panels and areas in the System.

2.3. Exceptions

2.3.1. The User does not have access rights to the selected Control Panel.

The System launches a Control Panel-style window with the following error message; “You do not have Access Rights to the requested Control Panel. Please contact your Administrator or Account Manager to request access to this Control Panel.”

2.3.2. The User is not a Client Account Administrator and has clicked on the User/Account Administration Suite link in the Brandkey Manage Subsystem.

The System displays an error message on the main page saying; “You do have Access Rights to the requested Suite. Only the Administrator of your Client Account may access this Suite. If you feel you have received this message in error, please contact your Account Manager.”

2.3.3. The User in Standard Demonstration Mode Attempts to Access the Virtual Kiosk Installation Control Panels in the Brandkey Deliver Subsystem.

The System launches a Control Panel-style window with the following error message; “You are currently running the System in Standard Demonstration Mode. The requested Control Panel is not available for Demonstration in this Mode. Please contact info@bksnetworks.com if you wish to gain access to this Control Panel or are interested in finding out how BKS Networks can help you further.”

General Navigation Items

1. General Navigation Items

This Use Case covers some general System navigation issues.

2. Flow of Events

2.1. Basic Flows

2.1.1. Session Timeout

The User clicks on a button to move to a new page. If the session has timed out, the System displays an error page informing the User that the session has timed out and they need to close the Control Panel and log in once again. All data is lost. If a Revert is possible then a Revert should be done.

2.1.2. Required Fields in Forms

All Required Fields as defined in the individual Use Cases shall have red asterisk marks to their left to denote that they are required.

2.1.3. Date Formats

All Date Formats in all tables will display as follows mm/dd/yyyy. All forms will be able to handle the following Date Formats:

mm/dd/yy

mm/dd/yyyy

2.2. Alternate Flows—None

2.3. Exceptions—None

Brandkey Manage Subsystem Level Services (See FIG. 7a through 7h)

User/Account Administration Suite

Update User Information

1. Update User Information

This Use Case allows the Administrator of a Client Account to update the information for any User of an account of which they are the Administrator.

The User clicks on the Search/Edit User Menu item in the Control Panel for Administering Users.

2. Flow of Events

2.1. Basic Flow

2.1.1. Update User Information

The System loads the Search for User page. The System will also display the User Marquee at the top of the page. The System will also display the appropriate Mode label on the page. In this case the appropriate label is “Operational Mode”. The User may fill in the Search Criteria and click the Search button to initiate the User Search. The System will initiate the User Search. The System will check if any of the Search fields are filled in. If no search criteria are filled in, the System will return a list of all Users for the Client Account who are not Administrators of the Client Account. If there are search criteria, the System will pull the list of Users of the Client Account who match the search criteria and are not Administrators of the Client Account from the Database. The System will then display the Search Results page with the results of the User Search displayed in the table. [See Alternate Flow 2.2.3 if there are no Users returned]. The User clicks on the User Full Name column to view the detailed information for that User. The System displays the Edit User Information page for the selected User. The fields of the User Information page will be filled in from the data pulled from the Database. All fields will be filled in except the Password and Confirm Password fields. The User updates the information for the selected User. The User clicks the Submit button to save the changes to the Database. The System checks that all required fields are filled in. [See Extension 3.1 if all required fields are not filled in]. The System checks that the User Name is not already in the System under a different User. [See Extension 3.2 if the User Name is being used by a different User]. The System checks that the Password and Confirm Password fields match as long as the Password field is filled in. [See Extension 3.3 if the Password and Confirm Password fields do not match]. If all required fields are filled in, and the User Name is unique, then the System will encrypt the Password field if it is entered by the User and then save the information to the Database. If the information is saved correctly to the Database, then the System will load the Update User Access Rights page with the appropriate Services visible for the Client Account and the Services currently assigned to the selected User checked by default. The System will also display the appropriate Mode label on the page. In this case the appropriate label is “Operational Mode”. The User Updates their Access Rights Information and clicks the Submit button to save their changes to the Database. The System will save the Access Rights information to the Database. Once the Information has been saved correctly to the Database, then the System will display the User Information Confirmation page. The System will also display the User Marquee at the top of the page. The System will also display the appropriate Mode label on the page. In this case the appropriate label is “Operational Mode”. The System will click the Confirm button to save the changes they have made and the System will display first page in the Search/Edit User Service. [See Alternate Flow 2.2.4 if the Edit button is clicked].

2.2. Alternate Flows

2.2.1. Any Other Menu Item is Pressed in the Control Panel.

The Information the User enters is not saved and the System displays the requested page.

2.2.2. The User Closes the Control Panel.

The Information the User enters is not saved and the User is taken back to the User/Account Administration Suite.

2.2.3. No Users are Returned from the User Search.

The Search Results table is displayed with no User data filled in. The System will display the following text in the table instead; “No records matched your Search Criteria. Please click the Back button to try a different User Search.”

2.2.4. The User Clicks the Edit Button on the Confirmation Page.

The System will take the User back to the Edit User page.

2.3. Exceptions

2.3.1. Not all Required Fields are Filled in.

The following fields are required:

First Name

Last Name

Phone Number

E-mail Address

User Name

Password (only required if Confirmed Password is also entered)

Confirm Password (only required if Password is also entered)

If any of the above are not filled in the System displays an error message saying; “You must fill in all required fields.”

2.3.2. If the User Name Entered is Already being Used by a Different User.

The System displays an error message saying; “The User Name you entered is already being used by another User. Please check the name you wish to use and enter it again.”

2.3.3. If the Password and Confirm Password fields do not match in the Edit User page The System displays an error message saying; “The Password and Confirm Password fields do not match. Please re-enter the password the same in both fields.”

Add New User

1. Add New User

This Use Case allows the Administrator of a Client Account to add a new User to the Client Account of which they are the Administrator.

The User clicks on the Add New User Menu item in the Control Panel for Administering Users.

2. Flow of Events

2.1. Basic Flow

2.1.1. AddNewUser

The System displays the Add New User Information page. The fields of the User Information page will be blank. The User enters the information for the new User. The User clicks the Submit button to save the new User to the Database. The System checks that all the required fields are filled in. The System checks that the User Name is not already in the System under a different User. [See Extension 3.2 if the User Name is being used by a different User]. The System checks that the Password and Confirm Password fields match. [See Extension 3.3 if the Password and Confirm Password fields do not match]. If all required fields are filled in, the User Name is unique, and the Password and Confirm Password fields match, then the System will encrypt the Password entered by the User and then save the information to the Database. If the information is saved correctly to the Database, then the System will load the Configure User Access Rights page with the appropriate Services visible for the Client Account. All Services will be unchecked for this new User by default. The System will also display the appropriate Mode label on the page. In this case the appropriate label is “Operational Mode”. The User Configures the Access Rights Information for the new User and clicks the Submit button to save their changes to the Database. The System will save the Access Rights information to the Database. Once the Information has been saved correctly to the Database, then the System will display the User Information Confirmation page. The System will also display the User Marquee at the top of the page. The System will also display the appropriate Mode label on the page. In this case the appropriate label is “Operational Mode”. The User will click the Confirm button to indicate that no changes are required to the saved information. The System will display the first page in the Search/Edit User Service. [See Alternate Flow 2.2.4 if the Edit button is clicked].

2.2. Alternate Flows

2.2.1. Any Other Menu Item is Pressed in the Control Panel.

The Information the User enters is not saved and the System displays the requested page.

2.2.2. The User Closes the Control Panel.

The Information the User enters is not saved and the System displays the User/Account Administration Suite.

2.2.3. The User Clicks the Edit Button on the Confirmation Page.

The System displays the Edit User page.

2.3. Exceptions

2.3.1. Not all Required Fields are Filled in.

The following fields are required:

First Name

Last Name

Phone Number

E-mail Address

User Name

Password

Confirm Password

If any of the above are not filled in the System displays an error message saying; “You must fill in all required fields.”

2.3.2. If the User Name Entered is Already being Used by a Different User.

The System displays an error message saying; “The User Name you entered is already being used by another User. Please check the name you wish to use and enter it again.”

2.3.3. The Password and Confirm Password Fields do not Match on the Add New User Page

The System displays an error message saying; “The Password and Confirm Password fields do not match. Please enter your password again in both fields.”

Update Company Information

1. Update Company Information

This Use Case allows the User to Update the information for the Client which they Administer.

The User clicks on the Update Company Info Menu item in the Control Panel for Administering Accounts.

2. Flow of Events

2.1. Basic Flow

2.1.1. Update Company Information

The System loads the Company Information page with the data for the Client filled in. The System will also display the User Marquee at the top of the page. The System will also display the appropriate Mode label on the page. In this case the appropriate label is “Operational Mode”. The User updates the information for the Client. The User clicks the Submit button to save the changes to the Database. The System checks that all the required fields are filled in. The System checks that the Client Name is not already in the System under a different Client. The System checks that the MIN or SPIN is not already in the System under a different Client. If all required fields are filled in, and the Client Name is unique, and the MIN or SPIN is unique, then the System will save the information to the Database. If the information is saved correctly to the Database, then the System will reload the Company Information page with the following message just below the instructional text; “The changes to the Client Information have been successfully saved to the System.”

2.2. Alternate Flows

2.2.1. Any Other Menu Item is Pressed in the Control Panel.

The Information the User enters is not saved and the User is taken to the requested page.

2.2.2. The User Closes the Control Panel.

The Information the User enters is not saved and the User is taken back to the User/Account Administration Suite.

2.3. Exceptions

2.3.1. Not all Required Fields are Filled in.

The following fields are required:

Client Name

Client Address (first textbox)

City

State

Zip/Postal Code

Country

Phone Number

E-mail Address

Company Website

Contact Person

Contact Phone Number

Contact E-mail Address

MIN or SPIN

If any of the above are not filled in the System displays an error message saying; “You must fill in all required fields.”

2.3.2. If the Client Name Entered is Already being Used by a Different Client.

The System displays an error message saying; “The Client Name you entered is already being used by another Client. Please check the name you wish to use and enter it again. If you feel you have received this message in error, please contact your Account Manager.”

2.3.3. If the MIN or SPIN Entered is Already being Used by a Different Client.

The System displays an error message saying; “The [MIN or SPIN] you entered is already being used be another Client. Please check the Identification Number you wish to use and enter it again. If you feel you have received this message in error, please contact your Account Manager.”

Update Administrator Information

1. Update Administrator Information

This Use Case allows the User to Update their personal information if they are the Client Account Administrator.

The User clicks on the Update Admin Info Menu item in the Control Panel for Administering Accounts.

2. Flow of Events

2.1. Basic Flow

2.1.1. Update Administrator Information

The System loads the Administrator Information page with the data for the Administrator filled in. The System will also display the User Marquee at the top of the page. The System will also display the appropriate Mode label on the page. In this case the appropriate label is “Operational Mode”. The User updates their information. The User clicks the Next button to save the changes to the Database. The System checks that all the required fields are filled in. The System checks that the User Name is not already in the System under a different User. The System checks that the Password and Confirm Password fields match. If all required fields are filled in, and the User Name is unique, and the Password and Confirm Password fields match, then the System will save the information to the Database. If the information is saved correctly to the Database, then the System will load User Access Rights page with the appropriate information for the Administrator filled in. The System will also display the User Marquee at the top of the page. The System will also display the appropriate Mode label on the page. In this case the appropriate label is “Operational Mode”. The User Updates their Access Rights Information and clicks the Submit button to save their changes to the Database. The System will save the Access Rights information to the Database. Once the Information has been saved correctly to the Database, then the System will display the Administrator Information Confirmation page. The System will also display the User Marquee at the top of the page. The System will also display the appropriate Mode label on the page. In this case the appropriate label is “Operational Mode”. The System will click the Confirm button to save the changes they have made and the System will return them to the first page in the Update Admin Info Service.

2.2. Alternate Flows

2.2.1. Any Other Menu Item is Pressed in the Control Panel.

The Information the User enters for that page is not saved and the User is taken to the requested page.

2.2.2. The User Closes the Control Panel.

The Information the User enters for that page is not saved and the User is taken back to the User/Account Administration Suite.

2.2.3. The User Clicks the Back Button on the Administrator Access Rights Page.

The Information the User enters for that page is not saved and the User is taken back to the Administrator Information page.

2.3. Exceptions

2.3.1. Not all Required Fields in the Admin Info Page are Filled in.

The following fields are required:

First Name

Last Name

Phone Number

E-mail Address

User Name

Password

Confirm Password

If any of the above are not filled in the System displays an error message saying; “You must fill in all required fields.”

2.3.2. If the User Name Entered is Already being Used by a Different User.

The System displays an error message saying; “The User Name you entered is already being used. Please choose a different User Name.”

2.3.3. If the Password and Confirm Password Fields do not Match.

The System displays an error message saying; “The Password and Confirm Password fields do not match. Please enter the same Password in both the fields again.”

Update Available Services

1. Update Available Services

This Use Case allows the User to request an Update of the Services available to their Client Account.

The User clicks on the Update Available Services Menu item in the Control Panel for Administering Accounts.

2. Flow of Events

2.1. Basic Flow

2.1.1. Update Available Services

The System loads the Available Services page with the data for the Client Account filled in. The System will also display the User Marquee at the top of the page. The System will also display the appropriate Mode label on the page. In this case the appropriate label is “Operational Mode”. The User updates the information for the list of available Services for the Client Account. The User clicks the Submit button to send the request to update the list of available Services for the Client Account to their Account Manager. The System send an email detailing the request to the Account Manager for the Client Account. A copy of the email is also sent to the User. The System displays the Confirmation page. The System will display the User Marquee at the top of the page. The System will also display the appropriate Mode label on the page. In this case the appropriate label is “Operational Mode”.

2.2. Alternate Flows

2.2.1. Any Other Menu Item is Pressed in the Control Panel.

The Information the User enters is not saved and the User is taken to the requested page.

2.2.2. The User Closes the Control Panel.

The Information the User enters is not saved and the User is taken back to the User/Account Administration Suite.

2.3. Exceptions

Update Brand Information

1. Update Brand Information

This Use Case allows the User to Add a New Brand Entity to the list of associated Brand Entities with the Client Account and to Add Trademarks or Servicemarks for the new Brand Entity as well as to Edit/Modify the existing Brand Entities and their Trademarks or Servicemarks.

The User clicks on the Edit Brand Entity Info Services Menu item in the Control Panel for Administering Accounts.

2. Flow of Events

2.1. Basic Flow

2.1.1. Update Brand Information

The System loads the Add New Brand Entity page. The form will be blank, no fields filled in. The System will also display the User Marquee at the top of the page. The System will also display the appropriate Mode label on the page. In this case the appropriate label is “Operational Mode”. The User clicks the Next button to view the list of Brand Entities for the Client Account. [See Alternate Flow 2.2.3 for Adding a New Brand Entity]. The System displays the Select Brand Entity page. The table is made up of the following fields:

Brand Entity Identification Number

Trademark(TM)/Servicemark(SM)

Product Descriptor(PD/Service Descriptor(SD)

US Trademark/Servicemark Registration No

Legal Owner of Brand Entity

Relationship of Administrator to Legal Owner

The System will also display the User Marquee at the top of the page. The System will also display the appropriate Mode label on the page. In this case the appropriate label is “Operational Mode”. The User clicks on the Brand Entity Identification Number (which is a hyperlink) to display the detailed information about the selected Brand Entity. The System displays the Edit Brand Entity page with the data for the selected Brand Entity filled in. The System will also display the User Marquee at the top of the page. The System will also display the appropriate Mode label on the page. In this case the appropriate label is “Operational Mode”. The User will update the information for the selected Brand Entity. The User clicks the Submit button to save the changes to the Database. The System will check that all required fields are filled in. If all required fields are filled in, then the System will display the Edit Trademark/Servicemark Portfolio page The System will also display the User Marquee at the top of the page. The System will also display the appropriate Mode label on the page. In this case the appropriate label is “Operational Mode”. The User will update the portfolio of Trademarks/Servicemarks for the selected Brand Entity. [See Alternate Flow 2.2.4 for Adding a text-based Trademark/Servicemark] [See Alternate Flow 2.2.5 for Adding a file-based Trademark/Servicemark] [See Alternate Flow 2.2.6 for activating/deactivating Trademarks/Servicemarks] The User makes changes to the portfolio of Trademarks/Servicemarks and clicks the Next button to save the changes to the Database: The System displays the Confirm Brand Entity Information page. The System will also display the User Marquee at the top of the page. The System will also display the appropriate Mode label on the page. In this case the appropriate label is “Operational Mode”. The User clicks the Confirm button for the System to display the first page of the Edit Brand Entity service again. [See Alternate Flow 2.2.7 for Editing Confirmation Page]

2.2. Alternate Flows

2.2.1. Any Other Menu Item is Pressed in the Control Panel.

The Information the User enters is not saved and the User is taken to the requested page.

2.2.2. The User Closes the Control Panel.

The Information the User enters is not saved and the User is taken back to the User/Account Administration Suite.

2.2.3. Adding a New Brand Entity

The User will enter the information for the new Brand Entity. The User clicks the Add Trademarks button to save the changes to the Database and display the Edit Trademarks/Servicemarks Portfolio page. The System will check that all required fields are filled in. If all required fields are filled in, then the System will display the Edit Trademark/Servicemark Portfolio page The System will also display the User Marquee at the top of the page. The System will also display the appropriate Mode label on the page. In this case the appropriate label is “Operational Mode”. The User will update the portfolio of Trademarks/Servicemarks for the new Brand Entity. [See Alternate Flow 2.2.4 for Adding a text-based Trademark/Servicemark] [See Alternate Flow 2.2.5 for Adding a file-based Trademark/Servicemark] The User updates the portfolio of Trademarks/Servicemarks and clicks the Next button to save the changes to the Database.

2.2.4. Adding a Text-Based Trademark/Servicemark

The User is in the Trademark/Servicemark Portfolio page. The User enters text in the “Text-Based Trademark/Servicemark” textbox. The User clicks the Update button to save the Trademark or Servicemark to the Database. The System checks whether or not the Trademark or Servicemark already exists in the System. If the Trademark or Servicemark does not exist in the System, then the System will save the Trademark/Servicemark to the Database. The System will reload the Portfolio page and display the newly added Trademark or Service.

2.2.5. Adding a File-Based Trademark/Servicemark

The User is in the Trademark/Servicemark Portfolio page. The User clicks the Browse button next to the “File-Based Trademark/Servicemark” textbox. The System will display a file-select dialog box appropriate for the operating system the User is on. The User will select the file to upload from their computer and click the OK button in the dialog box. The System will copy the filename to the “Text-Based Trademark/Servicemark” textbox. The User clicks the Update button to upload the file to the Brandkey Systems server and save the Trademark or Servicemark to the Database. The System checks whether or not the Trademark or Servicemark already exists in the System. If the Trademark or Servicemark does not exist in the System, then the System will save the Trademark/Servicemark to the Database. The System will reload the Portfolio page and display the newly added Trademark or Service.

2.2.6. Activating/Deactivating Trademarks/Servicemarks

The User is in the Trademark/Service Portfolio page. The User will uncheck the checkbox next to a Trademark/Service to deactivate it. The User will check the checkbox next to a Trademark/Servicemark to activate it. The User will click the Update button to save the changes to the Database. The System will save the changes to the Database and then reload the Portfolio page.

2.2.7. Editing the Brand Entity Confirmation Page

The User is on the Brand Entity Confirmation page. The User clicks the Edit button on that page The System displays the Edit Brand Entity page with the appropriate Mode graphic and the User Marquee filled in.

2.3. Exceptions

2.3.1. Required Fields not Filled in for the Brand Entity Page

The Brand Entity page has the following required fields:

Brand Entity Name

Product Descriptor OR Service Descriptor

Product/Service Category

Legal Owner of Brand

Relationship of Legal Owner to Administrator

If any of these fields are not filled in, the System will display an appropriate error message and reload the current page.

2.3.2. Text-Based Trademark/Servicemark Already Exists in the Data for the Brand Entity

The System will check in the Database whether or not the Trademark/Service exists in the Database for the Brand Entity. If the Trademark/Servicemark exists for the Brand Entity the System will display an error message saying; “The Trademark/Servicemark you entered already exists for the current Brand Entity. Please confirm you are entering the correct Trademark/Servicemark.”

2.3.3. File-Based Trademark/Servicemark Already Exists in the Data for the Brand Entity

The System will check in the Database whether or not the Trademark/Service exists in the Database for the Brand Entity. If the Trademark/Servicemark exists for the Brand Entity the System will display an error message saying; “The Trademark/Servicemark you entered already exists for the current Brand Entity. Please confirm you are entering the correct Trademark/Servicemark.”

Certify Advertising Agents.

1. Certify Advertising Agents

This Use Case allows the User to Certify or Decertify Advertising Agents associated with the Client Account.

The User clicks on the Certify Ad Agents Services Menu item in the Control Panel for Administering Accounts.

2. Flow of Events

2.1. Basic Flow

2.1.1. Certify Advertising Agents

The System loads the Certify Ad Agents page. The form will be filled in with the list of certified and decertified Advertising Agents for the Client Account. The System will also display the User Marquee at the top of the page. The System will also display the appropriate Mode label on the page. In this case the appropriate label is “Operational Mode”. The User can uncheck any of the Certified checkboxes for Certified Advertising Agents. The User can also check any of the Certified checkboxes for the Uncertified Advertising Agents. The User will click the Submit button to save the changes to the Database. The System will save the changes to the Database and reload the page with the changes visible.

2.2. Alternate Flows

2.2.1. Any Other Menu Item is Pressed in the Control Panel.

The Information the User enters is not saved and the User is taken to the requested page.

2.2.2. The User Closes the Control Panel.

The Information the User enters is not saved and the User is taken back to the User/Account Administration Suite.

2.3. Exceptions

Certify Promotional Agents

1. Certify Promotional Agents

This Use Case allows the User to Certify or Decertify Promotional Agents associated with the Client Account.

The User clicks on the Certify Promo Agents Services Menu item in the Control Panel for Administering Accounts.

2. Flow of Events

2.1. Basic Flow

2.1.1. Certify Promotional Agents

The System loads the Certify Promo Agents page. The form will be filled in with the list of certified and decertified Promotional Agents for the Client Account. The System will also display the User Marquee at the top of the page. The System will also display the appropriate Mode label on the page. In this case the appropriate label is “Operational Mode”. The User can uncheck any of the Certified checkboxes for Certified Promotional Agents. The User can also check any of the Certified checkboxes for the Uncertified Promotional Agents. The User will click the Submit button to save the changes to the Database. The System will save the changes to the Database and reload the page with the changes visible.

2.2. Alternate Flows

2.2.1. Any Other Menu Item is Pressed in the Control Panel.

The Information the User enters is not saved and the User is taken to the requested page.

2.2.2. The User Closes the Control Panel.

The Information the User enters is not saved and the User is taken back to the User/Account Administration Suite.

2.3. Exceptions

Administer Ad/Promo Privileges

1. Administer Ad/Promo Privileges

This Use Case will allow Retailers to administer the allowed Advertisement and Promotional privileges for Vendors and Service Providers on their Virtual Kiosks.

The User clicks on the Launch Control Panel for Administering Ad/Promo Privileges button on the left navigation menu of the User/Account Administration Suite in the Brandkey Manage subsystem.

2. Flow of Events

2.1. Basic Flow

2.1.1. Set Ad/Promo Privileges to not Allowed

The User clicks on the “View/Edit Ad/Promo Privileges for Installed Virtual Kiosks” button. The System shall display the Select Virtual Kiosk page in a control panel. This page contains a table with the following columns:

Virtual Kiosk Serial Number (link to next page)

Virtual Kiosk Name

Virtual Kiosk Type

Virtual Kiosk Installation Location

Privilege Type

The System retrieves the list of Virtual Kiosks from the InstalledVirtualKiosk table for those active Virtual Kiosks created by the logged-in User's Client Account. The System shall fetch the Virtual Kiosk Serial Number, Name, and Type from the Virtual Kiosk table for each of those Installed Virtual Kiosks. The System shall fetch the Virtual Kiosk Installation Location from the InstalledVirtualKiosk table. [See Exception “No active Virtual Kiosks for the current client account.” if there are no InstalledVirtualKiosks to display.] The System shall derive the Privilege Type by examining each row in the InstalledVirtualKioskPrivilege table for this client and Installed Virtual Kiosk. If there is a row with an Exclusive privilege type, then the Privilege Type is “Exclusive.” If there is at least one row with a Shared privilege type, then the Privilege Type is “Shared.” If neither of these conditions exist, then the Privilege Type is “Not Allowed.” The User clicks on the Virtual Kiosk Serial Number to select a Kiosk. The System shall display the Select Ad/Promo Privilege page. A table on the Select Ad/Promo Privilege page contains the detail information for the selected Virtual Kiosk:

Virtual Kiosk Serial Number

Virtual Kiosk Name

Virtual Kiosk Type

Virtual Kiosk Installation Location

Virtual Kiosk Installed By

Privilege Type (drop-down list of types pulled from AdPromoPrivilege table)

The System shall fetch the Virtual Kiosk Serial Number, Name, and Type from the VirtualKiosk table. The System shall fetch the Virtual Kiosk Installation Location, and Installed By from the InstalledVirtualKiosk table. The Privilege Type is set from the InstalledVirtualKioskPrivilege table as described for the previous page. The User selects the Not Allowed Privilege Type from the drop-down list and then clicks the Next button. [See Alternate Flow “Set Ad/Promo Privileges to Shared” if the User selects the Shared Privilege Type or Alternate Flow “Set Ad/Promo Privileges to Exclusive” if the User selects the Exclusive Privilege Type] The System shall update the Privilege type to “Not Allowed” in all rows in the InstalledVirtualKioskPrivilege table that are associated with the current Virtual Kiosk and the client associated with the client account selected by the User at login. The System shall display a Confirmation page with the message, “The Advertisement and Promotional privileges of all Vendors/Service Providers have been successfully set to “Not Allowed” for this Virtual Kiosk.”

2.2. Alternate Flows

2.2.1. Set Ad/Promo Privileges to Shared

The User selects “Shared” from the Privilege Type drop-down list on the Select Ad/Promo Privilege page and then clicks the Next button. The System shall display the Search for Vendors/Service Providers page. The page contains fields in which the User may enter search criteria to filter from the collection of all Vendors/Service Providers who have products/services on the current Virtual Kiosk. The User may filter by:

Vendor/Service Provider Name

Client Identification Number

Client City

Client State (drop-down list of states from the State table)

Client Zip/Postal Code

Client Country (drop-down list of countries from the Country table, defaulting to United State)

The User enters any desired criteria and clicks on the Search button. The System shall filter the InstalledVirtualKioskPrivileges table by the criteria entered by the User. If the User does not enter any criteria, the System shall return all rows where the Client.Country.Name is “USA.” The System shall display the Assign Vendor page, containing the rows returned by the filter. [See Exception “No rows returned from Filter” if no rows are returned.] The page shall have a table containing the following data:

Vendor/Service Provider Name

Client Identification Number

A Shared checkbox (marked with a check if this row has a Shared privilege type)

A navigation bar (if more than 5 rows were returned from the filter)

The User may check or uncheck any of the Shared checkboxes. If more than 5 rows were returned from the filter, the User may also navigate through the Vendor/Service Provider list using the navigation bar. The User shall click on the Submit button to save the changes. The System shall save the changes to the database. The System shall examine the rows in the InstalledVirtualKioskPrivilege table that are associated with both the current Virtual Kiosk and also with the client from the client account selected by the User at login. If any of these rows have Exclusive privilege, the System shall set the privilege to Shared. Any rows where the User has marked the checkbox shall be set to Shared. Any rows where the checkbox is not marked, shall be set to Not Allowed. (Note: there may be rows in the InstalledVirtualKioskPrivilege table that are not displayed on this page because the rows were filtered out during the search. The privilege will not be set to Not Allowed for the rows that were filtered out. Once the changes are saved, the System shall display a confirmation page with the following message, “The Advertisement and Promotional privileges of all selected Vendors/Service Providers have been successfully set to “Shared,” for this Virtual Kiosk. If any Vendors/Service Providers had exclusive privileges, these have also been set to “Shared.”

2.2.2. Set Ad/Promo Privileges to Exclusive

The User selects “Exclusive” from the Privilege Type drop-down list on the Select Ad/Promo Privilege page and then clicks the Next button. The System shall display the Search for Vendors/Service Providers page. The page contains fields in which the User may enter search criteria to filter from the collection of all Vendors/Service Providers who have products/services on the current Virtual Kiosk. The User may filter by:

Vendor/Service Provider Name

Client Identification Number

Client City

Client State (drop-down list of states from the State table)

Client Zip/Postal Code

Client Country (drop-down list of countries from the Country table, defaulting to United State)

The User enters any desired criteria and clicks on the Search button. The System shall filter the InstalledVirtualKioskPrivileges table by the criteria entered by the User. If the User does not enter any criteria, the System shall return all rows where the Client.Country.Name is “USA.” The System shall display the Assign Vendor page, containing the rows returned by the filter. [See Exception “No rows returned from Filter” if no rows are returned.] The page shall have a table containing the following data:

A drop-down list of Vendor/Service Provider Names returned from the search.

The Vendor/Service Provider who currently has Exclusive privilege will be pre-selected. If this. Vendor/Service Provider is not returned from the search, they will be added to the list anyway. If no one has the Exclusive Privilege, the list will be pre-selected to the text “Select an Exclusive Vendor/Service Provider,” which is interpreted as a null selection by WebObjects. The User may select any of the Vendors/Service Providers in the list. The User shall click on the Submit button to save the changes. [See Exception “No Vendor or Service Provider selected when Exclusive privileges are selected.”] The System shall save the changes to the database. The row in the InstalledVirtualKioskPrivilege table associated with the selected Vendor/Service Provider and the current Virtual Kiosk shall be saved with the Exclusive privilege and any other rows shall be saved with Not Allowed privileges. Once the changes are saved, the System shall display a confirmation page with the following message, “The Advertisement and Promotional privileges of the selected Vendor/Service Provider have been successfully set to “Exclusive,” for this Virtual Kiosk. If any other Vendors/Service Providers had privileges, these will be set to “Not Allowed.”

2.2.3. User Clicks on Back Button on Assign Vendors/Service Providers Page.

The System shall display the Search for Vendors/Service Providers page.

2.2.4. User is in Demonstration Mode.

The System shall not save any changes to the Database. [See the Programming Demo Use Cases in References.]

2.3. Exceptions

2.3.1. No Active Virtual Kiosks for the Current Client Account

The System displays the Select Virtual Kiosk page with the following message, “There are no installed Virtual Kiosks associated with this Client Account.”

2.3.2. No Rows Returned from Filter

The System redisplays the Search for Vendors/Service Providers page with the following message, “No matching Vendors/Service Providers found.”

2.3.3. No Vendor or Service Provider Selected when Exclusive Privileges are Selected

The System displays the Select Ad/Promo Privilege page with the following error message; “Please select a Vendor/Service Provider.”

Brandkey Create Subsystem Level Service

Brand Information Networks Management Suite (See 8A through 8I)

Select Brand Entity

1. Select Brand Entity

This Use Case allows the User to select a Brand Entity they wish to work with.

The User clicks on the Select Brand Entity menu item in the Brand Information Network Management Control Panel and on the Select Brand Entity sub-menu item.

2. Flow of Events

2.1. Basic Flow

2.1.1. Select Brand Entity

The System displays the Brand Entity Selection page that has a drop-down list containing the Brand Entities that are associated with the Client Account the User selected during the Login process. The System will also display the User Marquee at the top of the page. The System will also display the appropriate Mode label on the page. In this case the appropriate label is “Operational Mode”. The User selects a Brand Entity from the Drop-down list. The User clicks on the Select button. The System saves the selected Brand Entity information to the Session. The System displays the Brand Entity Selection Confirmation page. The User clicks the Continue button. The System displays the full Brand Information Network Management Control Panel.

2.2. Alternate Flows

2.2.1. Brand Entity has Previously been Selected.

The Brand Information Network Management Control Panel shall display all the services available to the User.

2.2.2. The User Clicks on Another Service Before Having Chosen a New Brand Entity.

The System displays the Service chosen by the User. The current Brand Entity is still valid.

2.3. Exceptions

2.3.1. The User does not Select a Brand Entity and Clicks the Select Button.

The System checks that the User has selected a Brand Entity from the drop-down list. If the User has not selected a Brand Entity, then the System will display the Brand Entity Selection page once again with the following error message displayed; “You must select a Brand Entity in order to proceed.”

Select Node Indices

1. Select Node Indices

This Use case allows the User to select which Node Indices will be available to them for programming purposes during Brand Information Network creation for any Brand Entity, Product, or Service.

The User clicks on the Configure Control Panel menu item in the Brand Information Network Management Control Panel and on the Select Node Indices sub-menu item. The User clicks on the Next button from the Set Number of Nodes page.

2. Flow of Events

2.1. Basic Flow

2.1.1. Select Node Indices

The System displays the Select Node Indices page that has a list of check-boxes for each Index available during creation of the Brand Information Network. If the User has not previously selected any Node Indices, then the System will display the page in the default setting with all Indices checked. If the User has previously selected Node Indices, then the System shall display the page with the appropriate checkboxes selected. In both cases, the System will pull the list of Indices from the Database to display. The list of selected Indices for a specific Brand Entity will also be pulled from the Database. The System will also display the User Marquee at the top of the page. The System will also display the appropriate Mode label on the page. In this case the appropriate label is “Operational Mode”. The User will select the Indices they want to have available during creation of the Brand Information Network and click the Next button to save the list of Indices to the Database. The System will save the list of Indices to the Database and display the next page (Select Node Languages page—see appropriate Use Case).

2.2. Alternate Flows

2.3. Exceptions

2.3.1. The User does not Select any Indices.

They System will check that the User has selected at least one Index. If the User has not selected at least one Index, then the System will reload the current page and display an error message saying; “You must select at least one Index to display during Brand Information Network creation process.”

Select Node Languages

1. Select Node Languages

This Use case allows the User to select which Languages will be available to them for programming the Data Links in the Brand Information Network for any Brand Entity, Product, or Service.

The User clicks on the Configure Control Panel menu item in the Brand Information Network Management Control Panel and on the Select Node Languages sub-menu item. The User clicks on the Next button from the Select Node Indices page.

2. Flow of Events

2.1. Basic Flow

2.1.1. Set Node Languages

The System displays the Select Node Languages page that has a list of check-boxes for each Language available for the Brand Information Network. If the User has not previously selected any Node Languages, then the System will display the page in the default setting with all available Languages checked. If the User has previously selected Node Languages, then the System shall display the page with the appropriate checkboxes selected. In both cases, the System will pull the list of Languages from the Database to display. The list of selected Languages for a specific Brand Entity will also be pulled from the Database. The System will also display the User Marquee at the top of the page. The System will also display the appropriate Mode label on the page. In this case the appropriate label is “Operational Mode”. The User will select the Languages they want to have available for the Brand Information Network and click the Next button to save the list of Languages to the Database. The System will save the list of Languages to the Database and display the Set Brand Resources Link page.

2.2. Alternate Flows

2.3. Exceptions

2.3.1. The User does not Select any Languages.

They System will check that the User has selected at least one Language. If the User has not selected at least one Language, then the System will reload the current page and display an error message saying; “You must select at least one Language for the Data Links during Brand Information Network creation process.”

Set Resource Links

1. Set Resource Links

This Use case allows the User to set the list of Available Brand Resources provided to them by their Content Management System and update them as needed.

The User clicks on the Configure Control Panel menu item in the Brand Information Network Management Control Panel and on the Set Brand Resources Link sub-menu item. The User clicks on the Next button from the Select Node Languages page.

2. Flow of Events

2.1. Basic Flow

2.1.1. Set Resource Links

The System displays the Set Brand Resources page. This page contains a table with the list of Available Brand Resources pulled from the Database for the Brand Entity selected by the User. The table is made up of:

Brand Resource URL

Active (checkbox)

The System will also display the User Marquee at the top of the page. The System will also display the appropriate Mode label on the page. In this case the appropriate label is “Operational Mode”. The User may deactivate any Brand Resource by unchecking the Active checkbox for that Brand Resource and then clicking the Next button. If the Next button is clicked, the changes are saved to the Database and the Set Product/Service Categories Use Case is invoked. The User may also click on the Brand Resource URL to launch that URL in a new stripped-down browser window in order to preview it. If the User clicks the Import button, then the Import page is displayed. On the Import page, the User may select the Brand Resource Listing file to upload to the System. The System will also display the User Marquee at the top of the page. The System will also display the appropriate Mode label on the page. In this case the appropriate label is “Operational Mode”. The User clicks the Browse button and selects the file from their computer to upload. The User clicks the Next button to begin the Upload process. If the User clicks the Back button, no Upload is done and the System returns the User to the previous page. If and upload is to be done, then the System uploads the file to a temporary directory on the Web Server. [See Extension 3.1 if there are any errors with the uploading or processing the file]. The System then loops through all the records in the file and checks whether the URL in the file already exists for that Brand Entity. If the URL already exists for the Brand Entity, it is not added again and the System moves on to the next record. Once all records have been added, then the System returns to the first page and displays the list of Brand Resources, including the new ones just added. The new Brand Resources will all be checked, by default.

2.2. Alternate Flows

2.3. Exceptions

2.3.1. There were Errors Uploading or Processing the File

The System displays the Upload page once again with an error message stating that there was a problem either uploading the file or processing the file. The error statement can be taken from WebObjects and formatted to confirm with the error statements currently used in BKS Networks.

Set Product/Service Categories

1. Set Product/Service Categories

This Use case allows the User to set the list of Product/Service Categories they wish to assign to the selected Brand Entity.

The User clicks on the Configure Control Panel menu item in the Brand Information Network Management Control Panel and on the Set Product Categories Link sub-menu item. The User clicks on the Next button from the Set Available Resources page.

2. Flow of Events

2.1. Basic Flow

2.1.1. Set Product/Service Categories

The System displays the Set Product Categories page. This page contains a table with the list of assigned Product Categories pulled from the Database for the Brand Entity selected by the User. The table is made up of:

Category

Active (checkbox)

The System will also display the User Marquee at the top of the page. The System will also display the appropriate Mode label on the page. In this case the appropriate label is “Operational Mode”. The User may deactivate any Category by unchecking the Active checkbox for that Category. The User will click the Finish to save the changes to the Database and return to the main Control Panel page if they no longer wish to do anything in this section. If the User clicks the Add Category button, then the Add Category page is displayed. On the Add Category page, the User may enter a new Product Category to be assigned to the selected Brand Entity. The System will also display the User Marquee at the top of the page. The System will also display the appropriate Mode label on the page. In this case the appropriate label is “Operational Mode”. The User enters the new Category name in the provided textbox. The User clicks the Next button to save the new Category to the Database. If no new Category is entered in the textbox, then no new Category is saved to the Database. The System checks that the Category is not already in the Database under the same Brand Entity. [See Extension 3.1 if the Category is already in the Database under this Brand Entity]. If the User clicks the Back button, no new Category is saved and the System returns the User to the previous page. If a new Category is saved, then the System saves the new Category to the Database and returns the User to the first page of the Use Case. The User clicks the Finish button to end the Use Case and launch the main page of the Control Panel.

2.2. Alternate Flows

2.3. Exceptions

2.3.1. The Category is Already Saved in the Database Under the Brand Entity

The System reloads the page with the following error message; “The Category you entered already exists in the Database for the selected Brand Entity. Please enter another one.”

Search/Manage Data String Records

1. Search/Manage Data String Records

This Use Case allows the User to Search for and Edit Data String Records.

The User clicks the Search/Manage Data String Records sub-menu item under the Manage Product Data Strings menu item in the Brand Information Network Management Control Panel in Brandkey Create™.

2. Flow of Events

2.1. Basic Flow

2.1.1. Search/Manage Data String Records

The User clicks the Search/Manage Data String Records sub-menu item. The System displays the Search for Product Data String Records page. [The Basic Flow describes the flow for Products. See Alternate Flow 2.2.1 for the flow for Services]. The User enters the search criteria in the text box and chooses the search parameters from the drop-down list. The search parameters are:

All Products in [enter name of Brand here that was selected previously]

Universal Product Number

Trademark

Product Descriptor

Product Name

The User clicks the Search button to initiate the Product Search. The System checks which Search Parameter was selected. [See Alternate Flow 2.2.6 if “All Products in . . . ” has been selected]. If a different Search Parameter was selected, the System checks to make sure some Search Criteria was entered. [See Extension 3.1 if no Search Criteria was entered]. The System will take the Search Criteria and Parameters and perform a Product Search in the Database for active records matching the Search Criteria with the supplied Parameters. The System will display the Search Results of the Product Search on the Product Search Results page. [If no Products were found see Alternate Flow 2.2.2]. If there are more than 5 Products to be displayed the page will show the Record Navigation Bar below the Search Results table. The User must click on the Universal Product Number to select the Product they wish to edit. When the User clicks on the Universal Product Number the System loads the Edit Product Data String Record page. The details of the selected Product Data String are displayed on this page. The User shall make the changes to the Product Data String they wish to make and click the Update button to save the changes to the Database. The Product Category drop-down list is populated with the records from the Database, and the selected Category (if any) will be selected by default. If there is no Category to be selected by default, then the System will have selected the first blank row in the drop-down list. If the User clicks the Back button the System takes to User to the Search Results page. [See Alternate Flow 2.2.4 if the User clicks the Back button]. The User clicks the Update button to save the Product Data String information to the Database. The System checks that all the following required fields have been filled in:

Universal Product Number Type

Universal Product Number

Product Descriptor

Product Name

The Product Category is not a required field

If the fields have not been filled in an error message is displayed. [See Extension 3.2 for error handling]. If all fields are filled in correctly the System will then check the UPN entered by the User to determine if it is a valid Type entered, belongs to the Client, and if an accurate number. The System checks which Number Type has been selected by the User. [See Alternate Flow 2.2.5 if UPC-A is selected]. [See Alternate Flow 2.2.6 if UPC-E is selected]. [See Alternate Flow 2.2.7 if EAN-13 is selected]. [See Alternate Flow 2.2.8 if EAN-8 is selected]. [See Alternate Flow 2.2.9 if JAN is selected]. If all checks pass, then the System will save the Product information to the Database and display the Product Data String Confirmation page. By default any new Product created by the User will be marked as Active. The Product Data String Confirmation page will be displayed. There will a link for the User to go directly to the page to add Links for this Data String.

2.2. Alternate Flows

2.2.1. No Search Results were Found to Display on the Search Results Page. [See Alternate Flow 2.2.2.1 for no Products Found and See Alternate Flow 2.2.2.2 for No Services Found].

No Products found in the Product Search.

The System will display the Search Results page with a message saying; “No Products were found matching your search criteria.”

No Services found in the Service Search.

The System will display the Search Results page with a message saying; “No Services were found matching your search criteria.”

2.2.2. More than 5 Records in the Search Results Page Results in the Display of the Record Navigation Bar.

If there are more than 5 records (Product or Service), then the Search Results page shall display the Record Navigation Bar below the table. The Search Results table shall display only 5 records at one time. The Record Navigation Bar shall display the number of pages of Records there are. The Double arrows shall take the User either to the last page (right double arrows) or to the first page (left double arrows). The single arrows shall take the user to the next page (right single arrow) or to the previous page (left single arrow). The User can also click on the page number to jump directly to that page of Search Results.

2.2.3. User Clicks the Back Button on the Edit Data String Page. [See Alternate Flow 2.2.4.1 for Product Data String Page and Alternate Flow 2.2.4.2 for Service Data String Page].

Edit Product Data String page

User clicks on the Back button The System takes the User back to the Product Search Results page.

Edit Service Data String page.

Use clicks on the Back button The System takes the User back to the Service Search Results page.

2.2.4. The User Selected “all Products . . . ” or “all Services . . . ” in the Search Parameters.

The System will perform a general search for all Products or Services within the selected Brand Entity.

2.2.5. UPC-A is Selected

The System checks that the entered UPN is 12 digits long. An error message is displayed if the UPN is longer or shorter than 12 digits. The System checks that the first 6 digits match the Manufacturer Identification Number stored in our Database for the Client to which the selected Brand Entity belongs. An error is displayed if the first 6 digits do not match the MIN. The System then checks that the last number is an accurate Check-Digit for this UPN. The following is an example for UPN: 438571639853

Add all digits in the odd positions of the UPN (4+8+7+6+9+5=39)

That number is multiplied by 3 (39*3=117)

Add all digits in the even positions of the UPN, not including the last check-digit number (3+5+1+3+8=20)

Add this number to the number calculated in step 2 (117+20=137)

The check digit is the number when added to the above sum equals a multiple of 10. Therefore the check digit for the above UPN is 3. (137+3=140, which is divisible by 10).

If this checks digit is not accurate, then an error message is displayed.

2.2.6. UPC-E is Selected

The System checks that the entered UPN is 8 digits long. An error message is displayed if the UPN is longer or shorter than 8 digits

2.2.7. EAN-13 is Selected

The System checks that the entered UPN is 13 digits long. An error message is displayed if the UPN is longer or shorter than 13 digits To check the Manufacturer Identification Number, the System extracts digits 3 to 7 from the UPN. By adding a 0 to the front of this number, the System can check the 6-digit Manufacturer Identification Number to what is stored in the Database. The System then checks that the last number is an accurate Check-Digit for this UPN. The following is an example for UPN:

Consider the right-most digit (not including the check digit number) to be in the Odd position.

Add all digits in the odd positions of the UPN, not including the last check digit number (0+5+7+1+4+2=19)

That number is multiplied by 3 (19*3=57)

Add all digits in the even positions of the UPN (0+7+6+8+6+1=28)

Add this number to the number calculated in step 2 (57+28=85)

The check digit is the number when added to the above sum equals a multiple of 10. Therefore the check digit for the above UPN is 5. (85+5=90, which is divisible by 10).

If this checks digit is not accurate, then an error message is displayed.

2.2.8. EAN-8 is Selected

The System checks that the entered UPN is 8 digits long. An error message is displayed if the UPN is longer or shorter than 8 digits

2.2.9. JAN is Selected

The JAN is checked in exactly the same manner as the EAN-13.

2.3. Exceptions

2.3.1. No Search Criteria has been Entered in the Search for Data String Records Page. [See 3.1.1 for this error in Product Data String Records Page and See 3.1.2 for this Error in Service Data String Records Page].

Product Data String Records page.

The User did not enter any Search Criteria in the Search for Product Data String Records page. The System displays an error message saying; “You must enter some criteria to search for Products.” The System displays the Product Search page with the above error message.

Service Data String Records page.

The User did not enter any Search Criteria in the Search for Service Data String Records page. The System displays an error message saying; “You must enter some criteria to search for Services.” The System displays the Service Search page with the above error message.

2.3.2. All Required Fields have not been Filled in on the Edit Data String Page. [See 3.2.1 for this Error in Product Data String Record Page and See 3.2.2 for this Error in Service Data String Record Page].

Product Data String Record page.

The User did not fill in all the required fields on the Product Data String Record page. The System displays an error message saying; “You must enter data for XXXXX”, for only the first missing record The System displays the Product Data String Record page with the above error message.

Service Data String Records page.

The User did not fill in all the required fields on the Service Data String Record page. The System displays an error message saying; “You must enter data for XXXXX”, for only the first missing record The System displays the Service Data String Record page with the above error message.

Create New Data String Record

1. Create New Data String Record

This Use Case allows the User to Add New Data String Records.

The User clicks the Search/Manage Data String Records sub-menu item under the Manage Product Data Strings menu item in the Brand Information Network Management Control Panel in Brandkey Create™.

2. Flow of Events

2.1. Basic Flow

2.1.1. Create New Data String Record

The User clicks the Create New Data String Record sub-menu item. The System displays the Add New Product Data String Record page. [The Basic Flow describes the flow for Products. See Alternate Flow 2.2.1 for the flow for Services]. The fields in the form are blank except for the drop-down lists which are filled in with the default values. The User shall enter the information for the new Product Data String and click the Add New button to save the new record to the Database. The following fields are required in the form:

Universal Product Number Type

Universal Product Number

Product Descriptor

Product Name

Product Category is not a required field.

The System shall check that the required fields have been filled in before saving the information for the New Data String Record to the Database. If the User has not filled in all the required fields, and error message is displayed. [See Extension 3.1 if the required fields have not been filled in]. If all fields are filled in correctly the System will then check the UPN entered by the User to determine if it is a valid Type entered, belongs to the Client, and if an accurate number. The System checks which Number Type has been selected by the User. [See Alternate Flow 2.2.2 if UPC-A is selected]. [See Alternate Flow 2.2.3 if UPC-E is selected]. [See Alternate Flow 2.2.4 if EAN-13 is selected]. [See Alternate Flow 2.2.5 if EAN-8 is selected]. [See Alternate Flow 2.2.6 if JAN is selected]. If all checks pass, then the System will save the Product information to the Database and display the Product Data String Confirmation page. By default any new Product created by the User will be marked as Active. The Product Data String Confirmation page will be displayed. There will a link for the User to go directly to the page to add Links for this Data String.

2.2. Alternate Flows

2.2.1. The User has Previously Selected a Service Brand Entity. The System Displays the Service Data String Records Page.

The fields in the form are blank except for the drop-down lists which are filled in with the default values. The User shall enter the information for the new Service Data String and click the Add New button to save the new record to the Database. The following fields are required in the form:

Universal Service Number Type

Universal Service Number

Service Descriptor

Service Name

Service Category is not a Required Field

The System shall check that the required fields have been filled in before saving the information for the New Data String Record to the Database. If the User has not filled in all the required fields, and error message is displayed. [See Extension 3.1 if the required fields have not been filled in]. If all fields are filled in correctly the System will save the Service information to the Database and display the Service Data String Confirmation page. By default any new Service created by the User will be marked as Active. The Product Data String Confirmation page will be displayed. There will a link for the User to go directly to the page to add Links for this Data String.

2.2.2. UPC-A is Selected

The System checks that the entered UPN is 12 digits long. An error message is displayed if the UPN is longer or shorter than 12 digits. The System checks that the first 6 digits match the Manufacturer Identification Number stored in our Database for the Client to which the selected Brand Entity belongs. An error is displayed if the first 6 digits do not match the MIN. The System then checks that the last number is an accurate Check-Digit for this UPN. The following is an example for UPN: 438571639853

Add all digits in the odd positions of the UPN (4+8+7+6+9+5=39)

That number is multiplied by 3 (39*3=117)

Add all digits in the even positions of the UPN, not including the last check-digit number (3+5+1+3+8=20)

Add this number to the number calculated in step 2 (117+20=137)

The check digit is the number when added to the above sum equals a multiple of 10. Therefore the check digit for the above UPN is 3. (137+3=140, which is divisible by 10).

If this checks digit is not accurate, then an error message is displayed.

2.2.3. UPC-E is Selected

The System checks that the entered UPN is 8 digits long. An error message is displayed if the UPN is longer or shorter than 8 digits

2.2.4. EAN-13 is Selected

The System checks that the entered UPN is 13 digits long. An error message is displayed if the UPN is longer or shorter than 13 digits To check the Manufacturer Identification Number, the System extracts digits 3 to 7 from the UPN. By adding a 0 to the front of this number, the System can check the 6-digit Manufacturer Identification Number to what is stored in the Database. The System then checks that the last number is an accurate Check-Digit for this UPN. The following is an example for UPN:

Consider the right-most digit (not including the check digit number) to be in the Odd position.

Add all digits in the odd positions of the UPN, not including the last check digit number (0+5+7+1+4+2=19)

That number is multiplied by 3 (19*3=57)

Add all digits in the even positions of the UPN (0+7+6+8+6+1=28)

Add this number to the number calculated in step 2 (57+28=85)

The check digit is the number when added to the above sum equals a multiple of 10. Therefore the check digit for the above UPN is 5. (85+5=90, which is divisible by 10).

If this checks digit is not accurate, then an error message is displayed.

2.2.5. EAN-8 is Selected

The System checks that the entered UPN is 8 digits long. An error message is displayed if the UPN is longer or shorter than 8 digits

2.2.6. JAN is Selected

The JAN is checked in exactly the same manner as the EAN-13.

2.3. Exceptions

2.3.1. All Required Fields have not been Filled in on the Add New Data String Page. [See 3.2.1 For this Error in Product Data String Record Page and See 3.2.2 for this Error in Service Data String Record Page].

Product Data String Record page.

The User did not fill in all the required fields on the Product Data String Record page. The System displays an error message saying; “You must enter data for XXXXX”, for only the first missing record The System displays the Product Data String Record page with the above error message.

Service Data String Records page.

The User did not fill in all the required fields on the Service Data String Record page. The System displays an error message saying; “You must enter data for XXXXX”, for only the first missing record The System displays the Service Data String Record page with the above error message.

Data String Import Marquee

1. Data String Import Marquee

This Use Case describes how the Import Marquee is generated on all appropriate pages in the System.

The User clicks the Import Data String Records sub-menu item under the Manage Product Data Strings menu item in the Brand Information Network Management Control Panel in Brandkey Create™.

2. Flow of Events

2.1. Basic Flow

2.1.1. Data String Import Marquee

The User reaches a page where the Import Marquee is to be displayed. The System pulls the information to be displayed on the Import Marquee from the Database. The System displays the information in the Import Marquee just below the User Marquee. The information to be displayed is:

Manufacturer Identification Number

Number of Products

Date of last Import

2.2. Alternate Flows

2.3. Exceptions

Import Data String Records

1. Import Data String Records

This Use Case allows the User to Import Product data for new Products in their Brand Entity into the BKS Network from EDI Engine.

The User clicks the Import Data String Records sub-menu item under the Manage Product Data Strings menu item in the Brand Information Network Management Control Panel in Brandkey Create™.

2. Flow of Events

2.1. Basic Flow

2.1.1. Import Data String Records

The User clicks the Import Data String Records sub-menu item. The System displays the first page in the Import Data String Records flow. This page contains the User Marquee (see the User Marquee Use Case to see how to populate this. The page also contains the Import Marquee (see the Import Marquee Use Case to see how to populate this). The System checks whether or not an Import has previously been performed for the selected Brand Entity. [See Alternate Flow 2.2.1 if a previous Import for the selected Brand Entity has been performed]. If a previous Import has not been performed or the User elects to proceed with another Import, the System then proceeds to the next step. The System checks if the User is in Operational Mode. [See Exception 2.3.3 if the User is not in Operational Mode]. The System will pull all the Products in the EDI Engine Database that belong to the same Manufacturer as the Client of the User who is logged into the BKS Network. From this list of Products, the System will pull the Trade Name for the EDI Engine Database. The System will display the list of unique Trade Names to the User with a checkbox next to each Trade Name. [See Alternate Flow 2.2.3 if no Products or Trade Names are found in the EDI Engine Database for the Manufacturer]. If there are more than 5 entries in the Trade Name list, the list shall be broken up into several “pages”. [See the Record Selector Use Case to set up these pages]. The System will display the following message; “Please select the Trade Name(s) whose Products you wish to import into the BKS Network at this time”. The User will select the Trade Names they wish to Import. [See Extension 3.1 if the User does not select any Trade Names]. The User clicks the ‘Back’ button. [See Alternate Flow 2.2.4 if the User clicks the ‘Back’ button]. If the User clicks the ‘Next’ button, then the System pulls in those Products from the EDI Engine Database belonging to the selected Trade Name(s). [See Alternate Flow 2.2.8 if no new Products are found in the EDI Engine Database]. The System checks each record for the UPC/EAN to see if it exists in the BKS Network Database. [See Alternate Flow 2.2.5 if the UPC/EAN already exists in the BKS Network Database] If the Product does not exist in the BKS Network Database, then the new Product is added to the Database. The System also checks if the Trade Name exists in the BKS Network Database. [See Alternate Flow 2.2.6 if the Trade Name does not exist in the BKS Network Database]. The System checks if any data in the record from the EDI Engine Database is missing. The following fields are required:

Customer Name

UPC/EAN

Trade Name (PID-2)

Product ID Description (PID-8)

[See Extension 3.2 if any fields are missing]

The System displays a counter for each x number of Records processed from the EDI Engine Database. The message will display as follows; “x records of [total number of records] processed.” Once all the Records have been processed, the System will check if there are any existing Records found. If there are any existing Records found, the System will display a list of those Records details in one column from the BKS Network Database and the Record details from the EDI Engine Database in a corresponding column with a checkbox in the next column. The User will select those records they wish to overwrite with the data being pulled from the EDI Engine. The User selects those records they wish to overwrite and clicks the ‘Next Button’. [See Alternate Flow 2.2.7 if the User clicks the Back button’. If the User clicks the Next button, the System checks which Records need to be overwritten. If the User did not select any records to be overwritten, then no records will be overwritten, else only those records selected by the User will be overwritten with the Data from the EDI Engine Database. Once this process is complete, the System will check if an error log was created for this Import process. If an error log was created, the System will ask the User if they wish to view the log. If the User wishes to view the log, then the log is displayed to the User. IF the User does not wish to view the log, they are taken to a confirmation page. The System will display the confirmation page detailing the number of records newly imported and the number of records overwritten for the Brand Entity and the list of Trade Names selected by the User.

2.2. Alternate Flows

2.2.1. The System Determines that a Previous Import has been Performed on the Selected Brand Entity.

The System displays a new page (with the User Marquee and the Import Marquee on top) displaying the following message; “An Import has previously been performed on this Brand Entity on [enter date here]. Click ‘Continue’ to proceed with another Import, or click the ‘Cancel’ button to terminate the Import process. If the User clicks on the ‘Continue’ button, then the System proceeds to step 2.1.4 in the Basic Flow, and if the User clicks on the ‘Cancel’ button, then the Use Case ends with the System displaying the Main Page of the Control Panel.

2.2.2. NA

2.2.3. No Products or Trade Names are found in the EDI Engine Database for the Manufacturer The System displays the following message; “No Products or Trade Names were found for your Company. Please contact your Account Manager to ensure your 832 Product/Sales Catalog was correctly sent to BKS Networks.” The page will have a ‘Next’ button. When the User clicks on the ‘Next’ button, the System will take them to the main page in the Control Panel.

2.2.4. The User Clicks the ‘Back’ Button on the Select Trade Names Page

The System returns the User to the initial page of the Import Use Case.

2.2.5. The UPC/EAN of a Product being Imported Already Exists in the BKS Network Database

The System stores the ID of the EDI Engine Database record as well as the ID of the BKS Network Database matching record in the session in the list of existing products.

2.2.6. The Trade Name does not Exist in the BKS Network Database

The System adds the Trade Name as a Trademark to the BKS Network Database. The new Trademark is also associated with all Products whose record contains that Trade Name in the EDI Engine Database. The Brand Entity is also associated with the new Trademark.

2.2.7. The User Clicks the ‘Back’ Button on the Overwrite Records Page

The System returns the User to the initial page of the Import Use Case.

2.2.8. No New Products are Found in the EDI Engine Database

The System displays the following message; “No new Products are available for import. Please contact your Account Manager to ensure that your 832 Product/Sales Catalog was updated and sent to BKS Networks.” The page will have a ‘Next’ button. When the User clicks on the ‘Next’ button, the System will take them to the main page in the Control Panel.

2.3. Exceptions

2.3.1. The User does not Select any Trade Names

The System displays the list of Trade Names once again with the following error message; “You must select at least one Trade Name from the list in order to perform the Import.”

2.3.2. Some Fields are Missing in the Product Record from the EDI Engine Database

The System creates a new file for the errors. The Record ID with the details of the record are written to the file.

2.3.3. The User is not in Operational Mode

The System reloads the first page with the following error message; “You must be in Operational Mode to perform an Import in the System.”

Synchronize Data String Records

1. Synchronize Data String Records

This Use Case allows the User to Synchronize Product data for Products in their Brand Entity in the BKS Network with the EDI Engine.

The User clicks the Synchronize Data String Records sub-menu item under the Manage Product Data Strings menu item in the Brand Information Network Management Control Panel in Brandkey Create™.

2. Flow of Events

2.1. Basic Flow

2.1.1. Synchronize Data String Records

The User clicks the Synchronize Data String Records sub-menu item. The System displays the first page in the Synchronize Data String Records flow. This page contains the User Marquee (see the User Marquee Use Case to see how to populate this. The page also contains the Import Marquee (see the Import Marquee Use Case to see how to populate this). The System confirms with the User whether or not they wish to proceed with the Synchronize for the selected Brand Entity. [See Alternate Flow 2.2.1 if the User does not wish to proceed]. If the User wishes to proceed with the Synchronize, the System then proceeds to the next step. The System checks if the User is in Operational Mode. [See Exception 2.3.3 if the User is not in Operational Mode]. The System will pull all the Products in the EDI Engine Database that belong to the same Manufacturer as the Client of the User who is logged into the BKS Network. From this list of Products, the System will pull the Trade Name for the EDI Engine Database. The System will display the list of unique Trade Names to the User with a checkbox next to each Trade Name. [See Alternate Flow 2.2.3 if no Products or Trade Names are found in the EDI Engine Database for the Manufacturer]. If there are more than 5 entries in the Trade Name list, the list shall be broken up into several “pages”. [See the Record Selector Use Case to set up these pages]. The System will display the following message; “Please select the Trade Name(s) whose Products you wish to synchronize in the BKS Network at this time”. The User will select the Trade Names they wish to Synchronize with. [See Extension 3.1 if the User does not select any Trade Names]. The page will also have a ‘Select All Trade Names’ button. [See Alternate Flow 2.2.2 if the User clicks on the ‘Select All Trade Names’ button]. The User clicks the ‘Back’ button. [See Alternate Flow 2.2.4 if the User clicks the ‘Back’ button]. If the User clicks the ‘Next’ button, then the System pulls in those Products from the EDI Engine Database belonging to the selected Trade Name(s). The System checks each record for the UPC/EAN to see if it exists in the BKS Network Database. [See Alternate Flow 2.2.5 if the UPC/EAN already exists in the BKS Network Database] If the Product does not exist in the BKS Network Database, then the new Product is added to the Database. If the record indicates an UPDATE to an existing Product, then that UPDATE is carried out automatically to the appropriate record. The System also checks if the Trade Name exists in the BKS Network Database. [See Alternate Flow 2.2.6 if the Trade Name does not exist in the BKS Network Database]. The System checks if any data in the record from the EDI Engine Database is missing. The following fields are required:

Customer Name

UPC/EAN

Trade Name (PID-2)

Product ID Description (PID-8)

[See Extension 3.2 if any fields are missing]

The System displays a counter for each x number of Records processed from the EDI Engine Database. The message will display as follows; “x records of [total number of records] processed.” Once all the Records have been processed, the System will check if an error log was created for this Synchronization process. If an error log was created, the System will ask the User if they wish to view the log. If the User wishes to view the log, then the log is displayed to the User. IF the User does not wish to view the log, they are taken to a confirmation page. The System will display the confirmation page detailing the number of records newly added and the number of records overwritten for the Brand Entity and the list of Trade Names selected by the User. The User can click the Finish button to be taken to the main page of the Control Panel and end the Use Case.

2.2. Alternate Flows

2.2.1. The User does not Wish to Proceed with the Synchronize.

The User is taken to the main page of the Control Panel.

2.2.2. The User Clicks on the ‘Select all Trade Names’ Button

The System checks all the Trade Names on the current page and saves the list to the session and then returns to step 2.1.12 in the Basic Flow.

2.2.3. No Products or Trade Names are Found in the EDI Engine Database for the Manufacturer

The System displays the following message; “No Products or Trade Names were found for your Company. Please contact your Account Manager to ensure your 832 Product/Sales Catalog was correctly sent to BKS Networks.” The page will have a ‘Next’ button. When the User clicks on the ‘Next’ button, the System will take them to the main page in the Control Panel.

2.2.4. The User Clicks the ‘Back’ Button on the Select Trade Names Page

The System returns the User to the initial page of the Synchronize Use Case.

2.2.5. The UPC/EAN of a Product being Synchronized Already Exists in the BKS Network Database

If the Record is not an UPDATE record, then no action is taken to change the record in the BKS Network Database.

2.2.6. The Trade Name does not Exist in the BKS Network Database

The System adds the Trade Name as a Trademark to the BKS Network Database. The new Trademark is also associated with all Products whose record contains that Trade Name in the EDI Engine Database. The Brand Entity is also associated with the new Trademark.

2.3. Exceptions

2.3.1. The User does not Select any Trade Names

The System displays the list of Trade Names once again with the following error message; “You must select at least one Trade Name from the list in order to perform the Synchronize.”

2.3.2. Some Fields are Missing in the Product Record from the EDI Engine Database

The System creates a new file for the errors. The Record ID with the details of the record are written to the file.

2.3.3. The User is not in Operational Mode

The System reloads the first page with the following error message; “You must be in Operational Mode to perform an Import in the System.”

Search/Manage Data Link Records

1. Search/Manage Data Link Records

This Use Case allows the User to Search for and Edit Data Link Records, and create Display Schemas for their Branded Products and Services.

The User clicks the Search/Manage Data Link Records sub-menu item under the Manage Product Data Links menu item in the Brand Information Network Management Control Panel in Brandkey Create™.

2. Flow of Events

2.1. Basic Flow

2.1.1. Search/Manage Data Link Records

The User clicks the Search/Manage Data Link Records sub-menu item. The System displays the Search for Product Data String Records page. [The Basic Flow describes the flow for Products. The same basic flow applies for Services with changes to Service Name, USN, SD, etc.]. The User enters the search criteria in the text box and chooses the search parameters from the drop-down list. The search parameters are:

All Products in [enter name of Brand here that was selected previously]

Universal Product Number

Trademark

Product Descriptor

Product Name

The User clicks the Search button to initiate the Product Search. The System checks whether any search criteria has been entered. [See Extension 3.1 if no search criteria has been entered]. The System will take the Search Criteria and Parameters and perform a Product Search in the Database for active records matching the Search Criteria with the supplied Parameters. The records must also have at least one Data Link associated with them in order to qualify for the Search Results. The System will display the Search Results of the Product Search on the Product Search Results page. [If no Products were found see Alternate Flow 2.2.2]. If there are more than 5 Products to be displayed the page will show the Record Navigation Bar below the Search Results table. [See Alternate Flow 2.2.3 for the workings of the Record Navigation Bar]. The User must click on the Universal Product Number to select the Product whose Brand Information Network they wish to edit. When the User clicks on the Universal Product Number the System loads the Edit Product Data Link Records page. The details of the selected Product Data String are displayed at the top of this page so that the User is reminded which Product they are working with. The Product information contains the following items:

Universal Product Number Type

Universal Product Number

Product Descriptor

Product Name

Product Category

Table of Trademarks

Below the Product Information, the page will display a button for the User to click if they wish to view the Brand Resources list. If they press this button, the System displays a new stripped-down browser pop-up with the list of Available Brand Resources pulled from the Database. Below the Brand Resources button, the page will display a table of tabs. The tabs are as follows:

All Active Links

All Inactive Links

All Links

By default the All Active Links tab will be selected.

This page shall have a table containing at most 5 links per page of all Active Links in the Brand Information Network. The table shall consist of the following columns:

URL at Node

Description of Node

Preview Link (button)

Active (checkbox)

The table shall also have a drop-down list of available Languages for the listed Data Links. The User may select a Language from the drop-down list and press the Set button to view links in that language only. The User can deselect any Active checkboxes to deactivate any Data Link Record from the Brand Information Network The User shall click the Update button to save the changes to the Database. If any Link is deactivated, then the System also checks if that Link is part of a Brand Information Network. If it is, then that Link is removed from the Brand Information Network. The System then checks if that was the only Link in that Brand Information Network. If it was, then that Brand Information Network is set to Inactive. The System then checks if that Brand Information Network is assigned to any Virtual Kiosks and if that Brand Information Network is the only one assigned to those Kiosks. If that is the case, then those Virtual Kiosks are also marked as Inactive, and every Installed instance of those Virtual Kiosks are also marked as Inactive. If the User clicks the Preview Link button for any of the links, then the System will open a new pop-up window with the selected link in it. If the User clicks the Back button the System will take the User back to the Search Results page. [See Alternate Flow 2.2.4 if the User clicks the Back button]. The User shall click the Add New button to add a new Data Link for the selected Product or Service. The Create New Data Link Record Use Case is initiated at Basic Flow 2.1.11. If there are more than 5 Data Link Records to be displayed the page will show the Record Navigation Bar below the Search Results table. [See Alternate Flow 2.2.7 for the workings of the Record Navigation Bar]. If the User clicks on the All Inactive Links tab the System will display the list of Data Link Records that are Inactive. [See Alternate Flow 2.2.11 if the User clicks on the All Inactive Links tab]. If the User clicks on the All Links tab the System will display the list of all Data Link Records. [See Alternate Flow 2.2.12 if the User clicks on the All Links tab]. If the User clicks on one of the Links the System shall display the detail page for the selected Link. [See Alternate Flow 2.2.17 if the User clicks on a Link]. The User clicks on the Next button. The System displays the Select Brand Information Network page. On this page, the System displays a list of all Brand Information Networks that have been created by the User. If there are no Brand Information Networks, then the System shall display a message in the table indicating this. The User may click on the Preview button to preview the Brand Information network. [See Alternate Flow 2.2.20 if the User clicks the Preview button]. The User may click the Add New button to add a new Brand Information Network. [See Alternate Flow 2.2.21 if the User clicks the Add New button]. The User may uncheck any Brand Information Network if they wish to deactivate it. The User will click the Update button to save their changes. The changes are saved to the Database and the page is reloaded. The User may click the Description link to edit the Brand Information Network. If the User clicks the link, then the System displays the Edit Brand Information Network page. On this page the System displays the details of the selected Brand Information Network. The User can update the Description of the Brand Information Network. The System also displays the stored Default Image filename pulled from the Database. The User may click the Browse button to upload a new Default Image to be used with the selected Brand Information Network. The System lists all Active Links that belong to the selected Product. The System will also display any Links that have been designated as “Assigned to all Products in Brand”. The User can select other links to add to the Brand Information Network or deselect any links currently on the Brand Information Network. The User clicks the Next button to save the changes. The System checks that the Description has been filled in and that at least one link has been selected for the Brand Information Network. [See Extension 3.6 if the Description has not been filled in]. [See Extension 3.7 if no Links have been selected for the Brand Information Network]. The User clicks on the Next button. The System displays the Select Display Schema page. The page consists of a table of the different display schemas available for the Brand Information Network. This list of schemas is pulled from the Database. The Pre-Post Purchase Display Schema is selected by default. The User selects one Display Schema and clicks the Next button. When the Next button is clicked, the System shall check that one Display Schema has been selected. [See Extension 3.3 if no Display Schema is selected]. [See Alternate Flow 2.2.18 if the User selects Simplex Display Schema]. [See Alternate Flow 2.2.19 if the User selects Complex Display Schema]. If the User clicks the Back button the System takes the User back to the Active Data Links page. [See Alternate Flow 2.2.13 if the User clicks on the Back button]. The User clicks the Next button The System displays the Customize Display Schema for the Pre-Post Purchase Display Schema. The Customize Display Schema has the following attributes:

A textbox for the Title Text

A drop-down list for the Background Color

A drop-down list for the Node Label Font

A drop-down list for the Node Label Font Color

The User shall select each item to customize their Display Schema and click the Next button to save their changes to the Database. If the User clicks the Browse button the System shall allow them to upload an image file. [See Alternate Flow 2.2.14 if the User clicks on the Browse button]. The User clicks the Next button to save their changes to the Database. If the User clicks the Back button, the System returns the User to the Select Display Schema page. [See Alternate Flow 2.2.15 if the User clicks on the Back button]. The User clicks the Next button The System displays the Confirm Display Schema page. The Systems displays the Display Schema on this page. The user shall review the Display Schema and click the Confirm button if it is acceptable or the Edit button to return to the Customize Display Schema page to modify the Display Schema further. If the User clicks the Edit button, the System shall take the User to the Customize Display Schema page. [See Alternate Flow 2.2.16 if the User clicks the Edit button]. If the User clicks the Confirm button, the System takes the User to the first page of the Use Case.

2.2. Alternate Flows

2.2.1. NA

2.2.2. No Search Results were Found to Display on the Search Results Page. [See Alternate Flow

2.2.2.1 for no Products Found and See Alternate Flow 2.2.2.2 for No Services Found].

No Products found in the Product Search.

The System will display the Search Results page with a message saying; “No Products were found matching your search criteria.”

No Products found in the Service Search.

The System will display the Search Results page with a message saying; “No Services were found matching your search criteria.”

2.2.3. More than 5 Records in the Search Results Page Results in the Display of the Record Navigation Bar.

If there are more than 5 records (Product or Service), then the Search Results page shall display the Record Navigation Bar below the table. The Search Results table shall display only 5 records at one time. The Record Navigation Bar shall display the number of pages of Records there are. The Double arrows shall take the User either to the last page (right double arrows) or to the first page (left double arrows). The single arrows shall take the user to the next page (right single arrow) or to the previous page (left single arrow). The User can also click on the page number to jump directly to that page of Search Results.

2.2.4. User Clicks the Back Button on the Edit Data Link Record Page.

User clicks on the Back button The System takes the User back to the Product Search Results page.

2.2.5. User Clicks the Browse Button at the Graphic Image Supported at Node Row.

The System displays an Operating System-defined Browse dialog box. The User shall use this dialog box to browse for the image file they wish to upload from their machine to the System. The System shall accept the file the User wishes to upload and stores the file information in the table in preparation for uploading when the form is Updated.

2.2.6. User Clicks the Browse Button at the Sound File Supported at Node Row.

The System displays an Operating System-defined Browse dialog box. The User shall use this dialog box to browse for the image file they wish to upload from their machine to the System. The System shall accept the file the User wishes to upload and stores the file information in the table in preparation for uploading when the form is Updated.

2.2.7. NA

2.2.8. NA

2.2.9. NA

2.2.10. NA

2.2.11. User Clicks on the all Inactive Links Tab

The System shall display the Inactive Links page. The page will display a button for the User to click if they wish to view the Brand Resources page as provided by their content management system for the Brand. The link is pulled from the Database. If there is a link in the database, the button is shown, otherwise it is not shown on this page. This page shall have a table containing at most 5 links per page of all Inactive Links in the Brand Information Network. The table shall consist of the following columns:

URL at Node

Description of Node

Preview Link (button)

Active (checkbox)

The table shall also have a drop-down list of available Languages for the listed Data Links. The User may select a Language from the drop-down list and press the Set button to view links in that language only. The User can deselect any Active checkboxes to deactivate any Data Link Record from the Brand Information Network The User shall click the Update button to save the changes to the Database If the User clicks the Back button the System will take the User back to the Search Results page. [See Alternate Flow 2.2.4 if the User clicks the Back button]. If there are more than 5 Data Link Records to be displayed the page will show the Record Navigation Bar below the Search Results table. [See Alternate Flow 2.2.7 for the workings of the Record Navigation Bar]. If the User clicks on the All Active Links tab the System will display the list of Data Link Records that are Inactive. [See Basic Flow if the User clicks on the All Active Links tab]. If the User clicks on the All Links tab the System will display the list of all Data Link Records. [See Alternate Flow 2.2.12 if the User clicks on the All Links tab]. If the User clicks on one of the Links the System shall display the detail page for the selected Link. [See Alternate Flow 2.2.17 if the User clicks on a Link]. If the User clicks on the Preview Link button for any link, then the System will display a pop-up window with the link loaded in it. The User clicks on the Next button.

2.2.12. User Clicks on the all Links Tab

The System shall display the Data Links page. The page will display a button for the User to click if they wish to view the Brand Resources page as provided by their content management system for the Brand. The link is pulled from the Database. If there is a link in the database, the button is shown, otherwise it is not shown on this page. This page shall have a table containing at most 5 links per page of All Links in the Brand Information Network. The table shall consist of the following columns:

URL at Node

Description of Node

Preview Link (button)

Active (checkbox)

The table shall also have a drop-down list of available Languages for the listed Data Links. The User may select a Language from the drop-down list and press the Set button to view links in that language only. The User can deselect any Active checkboxes to deactivate any Data Link Record from the Brand Information Network The User shall click the Update button to save the changes to the Database If the User clicks the Back button the System will take the User back to the Search Results page. [See Alternate Flow 2.2.4 if the User clicks the Back button]. If there are more than 5 Data Link Records to be displayed the page will show the Record Navigation Bar below the Search Results table. [See Alternate Flow 2.2.7 for the workings of the Record Navigation Bar]. If the User clicks on the All Inactive Links tab the System will display the list of Data Link Records that are Inactive. [See Alternate Flow 2.2.11 if the User clicks on the All Inactive Links tab]. If the User clicks on the All Active Links tab the System will display the list of all Data Link Records. [See Basic Flow if the User clicks on the All Active Links tab]. If the User clicks on one of the Links the System shall display the detail page for the selected Link. [See Alternate Flow 2.2.17 if the User clicks on a Link]. If the User clicks on the Preview Link button for any link, then the System will display a pop-up window with the link loaded in it. The User clicks on the Next button.

2.2.13. User Clicks the Back Button on the Select Display Schema Page.

User clicks on the Back button The System takes the User back to the Active Data Link Records page.

2.2.14. User Clicks the Browse Button on the Customize Display Schema Page.

The System displays an Operating System-defined Browse dialog box. The User shall use this dialog box to browse for the image file they wish to upload from their machine to the System. The System shall accept the file the User wishes to upload and stores the file information in the table in preparation for uploading when the form is Updated.

2.2.15. User Clicks the Back Button on the Customize Display Schema Page.

User clicks on the Back button The System takes the User back to the Select Display Schema page.

2.2.16. User Clicks the Edit Button on the Confirm Display Schema Page.

User clicks on the Edit button The System takes the User back to the Customize Display Schema page.

2.2.17. User Clicks on a Link

The page will display a button for the User to click if they wish to view the Brand Resources page as provided by their content management system for the Brand. The link is pulled from the Database. If there is a link in the database, the button is shown, otherwise it is not shown on this page. The System will display a table containing those Brandkey Indices as were set during the Configuration of this Control Panel. The list of Indices is pulled from the Database. The default values for those indices are also pulled from the Database. The following table rows are required:

Text-box for URL at Node (first row in table)

Textarea for Description of Node (second row in table)

Checkbox for Active Node (last row in table)

The values for these two rows are also pulled from the Database.

The User may make any changes to the Data Link record they wish and click the Update button to save the changes to the Database. If the User clicks the Back button the System will take the User back to the page from where they selected the Link to view in detail mode. If the User clicks the Browse button to add an image file for the node, the System will allow the User to upload an image file. [See Alternate Flow 2.2.5 if the User clicks the Graphic Image Supported at Node Browse button]. If the User clicks the Browse button to add a sound file for the node, the System will allow the User to upload a sound file. [See Alternate Flow 2.2.6 if the User clicks the Sound File Supported at Node Browse button]. If the User clicks on the Update button, the System shall check that all required fields are filled in. The required fields on this form are:

URL at Node

Description of Node

Active

[See Extension 3.2 if the required fields are not filled in].

The User shall click the Update button to save the changes to the Database. If the Link is changed from having the “Available to all Products in Brand” index marked as “Yes” to being marked as “No”, then the System also checks if that Link is part of any Brand Information Networks belonging to different Products in the Brand. If it is, then that Link is removed from those Brand Information Networks. The System then checks if that was the only Link in those Brand Information Networks. If it was, then those Brand Information Networks are set to Inactive. The System then checks if those Brand Information Networks are assigned to any Virtual Kiosks and if those Brand Information Networks is the only ones assigned to those Kiosks. If that is the case, then those Virtual Kiosks are also marked as Inactive, and every Installed instance of those Virtual Kiosks are also marked as Inactive.

2.2.18. NA

2.2.19. NA

2.2.20. User Clicks the Preview Button on the Select Brand Information Network Page

The System displays the preview of the Brand Information Network selected by the User. The User clicks the Next button to return to the Select Brand Information Network page.

2.2.21. The User Clicks the Add New Button on the Select Brand Information Network Page.

The System displays the Add New Brand Information Network page. The User can enter the Description of the new Brand Information Network. The System also displays the stored Default Image filename pulled from the Database. The User may click the Browse button to upload a new Default Image to be used with the selected Brand Information Network. The System lists all Active Links that belong to the selected Product. The System will also display any Links that have been designated as “Assigned to all Products in Brand”. The User can select other links to add to the Brand Information Network. The User clicks the Next button to save the new Brand Information Network. The System checks that the Description has been filled in and that at least one link has been selected for the Brand Information Network. [See Extension 3.6 if the Description has not been filled in]. [See Extension 3.7 if no Links have been selected for the Brand Information Network]. The User clicks on the Next button.

2.3. Exceptions

2.3.1. No Search Criteria has been Entered in the Search for Data String Records Page. [See 3.1.1 for this error in Product Data String Records Page and See 3.1.2 for this Error in Service Data String Records Page].

Product Data String Records page.

The User did not enter any Search Criteria in the Search for Product Data String Records page. The System displays an error message saying; “You must enter some criteria to search for Products.” The System displays the Product Search page with the above error message.

Service Data String Records page.

The User did not enter any Search Criteria in the Search for Service Data String Records page. The System displays an error message saying; “You must enter some criteria to search for Services.” The System displays the Service Search page with the above error message.

2.3.2. The Required Fields are not Filled in on the Data Link Record Page.

The User did not fill in all the required fields on the Data Link Record page. The System displays an error message saying; “You must enter data for all required fields for the selected Data Link Record”. The System displays the Data Link Record page with the above error message.

2.3.3. No Display Schema is Selected on the Select Display Schema Page.

The User does not select any Display Schema on the Select Display Schema page. The System displays an error message saying; “You must select a Display Schema in order to Configure the Brand Information Network.” The System displays the Select Display Schema page with the error message.

2.3.4. The User does not Select a Display Schema Template.

The User does not select a Display Schema Template on the Select Display Schema Template page. The System displays an error message saying; “You must select a Display Schema Template for the Brand Information Network you are editing.” The System displays the Select Display Schema Template page with the error message.

2.3.5. The User Selects a Link to be Displayed on More than One Node in the Display Schema.

The User selects a link to be displayed on more than one mode in the Display Schema. The System displays an error message saying; “You have selected a link to be displayed on more than one Node in the Display Schema. Please change the link either at these Nodes to display different links.” The System displays the Configure Display Schema page with the error message.

2.3.6. No Description has been Filled in for the Brand Information Network.

The User has not filled in a description for the Brand Information Network. The System displays an error message saying; “You must fill in a description for the Brand Information Network.” The System displays the page with the error message.

2.3.7. No Links are Selected for the Brand Information Network.

The User has not selected any links for the Brand Information Network. The System displays and error message saying; “You must select at least one link for the Brand Information Network.” The System displays the page with the error message.

Web Hosting

1. Web Hosting

This Use Case describes how a user can optionally select BKS Networks as the web host for their Branded Products and Services.

The user clicks the “Add Data Link” button in the “Data Link Master” web page followed by selecting the “Host this resource with BKS Networks, Inc.” radio button in the “Select Web Hosting Location” page.

2. Flow of Events

2.1. Basic Flow

2.1.1. Upload a Brand Resource File

From the “Data Link Master” page, the user clicks the “Add Data Link” button. The system shall display the “Select Web Hosting Location” page. The page shall display two radio buttons grouped together with the following labels: “This resource is hosted elsewhere” and “Host this resource with BKS Networks, Inc.” The system shall display the radio button labeled “This resource is hosted elsewhere” as the default (checked). On the “Select Web Hosting Location” page, the user selects the “Host this resource with BKS Networks, Inc.” radio button followed by the “Next” button. The system shall display the “Add Data Link” page. The “Add Data Link” page shall display all the fields as described in the Brandkey Create Search/Manage Data Link Records document. A text field labeled, “Brand Resource File:” combined with a “Browse” button, however, replaces the “URL at Node” field. When the user clicks the “Browse” button, a File Upload Dialog Box will display on the screen. The user will locate on their local machine or local network drive any image file, PDF file, video file, or any other potential resource file via the File Upload Dialog Box. When the user has selected a file to upload, the path and file name are displayed in the text field. When the other pertinent fields are completed, the user then clicks the “Add” button to start the actual upload process and save process. If there are no errors while uploading the brand resource file to the server or saving the record, the system shall display the “Data Link Master” page populated with the URL for the uploaded brand resource.

2.2. Alternate Flows

2.2.1. Default Radio Button is Selected

The “This resource is hosted elsewhere” radio button is selected followed by the “Next” button on the “Select Web Hosting Location” page. The system shall display the “Add Data Link” page with the “URL at Node:” text field empty.

2.2.2. Go Back

If the user clicks the “Back” button on the “Select Web Hosting Location” page, the system shall display the “Data Link Master” page.

2.3. Exceptions

2.3.1. No Brand Resource File Uploaded

If the user clicks the “Add” button on the “Add Data Link” page without selecting a file, the system shall display the error message, “No brand resource file uploaded.” on the “Add Data Link” page.

2.3.2. Error Encountered while Uploading

If an error is encountered while uploading the brand resource file, the system shall display the generic error message, “Error uploading brand resource file” on the “Add Data Link” page.

Create New Data Link Records

1. Create New Data Link Records

This Use Case allows the User to Create New Data Link Records.

The User clicks the Create New Data Link Records sub-menu item under the Manage Product Data Links menu item in the Brand Information Network Management Control Panel in Brandkey Create™.

2. Flow of Events

2.1. Basic Flow

2.1.1. Create New Data Link Records

The User clicks the Search/Manage Data Link Records sub-menu item. The System displays the Search for Product Data String Records page. [The Basic Flow describes the flow for Products. See Alternate Flow 2.2.1 for the flow for Services]. The User enters the search criteria in the text box and chooses the search parameters from the drop-down list. The search parameters are:

Universal Product Number

Trademark

Product Descriptor

Brand Entity

Product Name

The User clicks the Search button to initiate the Product Search. The System checks whether any search criteria has been entered. [See Extension 3.1 if no search criteria has been entered]. The System will take the Search Criteria and Parameters and perform a Product Search in the Database for active records matching the Search Criteria with the supplied Parameters. The records must also have no Data Links associated with them in order to qualify for the Search Results. The System will display the Search Results of the Product Search on the Product Search Results page. [If no Products were found see Alternate Flow 2.2.2]. If there are more than 5 Products to be displayed the page will show the Record Navigation Bar below the Search Results table. [See Alternate Flow 2.2.3 for the workings of the Record Navigation Bar]. The User must click on the Universal Product Number to select the Product for who they wish to add a new Product Data Link. When the User clicks on the Universal Product Number, the System loads the Select Link Type page. On this page the System displays two radio buttons for the User to choose one. The radio buttons are for Hosted Link and Unhosted Link. If the User selects Hosted link, the Use Case proceeds to Basic Flow 2.1.11. If the User selects Unhosted, then the Upload Brand Resource page is loaded and the Upload Brand Resource Use Case is initiated. When the User selects the Hosted Link option, the System loads the Add New Product Data Link Records page. The details of the selected Product Data String are displayed at the top of this page so that the User is reminded which Product they are working with. The Product information contains the following items:

Universal Product Number

Product Descriptor

Product Name

Product Category

Table of Trademarks

The table under the Product Information will contain those Brandkey Indices as were set during the Configuration of this Control Panel. The list of Indices is pulled from the Database. The default values for those indices are also pulled from the Database. The following table rows are required:

Text-box for URL at Node (first row in table)

Textarea for Description of Node (second row in table)

Checkbox for Active Node (last row in table)

The values for these two rows are also pulled from the Database.

Just above the table there will be a button to view the Available Brand Resources page as pulled from the content management system for the Brand. If the User clicks on this button, the System displays a new stripped-down browser pop-up window with the list of Available Brand Resources pulled from the Database. The User may enter the information required for the new Data Link record and click the Add button to add the new Data Link Record to the Database. If the User clicks the Browse button to add and image file for the node, the System will allow the User to upload an image file. [See Alternate Flow 2.2.4 if the User clicks the Graphic Image Supported at Node Browse button]. If the User clicks the Browse button to add a sound file for the node, the System will allow the User to upload a sound file. [See Alternate Flow 2.2.5 if the User clicks the Sound File Supported at Node Browse button]. The User shall click the Add button to save the changes to the Data Link Record to the Database. The System shall check that all required fields are filled in. The required fields on this form are:

URL at Node

Description of Node

Active

[See Extension 3.2 if the required fields are not filled in].

If the System saves the information correctly to the Database then the System shall display the Edit Data Link Record page. The BKS USE CASE FOR BRANDKEY CREATE—BKNM CONTROL PANEL—SEARCH-MANAGE DATA LINK RECORDS shall now take over from 2.1.11 of the Basic Flow.

2.2. Alternate Flows

2.2.1. The User has Previously Selected a Service Brand Entity. The System Displays the Service Data String Records Page.

The User enters the search criteria in the text box and chooses the search parameters from the drop-down list. The search parameters are:

Universal Service Number

Servicemark

Service Descriptor

Brand Entity

Service Name

The User clicks the Search button to initiate the Service Search. The System checks whether any search criteria has been entered. [See Extension 3.1 if no search criteria has been entered]. The System will take the Search Criteria and Parameters and perform a Service Search in the Database for active records matching the Search Criteria with the supplied Parameters. The records must also have at least one Data Link associated with them in order to qualify for the Search Results. The System will display the Search Results of the Service Search on the Service Search Results page. [If no Services were found see Alternate Flow 2.2.2]. If there are more than 5 Services to be displayed the page will show the Record Navigation Bar below the Search Results table. [See Alternate Flow 2.2.3 for the workings of the Record Navigation Bar]. The User must click on the Universal Product Number to select the Product whose Brand Information Network they wish to edit. When the User clicks on the Universal Service Number, the System loads the Select Link Type page. On this page the System displays two radio buttons for the User to choose one. The radio buttons are for Hosted Link and Unhosted Link. If the User selects Hosted link, the Use Case proceeds to Basic Flow 2.1.11. If the User selects Unhosted, then the Upload Brand Resource page is loaded and the Upload Brand Resource Use Case is initiated. When the User clicks selects the Hosted Link option, the System loads the Add New Service Data Link Records page. The details of the selected Service Data String are displayed at the top of this page so that the User is reminded which Service they are working with. The Service information contains the following items:

Universal Service Number

Service Descriptor

Service Name

Service Category

Table of Servicemarks

The table under the Service Information will contain those Brandkey Indices as were set during the Configuration of this Control Panel. The list of Indices is pulled from the Database. The default values for those indices are also pulled from the Database. The following table rows are required:

Text-box for URL at Node (first row in table)

Textarea for Description of Node (second row in table)

Checkbox for Active Node (last row in table)

The values for these two rows are also pulled from the Database.

Just above the table there will be a button to view the Available Brand Resources page as pulled from the content management system for the Brand. The System checks in the database to see if this link is there. If it is not, then this button is not displayed, if it is then the button is displayed. The User clicks on the button to open a new pop-up window with the link loaded in it. The User may enter the information required to the new Data Link record and click the Add button to add the new Data Link Record to the Database. If the User clicks the Browse button to add an image file for the node, the System will allow the User to upload an image file. [See Alternate Flow 2.2.4 if the User clicks the Graphic Image Supported at Node Browse button]. If the User clicks the Browse button to add a sound file for the node, the System will allow the User to upload a sound file. [See Alternate Flow 2.2.5 if the User clicks the Sound File Supported at Node Browse button]. The User shall click the Add button to save the changes to the Data Link Record to the Database. The System shall check that all required fields are filled in. The required fields on this form are:

URL at Node

Description of Node

Active

[See Extension 3.2 if the required field is not filled in].

If the System saves the information correctly to the Database then the System shall display the Edit Data Link Record page. The BKS USE CASE FOR BRANDKEY CREATE—BKNM CONTROL PANEL—SEARCH-MANAGE DATA LINK RECORDS shall now take over from 2.1.11 of the Basic Flow.

2.2.2. No Search Results were Found to Display on the Search Results Page. [See Alternate Flow 2.2.2.1 for no Products Found and See Alternate Flow 2.2.2.2 for No Services Found].

No Products found in the Product Search.

The System will display the Search Results page with a message saying; “No Products were found matching your search criteria.”

No Services found in the Service Search.

The System will display the Search Results page with a message saying; “No Services were found matching your search criteria.”

2.2.3. More than 5 Records in the Search Results Page Results in the Display of the Record Navigation Bar.

If there are more than 5 records (Product or Service), then the Search Results page shall display the Record Navigation Bar below the table. The Search Results table shall display only 5 records at one time. The Record Navigation Bar shall display the number of pages of Records there are. The Double arrows shall take the User either to the last page (right double arrows) or to the first page (left double arrows). The single arrows shall take the user to the next page (right single arrow) or to the previous page (left single arrow). The User can also click on the page number to jump directly to that page of Search Results.

2.2.4. User Clicks the Browse Button at the Graphic Image Supported at Node Row.

The System displays an Operating System-defined Browse dialog box. The User shall use this dialog box to browse for the image file they wish to upload from their machine to the System. The System shall accept the file the User wishes to upload and stores the file information in the table in preparation for uploading when the form is Updated.

2.2.5. User Clicks the Browse Button at the Sound File Supported at Node Row.

The System displays an Operating System-defined Browse dialog box. The User shall use this dialog box to browse for the image file they wish to upload from their machine to the System. The System shall accept the file the User wishes to upload and stores the file information in the table in preparation for uploading when the form is Updated.

2.2.6. More than 1 Record in the Active Data Links Page Results in the Display of the Record Navigation Bar.

If there is more than 1 record, then the Active Data Links page shall display the Record Navigation Bar below the table. The Active Data Links table shall display only 1 record at one time. The Record Navigation Bar shall display the number of pages of Records there are. The Double arrows shall take the User either to the last page (right double arrows), to add a new Data Link Record [See Alternate Flow 2.2.8], or to the first page (left double arrows). The single arrows shall take the user to the next page (right single arrow) or to the previous page (left single arrow). The User can also click on the page number to jump directly to that page of Search Results.

2.3. Exceptions

2.3.1. No Search Criteria has been Entered in the Search for Data String Records Page. [See 3.1.1 for this error in Product Data String Records Page and See 3.1.2 for this Error in Service Data String Records Page].

Product Data String Records page.

The User did not enter any Search Criteria in the Search for Product Data String Records page. The System displays an error message saying; “You must enter some criteria to search for Products.” The System displays the Product Search page with the above error message.

Service Data String Records page.

The User did not enter any Search Criteria in the Search for Service Data String Records page. The System displays an error message saying; “You must enter some criteria to search for Services.” The System displays the Service Search page with the above error message.

2.3.2. The Required Fields are not Filled in on the Data Link Record Page.

The User did not fill in all the required fields on the Data Link Record page. The System displays an error message saying; “You must enter data for all required fields for the new Data Link Record”. The System displays the Data Link Record page with the above error message.

Brandkey Deliver Subsystem Level Services

Virtual Kiosk Generation Suite (See FIG. 9a)

Control Panel for Generating Product-Specific Virtual Kiosks (See FIGS. 9b Through 9g)

Set Standard Configuration

1. Set Standard Configuration

This Use Case allows the User to set the standard Configuration options for the Product-Specific Virtual Kiosks to be created using this Control Panel.

The User clicks on the Configure P-S Virtual Kiosks top menu item in the Product-Specific Virtual Kiosks Control Panel and then the Set Standard Configuration sub-menu item.

2. Flow of Events

2.1. Basic Flow

2.1.1. Set Standard Configuration

The User clicks on the Set Standard Configuration sub-menu item. The System displays the Set Standard Configuration page. If a record is found for the Client Account and Virtual Kiosk Type in AllowConsumerInstallation Table, the answer is set as “YES”. Otherwise, the answer is set as “NO”. The User updates the standard configuration options if they wish to and clicks the Next button. The System saves the information to the Database and displays the Set Allowed Retailers page. [See Set Allowed Retailers Use Case].

2.2. Exceptions

Set Allowed Retailers

1. Set Allowed Retailers

This Use Case allows the User to set the list of Retailers who will be allowed to install the Product-Specific Virtual Kiosks to be created using this Control Panel.

The User clicks the Next button on the Set Standard Configuration page in the Deliver Generation Suite, under the Configure P-S Virtual Kiosks menu or clicks on the Set Allowed Retailers sub-menu item.

2. Flow of Events

2.1. Basic Flow

2.1.1. Set Allowed Retailers

The User clicks on the Next button in the Set Standard Configuration page. The System displays the Set Allowed Retailers page. The System displays the list of Retailers that have been allowed to install the Product-Specific Virtual Kiosks. The System pulls the list from the Database. [See Alternate Flow 2.2.1 if no Retailers have been previously set]. The table of Retailers consists of the following columns:

Retailer Name

City

State

Zip/Postal Code

Country

Allow (checkbox)

All Active Retailers will have their Active checkboxes checked by default. The User will change the information in the tables, making some Retailers Inactive by unchecking their Active checkbox and making others Active by checking their Active checkbox. The User clicks on the Next button to save the changes and move on to the next page. The System displays the Set Allowed Industrialists page. The Set Allowed Industrialists Use Case is initiated. [See Alternate Flow 2.2.2 if the User presses the Back button]. [See Alternate Flow 2.2.3 if the User presses the Add Retailers button].

2.2. Alternate Flows

2.2.1. No List of Retailers has Previously been Set.

They System displays an empty table with the following message; “There are no Allowed Retailers currently set. Please click the Add Retailers button to set some Allowed Retailers.”

2.2.2. The User Presses the Back Button.

The System displays the Set Standard Configuration page. The Set Standard Configuration Use Case is initiated.

2.2.3. The User Presses the Add Retailers Button.

The System displays the Search for Retailers page The User enters the search criteria for the Retailers they wish to search for. The User clicks the Search button to initiate the Retailer Search. [See Alternate Flow 2.2.4 if the User clicks the Back button]. The System searches for active Retailers in the Database that match the search criteria entered by the User and that have not already been selected as Allowed Retailers for this Client Account and Virtual Kiosk Type. The System displays the Retailer Search Results page. The User selects the Retailers to add to the list of Allowed Retailers by checking the Select checkbox. The User clicks the Add button to save the list of Retailers to the Database and return to the original Set Allowed Retailers page. [See Alternate Flow 2.2.5 if the User clicks the Back button]. The System saves the list of Retailers to the Database. The System displays the Set Allowed Retailers page with the updated list of Allowed Retailers.

2.2.4. The User Clicks the Back Button on the Retailer Search Page.

The System returns the User to the Set Allowed Retailers page.

2.2.5. The User Clicks the Back Button on the Retailer Search Results Page.

The System returns the User to the Retailers Search page.

2.3. Exceptions

Set Allowed Industrialists

1. Set Allowed Industrialists

This Use Case allows the User to set the list of Industrialists who will be allowed to install the Product-Specific Virtual Kiosks to be created using this Control Panel.

The User clicks the Next button on the Set Allowed Retailers page in the Deliver Generation Suite, under the Configure P-S Virtual Kiosks menu or clicks on the Set Allowed Industrialists sub-menu item.

2. Flow of Events

2.1. Basic Flow

2.1.1. Set Allowed Industrialists

The User clicks on the Next button in the Set Allowed Retailers page. The System displays the Set Allowed Industrialists page. The System displays the list of Industrialists that have been allowed to install the Product-Specific Virtual Kiosks. The System pulls the list from the Database. [See Alternate Flow 2.2.1 if no Industrialists have been previously set). The table of Industrialists consists of the following columns:

Industrialist Name

City

State

Zip/Postal Code

Country

Allow (checkbox)

All Active Industrialists will have their Active checkboxes checked by default. The User will change the information in the tables, making some Industrialists Inactive by unchecking their Active checkbox and making others Active by checking their Active checkbox. The User clicks on the Next button to save the changes and move on to the next page. The System displays the Set Forbidden Domains page. The Set Forbidden Domains Use Case is initiated. [See Alternate Flow 2.2.2 if the User presses the Back button]. [See Alternate Flow 2.2.3 if the User presses the Add Industrialists button].

2.1.2. Alternate Flows

2.1.2.1. No List of Industrialists has Previously been Set.

They System displays an empty table with the following message; “There are no Allowed Industrialists currently set. Please click the Add Industrialists button to set some Allowed Industrialists.”

2.1.2.2. The User Presses the Back Button.

The System displays the Set Allowed Retailer page. The Set Allowed Retailer Use Case is initiated.

2.1.2.3. The User Presses the Add Industrialists Button.

The System displays the Search for Industrialists page The User enters the search criteria for the Industrialists they wish to search for. [See Extension 3.1 if the User does not enter any Search Criteria]. The User clicks the Search button to initiate the Industrialist Search. [See Alternate Flow 2.2.4 if the User clicks the Back button]. The System searches for active Industrialists in the Database that match the search criteria entered by the User and that have not already been selected as Allowed Industrialists for this Client Account and Virtual Kiosk Type. The System displays the Industrialist Search Results page. The User selects the Industrialists to add to the list of Allowed Industrialists by checking the Select checkbox. The User clicks the Add button to save the list of Industrialists to the Database and return to the original Set Allowed Industrialists page. [See Alternate Flow 2.2.5 if the User clicks the Back button]. The System saves the list of Industrialists to the Database. The System displays the Set Allowed Industrialists page with the updated list of Allowed Industrialists.

2.1.2.4. The User Clicks the Back Button on the Industrialist Search Page.

The System returns the User to the Set Allowed Industrialists page.

2.1.2.5. The User Clicks the Back Button on the Industrialist Search Results Page.

The System returns the User to the Industrialists Search page.

2.2. Exceptions

2.2.1. The User does not Enter any Search Criteria

The System checks that some Search Criteria has been entered by the User for the Industrialist Search. The System displays the following message; “You must enter some Search Criteria to initiate the Industrialist Search.”

Set Forbidden Domains

1. Set Forbidden Domains

This Use Case allows the User to set the list of Domains from which the Product-Specific Virtual Kiosks to be created using this Control Panel will not be launched to launch.

The User clicks the Next button on the Set Allowed Industrialists page in the Deliver Generation Suite, under the Configure P-S Virtual Kiosks menu or clicks on the Set Forbidden Domains sub-menu item.

2. Flow of Events

2.1. Basic Flow

2.1.1. Set Forbidden Domains

The User clicks on the Next button in the Set Allowed Industrialists page. The System displays the Set Forbidden Domains page. The System displays the list of Forbidden Domains that will not be allowed to launch the Product-Specific Virtual Kiosks. The System pulls the list from the Database. [See Alternate Flow 2.2.1 if no Domains have been previously set]. The table of Forbidden Domains consists of the following columns:

Root Domain Name

Forbidden (checkbox)

All Forbidden Domains will have their Forbidden checkboxes checked by default. The User will change the information in the tables, making some Domains no longer Forbidden by unchecking their Forbidden checkbox and making others Forbidden by checking their Forbidden checkbox. The User clicks on the Finish button to save the changes and move on to the next page. The System displays the main page of the Product-Specific Virtual Kiosk Control Panel. [See Alternate Flow 2.2.2 if the User presses the Back button]. [See Alternate Flow 2.2.3 if the User presses the Add Domain button].

2.2. Alternate Flows

2.2.1. No List of Forbidden Domains has Previously been Set.

They System displays an empty table with the following message; “There are no Forbidden Domains currently set. Please click the Add Domains button to set some Forbidden Domains.”

2.2.2. The User Presses the Back Button.

The System displays the Set Allowed Industrialists page. The Set Allowed Industrialists Use Case is initiated.

2.2.3. The User Presses the Add Domains Button.

The System displays the Add Forbidden Domain page The User enters the Domain they wish to add to the Forbidden Domains list The User clicks the Add button to add the Domain to the list of Forbidden Domains. [See Alternate Flow 2.2.4 if the User clicks the Back button]. The System adds the entered Domain to the list of Forbidden Domains in the Database. The System displays the Set Forbidden Domains page with the updated list of Allowed Retailers.

2.2.4. The User Clicks the Back Button on the Retailer Search Page.

The System returns the User to the Set Forbidden Domains page.

2.3. Exceptions

Select Virtual Kiosk

1. Select Virtual Kiosk

The Use Case allows the User to select the Product-Specific Virtual Kiosk they wish to modify.

The User clicks the Modify Product-Specific Virtual Kiosks menu item.

2. Flow of Events

2.1. Basic Flow

2.1.1. Select Virtual Kiosk

The System loads the Select Virtual Kiosk page. The System populates the table with the list of all Virtual Kiosks created by the Client Account selected by the User when they logged in. The list of Virtual Kiosks will be sorted by Name first, then by Serial Number. All Virtual Kiosks for the Client Account will be pulled from the Database, whether Deployed or not, Active or not. The Navigation Bar is displayed if there are more than 5 Virtual Kiosks to be displayed in the table (see navigationBar Use Case). [See Alternate Flow 2.2.1 if no Virtual Kiosks are found]. The User clicks on an Edit button for the Virtual Kiosk they wish to modify. The virtualKioskID of the selected Virtual Kiosk is saved to the session. The setDisplayMode Use Case is initiated.

2.2. Alternate Flows

2.2.1. No Virtual Kiosks are Found.

The System displays the Select Virtual Kiosk page with the following message in the table; “No records found.”

2.2.2. The Add Virtual Kiosk Button is Clicked

The System loads the Set Display Mode page for a new Virtual Kiosk. The setDisplayMode Use Case is initiated and the Add New Virtual Kiosk Alternate Flow is followed.

2.3. Exceptions

Set Display Mode

1. Set Display Mode

The Use Case allows the User to set the Display Mode settings of the selected Product-Specific Virtual Kiosk.

The User clicks on a Virtual Kiosk Serial Number link on the Select Virtual Kiosk page to select that Virtual Kiosk to modify.

2. Flow of Events

2.1. Basic Flow

2.1.1. Set Display Mode for Edited Virtual Kiosk

The System loads the Set Display Mode page. The page has a list of the active Display Modes in a table. The System shall display the currently selected Virtual Kiosk information on the page also. The System pulls the information for the selected Virtual Kiosk from the Database for what Display Modes were selected and in what order when the Virtual Kiosk was created. The System shall populate the table accordingly. The User shall select or deselect any Display Mode they wish. The User shall set the Display Order for any Display Mode they wish. The User shall click the Next button to save their changes. The System shall check that at least one Display Mode has been selected. [See Exception 2.3.1 if no Display Modes are selected]. If each selected Display Mode is assigned a Display Order, then the System checks that no Display Order is duplicated for any selected Display Mode. [See Exception 2.3.2 if any Display Order is used on multiple selected Display Modes]. If each selected Display Mode is assigned a unique Display Order, then the System checks that all assigned Display Orders are consecutive. [See Exception 2.3.3 if the assigned Display Orders are not consecutive]. If all the above checks are passed then the System saves the changes to the Database. The setVirtualKioskName Use Case is initiated.

2.2. Alternate Flows

2.2.1. The Back Button is Pressed

The System loads the Select Virtual Kiosk page. All changes made on this page are discarded. The selected Virtual Kiosk is deleted from the session. The selectVirtualKiosk Use Case is initiated.

2.2.2. Set Display Mode for New Virtual Kiosk

The System loads the Set Display Mode page. The page has a list of the active Display Modes in a table. The System shall pull the list of active Display Modes from the Database. The System shall display a line stating a new Virtual Kiosk is being created. The User shall select any Display Mode they wish. The User shall set the Display Order for any Display Mode they wish. The User shall click the Next button to save their choices. The System shall check that at least one Display Mode has been selected. [See Exception 2.3.1 if no Display Modes are selected]. If each selected Display Mode is assigned a Display Order, then the System checks that no Display Order is duplicated for any selected Display Mode. [See Exception 2.3.2 if any Display Order is sued on multiple selected Display Modes]. If each selected Display Mode is assigned a unique Display Order, then the System checks that all assigned Display Orders are consecutive. [See Exception 2.3.3 if the assigned Display Orders are not consecutive]. If all the above checks are passed then the System saves the changes to the Database. The setVirtualKioskName Use Case is initiated. The Add New Virtual Kiosk Alternate Flow is followed.

2.3. Exceptions

2.3.1. No Display Modes were Selected when the Next Button was Clicked

The System reloads the Set Display Mode page with the following error message; “You must select at least one Display Mode for the Virtual Kiosk.” Return to 2.1.1.4 in the Use Case, or 2.2.2.3 if a new Virtual Kiosk is being added

2.3.2. Any One Display Order is Used Multiple Times on Different Selected Display Modes

The System reloads the Set Display Mode page with the following error message; “You must select a different Display Order for each selected Display Mode.” Return to 2.1.1.4 in the Use Case, or 2.2.2.3 if a new Virtual Kiosk is being added

2.3.3. The Assigned Display Orders are not Consecutive

The System reloads the Set Display Mode page with the following error message; “You must assign consecutive Display Order numbers to the selected Display Modes.” Return to 2.1.1.4 in the Use Case, or 2.2.2.3 if a new Virtual Kiosk is being added

Set Virtual Kiosk Name

1. Set Virtual Kiosk Name

The Use Case allows the User to update the name of the selected Product-Specific Virtual Kiosk.

The User clicks on the Next button in the Set Display Mode page.

2. Flow of Events

2.1. Basic Flow

2.1.1. Set Virtual Kiosk Name

The System loads the Set Virtual Kiosk Name page. The page displays the name currently assigned to the selected Product-Specific Virtual Kiosk. The System shall display the currently selected Virtual Kiosk information on the page also. The System pulls the name and other information for the selected Virtual Kiosk from the Database. The User may change the name of the Virtual Kiosk if they wish. The User shall click the Next button to save their changes. The System shall check that a name has been entered. [See Exception 2.3.1 if no name has been entered]. If a name has been entered, then the System saves the changes to the Database. The setVirtualKioskSkin Use Case is initiated.

2.2. Alternate Flows

2.2.1. The Back Button is Pressed

The System loads the Set Display Mode page. All changes made on this page are discarded. The setDisplayMode Use Case is initiated. The Basic Flow is initiated since a Virtual Kiosk has now been created and can be edited.

2.3. Exceptions

2.3.1. No Name has been Entered

The System reloads the Set Virtual Kiosk Name page with the following error message; “You must enter a name for the selected Virtual Kiosk.”

Set Virtual Kiosk Skin

1. Set Virtual Kiosk Skin

The Use Case allows the User to update the skin of the selected Product-Specific Virtual Kiosk.

The User clicks on the Next button in the Set Virtual Kiosk Name page.

2. Flow of Events

2.1. Basic Flow

2.1.1. Set Virtual Kiosk Skin

The System loads the Set Virtual Kiosk Skin page. Customization Options chosen by the User and an example of how the selected Virtual Kiosk will look with the current Options. The System shall display the currently selected Virtual Kiosk information on the page also. The System pulls the Product Logo and Virtual Kiosk Skin values from the Database if the User is Modifying an existing Virtual Kiosk, else the System leaves those values blank if the User is creating a new Virtual Kiosk. The list of possible Virtual Kiosk Skins is also pulled from the Database. The System also displays the list of available skins in the second column with their appropriate images. The User may change the Customization Options of the Virtual Kiosk if they wish. The User shall click the Next button to save their changes. The System shall check that a Virtual Kiosk Skin has been selected. [See Exception 2.3.1 if no Skin has been selected]. The System checks if a new Product Logo image file has been selected. If a new Product Logo image file has been selected then the System uploads the selected Product Logo image file into the appropriate directory for the clientIDclientAccountIDbrandEntityID. If the above checks pass, then the System saves the changes to the Database. The System loads the Set Virtual Kiosk Options page. The setVirtualKioskOptions Use Case is initiated.

2.2. Alternate Flows

2.2.1. The Back Button is Pressed

The System loads the Set Virtual Kiosk Name page. All changes made on this page are discarded. The setVirtualKioskName Use Case is initiated.

2.2.2. The Product Logo Browse Button is Clicked

The System displays the File Browse dialog box specific to the current operating system. The User browses in their File System and selects an image file to upload. The User clicks the OK button. The System closes the dialog box and records the path of the file in the Product Logo textbox.

2.2.3. The Preview Button is Clicked

The System shall check that a Virtual Kiosk Skin has been selected. [See Exception 2.3.1 if no Skin has been selected]. The System checks if a new Product Logo image file has been selected. If a new Product Logo image file has been selected then the System uploads the selected Product Logo image file into the appropriate directory for the clientIDclientAccountIDbrandEntityID. If the above checks pass, then the System loads the Virtual Kiosk in a stripped down browser window in Ad-Mode with the new Customization Options chosen by the User.

2.3. Exceptions

2.3.1. No Skin has been Selected

The System reloads the Set Virtual Kiosk Skin page with the following error message; “You must select a Skin for the Virtual Kiosk.”

Set Virtual Kiosk Options

1. Set Virtual Kiosk Options

The Use Case allows the User to select certain options to be made available for the selected Product-Specific Virtual Kiosk.

The User clicks on the Next button in the Set Virtual Kiosk Skin page.

2. Flow of Events

2.1. Basic Flow

2.1.1. Set Virtual Kiosk Options

The System loads the Set Virtual Kiosk Options page. The page displays the list of options for the Virtual Kiosk. The System shall display the currently selected Virtual Kiosk information on the page also. If these options have previously been set, then the System pulls the data from the Database. By default all options are set to “Yes” if not previously answered. The User may change the options if they wish. The User shall click the Next button to save their changes. The System shall check that all options have been set. [See Exception 2.3.1 if any option has not been set]. If all options have been set, then the System saves the changes to the Database. The System checks if there are any Products associated with this Virtual Kiosk. If there are, then the Set Product page is loaded, and the setProduct Use Case is initiated. Else, the Product Search page is loaded, and the productSearch Use Case is initiated.

2.2. Alternate Flows

2.2.1. The Back Button is Pressed

The System loads the Set Virtual Kiosk Skin page. All changes made on this page are discarded. The setVirtualKioskSkin Use Case is initiated.

2.3. Exceptions

2.3.1. All Options have not been Set

The System reloads the Set Virtual Kiosk Options page with the following error message; “You must set all options for this Virtual Kiosk.”

Set Product

1. Set Product

The Use Case allows the User to view the Product currently assigned to the selected Product-Specific Virtual Kiosk.

The User clicks on the Next button in the Set Virtual Kiosk Options page.

2. Flow of Events

2.1. Basic Flow

2.1.1. Set Product

The System loads the Set Product page. The page displays the Product currently assigned to the selected Product-Specific Virtual Kiosk in a list format. The System shall display the currently selected Virtual Kiosk information on the page also. The System pulls the information for the selected Virtual Kiosk from the Database for the Product that is assigned to that Virtual Kiosk. The System shall populate the table accordingly. The User shall click the Next button to proceed to the next page. If only one Product has been selected, then the System saves the changes to the Database. The System then checks to see which Display Modes have been selected for the Virtual Kiosk. If the Brand Information Network Display Mode has been selected, then the System loads the Select BIN page and the selectBIN Use Case is initiated. Else the System checks if the Buy Now Link has been enabled for this Virtual Kiosk. If it has, then the setBuyNowLink page is enabled. Else, the System loads the Confirmation Page. The confirmationPage Use Case is initiated.

2.2. Alternate Flows

2.2.1. No Products are Found.

The System displays the Set Product page with the following message in the table; “No records found.”

2.2.2. The Back Button is Pressed

The System loads the Set Virtual Kiosk Options page. All changes made on this page are discarded. The setVirtualKioskOptions Use Case is initiated.

2.2.3. The Change Product Button is Pressed

The System loads the Product Search page. The productSearch Use Case is initiated.

2.3. Exceptions

Product Search

1. Product Search

The Use Case allows the User to search for Products they wish to assign to the selected Product-Specific Virtual Kiosk.

The User clicks on the Add Product button in the Set Product page if the User is editing and existing Virtual Kiosk, or the User clicks on the Next button on the Set Virtual Kiosk Skin page if the User is creating a new Virtual Kiosk.

2. Flow of Events

2.1. Basic Flow

2.1.1. Product Search

The System loads the Product Search page. The page displays the Product Search form. The System shall display the currently selected Virtual Kiosk information on the page also. The System shall pull the Categories for the available Products into the appropriate drop-down list from the Database. The User may select any search criteria they wish. The User shall click the Search button to initiate the Product Search. The System shall check that if no Search Criteria are entered, then “All Active Products” has been selected in the Search By drop-down list. [See Exception 2.3.1 if that is not the case]. The System checks that if a Search Criteria is entered, then “All Active Products” has not been selected in the Search By drop-down list. [See Exception 2.3.1 if that is not the case]. If the above checks pass, then the System saves the Search Criteria to the session in order to execute the search on the following page. The System loads the Select Product page. The selectProduct Use Case is initiated.

2.2. Alternate Flows

2.2.1. The Back Button is Pressed

The System loads the previous page. If there are any products/services associated with this Virtual Kiosk, the System shall display the Set Product page. Otherwise the System shall display the Set Virtual Kiosk Options page. All changes made on this page are discarded. The setProduct or the setVirtualKioskOptions Use Case is initiated.

2.3. Exceptions

2.3.1. No Search Criteria has been Entered and “all Active Products” has not been Selected

The System reloads the Product Search page with the following error message; “You must enter a search criteria if you do not want to retrieve all active products.”

Select Product

1. Select Product

The Use Case allows the System to perform the Search specified in the previous Use Case and to display the results of that search for the User to select which Product they wish to assign to the selected Product-Specific Virtual Kiosk.

The User clicks on the Search button in the Product Search page.

2. Flow of Events

2.1. Basic Flow

2.1.1. Select Product

The System retrieves the Search Criteria stored in the session. The System performs the Product Search based on the Search Criteria. If “All Active Products” was selected in the Search By drop-down list on the previous page, then all Products associated with the selected Client Account are pulled from the Database. If “Universal Product Number” was selected in the Search By drop-down list on the previous page, then the System must make an exact match for the Universal Product Number to bring back any results. If any other items were selected in the Search By drop-down list on the previous page, then the System can do a wild-card search for the best matches for the entered Search Criteria. The list of matching Products is pulled from the Database. The System loads the Select Product page. The page displays the matching Products in a table. If no matching Products are found in the search, then the System displays the following message in the table; “no records found”. The Navigation Bar is displayed if there are more than 5 Products to be displayed in the table (see navigationBar Use Case). [See Alternate Flow 2.2.1 if no Products are found]. The System shall display the currently selected Virtual Kiosk information on the page also. The User may select any Product to add to the selected Virtual Kiosk by selecting its checkbox. The User shall click the Add button to save the selected Product. The System shall check that one Product has been selected. [See Exception 2.3.1 if more than one Product has been selected]. The User must click the Back button if they do not wish to make any changes to the Product assigned to the Virtual Kiosk. If one Product has been selected, then the System checks in the Database if any other Product is assigned to the selected Virtual Kiosk. If another Product is assigned to the Selected Virtual Kiosk, then the System deletes that Product. The newly selected Product is then assigned to the Virtual Kiosk in the Database. The System loads the Set Product page. The set Product Use Case is initiated.

2.2. Alternate Flows

2.2.1. No Products are Found.

The System displays the Select Product page with the following message in the table; “No records found.”

2.2.2. The Back Button is Pressed

The System loads the Product Search page. All changes made on this page are discarded. The productSearch Use Case is initiated.

2.3. Exceptions

2.3.1. More than One Product has been Selected for the Virtual Kiosk

The System reloads the Select Product page with the following error message; “You must select only one Product to assign to the Virtual Kiosk.”

Select BIN

1. Select BIN

The Use Case allows the User to select the BIN for the Product they assigned to the selected Product-Specific Virtual Kiosk.

The User clicks on the Next button in the Select Product page.

2. Flow of Events

2.1. Basic Flow

2.1.1. SelectBIN

The System loads the Select BIN page. The page displays the selected Product in a table. The System shall pull the list of available BINs from the Database to populate the BIN drop-down list for the Product. The System shall display the currently selected Virtual Kiosk information on the page also. The User may select any BIN for the Product to be added to the selected Virtual Kiosk by selecting it from the drop-down list. The User shall click the Next button to save the selected Product. The System saves the selected BIN to the Database. The System checks if the Buy Now Link feature is enabled for this Virtual Kiosk. If it is, then the System loads the Set Buy Now Link page. The setBuyNowLink Use Case is initiated. Else, the System loads the Confirmation Page.

2.2. Alternate Flows

2.2.1. The Preview Button is Pressed

The System determines which Brand Information Network is selected in the drop-down list. The System launches the Brand Information Network Preview page in a new stripped-down browser window. The brandInformationNetworkPreview Use Case is initiated.

2.2.2. The Back Button is Pressed

The System displays the previous page which is determined by whether or not there are any products/services already associated with the Virtual Kiosk. If there is a product/service, the System loads the Set Product page. Otherwise the System loads the Product Search page. All changes made on this page are discarded. The setProduct or the productSearch Use Case is initiated.

2.3. Exceptions

Set Buy Now Link

1. Set Buy Now Link

The Use Case allows the User to set the Buy Now Link for the Product associated with this Product-Specific Virtual Kiosk.

The User clicks on the Next button in the Select BIN page.

2. Flow of Events

2.1. Basic Flow

2.1.1. Set Product

The System loads the Set Buy Now Link page. The page displays the Product currently assigned to the selected Product-Specific Virtual Kiosk in a list format. The System shall display the currently selected Virtual Kiosk information on the page also. The System pulls the information for the selected Virtual Kiosk from the Database for the Product that is assigned to that Virtual Kiosk. The System shall populate the table accordingly. The User may update the Buy Now Link if they wish. The User shall click the Next button to save their changes. The System shall save any changes to the Database. The System loads the Confirmation Page. The confirmationPage Use Case is initiated.

2.2. Alternate Flows

2.2.1. No Products are Found.

The System displays the Set Product page with the following message in the table; “No records found.”

2.2.2. The Back Button is Pressed

The System loads the Select BIN page. All changes made on this page are discarded. The selectBIN Use Case is initiated.

2.3. Exceptions

Confirmation Page

1. Confirmation Page

The Use Case displays the Confirmation Page for the modified or created Product-Specific Virtual Kiosk.

The User clicks on the Next button in the Set Product page.

2. Flow of Events

2.1. Basic Flow

2.1.1. Confirmation Page

The System loads the Confirmation Page. The page displays text and instructions detailing what the User has done and the paths available to the User for the modified or created Product-Specific Virtual Kiosk.

2.2. Alternate Flows

2.2.1. The User Clicks the Link to Modify Another Product-Specific Virtual Kiosk

The System displays the Select Virtual Kiosk page. The selectVirtualKiosk Use Case is initiated.

2.2.2. The User Clicks the Link to Deploy a Product-Specific Virtual Kiosk

The System loads the Select Launch Environment page. The selectLaunchEnvironment Use Case is initiated.

2.2.3. The User Clicks the Link to Preview the Product-Specific Virtual Kiosk

The System launches the Product-Specific Virtual Kiosk in its own stripped-down browser window. The productSpecificVirtualKiosk Use Case is initiated.

2.3. Exceptions

Select Launch Environment

1. Select Launch Environment

The Use Case allows the User to Launch Environment to be used by the Virtual Kiosk being deployed.

The User clicks the Deploy P-S Virtual Kiosks from the top menu.

2. Flow of Events

2.1. Basic Flow

The User clicks the Deploy P-S Virtual Kiosks from the top menu. The System displays the Specify Virtual Kiosk page. The System will pull the list of Launch Environments from the database. The User will select the Launch Environment they wish to use for the Virtual Kiosk to be selected. The User clicks the Next button. The System checks that a Launch Environment has been selected. [See Extension 3.1 if a Launch Environment has not been selected] The System saves the Launch Environment information. The System displays the Select Virtual Kiosks page.

2.2. Alternate Flows

3. Extensions

3.1. No Launch Environment has been Selected

The System displays an error message on the page saying; “You must select a Launch Environment.”

Select Virtual Kiosk—HTML-Encoded Default Brandkey Systems Logo

1. Select Virtual Kiosk

The Use Case allows the User to select the Virtual Kiosks they wish to deploy.

The User clicks the Next button on the Specify Virtual Kiosks page;

2. Flow of Events

2.1. Basic Flow

2.1.1. Select Virtual Kiosk

The User clicks the Next button on the Specify Virtual Kiosks page. The System displays the Select Virtual Kiosks page. The System will pull the list of available Virtual Kiosks from the database. The System also checks if at least one ProductService is associated with each Virtual Kiosk. If no ProductService is associated with the Virtual Kiosk, then it will not be displayed in the list. The table of available Virtual Kiosks consists of the following columns:

Virtual Kiosk ID

Product-Specific Virtual Kiosk Name

Deploy (checkboxes)

The User will select the Virtual Kiosks they wish to deploy. The User clicks the Next button. The System checks that at least one Virtual Kiosk has been selected. [See Extension 3.1 if a Virtual Kiosk has not been selected] The System saves the list of Virtual Kiosks to be deployed. The System displays the Select Virtual Kiosk Languages page. The Select Virtual Kiosk Languages Use Case is initiated [See Alternate Flow 2.2.1 if the User clicks the Back button]

2.2. Alternate Flows

2.2.1. The User Clicks the Back Button

The System takes the User to the Specify Virtual Kiosks page.

2.3. Exceptions

2.3.1. No Virtual Kiosks have been Selected

The System displays an error message on the page saying; “You must select at least one Virtual Kiosk to deploy.”

Select Virtual Kiosk Languages—HTML-Encoded Default Brandkey Systems Logo

1. Select Virtual Kiosk Languages

The Use Case allows the User to select the Languages that will be available for the selected Virtual Kiosks to be deployed in.

The User clicks the Next button on the Select Virtual Kiosks page.

2. Flow of Events

2.1. Basic Flow

2.1.1. Select Virtual Kiosk Languages

The User clicks the Next button on the Select Virtual Kiosks page. The System displays the Select Virtual Kiosk Languages page. The System will pull the list of available Virtual Kiosk Languages from the database. The table of available Virtual Kiosk Languages consists of the following columns: —Virtual Kiosk Language with accompanying checkbox to select it. Currently only the English Language will be available for Users to select and that will be selected by default. The User will select the Virtual Kiosk Language they wish to make available. The User clicks the Next button. The System checks that at least one Virtual Kiosk Language has been selected. [See Extension 3.1 if a Virtual Kiosk Language has not been selected] The System saves the list of Virtual Kiosk Languages to be made available. The System displays the License Agreement page. The License Agreement Use Case is initiated [See Alternate Flow 2.2.1 if the User clicks the Back button]

2.2. Alternate Flows

2.2.1. The User Clicks the Back Button

The System takes the User to the Select Virtual Kiosks page.

2.3. Exceptions

2.3.1. No Virtual Kiosk Language has been Selected

The System displays an error message on the page saying; “You must select at least one Virtual Kiosk Language to make available.”

License Agreement—HTML-Encoded Default Brandkey Systems Logo

1. License Agreement

The Use Case allows the User to agree to the License Agreement for deploying Virtual Kiosks thereby deploying the selected Virtual Kiosks.

The User clicks the Next button on the Select Virtual Kiosk Languages page.

2. Flow of Events

2.1. Basic Flow

2.1.1. License Agreement

The User clicks the Next button on the Select Virtual Kiosk Languages page. The System displays the License Agreement page. The User will click on the I Agree button to accept the License agreement. The System will deploy the selected Virtual Kiosks by making their records available for activation and installation from the Virtual Kiosk Installation Suite. The files for the Virtual Kiosk tags are also copied over to the appropriate directory on the Web Server. The System displays the Confirm Deployment page. [See Alternate Flow 2.2.1 if the User clicks the Disagree button] The System informs the User that the selected Virtual Kiosks have now been deployed and that they User must Activate the Virtual Kiosks in order for them to be downloaded in the Installation Suite.

2.2. Alternate Flows

2.2.1. The User Clicks the Disagree Button

The System takes the User back to the Select Virtual Kiosk Languages page.

2.3. Exceptions

Select Virtual Kiosk—HTML-Encoded Desktop Icons

1. Select Virtual Kiosk

The Use Case allows the User to select the Virtual Kiosk they wish to deploy.

The User clicks the Next button on the Specify Virtual Kiosks page.

2. Flow of Events

2.1. Basic Flow

2.1.1. Select Virtual Kiosk

The User clicks the Next button on the Specify Virtual Kiosks page after having chosen the HTML-Encoded Desktop Icon radio button on that page. The System displays the Select Virtual Kiosk page. The System will pull the list of available Virtual Kiosks from the database. The System also checks if at least one ProductService is associated with each Virtual Kiosk. If no ProductService is associated with the Virtual Kiosk, then it will not be displayed in the list. The table of available Virtual Kiosks consists of the following columns:

Virtual Kiosk ID

Virtual Kiosk Name

Preview button

Select (checkboxes)

The User will select the Virtual Kiosk they wish to deploy in the HTML-Encoded Desktop Icon launch environment. The User clicks the Next button. The System checks that only one Virtual Kiosk has been selected. [See Extension 3.1 if only one Virtual Kiosk has not been selected] The System saves the Virtual Kiosk to be deployed. The System displays the Select Virtual Kiosk Languages page. The selectVirtualKioskLanguages Use Case is initiated [See Alternate Flow 2.2.1 if the User clicks the Back button] [See Alternate Flow 2.2.2 if the User clicks the Preview button for any Virtual Kiosk].

2.2. Alternate Flows

2.2.1. The User Clicks the Back Button

The System takes the User to the Specify Virtual Kiosks page.

2.2.2. The User Clicks the Preview Button for any Virtual Kiosk

The System determines which Virtual Kiosk has been selected. The System launches that Virtual Kiosk in a stripped-down browser for the User to preview. The Virtual Kiosk acts as if it were launched from any site. No Ads or Promos would be played since this Virtual Kiosk would not be already installed.

2.3. Exceptions

2.3.1. Only One Virtual Kiosk has not been Selected

The System displays an error message on the page saying; “You must select only one Virtual Kiosk to deploy in the HTML-Encoded Desktop Icon launch environment.”

Select Virtual Kiosk Languages—HTML-Encoded Desktop Icons

1. Select Virtual Kiosk Languages

The Use Case allows the User to select the Languages that will be available for the selected Virtual Kiosks to be deployed in.

The User clicks the Next button on the Select Virtual Kiosks page.

2. Flow of Events

2.1. Basic Flow

2.1.1. Select Virtual Kiosk Languages

The User clicks the Next button on the Select Virtual Kiosks page. The System displays the Select Virtual Kiosk Languages page. The System will pull the list of available Virtual Kiosk Languages from the database. The table of available Virtual Kiosk Languages consists of the following columns: —Virtual Kiosk Language with accompanying checkbox to select it. Currently only the English Language will be available for Users to select The User will select the Virtual Kiosk Language they wish to make available. The User clicks the Next button. The System checks that at least one Virtual Kiosk Language has been selected. [See Extension 3.1 if a Virtual Kiosk Language has not been selected] The System saves the list of Virtual Kiosk Languages to be made available. The System displays the Upload Image page. The Upload Image Use Case is initiated [See Alternate Flow 2.2.1 if the User clicks the Back button]

2.2. Alternate Flows

2.2.1. The User Clicks the Back Button

The System takes the User to the Select Virtual Kiosks page.

2.3. Exceptions

2.3.1. No Virtual Kiosk Language has been Selected

The System displays an error message on the page saying; “You must select at least one Virtual Kiosk Language to make available.”

Upload Image—HTML-Encoded Desktop Icons

1. Upload Image

The Use Case allows the User to upload the Image they wish to use to launch their Multi-Mode Virtual Kiosk and to select the clickable area they wish to set to launch the Virtual Kiosk.

The User clicks the Next button on the Select Virtual Kiosk Languages page.

2. Flow of Events

2.1. Basic Flow

2.1.1. Upload Image

The User clicks the Next button on the Select Virtual Kiosk Languages page. The System displays the Upload Image page. The User clicks the Browse button to browse for the Image to be used as the Launch Environment on their computer. Once the Image has been chosen the User clicks the Next button. They System will upload the Image and save the image name to the Database. [See Exception 3.1 if no Image is chosen]. The Select OS page is launched and the selectOS Use Case is initiated. [See Alternate Flow 2.2.1 if the User clicks the Back button]

2.2. Alternate Flows

2.2.1. The User Clicks the Back Button

The System takes the User to the Select Virtual Kiosk Languages page.

2.3. Exceptions

2.3.1. No Document is Chosen

The System displays an error message on the page saying; “You must select an Image from which the Multi-Mode Virtual Kiosk will be launched.”

Select Operating System—HTML-Encoded Desktop Icons

1. Select Operating System

The Use Case allows the User to select the Operating System for which they wish to create the Desktop Icon.

The User clicks the Next button on the Upload Image page.

2. Flow of Events

2.1. Basic Flow

2.1.1. Select Operating System

The User clicks the Next button on the Upload Image page. The System displays the Select Operating System page. The System loads the list of available Operating Systems from the Database into a table consisting of:

Operating System Name

Radio button to select the Operating System (first Operating System checked by default)

The User selects the Operating System for which they wish to create the Desktop Icon. The System saves the Operating System selection to the Database. The License Agreement Use Case is initiated [See Alternate Flow 2.2.1 if the User clicks the Back button]

2.2. Alternate Flows

2.2.1. The User Clicks the Back Button

The System takes the User to the Select Virtual Kiosk Languages page.

2.3. Exceptions

License Agreement—HTML-Encoded Desktop Icons

1. License Agreement

The Use Case allows the User to agree to the License Agreement for deploying Virtual Kiosks thereby deploying the selected Virtual Kiosks.

The User clicks the Next button on the Select Operating System page.

2. Flow of Events

2.1. Basic Flow

2.1.1. License Agreement

The User clicks the Next button on the Select Virtual Kiosk Languages page. The System displays the License Agreement page. The User will click on the I Agree button to accept the License agreement. The System will deploy the selected Virtual Kiosks by making their records available for activation and installation from the Virtual Kiosk Installation Suite. The files for the Virtual Kiosk tags are also copied over to the appropriate directory on the Web Server. The System displays the Confirm Deployment page. [See Alternate Flow 2.2.1 if the User clicks the Disagree button] The System informs the User that the selected Virtual Kiosks have now been deployed and that they User must Activate the Virtual Kiosks in order for them to be downloaded in the Installation Suite.

2.2. Alternate Flows

2.2.1. The User Clicks the Disagree Button

The System takes the User back to the Specify Virtual Kiosks page.

2.3. Exceptions

Select Virtual Kiosk—HTML-Encoded Document

1. Select Virtual Kiosk

The Use Case allows the User to select the Virtual Kiosk they wish to deploy.

The User clicks the Next button on the Specify Virtual Kiosks page.

2. Flow of Events

2.1. Basic Flow

2.1.1. Select Virtual Kiosk

The User clicks the Next button on the Specify Virtual Kiosks page. The System displays the Select Virtual Kiosk page. The System will pull the list of available Virtual Kiosks from the database. The System also checks if at least one ProductService is associated with each Virtual Kiosk. If no ProductService is associated with the Virtual Kiosk, then it will not be displayed in the list. The table of available Virtual Kiosks consists of the following columns:

Virtual Kiosk ID

Product-Specific Virtual Kiosk Name

Deploy (radio buttons)

The User will select the Virtual Kiosk they wish to deploy. The User clicks the Next button. The System checks that one Virtual Kiosk has been selected. [See Extension 3.1 if a Virtual Kiosk has not been selected] The System saves the Virtual Kiosk to be deployed. The System displays the Select Virtual Kiosk Languages page. The Select Virtual Kiosk Languages Use Case is initiated [See Alternate Flow 2.2.1 if the User clicks the Back button]

2.2. Alternate Flows

2.2.1. The User Clicks the Back Button

The System takes the User to the Specify Virtual Kiosks page.

2.3. Exceptions

2.3.1. No Virtual Kiosks have been Selected

The System displays an error message on the page saying; “You must select a Virtual Kiosk to deploy.”

Select Virtual Kiosk Languaes—HTML-Encoded Document

1. Select Virtual Kiosk Languages

The Use Case allows the User to select the Languages that will be available for the selected Virtual Kiosks to be deployed in.

The User clicks the Next button on the Select Virtual Kiosks page.

2. Flow of Events

2.1. Basic Flow

2.1.1. Select Virtual Kiosk Languages

The User clicks the Next button on the Select Virtual Kiosks page. The System displays the Select Virtual Kiosk Languages page. The System will pull the list of available Virtual Kiosk Languages from the database. The table of available Virtual Kiosk Languages consists of the following columns: —Virtual Kiosk Language with accompanying checkbox to select it. Currently only the English Language will be available for Users to select The User will select the Virtual Kiosk Language they wish to make available. The User clicks the Next button. The System checks that at least one Virtual Kiosk Language has been selected. [See Extension 3.1 if a Virtual Kiosk Language has not been selected] The System saves the list of Virtual Kiosk Languages to be made available. The System displays the Upload Document page. The Upload Document Use Case is initiated [See Alternate Flow 2.2.1 if the User clicks the Back button]

2.2. Alternate Flows

2.2.1. The User Clicks the Back Button

The System takes the User to the Select Virtual Kiosks page.

2.3. Exceptions

2.3.1. No Virtual Kiosk Language has been Selected

The System displays an error message on the page saying; “You must select at least one Virtual Kiosk Language to make available.”

Upload Document—HTML-Encoded Document

1. Upload Document

The Use Case allows the User to upload the Document they wish to use to launch their Multi-Mode Virtual Kiosk.

The User clicks the Next button on the Select Virtual Kiosk Languages page.

2. Flow of Events

2.1. Basic Flow

2.1.1. Confirmation Page

The User clicks the Next button on the Select Virtual Kiosk Languages page. The System displays the Upload Document page. The User clicks the Browse button to browse for the Document to be used as the Launch Environment on their computer. Once the Document has been chosen, the User clicks the Next button. The System will upload the Document and save the information to the Database. [See Extension 3.1 if no Document is selected]. The License Agreement Use Case is initiated [See Alternate Flow 2.2.1 if the User clicks the Back button]

2.2. Alternate Flows

2.2.1. The User Clicks the Back Button

The System takes the User to the Select Virtual Kiosk Languages page.

2.3. Exceptions

2.3.1. No Document is Chosen

The System displays an error message on the page saying; “You must select a Documents from which the Multi-Mode Virtual Kiosk will be launched.”

License Agreement—HTML-Encoded Document

1. License Agreement

The Use Case allows the User to agree to the License Agreement for deploying Virtual Kiosks thereby deploying the selected Virtual Kiosks.

The User clicks the Next button on the Select Virtual Kiosk Languages page.

2. Flow of Events

2.1. Basic Flow

The User clicks the Next button on the Select Virtual Kiosk Languages page. The System displays the License Agreement page. The User will click on the I Agree button to accept the License agreement. The System will deploy the selected Virtual Kiosks by making their records available for activation and installation from the Virtual Kiosk Installation Suite. The files for the Virtual Kiosk tags are also copied over to the appropriate directory on the Web Server. The System displays the Confirm Deployment page. [See Alternate Flow 2.2.1 if the User clicks the Disagree button] The System informs the User that the selected Virtual Kiosks have now been deployed and that they User must Activate the Virtual Kiosks in order for them to be downloaded in the Installation Suite.

2.2. Alternate Flows

2.2.1. The User Clicks the Disagree Button

The System takes the User back to the Specify Virtual Kiosks page.

3. Extensions

Select Virtual Kiosk—HTML-Encoded Image

1. Select Virtual Kiosk

The Use Case allows the User to select the Virtual Kiosk they wish to deploy.

The User clicks the Next button on the Specify Virtual Kiosks page.

2. Flow of Events

2.1. Basic Flow

2.1.1. Select Virtual Kiosk

The User clicks the Next button on the Specify Virtual Kiosks page after having chosen the HTML-Encoded Desktop Icon radio button on that page. The System displays the Select Virtual Kiosk page. The System will pull the list of available Virtual Kiosks from the database. The System also checks if at least one ProductService is associated with each Virtual Kiosk. If no ProductService is associated with the Virtual Kiosk, then it will not be displayed in the list. The table of available Virtual Kiosks consists of the following columns:

Virtual Kiosk ID

Virtual Kiosk Name

Preview button

Select (checkboxes)

The User will select the Virtual Kiosk they wish to deploy in the HTML-Encoded Desktop Icon launch environment. The User clicks the Next button. The System checks that only one Virtual Kiosk has been selected. [See Extension 3.1 if only one Virtual Kiosk has not been selected] The System saves the Virtual Kiosk to be deployed. The System displays the Select Virtual Kiosk Languages page. The selectVirtualKioskLanguages Use Case is initiated [See Alternate Flow 2.2.1 if the User clicks the Back button] [See Alternate Flow 2.2.2 if the User clicks the Preview button for any Virtual Kiosk].

2.2. Alternate Flows

2.2.1. The User Clicks the Back Button

The System takes the User to the Specify Virtual Kiosks page.

2.2.2. The User Clicks the Preview Button for any Virtual Kiosk

The System determines which Virtual Kiosk has been selected. The System launches that Virtual Kiosk in a stripped-down browser for the User to preview. The Virtual Kiosk acts as if it were launched from any site. No Ads or Promos would be played since this Virtual Kiosk would not be already installed.

2.3. Exceptions

2.3.1. Only One Virtual Kiosk has not been Selected

The System displays an error message on the page saying; “You must select only one Virtual Kiosk to deploy in the HTML-Encoded Desktop Icon launch environment.”

Select Virtual Kiosk Languages—HTML-Encoded Image

1. Select Virtual Kiosk Languages

The Use Case allows the User to select the Languages that will be available for the selected Virtual Kiosks to be deployed in.

The User clicks the Next button on the Select Virtual Kiosks page.

2. Flow of Events

2.1. Basic Flow

2.1.1. Select Virtual Kiosk Languages

The User clicks the Next button on the Select Virtual Kiosks page. The System displays the Select Virtual Kiosk Languages page. The System will pull the list of available Virtual Kiosk Languages from the database. The table of available Virtual Kiosk Languages consists of the following columns: —Virtual Kiosk Language with accompanying checkbox to select it. Currently only the English Language will be available for Users to select The User will select the Virtual Kiosk Language they wish to make available. The User clicks the Next button. The System checks that at least one Virtual Kiosk Language has been selected. [See Extension 3.1 if a Virtual Kiosk Language has not been selected] The System saves the list of Virtual Kiosk Languages to be made available. The System displays the Upload Image page. The Upload Image Use Case is initiated [See Alternate Flow 2.2.1 if the User clicks the Back button]

2.2. Alternate Flows

2.2.1. The User Clicks the Back Button

The System takes the User to the Select Virtual Kiosks page.

2.3. Exceptions

2.3.1. No Virtual Kiosk Language has been Selected

The System displays an error message on the page saying; “You must select at least one Virtual Kiosk Language to make available.”

Upload Image—HTML-Encoded Image

1. Upload Image

The Use Case allows the User to upload the Image they wish to use to launch their Multi-Mode Virtual Kiosk and to select the clickable area they wish to set to launch the Virtual Kiosk.

The User clicks the Next button on the Select Virtual Kiosk Languages page.

2. Flow of Events

2.1. Basic Flow

2.1.1. Upload Image

The User clicks the Next button on the Select Virtual Kiosk Languages page. The System displays the Upload Image page. The User clicks the Browse button to browse for the Image to be used as the Launch Environment on their computer. Once the Image has been chosen the User clicks the Next button. They System will upload the Image and save the image name to the Database. [See Exception 3.1 if no Image is chosen]. The Set Area page is launched and the setArea Use Case is initiated. [See Alternate Flow 2.2.1 if the User clicks the Back button]

2.2. Alternate Flows

2.2.1. The User Clicks the Back Button

The System takes the User to the Select Virtual Kiosk Languages page.

2.3. Exceptions

2.3.1. No Document is chosen

The System displays an error message on the page saying; “You must select an Image from which the Multi-Mode Virtual Kiosk will be launched.”

License Agreement—HTML-Encoded Image

1. License Agreement

The Use Case allows the User to agree to the License Agreement for deploying Virtual Kiosks thereby deploying the selected Virtual Kiosks.

The User clicks the Next button on the Select Operating System page.

2. Flow of Events

2.1. Basic Flow

2.1.1. License Agreement

The User clicks the Next button on the Select Virtual Kiosk Languages page. The System displays the License Agreement page. The User will click on the I Agree button to accept the License agreement. The System will deploy the selected Virtual Kiosks by making their records available for activation and installation from the Virtual Kiosk Installation Suite. The files for the Virtual Kiosk tags are also copied over to the appropriate directory on the Web Server. The System displays the Confirm Deployment page. [See Alternate Flow 2.2.1 if the User clicks the Disagree button] The System informs the User that the selected Virtual Kiosks have now been deployed and that they User must Activate the Virtual Kiosks in order for them to be downloaded in the Installation Suite.

2.2. Alternate Flows

2.2.1. The User Clicks the Disagree Button

The System takes the User back to the Specify Virtual Kiosks page.

2.3. Exceptions

Activate Virtual Kiosk

1. Activate Virtual Kiosk

The Use Case allows the User to Activate or Deactivate deployed Virtual Kiosks and shows a list of Virtual Kiosks awaiting creation of Desktop Icons

The User clicks the Activate P-S Virtual Kiosks top menu item.

2. Flow of Events

2.1. Basic Flow

2.1.1. Activate Virtual Kiosk

The User clicks the Activate P-S Virtual Kiosk top menu item. The System displays the Activate Virtual Kiosks page. The System pulls the list of deployed Virtual Kiosks from the Database and sorts them by Active and Inactivate and then by name in the tables. The System also checks if at least one ProductService is associated with each Virtual Kiosk. If no ProductService is associated with the Virtual Kiosk, then it will not be displayed in the list. The User can click on any Active Virtual Kiosk's checkbox to activate or deactivate that Virtual Kiosk depending if it is checked or not. The User will make the changes and click the Update button. The System will save the Virtual Kiosk activation information to the database. The System will reload the page with the changes saved to the Database and visible in the page.

2.2. Alternate Flows

2.3. Exceptions

Virtual Kiosk Installation Suite (See FIGS. 9H through 9K)

Control Panel for Installing Product-Specific Virtual Kiosks

Select Virtual Kiosk

1. Select Virtual Kiosk

The Use Case allows the User to select the Virtual Kiosk tags they wish to download and install.

The User clicks the Install Product-Specific Virtual Kiosks top menu item.

2. Flow of Events

2.1. Basic Flow

2.1.1. Select Virtual Kiosk

The User clicks the Install Product-Specific Virtual Kiosks top menu item. The System displays the Select Product-Specific Virtual Kiosks page. The System will pull the available Virtual Kiosks from the Database and populate the table with them. [See Alternate Flow 2.2.1 if the User is a Consumer] The User will select the Virtual Kiosks they wish to install on this page by checking their Install checkbox. The User will click the Next button to save the requested list. The System will check that at least one Virtual Kiosk has been selected by the User. [See Exception 2.3.1 if at least one Virtual Kiosk has not been selected] The System will save the list of Virtual Kiosks to be downloaded. The System will check if the Buy Now Link is allowed to be defined for any of the selected Virtual Kiosks. If it is, then the System will check if the currently logged-in User is either a Retailer or Industrialist. If they are either, then the System will display the Set Options page. If it is not, then the System will display the License Agreement page.

2.2. Alternate Flows

2.2.1. The User is a Consumer

The System will display the Alphabet and Numeric selection bar above the Virtual Kiosk table for all Vendors who allow their Product-Specific Virtual Kiosks to be downloaded by Consumers. The User may select any of the clickable Alphabets or numbers to view Product-Specific Virtual Kiosks from Vendors whose names begin with that letter or number. The User may also click the Search button to go to the Vendor Search page. The System will display the Vendor Search page. The User will be able to search for Vendors based on the Search criteria they entered on this page. The User will search from the list of available Vendors by Vendor Name. The User will click on the Search button to initiate the Vendor search. The System will check that some search criteria was entered. If no search criteria has been entered, then the System displays an error message informing the User that Search Criteria are required. The System will display the search results on the Vendor Search Results page. The User will select one Vendor whose list of Product-Specific Virtual Kiosks they wish to view before downloading. The System returns the User to the Select Virtual Kiosks page with the Virtual Kiosks of the selected Vendor displayed.

2.3. Exceptions

2.3.1. The User does not Select any Virtual Kiosks to Download

The System displays an error message on the screen saying; “You must select at least one Virtual Kiosk to download.”

License Agreement

1. License Agreement

The Use Case requires the User to agree to the License Agreement for installing Virtual Kiosks.

The User clicks the Next button on the Select Virtual Kiosks Languages page.

2. Flow of Events

2.1. Basic Flow

The User clicks the Next button on the Select Virtual Kiosks Languages page. The System displays the License Agreement page. The User will click on the I Agree button to accept the License agreement. The System displays the Installation Location Information page. The Installation Location Information Use Case is initiated. [See Alternate Flow 2.2.1 if the User clicks the Disagree button]

2.2. Alternate Flows

2.2.1. The User Clicks the Disagree Button

The System takes the User back to the Select Virtual Kiosks page.

Installation Location Information

1. Installation Location Information

The Use Case allows the User to enter the information for where the downloaded Virtual Kiosks will be installed.

The User clicks the Agree button on the License Agreement page.

2. Flow of Events

2.1. Basic Flow

2.1.1. Installation Location Information

The User clicks the Agree button on the License Agreement page. The System displays the Installation Location Information page. The User will fill in the information for where the Virtual Kiosk tag will be installed on the Internet The User clicks the Next button to save the information to the Database. They System checks that all required fields are filled in. The required fields are:

User Name

Installation Domain

City

State

Zip/Postal Code

Country

Reason for Installation.

[See Extension 3.1 if all required fields are not filled in] The System will save the information to the Database. The System will display the Download Virtual Kiosk Tag page. The Download Virtual Kiosk Tag Use Case is initiated. [See Alternate Flow 2.2.1 if the User clicks the Back button]

2.2. Alternate Flows

2.2.1. The User Clicks the Back Button

The System takes the User back to the License Agreement page.

2.3. Exceptions

2.3.1. All Required Fields are not Filled in

The System will display an error message on the page saying; “You must fill in all required fields to save the Location Information.”

Download Virtual Kiosk Tags

1. Installation Location Information

The Use Case allows the User to download the Virtual Kiosk tags they have selected.

The User clicks the Next button on the Location Information page page.

2. Flow of Events

2.1. Basic Flow

The User clicks the Next button on the Location Information page. The System displays the Download Virtual Kiosk Tags page. The User will click on the appropriate Virtual Kiosk Tag button to begin the download process for those set of tags. The System will recognize which set of Virtual Kiosk tags the User is requesting and provide the appropriate files for the User to download. The System will create the files for installing the Virtual Kiosk(s). The User will download the requested tags to their computer.

2.2. Alternate Flows

3. Extensions

Brandkey Advertise Subsystem Level Services

Virtual Kiosk Advertising Campaign Management Suite (See FIG. 10A)

Control Panel for Managing Advertising Campaigns (See FIGS. 10B through 10H)

Select Directory

1. Select Directory

This Use Case allows authorized Users to create and manage Virtual Kiosk Advertising Directories based on their logged-in Client Account.

The User launches the Brandkey Advertise Control Panel and then clicks the Manage Directories menu item.

2. Flow of Events

2.1. Basic Flow

2.1.1. Select Directory

The System launches the Select Directory page. The User Marquee is shown at the top of the page. The Select Directory table is shown. The table has three tabs; Active Directories, Inactive Directories, and All Directories. The Active Directories tab is selected by default. In the Active Directories tab, all available active Directories are pulled from the Database for the Client Account the User selected during Login. Those Directories are shown in the Select Directory table. The Active checkbox for each Directory will be checked by default. If there are more than five Directories pulled from the Database, then the System displays the appropriate navigation item beneath the table. If there are no Directories pulled from the Database, then the System displays the following message in the table; “No records found” [See Alternate Flow 2.2.1 if the User clicks on the Inactive Directories tab] [See Alternate Flow 2.2.2 if the User clicks on the All Directories tab] The User may check or uncheck the Active checkbox for any Directory, depending on the tab they are in. Clicking any of the Navigation items, tabs, or buttons will save any changes made on the page. Before saving the changes to the Database, the System will check if any Directories have been deactivated. If any Directories have been deactivated, then the System will check to see if that Directory is assigned to a running Campaign. If that Directory is assigned to a running Campaign, then the System displays an error message on the page saying; “You can not deactivate a Directory assigned to a running Campaign.”, and no changes are made to the Database. Else, any required changes are saved to the Database. [See Alternate Flow 2.2.3 if the User clicks on and Edit button] [See Alternate Flow 2.2.4 if the User clicks on the Add Directory button] The User will click on the Finish button to complete the editing process on this page. The System will load the Confirmation Page. The confirmationPage Use Case is invoked.

2.2. Alternate Flows

2.2.1. The User Clicks on the Inactive Directories Tab

In the Inactive Directories tab, all available inactive Directories are pulled from the Database for the Client Account the User selected during Login. Those Directories are shown in the Select Directory table. The Active checkbox for each Directory will not be checked by default. If there are more than five Directories pulled from the Database, then the System displays the appropriate navigation item beneath the table. If there are no Directories pulled from the Database, then the System displays the following message in the table; “No records found”

2.2.2. The User Clicks on the All Directories Tab

In the All Directories tab, all available Directories, both active and inactive are pulled from the Database for the Client Account the User selected during Login. Those Directories are shown in the Select Directory table. The Active checkbox for each Directory will be checked if that Directory is active. If there are more than five Directories pulled from the Database, then the System displays the appropriate navigation item beneath the table. If there are no Directories pulled from the Database, then the System displays the following message in the table; “No records found”

2.2.3. The User Clicks on an Edit Button

The System determines for which Directory was the Edit button clicked. The System loads the Set Directory Name and Type page. The setDirectoryNameType Use Case is invoked for editing an existing Directory.

2.2.4. The User Clicks on the Add Directory Button

The System loads the Set Directory Name and Type page. The setDirectoryNameType Use Case is invoked for adding a new Directory.

2.3. Exceptions

Set Directory Name and Type

1. Set Directory Name and Type

This Use Case allows authorized Users to create a new Advertising Directory or edit an existing Advertising Directory.

The User clicks either an Edit button or the Add Directory button on the Select Directory page.

2. Flow of Events

2.1. Basic Flow

2.1.1. Set Directory Name and Type for a New Directory

The System launches the Set Directory Name and Type page. The User Marquee is shown at the top of the page. The Set Directory Name and Type table is displayed. All fields in the table are blank or set as default. The Directory Name textbox is blank. The Directory Type radio button, General is selected. The Active checkbox is checked. The User will enter the basic information they wish to save for the new Directory. The User clicks the Next button to save their changes The System checks that all required fields (marked by red asterisk) are filled in. Required fields are: —Directory Name

[See Exception 2.3.1 if any required fields are not filled in] If all required fields are filled in, then the System saves the information to the Database. The System loads the List Virtual Kiosk page. The listVirtualKiosk Use Case is initiated. [See Alternate Flow 2.2.1 if the User clicks the Back button]

2.1.2. Set Directory Name and Type for an Existing Directory

The System launches the Set Directory Name and Type page. The User Marquee is shown at the top of the page. The Set Directory Name and Type table is displayed. All fields are filled in with information pulled for the Directory from the Database. The Directory Type radio buttons are not available in this instance (once a directory has been created you can not change its Type). The User will enter the basic information they wish to change for the Existing Directory. The User clicks the Next button to save their changes The System checks that all required fields (marked by red asterisk) are filled in. Required fields are:

Directory Name

[See Exception 2.3.1 if any required fields are not filled in] If all required fields are filled in, then the System saves the information to the Database. Before saving the changes to the Database, the System will check if the Directory has been deactivated. If the Directory has been deactivated, then the System will check to see if the Directory is assigned to a running Campaign. If the Directory is assigned to a running Campaign, then the System displays an error message on the page saying; “You can not deactivate a Directory assigned to a running Campaign.”, and no changes are made to the Database. Else, any required changes are saved to the Database. The System loads the List Virtual Kiosk page. The listVirtualKiosk Use Case is initiated. [See Alternate Flow 2.2.1 if the User clicks the Back button]

2.2. Alternate Flows

2.2.1. The User Clicks the Back Button

All changes are discarded. The Select Directory page is loaded. The selectDirectory Use Case is initiated.

2.3. Exceptions

2.3.1. All Required Fields are not Filled in

The System reloads the Set Directory Name and Type page with the following error message; “You must fill in all required fields (marked with a red asterisk).”

List Virtual Kiosk

1. List Virtual Kiosk

This Use Case displays the list of Virtual Kiosks assigned to the selected Directory.

The User clicks the Next button on the Set Directory Name and Type page.

2. Flow of Events

2.1. Basic Flow

2.1.1. List Virtual Kiosk

The System launches the List Virtual Kiosk page. The User Marquee is shown at the top of the page. The System pulls all Virtual Kiosks assigned to the selected Directory to be displayed in the Virtual Kiosk List table on the page. If there are more than 5 Virtual Kiosks found, then the System also displays the appropriate navigation item beneath the table. If there are no Virtual Kiosks assigned to the Directory, then the System displays the following message in the table; “No records found”. [See Alternate Flow 2.2.1 if the User clicks the Back button] [See Alternate Flow 2.2.2 if the User clicks the Select Virtual Kiosks button] [See Alternate Flow 2.2.3 if the User clicks on one of the Installation Domain links] [See Alternate Flow 2.2.4 if the User clicks on the Preview button for any one Virtual Kiosk] The User clicks the Finish button when they are done. The System loads the Select Directory page. The selectDirectory Use Case is initiated.

2.2. Alternate Flows

2.2.1. The User Clicks the Back Button

All changes are discarded. The Set Directory Name and Type page is loaded. The setDirectoryNameType Use Case is initiated.

2.2.2. The User Clicks the Select Virtual Kiosks Button

The System loads the Select Virtual Kiosk Type page. The selectVirtualKioskType Use Case is initiated.

2.2.3. The User Clicks on One of the Installation Domain Links

The System records which Installation Domain was selected to be previewed The System launches a new stripped-down browser window with the Installation Domain loaded in it.

2.2.4. The User Clicks the Preview Button for any One Virtual Kiosk

The System records which Virtual Kiosks was selected to be previewed The System launches the Virtual Kiosk in a new stripped-down browser window. The appropriate Virtual Kiosk Type Use Case is initiated.

2.3. Exceptions

Select Virtual Kiosk Type

1. Select Virtual Kiosk Type

This Use Case allows the User to select which Types of Virtual Kiosks will be available in the Directory.

The User clicks the Select Virtual Kiosk button on the List Virtual Kiosk page.

2. Flow of Events

2.1. Basic Flow

2.1.1. Select Virtual Kiosk Type

The System launches the Select Virtual Kiosk Type page. The User Marquee is shown at the top of the page. The System pulls all available Virtual Kiosk Types from the Database where there are Installed Virtual Kiosks for the Client Account the User selected during Login. If there are no available Virtual Kiosk Types, then the System displays the following message; “No Virtual Kiosks have been installed, therefore no Virtual Kiosk Types may be selected at this time.” The System checks if any Virtual Kiosk Type has previously been selected. If so, then those Virtual Kiosk Types are checked on the page, else all Virtual Kiosk Types are unchecked. The User may select or deselect any Virtual Kiosk Types they wish. The User clicks the Select button to save any changes. The System checks if any Virtual Kiosk Type has been deselected. If so, then They System checks in the list of Virtual Kiosks assigned to the Directory if there are any Virtual Kiosks of that Type. If there are, then the System removes those Virtual Kiosks from the Directory. The System checks if the Directory Type is “general”. If it is, then the System makes sure that all Virtual Kiosks of the selected Types are saved to the Database. Then the System loads the List Virtual Kiosk page. The listVirtualKiosk Use Case is initiated. [See Alternate Flow 2.2.1 if the User clicks the Back button] [See Alternate Flow 2.2.2 if the Directory Type is “brand-specific”]

2.2. Alternate Flows

2.2.1. The User Clicks the Back Button

All changes are discarded. System loads the List Virtual Kiosk page. The listVirtualKiosk Use Case is initiated.

2.2.2. The Directory Type is Brand-Specific

The System loads the List Brand page. The listBrand Use Case is initiated.

2.3. Exceptions

List Brand

1. List Brand

This Use Case lists the Brands that have been selected whose Products or Services are used to determine which Virtual Kiosks are assigned to the Directory.

The User clicks the Next button on the Select Virtual Kiosk Type page.

2. List Brand

2.1. Basic Flow

2.1.1. List Brand

The System launches the List brand page. The User Marquee is shown at the top of the page. The System pulls the list of assigned Brands from the Database into the Brand table on the page. All of the Brands are selected by default. If no Brands are pulled from the Database, then the following message is displayed in the table; “No records found” If there are more than five Brands pulled from the Database, then the System displays the navigation item appropriately beneath the table. The User may deselect any Brand they wish from the list. The User clicks the Finish button to save any changes they have made. The System checks if any Brand has been deselected. If so, then the System must see if there are any Virtual Kiosks in the Directory Virtual Kiosk list that belong exclusively to those deselected Brands. If so, then those Virtual Kiosks must be removed from the Database. The System must then checks that all the Virtual Kiosks in the table are linked to at least one of the selected Brands. If there are any Virtual Kiosks that do not have a corresponding Brand, then those Virtual Kiosks are removed from the table. The System then checks to make sure any new Virtual Kiosks are added if any new Brands have been added to the list. The System loads the List Virtual Kiosk page. The listVirtualKiosk Use Case is initiated. [See Alternate Flow 2.2.1 if the User clicks the Back button] [See Alternate Flow 2.2.2 if the User clicks the Add Brand button]

2.2. Alternate Flows

2.2.1. The User Clicks the Back Button

All changes are discarded. The Select Virtual Kiosk Type page is loaded. The selectVirtualKioskType Use Case is initiated.

2.2.2. The User Clicks the Add Brand Button

The System loads the Search Brand page. The searchBrand Use Case is initiated.

2.3. Exceptions

Search Brand

1. Search Brand

This Use Case allows the User to search for Brands whose Products or Services are used to determine which Virtual Kiosks are assigned to the Directory.

The User clicks the Add Brand button on the List Brand page.

2. Search Brand

2.1. Basic Flow

2.1.1. Search Brand

The System launches the Search Brand page. The User Marquee is shown at the top of the page. The System pulls all available Categories from the Database into the Category drop-down list. The User enters the search criteria they wish. Search criteria is not required to initiate a search. The User clicks the Search button to initiate the Search. The System saves the Search Criteria (if any is entered). The System loads the Add Brand page. The add Brand Use Case is initiated. [See Alternate Flow 2.2.1 if the User clicks the Back button]

2.2. Alternate Flows

2.2.1. The User Clicks the Back Button

The List Brand page is loaded. The listBrand Use Case is initiated.

2.3. Exceptions

Add Brand

1. Add Brand

This Use Case allows the User to select additional Brands whose Products or Services are used to determine which Virtual Kiosks are assigned to the Directory.

The User clicks the Search button on the Search Brand page.

2. Add Brand

2.1. Basic Flow

2.1.1. Add Brand

The System launches the Add Brand page. The User Marquee is shown at the top of the page. The System retrieves the Search Criteria entered by the User from the previous page. The System performs a Brand Search on available Brands in the Database based on the retrieved Search Criteria. The System lists the matching Brands in the table on the page. The System lists those Brands that match the Search Criteria and that are not already added to the Directory. If no matching Brands were found, then the System displays the following message in the table; “No records found”. If more than five matching Brands were retrieved then the System displays the appropriate navigation item beneath the table. The User may select any Brand they wish to add to the Directory by checking the appropriate checkbox. The User clicks the Add button to add the Brand to the list. The System adds the selected Brands to the list and saves the changes to the Database. The System loads the List Brand page. The listBrand Use Case is initiated. [See Alternate Flow 2.2.1 if the User clicks the Back button]

2.2. Alternate Flows

2.2.1. The User Clicks the Back Button

Any changes are discarded. The Search Brand page is loaded. The searchBrand Use Case is initiated.

2.3. Exceptions

Confirmation Page

1. Confirmation Page

This Use Case describes the Confirmation Page the User reaches when they have completed their editing process for Advertising Directories.

The User clicks the Finish button on the Select Directory page.

2. Flow of Events

2.1. Basic Flow

2.1.1. Confirmation Page

The System loads the Confirmation Page for Managing Directories.

2.2. Alternate Flows

2.3. Exceptions

Select Campaign

1. Select Campaign

This Use Case displays a list of Campaigns that have been created for the selected Client Account. The Campaigns may be Run or Stopped by the User depending on their current status. The User may also select a Campaign to view metrics on it, or select a Campaign to edit it. The User may also add a new Campaign to the Client Account.

The User launches the Brandkey Advertise Control Panel, then clicks the Manage Campaigns menu item, and then clicks the Manage Campaigns sub-menu item.

2. Flow of Events

2.1. Basic Flow

2.1.1. Select Campaign

The System launches the Select Campaign page. The User Marquee is shown at the top of the page. The Select Campaign table is shown. The table has three tabs; Active Campaigns, Inactive Campaigns, and All Campaigns. The Active Campaigns tab is selected by default. In the Active Campaigns tab, all available active Campaigns are pulled from the Database for the Client Account the User selected during Login. Those Campaigns are shown in the Select Campaign table. If there are more than five Campaigns pulled from the Database, then the System displays the appropriate navigation item beneath the table. If there are no Campaigns pulled from the Database, then the System displays the following message in the table; “No records found” The Campaign table consists of the following rows:

Campaign Name (link)

Registration Number

Start Date (mm/dd/yyyy format)

Stop Date (mm/dd/yyyy format)

Status (says either: stopped or running)

Select (has either a Run button, Stop button, or expired text)

Edit (Edit button)

If the Campaign is currently running, then the Status column has “running” text in it for that Campaign in green. If the Campaign is no longer running, then the Status column has “stopped” text in if for that Campaign in red. If the Stop Date for a Campaign is past the current date, then the Select column will have “expired” text in it for that Campaign. If the Campaign is currently not expired and is stopped, there will be a “Start” button in the Select column. If the Campaign is currently not expired and is running, there will be a “Stop” button in the Select column. The Edit column will have an “Edit” button as long as the Directory assigned to the Campaign is still active. If the Directory is no longer active, then there will be no button displayed in the Edit column. If the User clicks the Run button for a Campaign, the System marks that Campaign as running in the Database and refreshes the page. If the User clicks the Stop button for a Campaign, the System marks that Campaign as stopped in the Database and refreshes the page. The User clicks the Finish button. The System loads the Confirmation Page. The confirmationPage Use Case is initiated. [See Alternate Flow 2.2.1 if the User clicks on the Inactive Campaigns tab] [See Alternate Flow 2.2.2 if the User clicks on the All Campaigns tab] [See Alternate Flow 2.2.3 if the User clicks on a Campaign Name link to view Metrics for that Campaign]. [See Alternate Flow 2.2.4 if the User clicks the Edit button for a Campaign]. [See Alternate Flow 2.2.5 if the User clicks the Add Campaign button].

2.2. Alternate Flows

2.2.1. The User Clicks on the Inactive Campaigns Tab

In the Inactive Campaigns tab, all available inactive Campaigns are pulled from the Database for the Client Account the User selected during Login. Those Campaigns are shown in the Select Campaign table. If there are more than five Campaigns pulled from the Database, then the System displays the appropriate navigation item beneath the table. If there are no Campaigns pulled from the Database, then the System displays the following message in the table; “No records found”

2.2.2. The User Clicks on the all Campaigns Tab

In the All Campaigns tab, all available Campaigns, both active and inactive are pulled from the Database for the Client Account the User selected during Login. Those Campaigns are shown in the Select Campaign table. If there are more than five Campaigns pulled from the Database, then the System displays the appropriate navigation item beneath the table. If there are no Campaigns pulled from the Database, then the System displays the following message in the table; “No records found”

2.2.3. The User Clicks on a Campaign Name Link

The System saves which Campaign was selected. The System launches the View Campaign Metrics page. The viewCampaignMetrics Use Case is initiated.

2.2.4. The User Clicks the Edit Button for a Campaign

The System saves which Campaign was selected. The System launches the Edit Campaigns Details page. The editCampaignDetails Use Case is initiated for the Edit Campaign Flow.

2.2.5. The User Clicks the Add Campaign Button

The System launches the Edit Campaigns Details page. The editCampaignDetails Use Case is initiated for the Add Campaign Flow.

2.3. Exceptions

Edit Campaign Details

1. Edit Campaign Details

This Use Case displays the basic details of the selected Campaign.

The User clicks on an Edit button or on the Add Campaign button in the Select Campaign page.

2. Flow of Events

2.1. Basic Flow

2.1.1. Edit Campaign Details

The System launches the Edit Campaign page. The User Marquee is shown at the top of the page. The Campaign Details table is displayed with the appropriate data pulled from the Database for the selected Campaign. The User may make any changes to the details of the Campaign. The User clicks the Next button to save the changes. The System checks that all required fields have been filled in. (All fields are required). [See Exception 2.3.1 if all required fields are not filled in]. The System checks that the dates entered by the User are formatted correctly. [See Exception 2.3.2 if any of the dates are not formatted correctly]. The System checks that the times entered by the User are formatted correctly. [See Exception 2.3.3 if any of the times are not formatted correctly]. The System checks that the Stop Date is greater than the current date. [See Exception 2.3.4 if the Stop Date is before the current date]. The System checks that the Stop Date is greater than the Start Date. [See Exception 2.3.5 if the Stop Date is before the Start Date]. If all the checks pass, then the changes are stored to the Database. The Select Virtual Kiosks page is launched. The selectVirtualKiosks Use Case is initiated. [See Alternate Flow 2.2.1 if the User clicks the Back button].

2.1.2. Add Campaign Details

The System launches the Edit Campaign page. The User Marquee is shown at the top of the page. The Campaign Details table is displayed with all fields blank except the Time Zone drop-down list which is populated from the Database. The User may make any changes to the details of the Campaign. The User clicks the Next button to save the changes. The System checks that all required fields have been filled in. (All fields are required). [See Exception 2.3.1 if all required fields are not filled in]. The System checks that the dates entered by the User are formatted correctly. [See Exception 2.3.2 if any of the dates are not formatted correctly]. The System checks that the times entered by the User are formatted correctly. [See Exception 2.3.3 if any of the times are not formatted correctly]. The System checks that the Stop Date is greater than the current date. [See Exception 2.3.4 if the Stop Date is before the current date]. The System checks that the Stop Date is greater than the Start Date. [See Exception 2.3.5 if the Stop Date is before the Start Date]. If all the checks pass, then the changes are stored to the Database. The Select Advertising Directory page is launched. The selectAdvertisingDirectory Use Case is initiated. [See Alternate Flow 2.2.1 if the User clicks the Back button].

2.2. Alternate Flows

2.2.1. The User Clicks the Back Button

The System discards any changes made on the page and launches the Select Campaign page. The selectCampaign Use Case is initiated.

2.3. Exceptions

2.3.1. All Required Fields are not Filled in by the User

The System reloads the page with the following error message; “You must fill in all required fields on this page in order to continue. All fields are required.”

2.3.2. A User-Entered Date is not Formatted Correctly

The System reloads the page with the following error message; “The date you entered was formatted incorrectly. The correct format is “mm/dd/yyyy”. Please correct the format and submit the page again.”

2.3.3. A User-Entered Time is not Formatted Correctly

The System reloads the page with the following error message; “The time you entered was formatted incorrectly. The correct format is “00:00”. Please correct the format and submit the page again.”

2.3.4. The Stop Date Entered by the User is Before the Current Date

The System loads the page with the following error message; “The Stop Date you entered must be after today.”

2.3.5. The Stop Date Entered by the User is Before the Start Date

The System loads the page with the following error message; “The Stop Date you entered must be after the Start Date.”

Select Advertising Directory

1. Select Advertising Directory

This Use Case allows the User to select which Advertising Directory will be used to populate the selected Campaign.

The User clicks on the Next button in the Edit Campaign page.

2. Flow of Events

2.1. Basic Flow

2.1.1. Select Advertising Directory

The System launches the Select Advertising Directory page. The User Marquee is shown at the top of the page. The Advertising Directories table is displayed on the page. If there are more than 5 Directories, then the Navigation Item is displayed beneath the table. The Advertising Directories table consists of the following columns:

Directory Name (link to next page)

Directory Type

Number of Kiosks

Date Created

The User may select any Directory to work with by clicking on the Directory Name. The Select Virtual Kiosks page is launched. The selectVirtualKiosks Use Case is initiated. [See Alternate Flow 2.2.1 if the User clicks the Back button].

2.2. Alternate Flows

2.2.1. The User Clicks the Back Button

The System discards any changes made on the page and launches the Edit Campaign page. The editCampaignDetails Use Case is initiated.

2.3. Exceptions

Select Virtual Kiosks

1. Select Virtual Kiosks

This Use Case allows the User to select which Virtual Kiosks will be added to the Campaign.

The User clicks on one of the Directories on the Select Advertising Directory page.

2. Flow of Events

2.1. Basic Flow

2.1.1. Select Virtual Kiosks

The System launches the Select Virtual Kiosks page. The User Marquee is shown at the top of the page. The Virtual Kiosks table is displayed on the page. If there are more than 5 Virtual Kiosks, then the Navigation Item is displayed beneath the table. The Virtual Kiosks table consists of the following columns:

Virtual Kiosk Name

Type

Display Order

Installation Domain (link to launch the Installation Domain page)

Preview (button)

Select (checkbox)

Any Virtual Kiosks that have previously been selected will be checked in the list. The User may select any new Virtual Kiosks to add select also. They may also deselect any Virtual Kiosk they no longer wish to have selected in the Campaign. The User clicks the Select button to save their changes. The System checks if any Virtual Kiosks have been deselected from the list. If they have, then the System checks if this Campaign has any Spot Order associated with it. If it has, then the System checks if there are any Spot Order Details for those Spot Orders. If there are, then the System checks if the deselected Virtual Kiosks were in any of those Spot Order Details. If they were, then those Spot Order Details are deleted from the Database. Once this is done, the changes are saved in the Database. The System launches the Select Campaign page. The selectCampaign Use Case is initiated. [See Alternate Flow 2.2.1 if the User clicks the Back button].

2.2. Alternate Flows

2.2.1. The User Clicks the Back Button

The System discards any changes made on the page and launches the Select Advertising Directory page. The editCampaignDetails Use Case is initiated.

2.3. Exceptions

View Campaign Metrics

1. View Campaign Metrics

This Use Case displays the collected Metrics for the Campaign selected by the User on the previous page.

The User clicks on the Campaign Name link on the Select Campaign page.

2. Flow of Events

2.1. Basic Flow

2.1.1. View Campaign Metrics

The System launches the View Campaign Metrics page. The User Marquee is shown at the top of the page. The Campaign Metrics table is shown with the Campaign data pulled from the Database. [See Alternate Flow 2.2.1 if the User clicks the Edit button]. [See Alternate Flow 2.2.2 if the User clicks the Back button].

2.2. Alternate Flows

2.2.1. The User clicks the Edit button for a Campaign The System saves which Campaign was selected. The System launches the Edit Campaigns Details page. The editCampaignDetails Use Case is initiated for the Edit Campaign Flow.

2.2.2. The User Clicks the Back Button

The System launches the Select Campaign page. The selectCampaign Use Case is initiated.

2.3. Exceptions

Select Spot Order

1. Select Spot Order

This Use Case displays a list of Spot Orders that have been created for the selected Client Account. The Spot Orders may be modified by the User. The User may also select a Spot Order to edit it. The User may also add a new Spot Order to the Client Account.

The User launches the Brandkey Advertise Control Panel, then clicks the Manage Spot Orders menu item.

2. Flow of Events

2.1. Basic Flow

2.1.1. Select Spot Order

The System launches the Select Spot Order page. The User Marquee is shown at the top of the page. The Select Spot Order table is shown. The table has three tabs; Active Spot Orders, Inactive Spot Orders, and All Spot Orders. The Active Spot Orders tab is selected by default. In the Active Spot Orders tab, all available active Spot Orders are pulled from the Database for the Client Account the User selected during Login. Those Spot Orders are shown in the Select Spot Order table. If there are more than five Spot Orders pulled from the Database, then the System displays the appropriate navigation item beneath the table. If there are no Spot Orders pulled from the Database, then the System displays the following message in the table; “No records found” The Spot Orders table consists of the following columns:

Spot Order Number

Campaign

Placed

No. of Ad-Spots

No. of Virtual Kiosks

Edit (Edit button)

Active (checkbox)

The User clicks the Finish button. Any changes made in the table are saved to the Database. The System loads the Confirmation Page. The confirmationPage Use Case is initiated. [See Alternate Flow 2.2.1 if the User clicks on the Inactive Spot Orders tab] [See Alternate Flow 2.2.2 if the User clicks on the All Spot Orders tab] [See Alternate Flow 2.2.3 if the User clicks the Edit button for a Spot Order]. [See Alternate Flow 2.2.4 if the User clicks the New Spot Order button].

2.2. Alternate Flows

2.2.1. The User Clicks on the Inactive Spot Orders Tab

In the Inactive Spot Orders tab, all available inactive Spot Orders are pulled from the Database for the Client Account the User selected during Login. Those Spot Orders are shown in the Select Spot Order table. If there are more than five Spot Orders pulled from the Database, then the System displays the appropriate navigation item beneath the table. If there are no Spot Orders pulled from the Database, then the System displays the following message in the table; “No records found”

2.2.2. The User Clicks on the all Spot Orders Tab

In the All Spot Orders tab, all available Spot Orders, both active and inactive are pulled from the Database for the Client Account the User selected during Login. Those Spot Orders are shown in the Select Spot Order table. If there are more than five Spot Orders pulled from the Database, then the System displays the appropriate navigation item beneath the table. If there are no Spot Orders pulled from the Database, then the System displays the following message in the table; “No records found”

2.2.3. The User Clicks the Edit Button for a Spot Order

The System saves which Spot Order was selected. The System launches the Manage Ad Spots page. The manageAdSpots Use Case is initiated for the Edit Spot Order Flow.

2.2.4. The User Clicks the Add Spot Order Button

The System launches the Select Campaign page. The selectCampaign Use Case is initiated for the Add Spot Order Flow.

2.3. Exceptions

Select Campaign

1. Select Campaign

This Use Case displays a list of Campaigns that have been created for the selected Client Account. The User may also select a Campaign to add it to the Spot Order.

The User clicks the Edit or New Spot Order button on the Select Spot Order page.

2. Flow of Events

2.1. Basic Flow

2.1.1. Select Campaign

The System launches the Select Campaign page. The User Marquee is shown at the top of the page. The Select Campaign table is shown. The list of available Campaigns is pulled from the Database to populate this table. If no Campaigns are found, then the following message is shown in the table; “no records found.” The Campaign table consists of the following columns:

Campaign Name (link to the next page)

Registration Number

Start Date

Stop Date

No. of Kiosks

No. of Spot Orders

Status

The User clicks on a Campaign Name to select it. The System loads the Manage Ad Spots Page. The manageAdSpots Use Case is initiated. [See Alternate Flow 2.2.1 if the User clicks the Back button].

2.2. Alternate Flows

2.2.1. The User Clicks on the Back Button

The System loads the Select Spot Order page. The selectSpotOrder Use Case is initiated.

2.3. Exceptions

Manage Ad Spots

1. Manage Ad Spots

This Use Case displays a list of Ad-Spots that have been assigned to the Spot Order. The User may select new Ad-Spots, place Ad-Spots on Virtual Kiosks, and set the sequence of the Ad-Spots to be played in the Virtual Kiosk, or remove any Ad-Spots from the Spot Order.

The User selects a Campaign from the Select Campaign page.

2. Flow of Events

2.1. Basic Flow

2.1.1. Manage Ad Spot

The System launches the Manage Ad Spot page. The User Marquee is shown at the top of the page. The Ad-Spot table is shown. The table has three tabs; Selected Ad-Spots, Deselected Ad-Spots, and All Ad-Spots. The Selected Ad-Spots tab is selected by default. In the Selected Ad-Spots tab, all available active Ad-Spots are pulled from the Database for the selected Spot Order. Those Ad-Spots are shown in the Manage Ad-Spot table. If there are more than five Ad-Spots pulled from the Database, then the System displays the appropriate navigation item beneath the table. If there are no Ad-Spots pulled from the Database, then the System displays the following message in the table; “No records found” The Manage Ad-Spots table consists of the following columns:

Ad-Spot (link to view the advertisement)

Description

Place Ad-Spot on Virtual Kiosks (Place button)

Select (checkbox)

The User may select any unselected Ad-Spot or deselect any selected Ad-Spot. The User clicks the Next button to save the changes. The System checks if the User has deselected any Ad-Spot. If the User has deselected any Ad-Spot, then the System will set those records as inactive in the Database. The System loads the Select Campaign Page. The selectCampaign Use Case is initiated. [See Alternate Flow 2.2.1 if the User clicks on the Deselected Ad-Spots tab] [See Alternate Flow 2.2.2 if the User clicks on the All Ad-Spots tab] [See Alternate Flow 2.2.3 if the User clicks the Place button for an Ad-Spot]. [See Alternate Flow 2.2.4 if the User clicks the Select Advertisements button]. [See Alternative Flow 2.2.5 if the User clicks the Sequence Ad Spots button]. [See Alternative Flow 2.2.6 if the User clicks on the Back button]. [See Alternate Flow 2.2.7 if the User clicks on an Ad-Spot link].

2.2. Alternate Flows

2.2.1. The User Clicks on the Deselected Ad-Spots Tab

In the Deselected Ad-Spots tab, all available inactive Ad-Spots are pulled from the Database for the selected Spot Order. Those Ad-Spots are shown in the Manage Ad-Spots table. If there are more than five Ad-Spots pulled from the Database, then the System displays the appropriate navigation item beneath the table. If there are no Ad-Spots pulled from the Database, then the System displays the following message in the table; “No records found”

2.2.2. The User Clicks on the all Ad-Spots Tab

In the All Ad-Spots tab, all available Ad-Spots are pulled from the Database for the selected Spot Order. Those Ad-Spots are shown in the Manage Ad-Spots table. If there are more than five Ad-Spots pulled from the Database, then the System displays the appropriate navigation item beneath the table. If there are no Ad-Spots pulled from the Database, then the System displays the following message in the table; “No records found”

2.2.3. The User Clicks the Place Button for an Ad-Spot

The System saves which Ad-Spot was selected. The System launches the Place Ad-Spots page. The placeAdSpots Use Case is initiated.

2.2.4. The User Clicks the Select Advertisements Button

The System launches the Select Advertisements page. The selectAdvertisements Use Case is initiated.

2.2.5. The User Clicks the Sequence Ad-Spots Button

The System launches the Sequence Ad-Spots page. The sequenceAdSpots Use Case is initiated.

2.2.6. The User Clicks the Back Button

The System discards any changes the User made and launches the Select Campaign page. The selectCampaign Use Case is initiated.

2.2.7. The User Clicks on an Ad-Spot Link

The System saves which link the User clicked on. The System launches the View Ad-Spot page. The viewAdSpot Use Case is initiated.

2.3. Exceptions

Select Advertisements

1. Select Advertisements

This Use Case allows the User to select which Advertisements to add to the Spot Order from a list of Advertisements not already added.

The User clicks the Select Advertisements button on the Manage Ad-Spots page.

2. Flow of Events

2.1. Basic Flow

2.1.1. Select Advertisements

The System launches the Select Advertisements page. The User Marquee is shown at the top of the page. The Advertisements table is shown. In the Advertisements table, all available active Advertisements are pulled from the Database for the selected Campaign. If no additional Advertisements are available then the following message will be displayed in the table; “No additional records found”. The Advertisements table consists of the following columns:

Advertisement (link to view the advertisement)

Description

Select (checkbox→unchecked by default)

The User may select any Advertisement to add to the Spot Order. The User clicks the Import button to save the changes. The System saves the list of selected Advertisements to the Spot Order and then loads the Manage Ad-Spot Page. The manageAdSpot Use Case is initiated. [See Alternative Flow 2.2.6 if the User clicks on the Back button].

2.2. Alternate Flows

2.2.1. The User Clicks the Back Button

The System discards any changes the User made and launches the Select Campaign page. The selectCampaign Use Case is initiated.

2.3. Exceptions

Place Ad Spots

1. Place Ad Spots

This Use Case displays a list of Virtual Kiosks on which the selected advertisement may be placed. The User may place the advertisement on any of the available Virtual Kiosks.

The User clicks on a Place button on the Manage Ad-Spots page.

2. Flow of Events

2.1. Basic Flow

2.1.1. Place Ad Spot

The System launches the Place Ad Spot page. The User Marquee is shown at the top of the page. The Ad-Spot Placement table is shown. The table has multiple tabs based on the number of Virtual Kiosk Types that are available; All, P-S, S-S, V-S, S-P-S, R-S, I-S, and C-S. The All tab is selected by default. In the All tab, all available active Virtual Kiosks are pulled from the Database for the selected Campaign. Those Virtual Kiosks are shown in the Ad-Spot Placement table. If there are more than five Virtual Kiosks pulled from the Database, then the System displays the appropriate navigation item beneath the table. If there are no Virtual Kiosks pulled from the Database, then the System displays the following message in the table; “No records found” The Ad-Spots Placement table consists of the following columns:

Virtual Kiosk Name

Display Order

Installation Domain (link to launch the Installation Domain URL)

Preview (Preview button)

Dates (Dates button)

Current Number of Ad-Spots

Select (checkbox, only if the Current Number of Ad-Spots is less than 5)

The System shall check any checkbox on which the advertisement is already installed and active. The User may select any unselected Virtual Kiosk or deselect any selected Virtual Kiosk. The User clicks the Select button to save the changes. The System checks if the User has deselected any Virtual Kiosk. If the User has deselected any Virtual Kiosk, then the System will set those records as inactive in the Database. The System loads the Manage Ad Spots Page. The manageAdSpots Use Case is initiated. [See Alternate Flow 2.2.1 if the User clicks on any of the other Virtual Kiosk tabs] [See Alternate Flow 2.2.2 if the User clicks on the Installation Domain link for a Virtual Kiosk] [See Alternate Flow 2.2.3 if the User clicks the Preview button for a Virtual Kiosk]. [See Alternate Flow 2.2.4 if the User clicks the Dates button for a Virtual Kiosk]. [See Alternative Flow 2.2.5 if the User clicks the Set Default Dates button]. [See Alternative Flow 2.2.6 if the User clicks on the Back button].

2.2. Alternate Flows

2.2.1. The User Clicks on any of the Other Virtual Kiosk Tabs

The System determines which Virtual Kiosk Type is to be displayed. In the appropriate Virtual Kiosk tab, all available active Virtual Kiosks of the selected Type are pulled from the Database for the selected Campaign. Those Virtual Kiosks are shown in the Ad-Spot Placement table. If there are more than five Virtual Kiosks pulled from the Database, then the System displays the appropriate navigation item beneath the table. If there are no Virtual Kiosks pulled from the Database, then the System displays the following message in the table; “No records found”

2.2.2. The User clicks on the Installation Domain link for a Virtual Kiosk The System saves which Installation Domain was selected by the User. The System loads the View Installation Domain page. The viewInstallationDomain Use Case is initiated.

2.2.3. The User Clicks on the Preview Button for a Virtual Kiosk

The System saves which Virtual Kiosk was selected. The System launches the Virtual Kiosk. The appropriate Virtual Kiosk Use Case is initiated.

2.2.4. The User Clicks on the Dates Button for a Virtual Kiosk

The System saves which Virtual Kiosk was selected. The System launches the Set Date Text page. The setDateText Use Case is initiated for a Specific Ad-Spot.

2.2.5. The User Clicks the Set Default Dates Button

The System launches the Set Date Text page. The setDateText Use Case is initiated for all Ad-Spots.

2.2.6. The User Clicks the Back Button

The System discards any changes the User made and launches the Manage Ad-Spots page. The manageAdSpots Use Case is initiated.

2.3. Exceptions

Set Dates

1. Set Dates

This Use Case allows the User to set the Start and Stop Dates for the selected Ad-Spot.

The User clicks on a Dates button on the Place Ad-Spots page for a specific Ad-Spot or on the Set Default Dates button.

2. Flow of Events

2.1. Basic Flow

2.1.1. Set Dates for a Specific Ad-Spot

The System launches the Set Dates page. The User Marquee is shown at the top of the page. The Set Dates table is shown. If the Dates for this Ad-Spot have previously been set, then they are displayed on this page, else the fields are blank. The System pulls the list of Time Zones from the Database. The User enters the dates and times for the Ad-Spot. The User clicks the Set button to save the changes. The System checks to see if all required fields have been filled in. All fields on this page are required. [See Exception 2.3.1 if all required fields are not filled in]. The System then checks to see if the format of the Dates entered is correct. [See Exception 2.3.2 if the Date format is not correct]. The System then checks to see if the format of the Times entered is correct. [See Exception 2.3.3 if the Time format is not correct]. The System then checks to see if the Start Date entered for the Ad-Spot is after the Start Date of the Campaign. [See Exception 2.3.4 if the Start Date is before the Start Date of the Campaign]. The System then checks to see if the End Date of the Ad-Spot is after today's date. [See Exception 2.3.5 if the End Date is before today's date]. The System saves the information to the Database for the selected Ad-Spot. The System loads the Place Ad-Spots page. The placeAdSpots Use Case is initiated. [See Alternate Flow 2.2.1 if the Back button is clicked].

2.1.2. Set Default Dates for all Ad-Spots

The System launches the Set Default Dates page. The User Marquee is shown at the top of the page. The Set Dates table is shown. If the Dates for this Ad-Spot have previously been set, then they are displayed on this page, else the fields are blank. The System pulls the list of Time Zones from the Database. The User enters the dates and times for the Ad-Spot. The User clicks the Set button to save the changes. The System checks to see if all required fields have been filled in. All fields on this page are required. [See Exception 2.3.1 if all required fields are not filled in]. The System then checks to see if the format of the Dates entered is correct. [See Exception 2.3.2 if the Date format is not correct]. The System then checks to see if the format of the Times entered is correct. [See Exception 2.3.3 if the Time format is not correct]. The System then checks to see if the Start Date entered for the Ad-Spot is after the Start Date of the Campaign. [See Exception 2.3.4 if the Start Date is before the Start Date of the Campaign]. The System then checks to see if the End Date of the Ad-Spot is after today's date. [See Exception 2.3.5 if the End Date is before today's date]. The System then checks to see if the End Date of the Ad-Spot is before the End Date of the Campaign. [See Exception 2.3.6 if the End Date of the Ad-Spot is after the End Date of the Campaign]. The System saves the information to the Database for all checked Ad-Spots. The System loads the Place Ad-Spots page. The placeAdSpots Use Case is initiated. [See Alternate Flow 2.2.1 if the Back button is clicked].

2.2. Alternate Flows

2.2.1. The User Clicks the Back Button

The System discards any changes the User made and launches the Place Ad-Spots page. The placeAdSpots Use Case is initiated.

2.3. Exceptions

2.3.1. The User has not Filled in all Required Fields

The System loads the current page with the following error message; “Please fill in all required fields.”

2.3.2. The Date Format is not Correct

The System loads the current page with the following error message; “The format of the Dates you entered is not correct. Please use the following format: mm/dd/yyyy.”

2.3.3. The Time Format is not Correct

The System loads the current page with the following error message; “The format of the Times you entered is not correct. Please use the following format: 00:00.”

2.3.4. The Start Date is Before the Start Date of the Campaign

The System loads the current page with the following error message; “The Start Date of the Ad-Spot you entered is before the Start Date of the Campaign. Please change your Start Date to be after the beginning of the Campaign.”

2.3.5. The End Date is Before Today's Date

The System loads the current page with the following error message; “The End Date of the Ad-Spot you entered is before today's date. Please change your End Date to be after today's date.”

2.3.6. The End Date is after the End Date of the Campaign

The System loads the current page with the following error message; “The End Date of the Ad-Spot you entered is after the End Date of the Campaign. Please change your End Date to be before the ending of the Campaign.”

Sequence Ad Spots

1. Sequence Ad Spots

This Use Case allows the User to select for which Virtual Kiosk they wish to set the Ad-Pot Sequence.

The User clicks the Sequence Ad Spots button on the Manage Ad-Spots page.

2. Flow of Events

2.1. Basic Flow

2.1.1. Sequence Ad Spots

The System launches the Sequence Ad Spots page. The User Marquee is shown at the top of the page. The Sequence Ad Spots table is shown. The table has multiple tabs based on the number of Virtual Kiosk Types that are available; All, P-S, S-S, V-S, S-P-S, R-S, I-S, and C-S. The All tab is selected by default. In the All tab, all selected Virtual Kiosks in the Spot Order are pulled from the Database. Those Virtual Kiosks are shown in the Sequence Ad Spots table. If there are more than five Virtual Kiosks pulled from the Database, then the System displays the appropriate navigation item beneath the table. If there are no Virtual Kiosks pulled from the Database, then the System displays the following message in the table; “No records found” [See Alternate Flow 2.2.1 if the User clicks on any of the other tabs]. The Sequence Ad Spots table consists of the following columns:

Virtual Kiosk Name

Display Order

Installation Domain (link to launch the Installation Domain URL)

Preview (Preview button)

Sequence Ad-Spots (Sequence button)

The User clicks the Next button to save the Next button to continue to the next page. The System loads the Manage Ad-Spot Page. The manageAdSpot Use Case is initiated. [See Alternate Flow 2.2.2 if the User clicks a Sequence button]. [See Alternate Flow 2.2.3 if the User clicks an Installation Domain link]. [See Alternate Flow 2.2.4 if the User clicks a Preview button]. [See Alternative Flow 2.2.5 if the User clicks on the Back button].

2.2. Alternate Flows

2.2.1. The User Clicks on any of the Other Virtual Kiosk Tabs

The System determines which Virtual Kiosk Type is to be displayed. In the appropriate Virtual Kiosk tab, all available active Virtual Kiosks of the selected Type are pulled from the Database for the selected Campaign. Those Virtual Kiosks are shown in the Ad-Spot Placement table. If there are more than five Virtual Kiosks pulled from the Database, then the System displays the appropriate navigation item beneath the table. If there are no Virtual Kiosks pulled from the Database, then the System displays the following message in the table; “No records found”

2.2.2. The User Clicks a Sequence Button

The System saves which Virtual Kiosk was selected. The System loads the Set Sequence page. The setSequence Use Case is initiated.

2.2.3. The User Clicks on the Installation Domain Link for a Virtual Kiosk

The System saves which Installation Domain was selected by the User. The System loads the View Installation Domain page. The viewInstallationDomain Use Case is initiated.

2.2.4. The User Clicks on the Preview Button for a Virtual Kiosk

The System saves which Virtual Kiosk was selected. The System launches the Virtual Kiosk. The appropriate Virtual Kiosk Use Case is initiated.

2.2.5. The User Clicks the Back Button

The System discards any changes the User made and launches the Select Campaign page. The selectCampaign Use Case is initiated.

2.3. Exceptions

Set Sequence

1. Set Sequence

This Use Case allows the User to set the Sequence of the Advertisements to be viewed by consumers when the selected Virtual Kiosk is launched.

The User clicks the Sequence button for a Virtual Kiosk on the Sequence Ad Spots page.

2. Flow of Events

2.1. Basic Flow

2.1.1. Set Sequence

The System launches the Set Sequence page. The User Marquee is shown at the top of the page. The Set Sequence table is shown. The Set Sequence table consists of the following columns:

Ad Spot (link to view the Ad-Spot)

Description

Select (drop-down list of the number of Ad-Spots that are available)

The User shall select the sequence in which the Advertisements will be shown in the Virtual Kiosk. The User clicks the Sequence button to save the save the changes. The System checks that no duplicate Sequence Numbers have been selected. [See Exception 2.3.1 if duplicate Sequence Numbers have been selected]. The System loads the Sequence Ad-Spot Page. The sequenceAdSpot Use Case is initiated. [See Alternative Flow 2.2.1 if the User clicks on the Back button].

2.2. Alternate Flows

2.2.1. The User Clicks the Back Button

The System discards any changes the User made and launches the Sequence Ad Spot page. The sequenceAdSpot Use Case is initiated.

2.3. Exceptions

2.3.1. Duplicate Sequence Numbers have been Selected

The System loads the current page with the following error message; “You must select unique Sequence Numbers for each Advertisement in the list.”

Brandkey Promote Subsystem Level Services

Virtual Kiosk Promotion Campaign Management Suite (See FIG. 11A)

Control Panel for Managing Promotional Campaigns (See FIG. 11B through 11G)

Select Directory

1. Select Directory

This Use Case allows authorized Users to create and manage Virtual Kiosk Promotional Directories based on their logged-in Client Account.

The User launches the Brandkey Promote Control Panel, and then clicks the Manage Directories menu item.

2. Flow of Events

2.1. Basic Flow

2.1.1. Select Directory

The System launches the Select Directory page. The User Marquee is shown at the top of the page. The Select Directory table is shown. The table has three tabs; Active Directories, Inactive Directories, and All Directories. The Active Directories tab is selected by default. In the Active Directories tab, all available active Directories are pulled from the Database for the Client Account the User selected during Login. Those Directories are shown in the Select Directory table. The Active checkbox for each Directory will be checked by default. If there are more than five Directories pulled from the Database, then the System displays the appropriate navigation item beneath the table. If there are no Directories pulled from the Database, then the System displays the following message in the table; “No records found” [See Alternate Flow 2.2.1 if the User clicks on the Inactive Directories tab] [See Alternate Flow 2.2.2 if the User clicks on the All Directories tab] The User may check or uncheck the Active checkbox for any Directory, depending on the tab they are in. Clicking any of the Navigation items, tabs, or buttons will save any changes made on the page. Before saving the changes to the Database, the System will check if any Directories have been deactivated. If any Directories have been deactivated, then the System will check to see if that Directory is assigned to a running Campaign. If that Directory is assigned to a running Campaign, then the System displays an error message on the page saying; “You can not deactivate a Directory assigned to a running Campaign.”, and no changes are made to the Database. Else, any required changes are saved to the Database. [See Alternate Flow 2.2.3 if the User clicks on and Edit button] [See Alternate Flow 2.2.4 if the User clicks on the Add Directory button] The User will click on the Finish button to complete the editing process on this page. The System will load the Confirmation Page. The confirmationPage Use Case is invoked.

2.2. Alternate Flows

2.2.1. The User Clicks on the Inactive Directories Tab

In the Inactive Directories tab, all available inactive Directories are pulled from the Database for the Client Account the User selected during Login. Those Directories are shown in the Select Directory table. The Active checkbox for each Directory will not be checked by default. If there are more than five Directories pulled from the Database, then the System displays the appropriate navigation item beneath the table. If there are no Directories pulled from the Database, then the System displays the following message in the table; “No records found”

2.2.2. The User Clicks on the all Directories Tab

In the All Directories tab, all available Directories, both active and inactive are pulled from the Database for the Client Account the User selected during Login. Those Directories are shown in the Select Directory table. The Active checkbox for each Directory will be checked if that Directory is active. If there are more than five Directories pulled from the Database, then the System displays the appropriate navigation item beneath the table. If there are no Directories pulled from the Database, then the System displays the following message in the table; “No records found”

2.2.3. The User Clicks on an Edit Button

The System determines for which Directory was the Edit button clicked. The System loads the Set Directory Name and Type page. The setDirectoryNameType Use Case is invoked for editing an existing Directory.

2.2.4. The User Clicks on the Add Directory Button

The System loads the Set Directory Name and Type page. The setDirectoryNameType Use Case is invoked for adding a new Directory.

2.3. Exceptions

Set Directory Name and Type

1. Set Directory Name and Type

This Use Case allows authorized Users to create a new Promotional Directory or edit an existing Promotional Directory.

The User clicks either an Edit button or the Add Directory button on the Select Directory page.

2. Flow of Events

2.1. Basic Flow

2.1.1. Set Directory Name and Type for a New Directory

The System launches the Set Directory Name and Type page. The User Marquee is shown at the top of the page. The Set Directory Name and Type table is displayed. All fields in the table are blank or set as default. The Directory Name textbox is blank. The Directory Type radio button, General is selected. The Active checkbox is checked. The User will enter the basic information they wish to save for the new Directory. The User clicks the Next button to save their changes The System checks that all required fields (marked by red asterisk) are filled in. Required fields are: —Directory Name

[See Exception 2.3.1 if any required fields are not filled in] If all required fields are filled in, then the System saves the information to the Database. The System loads the List Virtual Kiosk page. The listVirtualKiosk Use Case is initiated. [See Alternate Flow 2.2.1 if the User clicks the Back button]

2.1.2. Set Directory Name and Type for an Existing Directory

The System launches the Set Directory Name and Type page. The User Marquee is shown at the top of the page. The Set Directory Name and Type table is displayed. All fields are filled in with information pulled for the Directory from the Database. The Directory Type radio buttons are not available in this instance (once a directory has been created you can not change its Type). The User will enter the basic information they wish to change for the Existing Directory. The User clicks the Next button to save their changes The System checks that all required fields (marked by red asterisk) are filled in. Required fields are: —Directory Name

[See Exception 2.3.1 if any required fields are not filled in] If all required fields are filled in, then the System saves the information to the Database. Before saving the changes to the Database, the System will check if the Directory has been deactivated. If the Directory has been deactivated, then the System will check to see if the Directory is assigned to a running Campaign. If the Directory is assigned to a running Campaign, then the System displays an error message on the page saying; “You can not deactivate a Directory assigned to a running Campaign.”, and no changes are made to the Database. Else, any required changes are saved to the Database. The System loads the List Virtual Kiosk page. The listVirtualKiosk Use Case is initiated. [See Alternate Flow 2.2.1 if the User clicks the Back button]

2.2. Alternate Flows

2.2.1. The User Clicks the Back Button

All changes are discarded. The Select Directory page is loaded. The selectDirectory Use Case is initiated.

2.3. Exceptions

2.3.1. All Required Fields are not Filled in

The System reloads the Set Directory Name and Type page with the following error message; “You must fill in all required fields (marked with a red asterisk).”

List Virtual Kiosk

1. List Virtual Kiosk

This Use Case displays the list of Virtual Kiosks assigned to the selected Directory.

The User clicks the Next button on the Set Directory Name and Type page.

2. Flow of Events

2.1. Basic Flow

2.1.1. List Virtual Kiosk

The System launches the List Virtual Kiosk page. The User Marquee is shown at the top of the page. The System pulls all Virtual Kiosks assigned to the selected Directory to be displayed in the Virtual Kiosk List table on the page. If there are more than 5 Virtual Kiosks found, then the System also displays the appropriate navigation item beneath the table. If there are no Virtual Kiosks assigned to the Directory, then the System displays the following message in the table; “No records found”. [See Alternate Flow 2.2.1 if the User clicks the Back button] [See Alternate Flow 2.2.2 if the User clicks the Select Virtual Kiosks button] [See Alternate Flow 2.2.3 if the User clicks on one of the Installation Domain links] [See Alternate Flow 2.2.4 if the User clicks on the Preview button for any one Virtual Kiosk] The User clicks the Finish button when they are done. The System loads the Select Directory page. The selectDirectory Use Case is initiated.

2.2. Alternate Flows

2.2.1. The User Clicks the Back Button

All changes are discarded. The Set Directory Name and Type page is loaded. The setDirectoryNameType Use Case is initiated.

2.2.2. The User Clicks the Select Virtual Kiosks Button

The System loads the Select Virtual Kiosk Type page. The selectVirtualKioskType Use Case is initiated.

2.2.3. The User Clicks on One of the Installation Domain Links

The System records which Installation Domain was selected to be previewed The System launches a new stripped-down browser window with the Installation Domain loaded in it.

2.2.4. The User Clicks the Preview Button for any One Virtual Kiosk

The System records which Virtual Kiosks was selected to be previewed The System launches the Virtual Kiosk in a new stripped-down browser window. The appropriate Virtual Kiosk Type Use Case is initiated.

2.3. Exceptions

Select Virtual Kiosk Type

1. Select Virtual Kiosk Type

This Use Case allows the User to select which Types of Virtual Kiosks will be available in the Directory.

The User clicks the Select Virtual Kiosk button on the List Virtual Kiosk page.

2. Flow of Events

2.1. Basic Flow

2.1.1. Select Virtual Kiosk Type

The System launches the Select Virtual Kiosk Type page. The User Marquee is shown at the top of the page. The System pulls all available Virtual Kiosk Types from the Database where there are Installed Virtual Kiosks for the Client Account the User selected during Login. If there are no available Virtual Kiosk Types, then the System displays the following message; “No Virtual Kiosks have been installed, therefore no Virtual Kiosk Types may be selected at this time.” The System checks if any Virtual Kiosk Type has previously been selected. If so, then those Virtual Kiosk Types are checked on the page, else all Virtual Kiosk Types are unchecked. The User may select or deselect any Virtual Kiosk Types they wish. The User clicks the Select button to save any changes. The System checks if any Virtual Kiosk Type has been deselected. If so, then They System checks in the list of Virtual Kiosks assigned to the Directory if there are any Virtual Kiosks of that Type. If there are, then the System removes those Virtual Kiosks from the Directory. The System checks if the Directory Type is “general”. If it is, then the System makes sure that all Virtual Kiosks of the selected Types are saved to the Database. Then the System loads the List Virtual Kiosk page. The listVirtualKiosk Use Case is initiated. [See Alternate Flow 2.2.1 if the User clicks the Back button] [See Alternate Flow 2.2.2 if the Directory Type is “brand-specific”]

2.2. Alternate Flows

2.2.1. The User Clicks the Back Button

All changes are discarded. The System loads the List Virtual Kiosk page. The listVirtualKiosk Use Case is initiated.

2.2.2. The Directory Type is Brand-Specific

The System loads the List Brand page. The listBrand Use Case is initiated.

2.3. Exceptions

List Brand

1. List Brand

This Use Case lists the Brands that have been selected whose Products or Services are used to determine which Virtual Kiosks are assigned to the Directory.

The User clicks the Next button on the Select Virtual Kiosk Type page.

2. List Brand

2.1. Basic Flow

2.1.1. List Brand

The System launches the List brand page. The User Marquee is shown at the top of the page. The System pulls the list of assigned Brands from the Database into the Brand table on the page. All of the Brands are selected by default. If no Brands are pulled from the Database, then the following message is displayed in the table; “No records found” If there are more than five Brands pulled from the Database, then the System displays the navigation item appropriately beneath the table. The User may deselect any Brand they wish from the list. The User clicks the Finish button to save any changes they have made. The System checks if any Brand has been deselected. If so, then the System must see if there are any Virtual Kiosks in the Directory Virtual Kiosk list that belong exclusively to those deselected Brands. If so, then those Virtual Kiosks must be removed from the Database. The System must then checks that all the Virtual Kiosks in the table are linked to at least one of the selected Brands. If there are any Virtual Kiosks that do not have a corresponding Brand, then those Virtual Kiosks are removed from the table. The System then checks to make sure any new Virtual Kiosks are added if any new Brands have been added to the list. The System loads the List Virtual Kiosk page. The listVirtualKiosk Use Case is initiated. [See Alternate Flow 2.2.1 if the User clicks the Back button] [See Alternate Flow 2.2.2 if the User clicks the Add Brand button]

2.2. Alternate Flows

2.2.1. The User Clicks the Back Button

All changes are discarded. The Select Virtual Kiosk Type page is loaded. The selectVirtualKioskType Use Case is initiated.

2.2.2. The User Clicks the Add Brand Button

The System loads the Search Brand page. The searchBrand Use Case is initiated.

2.3. Exceptions

Search Brand

1. Search Brand

This Use Case allows the User to search for Brands whose Products or Services are used to determine which Virtual Kiosks are assigned to the Directory.

The User clicks the Add Brand button on the List Brand page.

2. Search Brand

2.1. Basic Flow

2.1.1. Search Brand

The System launches the Search Brand page. The User Marquee is shown at the top of the page. The System pulls all available Categories from the Database into the Category drop-down list. The User enters the search criteria they wish. Search criteria is not required to initiate a search. The User clicks the Search button to initiate the Search. The System saves the Search Criteria (if any is entered). The System loads the Add Brand page. The addBrand Use Case is initiated. [See Alternate Flow 2.2.1 if the User clicks the Back button]

2.2. Alternate Flows

2.2.1. The User Clicks the Back Button

The List Brand page is loaded. The listBrand Use Case is initiated.

2.3. Exceptions

Add Brand

1. Add Brand

This Use Case allows the User to select additional Brands whose Products or Services are used to determine which Virtual Kiosks are assigned to the Directory.

The User clicks the Search button on the Search Brand page.

2. Add Brand

2.1. Basic Flow

2.1.1. Add Brand

The System launches the Add Brand page. The User Marquee is shown at the top of the page. The System retrieves the Search Criteria entered by the User from the previous page. The System performs a Brand Search on available Brands in the Database based on the retrieved Search Criteria. The System lists the matching Brands in the table on the page. The System lists those Brands that match the Search Criteria and that are not already added to the Directory. If no matching Brands were found, then the System displays the following message in the table; “No records found”. If more than five matching Brands were retrieved then the System displays the appropriate navigation item beneath the table. The User may select any Brand they wish to add to the Directory by checking the appropriate checkbox. The User clicks the Add button to add the Brand to the list. The System adds the selected Brands to the list and saves the changes to the Database. The System loads the List Brand page. The listBrand Use Case is initiated. [See Alternate Flow 2.2.1 if the User clicks the Back button]

2.2. Alternate Flows

2.2.1. The User Clicks the Back Button

Any changes are discarded. The Search Brand page is loaded. The searchBrand Use Case is initiated.

2.3. Exceptions

List Virtual Kiosk

1. List Virtual Kiosk

This Use Case displays the list of Virtual Kiosks assigned to the selected Directory.

The User clicks the Next button on the Set Directory Name and Type page.

2. Flow of Events

2.1. Basic Flow

2.1.1. List Virtual Kiosk

The System launches the List Virtual Kiosk page. The User Marquee is shown at the top of the page. The System pulls all Virtual Kiosks assigned to the selected Directory to be displayed in the Virtual Kiosk List table on the page. If there are more than 5 Virtual Kiosks found, then the System also displays the appropriate navigation item beneath the table. If there are no Virtual Kiosks assigned to the Directory, then the System displays the following message in the table; “No records found”. [See Alternate Flow 2.2.1 if the User clicks the Back button] [See Alternate Flow 2.2.2 if the User clicks the Select Virtual Kiosks button] [See Alternate Flow 2.2.3 if the User clicks on one of the Installation Domain links] [See Alternate Flow 2.2.4 if the User clicks on the Preview button for any one Virtual Kiosk] The User clicks the Finish button when they are done. The System loads the Select Directory page. The selectDirectory Use Case is initiated.

2.2. Alternate Flows

2.2.1. The User Clicks the Back Button

All changes are discarded. The Set Directory Name and Type page is loaded. The setDirectoryNameType Use Case is initiated.

2.2.2. The User Clicks the Select Virtual Kiosks Button

The System loads the Select Virtual Kiosk Type page. The selectVirtualKioskType Use Case is initiated.

2.2.3. The User Clicks on One of the Installation Domain Links

The System records which Installation Domain was selected to be previewed The System launches a new stripped-down browser window with the Installation Domain loaded in it.

2.2.4. The User Clicks the Preview Button for any One Virtual Kiosk

The System records which Virtual Kiosks was selected to be previewed The System launches the Virtual Kiosk in a new stripped-down browser window. The appropriate Virtual Kiosk Type Use Case is initiated.

2.3. Exceptions

Confirmation Page

1. Confirmation Page

This Use Case describes the Confirmation Page the User reaches when they have completed their editing process for Promotional Directories.

The User clicks the Finish button on the Select Directory page.

2. Flow of Events

2.1. Basic Flow

2.1.1. Confirmation Page

The System loads the Confirmation Page for Managing Directories.

2.2. Alternate Flows

2.3. Exceptions

Select Campaign

1. Select Campaign

This Use Case displays a list of Campaigns that have been created for the selected Client Account. The Campaigns may be Run or Stopped by the User depending on their current status. The User may also select a Campaign to view metrics on it, or select a Campaign to edit it. The User may also add a new Campaign to the Client Account.

The User launches the Brandkey Promote Control Panel, then clicks the Manage Campaigns menu item, and then clicks the Manage Campaigns sub-menu item.

2. Flow of Events

2.1. Basic Flow

2.1.1. Select Campaign

The System launches the Select Campaign page. The User Marquee is shown at the top of the page. The Select Campaign table is shown. The table has three tabs; Active Campaigns, Inactive Campaigns, and All Campaigns. The Active Campaigns tab is selected by default. In the Active Campaigns tab, all available active Campaigns are pulled from the Database for the Client Account the User selected during Login. Those Campaigns are shown in the Select Campaign table. If there are more than five Campaigns pulled from the Database, then the System displays the appropriate navigation item beneath the table. If there are no Campaigns pulled from the Database, then the System displays the following message in the table; “No records found” The Campaign table consists of the following rows:

Campaign Name (link)

Registration Number

Start Date (mm/dd/yyyy format)

Stop Date (mm/dd/yyyy format)

Status (says either: stopped or running)

Select (has either a Run button, Stop button, or expired text)

Edit (Edit button)

If the Campaign is currently running, then the Status column has “running” text in it for that Campaign in green. If the Campaign is no longer running, then the Status column has “stopped” text in if for that Campaign in red. If the Stop Date for a Campaign is past the current date, then the Select column will have “expired” text in it for that Campaign. If the Campaign is currently not expired and is stopped, there will be a “Start” button in the Select column. If the Campaign is currently not expired and is running, there will be a “Stop” button in the Select column. The Edit column will have an “Edit” button as long as the Directory assigned to the Campaign is still active. If the Directory is no longer active, then there will be no button displayed in the Edit column. If the User clicks the Run button for a Campaign, the System marks that Campaign as running in the Database and refreshes the page. If the User clicks the Stop button for a Campaign, the System marks that Campaign as stopped in the Database and refreshes the page. The User clicks the Finish button. The System loads the Confirmation Page. The confirmationPage Use Case is initiated. [See Alternate Flow 2.2.1 if the User clicks on the Inactive Campaigns tab] [See Alternate Flow 2.2.2 if the User clicks on the All Campaigns tab] [See Alternate Flow 2.2.3 if the User clicks on a Campaign Name link to view Metrics for that Campaign]. [See Alternate Flow 2.2.4 if the User clicks the Edit button for a Campaign]. [See Alternate Flow 2.2.5 if the User clicks the Add Campaign button].

2.2. Alternate Flows

2.2.1. The User Clicks on the Inactive Campaigns Tab

In the Inactive Campaigns tab, all available inactive Campaigns are pulled from the Database for the Client Account the User selected during Login. Those Campaigns are shown in the Select Campaign table. If there are more than five Campaigns pulled from the Database, then the System displays the appropriate navigation item beneath the table. If there are no Campaigns pulled from the Database, then the System displays the following message in the table; “No records found”

2.2.2. The User Clicks on the All Campaigns Tab

In the All Campaigns tab, all available Campaigns, both active and inactive are pulled from the Database for the Client Account the User selected during Login. Those Campaigns are shown in the Select Campaign table. If there are more than five Campaigns pulled from the Database, then the System displays the appropriate navigation item beneath the table. If there are no Campaigns pulled from the Database, then the System displays the following message in the table; “No records found”

2.2.3. The User Clicks on a Campaign Name Link

The System saves which Campaign was selected. The System launches the View Campaign Metrics page. The viewCampaignMetrics Use Case is initiated.

2.2.4. The User Clicks the Edit Button for a Campaign

The System saves which Campaign was selected. The System launches the Edit Campaigns Details page. The editCampaignDetails Use Case is initiated for the Edit Campaign Flow.

2.2.5. The User Clicks the Add Campaign Button

The System launches the Edit Campaigns Details page. The editCampaignDetails Use Case is initiated for the Add Campaign Flow.

2.3. Exceptions

Edit Campaign Details

1. Edit Campaign Details

This Use Case displays the basic details of the selected Campaign.

The User clicks on an Edit button or on the Add Campaign button in the Select Campaign page.

2. Flow of Events

2.1. Basic Flow

2.1.1. Edit Campaign Details

The System launches the Edit Campaign page. The User Marquee is shown at the top of the page. The Campaign Details table is displayed with the appropriate data pulled from the Database for the selected Campaign. The User may make any changes to the details of the Campaign. The User clicks the Next button to save the changes. The System checks that all required fields have been filled in. (All fields are required). [See Exception 2.3.1 if all required fields are not filled in]. The System checks that the dates entered by the User are formatted correctly. [See Exception 2.3.2 if any of the dates are not formatted correctly]. The System checks that the times entered by the User are formatted correctly. [See Exception 2.3.3 if any of the times are not formatted correctly]. The System checks that the Stop Date is greater than the current date. [See Exception 2.3.4 if the Stop Date is before the current date]. The System checks that the Stop Date is greater than the Start Date. [See Exception 2.3.5 if the Stop Date is before the Start Date]. If all the checks pass, then the changes are stored to the Database. The Select Virtual Kiosks page is launched. The selectVirtualKiosks Use Case is initiated. [See Alternate Flow 2.2.1 if the User clicks the Back button].

2.1.2. Add Campaign Details

The System launches the Edit Campaign page. The User Marquee is shown at the top of the page. The Campaign Details table is displayed with all fields blank except the Time Zone drop-down list which is populated from the Database. The User may make any changes to the details of the Campaign. The User clicks the Next button to save the changes. The System checks that all required fields have been filled in. (All fields are required). [See Exception 2.3.1 if all required fields are not filled in]. The System checks that the dates entered by the User are formatted correctly. [See Exception 2.3.2 if any of the dates are not formatted correctly]. The System checks that the times entered by the User are formatted correctly. [See Exception 2.3.3 if any of the times are not formatted correctly]. The System checks that the Stop Date is greater than the current date. [See Exception 2.3.4 if the Stop Date is before the current date]. The System checks that the Stop Date is greater than the Start Date. [See Exception 2.3.5 if the Stop Date is before the Start Date]. If all the checks pass, then the changes are stored to the Database. The Select Promotional Directory page is launched. The selectPromotionalDirectory Use Case is initiated. [See Alternate Flow 2.2.1 if the User clicks the Back button].

2.2. Alternate Flows

2.2.1. The User Clicks the Back Button

The System discards any changes made on the page and launches the Select Campaign page. The selectCampaign Use Case is initiated.

2.3. Exceptions

2.3.1. All Required Fields are not Filled in by the User

The System reloads the page with the following error message; “You must fill in all required fields on this page in order to continue. All fields are required.”

2.3.2. A User-Entered Date is not Formatted Correctly

The System reloads the page with the following error message; “The date you entered was formatted incorrectly. The correct format is “mm/dd/yyyy”. Please correct the format and submit the page again.”

2.3.3. A User-Entered Time is not Formatted Correctly

The System reloads the page with the following error message; “The time you entered was formatted incorrectly. The correct format is “00:00”. Please correct the format and submit the page again.”

2.3.4. The Stop Date Entered by the User is Before the Current Date

The System loads the page with the following error message; “The Stop Date you entered must be after today.”

2.3.5. The Stop Date Entered by the User is Before the Start Date

The System loads the page with the following error message; “The Stop Date you entered must be after the Start Date.”

Select Promotional Directory

1. Select Promotional Directory

This Use Case allows the User to select which Promotional Directory will be used to populate the selected Campaign.

The User clicks on the Next button in the Edit Campaign page.

2. Flow of Events

2.1. Basic Flow

2.1.1. Select Promotional Directory

The System launches the Select Promotional Directory page. The User Marquee is shown at the top of the page. The Promotional Directories table is displayed on the page. If there are more than 5 Directories, then the Navigation Item is displayed beneath the table. The Promotional Directories table consists of the following columns:

Directory Name (link to next page)

Directory Type

Number of Kiosks

Date Created

The User may select any Directory to work with by clicking on the Directory Name. The Select Virtual Kiosks page is launched. The selectVirtualKiosks Use Case is initiated. [See Alternate Flow 2.2.1 if the User clicks the Back button].

2.2. Alternate Flows

2.2.1. The User Clicks the Back Button

The System discards any changes made on the page and launches the Edit Campaign page. The editCampaignDetails Use Case is initiated.

2.3. Exceptions

Select Virtual Kiosks

1. Select Virtual Kiosks

This Use Case allows the User to select which Virtual Kiosks will be added to the Campaign.

The User clicks on one of the Directories on the Select Promotional Directory page.

2. Flow of Events

2.1. Basic Flow

2.1.1. Select Virtual Kiosks

The System launches the Select Virtual Kiosks page. The User Marquee is shown at the top of the page. The Virtual Kiosks table is displayed on the page. If there are more than 5 Virtual Kiosks, then the Navigation Item is displayed beneath the table. The Virtual Kiosks table consists of the following columns:

Virtual Kiosk Name

Type

Display Order

Installation Domain (link to launch the Installation Domain page)

Preview (button)

Select (checkbox)

Any Virtual Kiosks that have previously been selected will be checked in the list. The User may select any new Virtual Kiosks to add select also. They may also deselect any Virtual Kiosk they no longer wish to have selected in the Campaign. The User clicks the Select button to save their changes. The System checks if any Virtual Kiosks have been deselected from the list. If they have, then the System checks if this Campaign has any Spot Order associated with it. If it has, then the System checks if there are any Spot Order Details for those Spot Orders. If there are, then the System checks if the deselected Virtual Kiosks were in any of those Spot Order Details. If they were, then those Spot Order Details are deleted from the Database. Once this is done, the changes are saved in the Database. The System launches the Select Campaign page. The selectCampaign Use Case is initiated. [See Alternate Flow 2.2.1 if the User clicks the Back button].

2.2. Alternate Flows

2.2.1. The User Clicks the Back Button

The System discards any changes made on the page and launches the Select Promotional Directory page. The editCampaignDetails Use Case is initiated.

2.3. Exceptions

View Campaign Metrics

1. View Campaign Metrics

This Use Case displays the collected Metrics for the Campaign selected by the User on the previous page.

The User clicks on the Campaign Name link on the Select Campaign page.

2. Flow of Events

2.1. Basic Flow

2.1.1. View Campaign Metrics

The System launches the View Campaign Metrics page. The User Marquee is shown at the top of the page. The Campaign Metrics table is shown with the Campaign data pulled from the Database. [See Alternate Flow 2.2.1 if the User clicks the Edit button]. [See Alternate Flow 2.2.2 if the User clicks the Back button].

2.2. Alternate Flows

2.2.1. The User Clicks the Edit Button for a Campaign

The System saves which Campaign was selected. The System launches the Edit Campaigns Details page. The editCampaignDetails Use Case is initiated for the Edit Campaign Flow.

2.2.2. The User Clicks the Back Button

The System launches the Select Campaign page. The selectCampaign Use Case is initiated.

2.3. Exceptions

Select Spot Order

1. Select Spot Order

This Use Case displays a list of Spot Orders that have been created for the selected Client Account. The Spot Orders may be modified by the User. The User may also select a Spot Order to edit it. The User may also add a new Spot Order to the Client Account.

The User launches the Brandkey Promote Control Panel, then clicks the Manage Spot Orders menu item.

2. Flow of Events

2.1. Basic Flow

2.1.1. Select Spot Order

2.1.2.

The System launches the Select Spot Order page. The User Marquee is shown at the top of the page. The Select Spot Order table is shown. The table has three tabs; Active Spot Orders, Inactive Spot Orders, and All Spot Orders. The Active Spot Orders tab is selected by default. In the Active Spot Orders tab, all available active Spot Orders are pulled from the Database for the Client Account the User selected during Login. Those Spot Orders are shown in the Select Spot Order table. If there are more than five Spot Orders pulled from the Database, then the System displays the appropriate navigation item beneath the table. If there are no Spot Orders pulled from the Database, then the System displays the following message in the table; “No records found” The Spot Orders table consists of the following columns:

Spot Order Number

Campaign

Placed

No. of Ad-Spots

No. of Virtual Kiosks

Edit (Edit button)

Active (checkbox)

The User clicks the Finish button. Any changes made in the table are saved to the Database. The System loads the Confirmation Page. The confirmationPage Use Case is initiated. [See Alternate Flow 2.2.1 if the User clicks on the Inactive Spot Orders tab] [See Alternate Flow 2.2.2 if the User clicks on the All Spot Orders tab] [See Alternate Flow 2.2.3 if the User clicks the Edit button for a Spot Order]. [See Alternate Flow 2.2.4 if the User clicks the New Spot Order button].

2.2. Alternate Flows

2.2.1. The User Clicks on the Inactive Spot Orders Tab

In the Inactive Spot Orders tab, all available inactive Spot Orders are pulled from the Database for the Client Account the User selected during Login. Those Spot Orders are shown in the Select Spot Order table. If there are more than five Spot Orders pulled from the Database, then the System displays the appropriate navigation item beneath the table. If there are no Spot Orders pulled from the Database, then the System displays the following message in the table; “No records found”

2.2.2. The User Clicks on the all Spot Orders Tab

In the All Spot Orders tab, all available Spot Orders, both active and inactive are pulled from the Database for the Client Account the User selected during Login. Those Spot Orders are shown in the Select Spot Order table. If there are more than five Spot Orders pulled from the Database, then the System displays the appropriate navigation item beneath the table. If there are no Spot Orders pulled from the Database, then the System displays the following message in the table; “No records found”

2.2.3. The User Clicks the Edit Button for a Spot Order

The System saves which Spot Order was selected. The System launches the Manage Promo Spots page. The managePromoSpots Use Case is initiated for Edit Spot Order Flow.

2.2.4. The User Clicks the Add Spot Order Button

The System launches the Select Campaign page. The selectCampaign Use Case is initiated for the Add Spot Order Flow.

2.3. Exceptions

Select Campaign

1. Select Campaign

This Use Case displays a list of Campaigns that have been created for the selected Client Account. The User may also select a Campaign to add it to the Spot Order.

The User clicks the Edit or New Spot Order button on the Select Spot Order page.

2. Flow of Events

2.1. Basic Flow 2.1.1. Select Campaign

The System launches the Select Campaign page. The User Marquee is shown at the top of the page. The Select Campaign table is shown. The list of available Campaigns is pulled from the Database to populate this table. If no Campaigns are found, then the following message is shown in the table; “no records found.” The Campaign table consists of the following columns:

Campaign Name (link to the next page)

Registration Number

Start Date

Stop Date

No. of Kiosks

No. of Spot Orders

Status

The User clicks on a Campaign Name to select it. The System loads the Manage Promo Spots Page. The managePromoSpots Use Case is initiated. [See Alternate Flow 2.2.1 if the User clicks the Back button].

2.2. Alternate Flows

2.2.1. The User Clicks on the Back Button

The System loads the Select Spot Order page. The selectSpotOrder Use Case is initiated.

2.3. Exceptions

Manage Promo Spots

1. Manage Promo Spots

This Use Case displays a list of Promo-Spots that have been assigned to the Spot Order. The User may select new Promo-Spots, place Promo-Spots on Virtual Kiosks, and set the sequence of the Promo-Spots to be played in the Virtual Kiosk, or remove any Promo-Spots from the Spot Order.

The User selects a Campaign from the Select Campaign page.

2. Flow of Events

2.1. Basic Flow

2.1.1. Manage Promo Spot

The System launches the Manage Promo Spot page. The User Marquee is shown at the top of the page. The Promo-Spot table is shown. The table has three tabs; Selected Promo-Spots, Deselected Promo-Spots, and All Promo-Spots. The Selected Promo-Spots tab is selected by default. In the Selected Promo-Spots tab, all available active Promo-Spots are pulled from the Database for the selected Spot Order. Those Promo-Spots are shown in the Manage Promo-Spot table. If there are more than five Promo-Spots pulled from the Database, then the System displays the appropriate navigation item beneath the table. If there are no Promo-Spots pulled from the Database, then the System displays the following message in the table; “No records found” The Manage Promo-Spots table consists of the following columns:

Promo-Spot (link to view the promotion)

Description

Place Promo-Spot on Virtual Kiosks (Place button)

Select (checkbox)

The User may select any unselected Promo-Spot or deselect any selected Promo-Spot. The User clicks the Next button to save the changes. The System checks if the User has deselected any Promo-Spot. If the User has deselected any Promo-Spot, then the System will set those records as inactive in the Database. The System loads the Select Campaign Page. The selectCampaign Use Case is initiated. [See Alternate Flow 2.2.1 if the User clicks on the Deselected Promo-Spots tab] [See Alternate Flow 2.2.2 if the User clicks on the All Promo-Spots tab] [See Alternate Flow 2.2.3 if the User clicks the Place button for an Promo-Spot]. [See Alternate Flow 2.2.4 if the User clicks the Select Promotions button]. [See Alternative Flow 2.2.5 if the User clicks the Sequence Promo Spots button]. [See Alternative Flow 2.2.6 if the User clicks on the Back button]. [See Alternate Flow 2.2.7 if the User clicks on an Promo-Spot link].

2.2. Alternate Flows

2.2.1. The User Clicks on the Deselected Promo-Spots Tab

In the Deselected Promo-Spots tab, all available inactive Promo-Spots are pulled from the Database for the selected Spot Order. Those Promo-Spots are shown in the Manage Promo-Spots table. If there are more than five Promo-Spots pulled from the Database, then the System displays the appropriate navigation item beneath the table. If there are no Promo-Spots pulled from the Database, then the System displays the following message in the table; “No records found”

2.2.2. The User Clicks on the all Promo-Spots Tab

In the All Promo-Spots tab, all available Promo-Spots are pulled from the Database for the selected Spot Order. Those Promo-Spots are shown in the Manage Promo-Spots table. If there are more than five Promo-Spots pulled from the Database, then the System displays the appropriate navigation item beneath the table. If there are no Promo-Spots pulled from the Database, then the System displays the following message in the table; “No records found”

2.2.3. The User Clicks the Place Button for an Promo-Spot

The System saves which Promo-Spot was selected. The System launches the Place Promo-Spots page. The placePromoSpots Use Case is initiated.

2.2.4. The User Clicks the Select Promotions Button

The System launches the Select Promotions page. The selectPromotions Use Case is initiated.

2.2.5. The User Clicks the Sequence Promo-Spots Button

The System launches the Sequence Promo-Spots page. The sequencePromoSpots Use Case is initiated.

2.2.6. The User Clicks the Back Button

The System discards any changes the User made and launches the Select Campaign page. The selectCampaign Use Case is initiated.

2.2.7. The User Clicks on an Promo-Spot Link

The System saves which link the User clicked on. The System launches the View Promo-Spot page. The viewPromoSpot Use Case is initiated.

2.3. Exceptions

Select Promotions

1. Select Promotions

This Use Case allows the User to select which Promotions to add to the Spot Order from a list of Promotions not already added.

The User clicks the Select Promotions button on the Manage Promo-Spots page.

2. Flow of Events

2.1. Basic Flow

2.1.1. Select Promotions

The System launches the Select Promotions page. The User Marquee is shown at the top of the page. The Promotions table is shown. In the Promotions table, all available active Promotions are pulled from the Database for the selected Campaign. If no additional Promotions are available then the following message will be displayed in the table; “No additional records found”. The Promotions table consists of the following columns:

Promotion (link to view the promotion)

Description

Select (checkbox→unchecked by default)

The User may select any Promotion to add to the Spot Order. The User clicks the Import button to save the changes. The System saves the list of selected Promotion to the Spot Order and then loads the Manage Promo-Spot Page. The managePromoSpot Use Case is initiated. [See Alternative Flow 2.2.6 if the User clicks on the Back button].

2.2. Alternate Flows

2.2.1. The User Clicks the Back Button

The System discards any changes the User made and launches the Select Campaign page. The selectCampaign Use Case is initiated.

2.3. Exceptions

Place Promo Spots

1. Place Promo Spots

This Use Case displays a list of Virtual Kiosks on which the selected promotion may be placed. The User may place the promotion on any of the available Virtual Kiosks.

The User clicks on a Place button on the Manage Promo-Spots page.

2. Flow of Events

2.1. Basic Flow

2.1.1. Place Promo Spot

The System launches the Place Promo Spot page. The User Marquee is shown at the top of the page. The Promo-Spot Placement table is shown. The table has multiple tabs based on the number of Virtual Kiosk Types that are available; All, P-S, S-S, V-S, S-P-S, R-S, I-S, and C-S. The All tab is selected by default. In the All tab, all available active Virtual Kiosks are pulled from the Database for the selected Campaign. Those Virtual Kiosks are shown in the Promo-Spot Placement table. If there are more than five Virtual Kiosks pulled from the Database, then the System displays the appropriate navigation item beneath the table. If there are no Virtual Kiosks pulled from the Database, then the System displays the following message in the table; “No records found” The Promo-Spots Placement table consists of the following columns:

Virtual Kiosk Name

Display Order

Installation Domain (link to launch the Installation Domain URL)

Preview (Preview button)

Dates (Dates button)

Current Number of Promo-Spots

Select (checkbox, only if the Current Number of Promo-Spots is less than 5)

The System shall check any checkbox on which the promotion is already installed and active. The User may select any unselected Virtual Kiosk or deselect any selected Virtual Kiosk. The User clicks the Select button to save the changes. The System checks if the User has deselected any Virtual Kiosk. If the User has deselected any Virtual Kiosk, then the System will set those records as inactive in the Database. The System loads the Manage Promo Spots Page. The managePromoSpots Use Case is initiated. [See Alternate Flow 2.2.1 if the User clicks on any of the other Virtual Kiosk tabs] [See Alternate Flow 2.2.2 if the User clicks on the Installation Domain link for a Virtual Kiosk] [See Alternate Flow 2.2.3 if the User clicks the Preview button for a Virtual Kiosk]. [See Alternate Flow 2.2.4 if the User clicks the Dates button for a Virtual Kiosk]. [See Alternative Flow 2.2.5 if the User clicks the Set Default Dates button]. [See Alternative Flow 2.2.6 if the User clicks on the Back button].

2.2. Alternate Flows

2.2.1. The User Clicks on any of the Other Virtual Kiosk Tabs

The System determines which Virtual Kiosk Type is to be displayed. In the appropriate Virtual Kiosk tab, all available active Virtual Kiosks of the selected Type are pulled from the Database for the selected Campaign. Those Virtual Kiosks are shown in the Promo-Spot Placement table. If there are more than five Virtual Kiosks pulled from the Database, then the System displays the appropriate navigation item beneath the table. If there are no Virtual Kiosks pulled from the Database, then the System displays the following message in the table; “No records found”

2.2.2. The User Clicks on the Installation Domain Link for a Virtual Kiosk

The System saves which Installation Domain was selected by the User. The System loads the View Installation Domain page. The viewInstallationDomain Use Case is initiated.

2.2.3. The User Clicks on the Preview Button for a Virtual Kiosk

The System saves which Virtual Kiosk was selected. The System launches the Virtual Kiosk. The appropriate Virtual Kiosk Use Case is initiated.

2.2.4. The User Clicks on the Dates Button for a Virtual Kiosk

The System saves which Virtual Kiosk was selected. The System launches the Set Date Text page. The setDateText Use Case is initiated for a Specific Promo-Spot.

2.2.5. The User Clicks the Set Default Dates Button

The System launches the Set Date Text page. The setDateText Use Case is initiated for default settings.

2.2.6. The User Clicks the Back Button

The System discards any changes the User made and launches the Manage Promo-Spots page. The managePromoSpots Use Case is initiated.

2.3. Exceptions

Set Dates

1. Set Dates

This Use Case allows the User to set the Start and Stop Dates and Promotional Text for the selected Promo-Spot.

The User clicks on a Dates button on the Place Promo-Spots page for a specific Promo-Spot or on the Set Default Dates button.

2. Flow of Events

2.1. Basic Flow

2.1.1. Set Dates for a Specific Promo-Spot

The System launches the Set Dates page. The User Marquee is shown at the top of the page. The Set Dates table is shown. If the Dates for this Promo-Spot have previously been set, then they are displayed on this page, else the fields are blank. The System pulls the list of Time Zones from the Database. The User enters the dates and times for the Promo-Spot. The User clicks the Set button to save the changes. The System checks to see if all required fields have been filled in. All fields on this page are required. [See Exception 2.3.1 if all required fields are not filled in]. The System then checks to see if the format of the Dates entered is correct. [See Exception 2.3.2 if the Date format is not correct]. The System then checks to see if the format of the Times entered is correct. [See Exception 2.3.3 if the Time format is not correct]. The System then checks to see if the Start Date entered for the Promo-Spot is after the Start Date of the Campaign. [See Exception 2.3.4 if the Start Date is before the Start Date of the Campaign]. The System then checks to see if the End Date of the Promo-Spot is after today's date. [See Exception 2.3.5 if the End Date is before today's date]. The System saves the information to the Database for the selected Promo-Spot. The System loads the Place Promo-Spots page. The placePromoSpots Use Case is initiated. [See Alternate Flow 2.2.1 if the Back button is clicked].

2.1.2. Set Default Dates for all Promo-Spots

The System launches the Set Default Dates page. The User Marquee is shown at the top of the page. The Set Dates table is shown. If the Dates for this Promo-Spot have previously been set, then they are displayed on this page, else the fields are blank. The System pulls the list of Time Zones from the Database. The User enters the dates and times for the Promo-Spot. The User clicks the Set button to save the changes. The System checks to see if all required fields have been filled in. All fields on this page are required. [See Exception 2.3.1 if all required fields are not filled in]. The System then checks to see if the format of the Dates entered is correct. [See Exception 2.3.2 if the Date format is not correct]. The System then checks to see if the format of the Times entered is correct. [See Exception 2.3.3 if the Time format is not correct]. The System then checks to see if the Start Date entered for the Promo-Spot is after the Start Date of the Campaign. [See Exception 2.3.4 if the Start Date is before the Start Date of the Campaign]. The System then checks to see if the End Date of the Promo-Spot is after today's date. [See Exception 2.3.5 if the End Date is before today's date]. The System then checks to see if the End Date of the Promo-Spot is before the End Date of the Campaign. [See Exception 2.3.6 if the End Date of the Promo-Spot is after the End Date of the Campaign]. The System saves the information to the Database for all checked Promo-Spots. The System loads the Place Promo-Spots page. The placePromoSpots Use Case is initiated. [See Alternate Flow 2.2.1 if the Back button is clicked].

2.2. Alternate Flows

2.2.1. The User Clicks the Back Button

The System discards any changes the User made and launches the Place Promo-Spots page. The placePromoSpots Use Case is initiated.

2.3. Exceptions

2.3.1. The User has not Filled in all Required Fields

The System loads the current page with the following error message; “Please fill in all required fields.”

2.3.2. The Date Format is not Correct

The System loads the current page with the following error message; “The format of the Dates you entered is not correct. Please use the following format: mm/dd/yyyy.”

2.3.3. The Time Format is not Correct

The System loads the current page with the following error message; “The format of the Times you entered is not correct. Please use the following format: 00:00.”

2.3.4. The Start Date is Before the Start Date of the Campaign

The System loads the current page with the following error message; “The Start Date of the Promo-Spot you entered is before the Start Date of the Campaign. Please change your Start Date to be after the beginning of the Campaign.”

2.3.5. The End Date is Before Today's Date

The System loads the current page with the following error message; “The End Date of the Promo-Spot you entered is before today's date. Please change your End Date to be after today's date.”

2.3.6. The End Date is after the End Date of the Campaign

The System loads the current page with the following error message; “The End Date of the Promo-Spot you entered is after the End Date of the Campaign. Please change your End Date to be before the ending of the Campaign.”

Sequence Promo Spots

1. Sequence Promo Spots

This Use Case allows the User to select for which Virtual Kiosk they wish to set the Promo-Pot Sequence.

The User clicks the Sequence Promo Spots button on the Manage Promo-Spots page.

2. Flow of Events

2.1. Basic Flow

2.1.1. Sequence Promo Spots

The System launches the Sequence Promo Spots page. The User Marquee is shown at the top of the page. The Sequence Promo Spots table is shown. The table has multiple tabs based on the number of Virtual Kiosk Types that are available; All, P-S, S-S, V-S, S-P-S, R-S, I-S, and C-S. The All tab is selected by default. In the All tab, all selected Virtual Kiosks in the Spot Order are pulled from the Database. Those Virtual Kiosks are shown in the Sequence Promo Spots table. If there are more than five Virtual Kiosks pulled from the Database, then the System displays the appropriate navigation item beneath the table. If there are no Virtual Kiosks pulled from the Database, then the System displays the following message in the table; “No records found” [See Alternate Flow 2.2.1 if the User clicks on any of the other tabs]. The Sequence Promo Spots table consists of the following columns:

Virtual Kiosk Name

Display Order

Installation Domain (link to launch the Installation Domain URL)

Preview (Preview button)

Sequence Promo-Spots (Sequence button)

The User clicks the Next button to save the Next button to continue to the next page. The System loads the Manage Promo-Spot Page. The managePromoSpot Use Case is initiated. [See Alternate Flow 2.2.2 if the User clicks a Sequence button]. [See Alternate Flow 2.2.3 if the User clicks an Installation Domain link]. [See Alternate Flow 2.2.4 if the User clicks a Preview button]. [See Alternative Flow 2.2.5 if the User clicks on the Back button].

2.2. Alternate Flows

2.2.1. The User Clicks on any of the Other Virtual Kiosk Tabs

The System determines which Virtual Kiosk Type is to be displayed. In the appropriate Virtual Kiosk tab, all available active Virtual Kiosks of the selected Type are pulled from the Database for the selected Campaign. Those Virtual Kiosks are shown in the Promo-Spot Placement table. If there are more than five Virtual Kiosks pulled from the Database, then the System displays the appropriate navigation item beneath the table. If there are no Virtual Kiosks pulled from the Database, then the System displays the following message in the table; “No records found”

2.2.2. The User Clicks a Sequence Button

The System saves which Virtual Kiosk was selected. The System loads the Set Sequence page. The setSequence Use Case is initiated.

2.2.3. The User Clicks on the Installation Domain Link for a Virtual Kiosk

The System saves which Installation Domain was selected by the User. The System loads the View Installation Domain page. The viewInstallationDomain Use Case is initiated.

2.2.4. The User Clicks on the Preview Button for a Virtual Kiosk

The System saves which Virtual Kiosk was selected. The System launches the Virtual Kiosk. The appropriate Virtual Kiosk Use Case is initiated.

2.2.5. The User Clicks the Back Button

The System discards any changes the User made and launches the Select Campaign page. The selectCampaign Use Case is initiated.

2.3. Exceptions

Set Sequence

1. Set Sequence

This Use Case allows the User to set the Sequence of the Promotions to be viewed by consumers when the selected Virtual Kiosk is launched.

The User clicks the Sequence button for a Virtual Kiosk on the Sequence Promo Spots page.

2. Flow of Events

2.1. Basic Flow

2.1.1. Set Sequence

The System launches the Set Sequence page. The User Marquee is shown at the top of the page. The Set Sequence table is shown. The Set Sequence table consists of the following columns:

Promo Spot (link to view the Promo-Spot)

Description

Select (drop-down list of the number of Promo-Spots that are available)

The User shall select the sequence in which the Promotions will be shown in the Virtual Kiosk. The User clicks the Sequence button to save the save the changes. The System checks that no duplicate Sequence Numbers have been selected. [See Exception 2.3.1 if duplicate Sequence Numbers have been selected]. The System loads the Sequence Promo-Spot Page. The sequencePromoSpot Use Case is initiated. [See Alternative Flow 2.2.1 if the User clicks on the Back button].

2.2. Alternate Flows

2.2.1. The User Clicks the Back Button

The System discards any changes the User made and launches the Sequence Promo Spot page. The sequencePromoSpot Use Case is initiated.

2.3. Exceptions

2.3.1. Duplicate Sequence Numbers have been Selected

The System loads the current page with the following error message; “You must select unique Sequence Numbers for each Promotion in the list.”

Using the Brand Management and Marketing Communication Network of the Present Invention The Brand Management and Marketing Communication Network of the present invention was designed for the ‘non-techie’ marketer. Brand managers with minimal technical knowledge can easily create, install and modify Multi-Mode Virtual Kiosks from their own computers using the five simple tools detailed above, namely: Brandkey Manage™ which allows brand owners to manage accounts, brands and user rights on the Network for organizations having any kind of collaborative arrangement; Brandkey Create™ Subsystem which allows users to choose the content, arrangement and “look and feel” of Brand Information Networks; Brandkey Deliver™ Subsystem which enables users to create and deploy Multi-Mode Virtual Kiosks anywhere on the Web; Brandkey Advertise™ Subsystem which provides brand managers and their advertising agents with a collaborative online marketing communication network to build, track and modify Virtual Kiosk based advertising campaigns in real-time; and Brandkey Promote™ Subsystem Subsystem which, similar to Brandkey Advertise Subsystem, enables brand managers to create, monitor and modify their ever-changing campaigns with promotional agents in real-time.

This suite of Web-based marketing tools or instruments enables brand management teams and their trading partners to deploy and install Multi-Mode Virtual Kiosks at points of display and purchase on the Web. With a few mouse clicks, brand managers regulate the rights and privileges of team members and trading partners on the Subsystem.

Brand management team members and trading partners build and install Multi-Mode Virtual Kiosks. Then brand management team members, as well as their agents and trading partners, simply program the multiple display modes of installed Virtual Kiosks, so that rich media advertising spots, promotional spots, and brand building resources are delivered to shoppers where it counts, creating information-rich brand experiences as intended by brand owners, developing more consistent brand images across all e-tail marketing channels, while simultaneously creating great value and benefits for e-tailer trading partners.

Creating Brand Information Networks

At the heart of the present invention is the Brand Information Network (BIN), which serves as and invisible, but critical foundation for all activities on the Network, and storehouse of links for the digital assets consumers view in each Multi-Mode Virtual Kiosk. Each Brand Information Network is, in essence, a set of data comprised of the following items:

Basic information about the product/service which function as Brand Information Search Keys: Universal Product or Service Number; Trademark or Service mark; Product or Service Descriptor; Product or Service Brand Name; and Product or Service Category

Web location or address (URL) of brand assets/content at the brand owner's disposal (e.g., product video, audio, product image, etc.—in multiple languages if applicable)

Basic, practical display attributes of the brand assets (i.e., text for clickable links, icons dis-played next to the links, sound files associated with the links, types of links, etc.).

Brand owners use combinations of these data links to build and manage Brand Information Networks anywhere using a Web-enabled computer. They can quickly access, shift or change these components when seasonality, pre-purchase/post-purchase considerations and different target audiences require them to modify Brand Information Networks.

The same brand-related information keys (e.g., Universal Product Numbers, Trademarks, Product Descriptors, Universal Service Numbers, Servicemarks, Brand Names, etc.) are used to index each rich media advertising spot, promotional spot, and other brand asset associated with a created Brand Information Network, and these brand-related information keys represent basic building blocks of brand information management and communication system architecture.

Once the Brand Information Networks are in place, brand owners can decide how and where to showcase their brands by building and deploying Multi-Mode Virtual Kiosks. Brand images and messages can be communicated to shoppers through one or more of the three distinct display modes in each Virtual Kiosk: Advertising Display Mode (e.g., rich media intended to create emotional connection); Promotional Display Mode (e.g., time-limited offers in the form of price-based messaging); and Brand Information Network Display Mode (a set of links providing a wide range of information about the product or service, along with search capabilities for the brand's other offerings)

When the user clicks on a Multi-Mode Virtual Kiosk, a combination of the three display modes will play automatically for the consumer, in a sequence determined by the brand owner or trading partner who creates and deploys the Multi-Mode Virtual Kiosk to deliver an effectively choreographed brand experience to the consumer. For example, a Multi-Mode Virtual Kiosk could open with a rich media advertisement, followed by a promotional offer and finally lead the consumer to a custom set of additional brand information—all in a seamless progression. To help marketers rise above the clutter, the same brand-related information keys (e.g., Universal Product Numbers, Trademarks, Product Descriptors, Universal Service Numbers, Servicemarks, Brand Names, etc.) used to index rich media advertising spots, promotional spots, and other brand assets associated with creating Brand Information Networks, are also used to program “virtual brand communication channels” in each Multi-Mode Virtual Kiosk installed on the Network. These brand-related information keys enable consumers to easily search for and access brand information from Multi-Mode Virtual Kiosks at diverse consumer touchpoints.

Customizing and Programming Multi-Mode Virtual Kiosks

Brand owners also have multiple options to customize every Multi-ModeVirtual Kiosk, from selecting its look-and-feel variables (including ‘skin type’ defined by surface texture, color, button style, etc.) and placement of the brand logo, to the type and arrangement of links in each Brand Information Network.

Because brand management teams can create and modify these Virtual Kiosks in-house, they can easily and inexpensively test consumer reception to the arrangement and sequence of these assets in specific Virtual Kiosks.

One of the most intriguing utilities of the BKS Network solution is the sophisticated search capabilities within the same Virtual Kiosk for multiple products and services from a brand owner. The Network has been designed to cater to virtually any level of brand portfolio complexity, and provides the capability for consumers to search for an unlimited number of products or services through the Virtual Kiosk, as determined by the brand owner.

By experimenting with various different display schemas for Brand Information Networks as well as their presentation, brand managers can create powerful new vehicles that convey the value of their product or service brands more effectively than ever before. Because most new combinations of brand assets in a Brand Information Network are protectable under copyright laws, the Brand Management and Marketing Communications Network of the present invention offers brand owners the opportunity to create new forms of intellectual property.

Deploying Multi-Mode Virtual Kiosks

Once the brand owner has built the Virtual Kiosk, s/he can instantly install it on the Web by placing a ‘trigger point’ (tag) on an online retail partner's site.

The Virtual Kiosks can then be ‘brought to life’ (opened) by the user in four simple, intuitive ways: Launch button on an e-tail site or other Web touch point; Clickable image on a website; Image embedded in a document; and Icon on a computer desktop.

The brand owner can, of course, turn any Virtual Kiosk on or off with one click of the mouse, through Network's easy-to-use Web-based system management interface.

Managing Multi-Mode Virtual Kiosks

Once brand owners or their trading partners have placed Virtual Kiosks on the Web, they can easily manipulate the way their Virtual Kiosks deliver brand communications. For example, they can create an advertising campaign (with Advertising Display Mode as the dominant user experience) for a certain length of time and monitor its outcome. They can then shift the focus of the communication to a more promotionally-oriented experience (emphasizing the Promotional Display Mode), without having to recreate the whole set-up process from scratch and spend additional time, money and resources. When important new information about the product or service changes or fresh information becomes available, they can easily add one or more links to the Brand Information Display Mode, with a maximum of ten links.

Collaborating with Trading Partners

The Brand Management and Marketing Communications Network has intuitive, easy-to-use system management interfaces for brand management team members. This system enables brand managers to collaborate with advertising and promotional agents as well as trading partners with and unprecedented level of efficiency and accountability. By simply using a Web browser and a mouse, for example, brand managers can set and adjust the rights and responsibilities of their associates and/or agency and retail trading partners ‘on the fly’.

The Brand Management and Marketing Communications Network provides brand owners with the ability to tightly control their online brand assets, effectively collaborate with their advertising and promotional agents and e-tail trading partners during online brand marketing campaigns, as well as directly communicate with online shoppers across multiple e-tail channels, both at points-of-sale and other places on the Web. The result is that consumers have information-rich brand experiences as intended by brand owners and develop more consistent brand images across all e-tail marketing channels, while great value and benefits are simultaneously created for e-tailer trading partners.

Tracking Web Metrics

The Network offers invaluable insights for brand owners into the way their online marketing programs perform. By continuously monitoring user activity in collaboration with the brand management team, upcoming online communication initiatives can be planned more effectively and efficiently.
The most critical metrics offered for ROI calculations are:
Most typical user paths/behaviors within the Virtual Kiosks
Relative popularity of content within the Virtual Kiosks
Sales where the Virtual Kiosk played a role
How multiple Virtual Kiosks perform against each other within the same campaign
How a brand owner's Virtual Kiosk measures up against other Virtual Kiosks competing in the same category (with all information confidential and anonymous)

The Brand Management and Marketing Communications Network will be filling a critical need for brand managers, e-tailers, advertising agents promotion partners who will need to work even harder in the years to come to communicate rich brand experiences to the impatient consumer on a variety of Web-enabled devices when and where they decide to make a purchase decision. With its ability to target messages to online shoppers, modify content in real-time, and monitor and measure consumer buying behavior in both online and offline platforms, the Brand Management and Marketing Communications Network of the present invention is set to become an indispensable tool to marketers worldwide.

Setting Up and Using the BKS Network

Getting setup to use the BKS Network is a simple procedure. Simply fill in the Registration Form, and let BKS Networks, Inc. (Administrator) verify your information. BKS Networks will also set up your account for you initially. You can then go in and manage your Users and other partners through the Brandkey Manage Subsystem interface. Once you have done that, you can begin to mange your Products and Services through the Brandkey Create Subsystem interface. You can also create and manage the Brand Information Networks through Brandkey Create Subsystem. Once you have created the Brand Information Networks for your Products and Services, you would create and install the Virtual Kiosks you want. You would do that through the Brandkey Deliver Subsystem interface. Once you have Virtual Kiosks installed on different Internet touchpoints, you or your Ad/Promo Agents can create Campaigns and place Advertisements and Promotions on those Virtual Kiosks through the Brandkey Advertise and Brandkey Promote interfaces. You can then manage all your Virtual Kiosks, Advertisements, Promotions, Users, and Metrics through the five subsystems in the BKS Network.

FIG. 11H illustrates an exemplary process describing how a vendor brand manager can work with a retailer brand manager to use the Brand Management and Marketing Communications Network of the present invention in order to deploy and install Product-Specific Multi-Mode Virtual Kiosks on the etailers WWW site at points of virtual product display.

The Brand Management and Marketing Communications Network of the present invention solution generates value simultaneously for all three market participants: brand owner, consumer and e-tailer:

Brand owners can engage the online shopper in interactive shopping experiences that positively influence brand perceptions and impact purchase intent through the use of Multi-Mode Virtual Kiosks, which communicate engaging messages, brand images and a range of information to shoppers while they are in a transactional mindset. They also enjoy better partnerships with their advertising and promotional agents and other trading partners by enabling efficient control over real-time communication in Web-based marketing campaigns.

E-tailers enjoy higher conversion rates of online browsers to buyers, more sales and higher profit margins as the demanding, deal-driven shopper begins to make buying decisions based on compelling brand information rather than price and promotional perks alone. E-tailers can deliver value-added services to consumers, and also generate new revenue not only from the placement of Multi-Mode Virtual Kiosks on their sites, but from advertising and promotion spots as well. Their back-end information processes are more efficient, and their e-commerce sites are less cluttered and more appealing. Also, e-tailers can maintain their e-commerce sites with substantially reduced overhead and significant cost savings.

Consumers experience the enticing, information-rich shopping experiences that help motivate them to follow through with the checkout process and purchase online, as well as received relevant brand information and post-purchase services which build customer loyalty and retention.

Description of Design of Multi-Mode Virtual Kiosks (MMVKs) of the Present Invention

HTML & Embedded Media Player (Current Configuration)

In this configuration, shown in FIG. 15A, the basic layout of the Multi-Mode Virtual Kiosk is created in HTML. All components are also done in HTML with the Media Player part of the Virtual Kiosk as the media layer components of the individually supported players, such as Windows Media Player, QuickTime, etc. Control over the Media Player is held by the base Virtual Kiosk using JavaScript and VBScript.

The Virtual Kiosk will communicate with the Server using HTTP and HTML. The SVG application will communicate with the Server using HTTP and HTML

HTML, Flash & Embedded Media Player

In this configuration, shown in FIG. 15B, the basic layout of the Multi-Mode Virtual Kiosk is again done in HML. The difference is that the Brand Information Network part of the Virtual Kiosk is programmed in Flash. The Media Player portion of the Virtual Kiosk is composed of the individually supported players. Control over the Media Player section of the Virtual Kiosk is held by the base Virtual Kiosk component as well as the Flash component through JavaScript and VBScript.

The Virtual Kiosk will communicate with the Server using HTTP and HTML. The SVG application will communicate with the Server using HTTP, HTML and WS (Web Services).

DHTML & Embedded Media Player

In this configuration, shown in FIG. 15C, the base layout of the Multi-Mode Virtual Kiosk is done in HTML with the Brand Information Network done in DHTML. He Media Player portion of the Virtual Kiosk is composed of the individually supported players. Control over the Media Player section of the Virtual Kiosk is held by the base Virtual Kiosk as well as the DHTML section through JavaScript and VBScript.

The Virtual Kiosk will communicate with the Server using HTTP and HTML. The SVG application will communicate with the Server using HTTP, HTML and XML (Extensible Markup Language).

Applet

In this configuration, shown in FIG. 15D, the base layout of the Virtual Kiosk is again in HTML, but all of the internal components form an Applet. Each internal Applet component such as the Media Player and Brand Information Network communicate internally to provide the User Experience.

The Virtual Kiosk will communicate with the Server using HTTP and HTML. The SVG application will communicate with the Server using HTTP, HTML, XML (Extensible Markup Language) and WS (Web Services).

SVG

In this configuration, shown in FIG. 15E, the base layout of the Virtual Kiosk is again in HTML, but all of the internal components are done in SVG (Scalar Vector Graphics). Each internal component such as the Media Player and Brand Information Network communicate internally to provide the User Experience.

The Virtual Kiosk will communicate with the Server using HTTP and HTML. The SVG application will communicate with the Server using HTTP, HTML, XML (Extensible Markup Language) and WS (Web Services).

Automatic Client Browser and Media Player Detection Mechanism for Automatically Configuring Multi-Mode Virtual Kiosks of the Present Invention

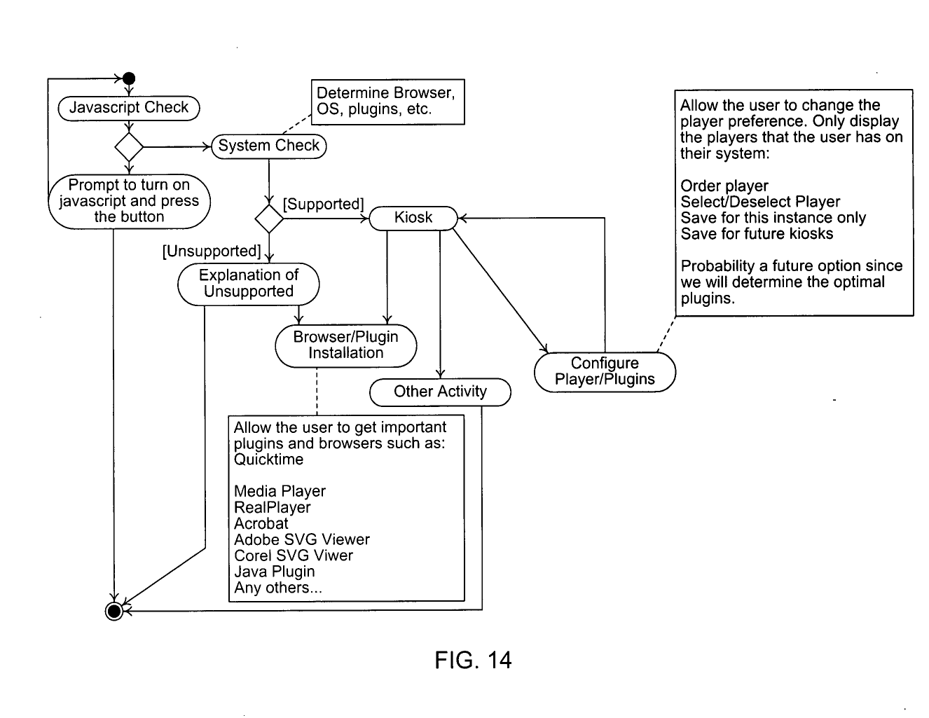

Referring to FIG. 14, the automatic client browser and media player detection mechanism for use in automatically configuring MMVKs of the present invention upon launch (on any Web-enabled client computer) will now described in detail below.

Upon launch, the Multi-Mode Virtual Kiosk shall first check on the client-side of the Network whether JavaScript is turned on within the Client computer supporting the MMVK. If JavaScript is not turned on, then the Multi-Mode Virtual Kiosk shall display a message prompting the User to turn on JavaScript and to then re-launch the Virtual Kiosk.

If JavaScript was already enabled, then the Multi-Mode Virtual Kiosk shall continue to detect which Browser and Operating System the Client is operating on. If an unsupported configuration is detected, then the Multi-Mode Virtual Kiosk shall display a message detailing the reason for the stoppage and listing which platforms are supported.

On the server-side of the Network, the Multi-Mode Virtual Kiosk uses the Request Headers provided by all Browsers and Operating System to determine which platform it is running on. The Request Header is parsed for the information specific to each platform.

If the Multi-Mode Virtual Kiosk is running on a supported platform, then it progresses to check whether all required plug-ins are available. This can be done by polling the Client computer to determine its setup. If any plug-in is missing, the Multi-Mode Virtual Kiosk shall display a notification page regarding the missing plug-in, and if the plug-in is critical, then it will direct the User to download the plug-in. If the plug-in is not critical, it will give the User a choice to download the plug-in or continue with their experience. Once the platform is accepted and all plug-ins are in place, the Virtual Kiosk shall immediately proceed through its programmed modes.

Description of Operation of Multi-Mode Virtual Kiosks (MMVKs) of the Present Invention

Operation of the Product-Specific Multi-Mode Virtual Kiosk of the Illustrative Embodiment

This use case describes the operation of a Product-Specific Multi-Mode Virtual Kiosk from a launch environment.

The user clicks to launch the Product-Specific Virtual Kiosk from a launch environment.

Flow of Events

Launch Multi-Mode Virtual Kiosk with BIN, Ad, and Promo Modes Respectively

The use case begins when the user clicks on the HTML-Encoded Brandkey™ Button to launch the Product-Specific Multi-Mode Virtual Kiosk. The embedded URL tag contains the encrypted identification number of the installed Product-Specific Virtual Kiosk to be launched. The tag sends a request to the system for the virtual kiosk. The system searches for the installed virtual kiosk id, and the system responds by sending back a “Loading . . . ” splash screen to the requestor. When the system finds the virtual kiosk id, the system then determines whether or not the requested virtual kiosk is still active and deployed. If the virtual kiosk is active and deployed, the system shall check whether the requesting domain (website where the virtual kiosk is launched from) is an allowed domain. If the virtual kiosk is launched from an allowed domain, the system shall determine the type of virtual kiosk that is being requested. The system shall determine the layout, color, button set style, and surface texture (skin) to be used in displaying the requested Product-Specific Virtual Kiosk. The system shall determine which display modes and the order they play on the specific Product-Specific Virtual Kiosk. The system shall replace the opened splash screen with the actual Product-Specific Virtual Kiosk. If the Brand Information Network (BIN) Mode was selected first when installing the virtual kiosk, the system shall display the BIN Mode under the “Info” tab to the right of the “Home” tab followed by the “Ads” tab (See FIG. 1). The BIN Mode layout shall contain a Content Display window near the top, all associated links (BIN) in the middle, and an information text bar near the bottom. If the “Send to Friend” feature has been enabled, the system shall display the “Send to Friend” button at the bottom of the BIN Mode layout. As long as a desktop icon has been uploaded, and if the “Download” feature has been enabled, the system shall display the “Download” button at the bottom of the BIN Mode layout. The system shall display the “Buy Now” feature at the bottom of the BIN Mode layout if it is enabled and an associated link has been specified. The system shall display a default image supplied by the virtual kiosk owner in the Content Display window whenever the virtual kiosk is in an idle state (See FIG. 3). The system checks if the multi-mode virtual kiosk has been installed by a retailer. If so, the system checks if there are any purchase-enabling links within the BIN. If true, the system shall not display the purchase-enabling links in the BIN. The Content Display window shall serve as a web browser whenever an associated BIN link is clicked. The system shall display the contents of the link in the Content Display window. (See FIG. 4) In addition, if any of the associated BIN links contains a video clip, the system shall display the virtual kiosk video components while the specific link is clicked and viewed. The virtual kiosk video components shall consist of a graphical mute button, “+” and “−” volume control buttons, a “<<Replay” button, a “Skip>>” button, and a time-lapse meter. After viewing the video clip contained in the link, if the user clicks another BIN link that contains no video clip, the system shall hide the video components from the BIN Mode layout. Within the BIN, the system shall display the associated links of the brand as either Simple Tabular format or Pre-Post Purchase format (See FIG. 3). If there are more than 3 associated links for the BIN, the system shall display the batch navigation bar at the bottom of the Simple Tabular or Pre-Post Purchase table. If the creator of the MMVK had previously selected the “Enable Voting for Link” feature in Brandkey Create™, the system shall display the “Rating” Indicator pull-down list along with the “Vote” button when an associated link in the BIN is clicked. When the user votes for the selected link: The system shall save the vote in the database. The system re-calculates the “Rating” Indicator. The system shall refresh the “Rating” Indicator if needed. If the Ad Mode was selected second when creating the virtual kiosk, the system shall determine the Ad Mode as the next mode and display the Ad Mode under the “Ads” tab to the right of the “Info” tab. If the play list is empty for the Ad Mode, the system shall not display “Ads” tab in the virtual kiosk. If the user clicks the “Ads” tab, the system shall generate a list of ad-spot video clips previously selected in Brandkey Advertise™. If the Promo Mode was selected third when creating the virtual kiosk, the system shall determine the Promo Mode as the next mode and display the Promo Mode under the “Promos” tab to the right of the “Ads” tab when the “Ads” tab is clicked the first time. If the play list is empty for the Promo Mode, the system shall not display the “Promos” tab in the virtual kiosk. For the Ad Mode, the system shall resize, display, and run the generated list of ad-spot video clips in the Ad-Spot Display window. The system shall display the video components below the Ad-Spot Display window, an information text bar near the bottom, and three buttons at the bottom, namely, “Send to Friend”, “Download”, and “Buy Now” as long as they each have been enabled and there has been a desktop icon image uploaded for the Download button and there has been a link specified for the Buy Now button. While the ad-spot video clips are playing, the user may click the “<<Replay” or “Skip>>” button at any time. If the user clicks the “<<Replay” button, the system shall replay the currently playing ad-spot video clip. If the user clicks the “Skip>>” button, the system shall interrupt the ad-spot video clip currently playing, advance to the next video, and start playing. When the last ad-spot video in the list has played, the system shall display the contents of the “Promos” tab automatically. If the user clicks the “Promos” tab prior to the last ad-spot video completing, the system shall generate a list of promo-spot video clips previously selected in Brandkey Promote™. The system shall resize, display, and run the generated list of promo-spot video clips in the Promo-Spot Display window. The system shall display the video components below the Promo-Spot Display window, and a promotions-related text bar near the bottom. If the “Send to Friend” feature has been enabled, the system shall display the “Send to Friend” button at the bottom of the Promo Mode layout. As long as a desktop icon has been uploaded, and if the “Download” feature has been enabled, the system shall display the “Download” button at the bottom of the Promo Mode layout. The system shall display the “Buy Now” feature at the bottom of the Promo Mode layout if it is enabled and an associated link has been specified. The system shall display a default image supplied by the virtual kiosk owner in the Content Display window whenever the virtual kiosk is in an idle state. While the promo-spot video clips are playing, the user may click the “<<Replay” or “Skip>>” button at any time. If the user clicks the “<<Replay” button, the system shall replay the currently playing promo-spot video clip. If the user clicks the “Skip>>” button, the system shall interrupt the promo-spot video clip currently playing, advance to the next video, and start playing. When the last promo-spot video in the list has played, the system shall remain in that state until the user clicks a button. The system shall display the default image, if one has been defined for the BIN, in the Content Display window. If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying the “Info” tab section, the “Ads” tab, and the “Promos” tab to the right of the “Info” tab.

Launch Multi-Mode Virtual Kiosk with BIN, and Ad Modes

After the system has displayed the BIN Mode and Ad Mode, the system shall check for the next mode. The system determines there is no Promo Mode, and the system shall remain in Ad Mode state until the user clicks a button. If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying the “Info” tab section, and the “Ads” tab to the right of the “Info” tab.

Launch Multi-Mode Virtual Kiosk with BIN Only

After the system has displayed the BIN Mode, the system shall check for the next mode. The system determines there is neither Ad Mode nor Promo Mode, and the system shall remain in the BIN Mode. If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying the “Info” tab section.

Launch Multi-Mode Virtual Kiosk with Ad and Promo Modes

If the Ad Mode was selected first when creating the virtual kiosk, the system determines there is no BIN Mode and displays the Ad Mode under the “Ads” tab to the right of the “Home” tab (See FIG. 1). The system shall check for the next mode. The system determines the Promo Mode is next and displays the Promo Mode under the “Promos” tab to the right of the “Ads” tab (See FIG. 2). If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying the “Ads” tab section, and the “Promos” tab to the right of the “Ads” tab.

Launch Multi-Mode Virtual Kiosk with only Ad or Promo Mode

If either the Ad Mode or Promo Mode was selected as the only mode when creating the virtual kiosk, the system determines there is neither a BIN Mode nor Ad/Promo Mode and displays the Ad/Promo Mode under the “Ads”/“Promos” tab to the right of the “Home” tab. If the user clicks the “Home” tab at anytime, the system shall reset the virtual kiosk to the original order while the system re-displays the “Loading . . . ” splash screen. When the reset is complete, the system shall replace the splash screen with the Product-Specific Virtual Kiosk displaying either the “Ads” or “Promos” tab section to the right of the “Home” tab.

The Replay Button is Clicked

If the system is in Ad Mode, the system shall replay the currently playing ad-spot video clip. If the system is in Promo Mode, the system shall replay the currently playing promo-spot video clip. If the system is in BIN Mode, and if any of the associated BIN links contains a video clip, the system shall play the video contained in the BIN link from the beginning.

The Skip Button is Clicked

If the system is in Ad Mode, the system shall interrupt the ad-spot video clip currently playing, advance to the next video, and start playing. If the system is in Promo Mode, the system shall interrupt the promo-spot video clip currently playing, advance to the next video, and start playing. If the system is in BIN Mode, and if any of the associated BIN links contains a video clip, the system shall advance the video to the end and stop.

The Volume Control (+) Button is Clicked

The system increases the volume.

The Volume Control (−) Button is Clicked

The system decreases the volume.

The Send to Friend Button is Clicked

If the user clicks the “Send to Friend” button, the system shall display a small form in the Content Display window that contains a “From:” section comprised of a “Name:” text field, an “E-mail:” text field, and a “Message” text area, a “To:” section comprised of an “E-mail1:” text field, an “E-mail2:” text field, an “E-mail3:” text field, an “E-mail4:” text field, an “E-mail5:” text field, a “Send” button, and a “Cancel” button (See FIG. 5). If the user fills the information on the form and clicks the “Send” button, the system shall send the message via the system SMTP server. The message is sent and the system shall replace the message form with a confirmation page. The confirmation page shall display the following message, “A link to this virtual kiosk has been sent, and a confirmation e-mail has also been sent to your e-mail address. Click here to re-launch this Virtual Kiosk.” If the user clicks the “Cancel” button, the system shall replace the message form with the contents of the previously selected tab. If the User clicks the link to re-launch the Virtual Kiosk, then the system shall reset the virtual kiosk to the original order while the system re-displays the “Loading . . . ” splash screen.

The Download Button is Clicked

TBD

The Buy Now Button is Clicked

If the user clicks the “Buy Now” button, the system shall determine where to open the “Buy Now” associated link. If the creator of the virtual kiosk originally selected to open the associated link in the virtual kiosk, the system shall open the “Buy Now” link in the Content Display window. If the creator of the virtual kiosk originally selected to open the associated link outside of the virtual kiosk, the system shall determine whether there is a parent window to open the virtual kiosk in or open the virtual kiosk in a new window.

Requested Virtual Kiosk is No Longer Active or Deployed

The system shall display the following error message on the screen, “The requested Virtual Kiosk is no longer available from [Virtual Kiosk Sponsor's Name].”

The Launching Domain is a Forbidden Domain

The system shall display the following error message on the screen, “This website is not authorized to launch the requested Virtual Kiosk. Please contact admin@bksnetworks.com to inform them of any illegal use of the requested Virtual Kiosk. Thank you.”

One or More Visual Attributes of the Requested Virtual Kiosk are not Available

The system shall display the following error message on the screen, “The requested Virtual Kiosk is currently not available. Please try back again later.”

Operation of the Vendor-Specific Multi-Mode Virtual Kiosk of the Illustrative Embodiment

This use case describes the operation of a Vendor-Specific Virtual Kiosk from a launch environment.

The user clicks to launch the Vendor-Specific Virtual Kiosk from a launch environment.

Flow of Events

Launch Multi-Mode Virtual Kiosk with BIN, Ad, and Promo Modes Respectively

The use case begins when the user clicks on the HTML-Encoded Brandkey™ Button to launch the Vendor-Specific Multi-Mode Virtual Kiosk. The embedded URL tag contains the encrypted identification number of the installed Vendor-Specific Virtual Kiosk to be launched. The tag sends a request to the system for the virtual kiosk. The system searches for the installed virtual kiosk id, and the system responds by sending back a “Loading . . . ” splash screen to the requester. When the system finds the virtual kiosk id, the system then determines whether or not the requested virtual kiosk is still active and deployed. If the virtual kiosk is active and deployed, the system shall check whether the requesting domain (website where the virtual kiosk is launched from) is an allowed domain. If the virtual kiosk is launched from an allowed domain, the system shall determine the type of virtual kiosk that is being requested. The system shall determine the color to be used in displaying the requested Vendor-Specific Virtual Kiosk. The system shall determine which display modes and the order they play on the specific Vendor-Specific Virtual Kiosk. The system shall replace the opened splash screen with the actual Vendor-Specific Virtual Kiosk. If the Brand Information Network (BIN) Mode was selected first when creating the virtual kiosk, the system shall display the BIN Mode under the “Info” tab to the right of the “Home” tab followed by the “Ads” tab. The BIN Mode layout shall contain a Content Display window near the top, all associated links (BIN) in the middle, and an information text bar near the bottom. The system shall check how many products are associated with this virtual kiosk. If there is more than one product associated, the system shall display the “Search” tab to the right of all other tabs (See FIG. 6). If there are no products associated, the “Search” tab will not be displayed. If there is only one product associated with the virtual kiosk, the system shall not display the “Search” tab. As soon as the “Promo” tab is selected, the system shall display the “Info” tab. (See FIG. 2) If the “Send to Friend” feature has been enabled, the system shall display the “Send to Friend” button at the bottom of the BIN Mode layout. As long as a desktop icon has been uploaded, and if the “Download” feature has been enabled, the system shall display the “Download” button at the bottom of the BIN Mode layout. The system shall display the “Buy Now” feature at the bottom of the BIN Mode layout if it is enabled and an associated link has been specified. The system shall display a default image supplied by the virtual kiosk owner in the Content Display window whenever the virtual kiosk is in an idle state. The system checks if a retailer has installed the multi-mode virtual kiosk. If so, the system checks if there are any purchase-enabling links within the BIN. If true, the system shall not display the purchase-enabling links in the BIN. The Content Display window shall serve as a web browser whenever an associated BIN link is clicked. The system shall display the contents of the link in the Content Display window (See FIG. 4). In addition, if any of the associated BIN links contains a video clip, the system shall display the virtual kiosk video components while the specific link is clicked and viewed. The virtual kiosk video components shall consist of a graphical mute button, “+” and “−” volume control buttons, a “<<Replay” button, a “Skip>>” button, and a time-lapse meter. After viewing the video clip contained in the link, if the user clicks another BIN link that contains no video clip, the system shall hide the video components from the BIN Mode layout. Within the BIN, the system shall display the associated links of the brand as either Simple Tabular format or Pre-Post Purchase format. If there are more than 3 associated links for the BIN, the system shall display the batch navigation bar at the bottom of the Simple Tabular or Pre-Post Purchase table. If the creator of the MMVK had previously selected the “Enable Voting for Link” feature in Brandkey Create™, the system shall display the “Rating” Indicator pull-down list along with the “Vote” button when an associated link in the BIN is clicked. When the user votes for the selected link: The system shall save the vote in the database. The system re-calculates the “Rating” Indicator. The system shall refresh the “Rating” Indicator if needed. If the Ad Mode was selected second when creating the virtual kiosk, the system shall determine the Ad Mode as the next mode and display the Ad Mode under the “Ads” tab to the right of the “Info” tab. If the play list is empty for the Ad Mode, the system shall not display “Ads” tab in the virtual kiosk. If the user clicks the “Ads” tab, the system shall generate a list of ad-spot video clips previously selected in Brandkey Advertise™. If the Promo Mode was selected third when creating the virtual kiosk, the system shall determine the Promo Mode as the next mode and display the Promo Mode under the “Promos” tab to the right of the “Ads” tab when the “Ads” tab is clicked the first time. If the play list is empty for the Promo Mode, the system shall not display the “Promos” tab in the virtual kiosk. For the Ad Mode, the system shall resize, display, and run the generated list of ad-spot video clips in the Ad-Spot Display window. The system shall display the video components below the Ad-Spot Display window, and information text bar near the bottom, and three buttons at the bottom, namely, “Send to Friend”, “Download”, and “Buy Now” as long as they each have been enabled and there has been a desktop icon image uploaded for the Download button and there has been a link specified for the Buy Now button. While the ad-spot video clips are playing, the user may click the “<<Replay” or “Skip>>” button at any time. If the user clicks the “<<Replay” button, the system shall replay the currently playing ad-spot video clip. If the user clicks the “Skip>>” button, the system shall interrupt the ad-spot video clip currently playing, advance to the next video, and start playing. When the last ad-spot video in the list has played, the system shall display the contents of the “Promos” tab automatically. If the user clicks the “Promos” tab prior to the last ad-spot video completing, the system shall generate a list of promo-spot video clips previously selected in Brandkey Promote™. The system shall resize, display, and run the generated list of promo-spot video clips in the Promo-Spot Display window. The system shall display the video components below the Promo-Spot Display window, and a promotions-related text bar near the bottom. If the “Send to Friend” feature has been enabled, the system shall display the “Send to Friend” button at the bottom of the Promo Mode layout. As long as a desktop icon has been uploaded, and if the “Download” feature has been enabled, the system shall display the “Download” button at the bottom of the Promo Mode layout. The system shall display the “Buy Now” feature at the bottom of the Promo Mode layout if it is enabled and an associated link has been specified. The system shall display a default image supplied by the virtual kiosk owner in the Content Display window whenever the virtual kiosk is in an idle state. While the promo-spot video clips are playing, the user may click the “<<Replay” or “Skip>>” button at any time. If the user clicks the “<<Replay” button, the system shall replay the currently playing promo-spot video clip. If the user clicks the “Skip>>” button, the system shall interrupt the promo-spot video clip currently playing, advance to the next video, and start playing. When the last promo-spot video in the list has played, the system shall remain in that state until the user clicks a button. The system shall display the default image, if one has been defined for the BIN, in the Content Display window. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Info” tab section, the “Ads” tab, the “Promos” tab, and if there is more than one product associated with the Vendor-Specific Virtual Kiosk, the “Search” tab to the right of the other tabs.

Launch Multi-Mode Virtual Kiosk with BIN, and Ad Modes

After the system has displayed the BIN Mode and Ad Mode, the system shall check for the next mode. The system determines there is no Promo Mode, and the system shall remain in Ad Mode state until the user clicks a button. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Info” tab section, the “Ads” tab, and if there is more than one product associated with the Vendor-Specific Virtual Kiosk, the “Search” tab to the right of the other tabs.

Launch Multi-Mode Virtual Kiosk with BIN Only

After the system has displayed the BIN Mode, the system shall check for the next mode. The system determines there is neither Ad Mode nor Promo Mode, and the system shall remain in the BIN Mode. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Info” tab section, and if there is more than one product associated with the Vendor-Specific Virtual Kiosk, the “Search” tab to the right of the “Info” tab.

Launch Multi-Mode Virtual Kiosk with Ad and Promo Modes

If the Ad Mode was selected first when creating the virtual kiosk, the system determines there is no BIN Mode and displays the Ad Mode under the “Ads” tab to the right of the “Home” tab. The system shall check for the next mode. The system determines the Promo Mode is next and displays the Promo Mode under the “Promos” tab to the right of the “Ads” tab. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying the “Ads” tab section, the “Promos” tab to the right of the “Ads” tab, and if there more than one product associated with the Vendor-Specific Virtual Kiosk, the “Search” tab to the right of the “Promos” tab.

Launch Multi-Mode Virtual Kiosk with only Ad or Promo Mode

If either the Ad Mode or Promo Mode was selected as the only mode when creating the virtual kiosk, the system determines there is neither a BIN Mode nor Ad/Promo Mode and displays the Ad/Promo Mode under the “Ads”/“Promos” tab to the right of the “Home” tab. If the user clicks the “Home” tab at anytime, the system shall reset the virtual kiosk to the original order while the system re-displays the “Loading . . . ” splash screen. When the reset is complete, the system shall replace the splash screen with the Vendor-Specific Virtual Kiosk displaying either the “Ads” or “Promos” tab section to the right of the “Home” tab, and if there is more than one product associated with the Vendor-Specific Virtual Kiosk, the “Search” tab to the right of either the “Ads” or “Promos” tab.

The Replay Button is Clicked

If the system is in Ad Mode, the system shall replay the currently playing ad-spot video clip. If the system is in Promo Mode, the system shall replay the currently playing promo-spot video clip. If the system is in BIN Mode, and if any of the associated BIN links contains a video clip, the system shall play the video contained in the BIN link from the beginning.

The Skip Button is Clicked

If the system is in Ad Mode, the system shall interrupt the ad-spot video clip currently playing, advance to the next video, and start playing. If the system is in Promo Mode, the system shall interrupt the promo-spot video clip currently playing, advance to the next video, and start playing. If the system is in BIN Mode, and if any of the associated BIN links contains a video clip, the system shall advance the video to the end and stop.

The Volume Control (+) Button is Clicked

The system increases the volume.

The Volume Control (−) Button is Clicked

The system decreases the volume.

The Search Tab is Clicked

If the user clicks the “Search” tab, the system shall display the Search page of the Vendor-Specific Virtual Kiosk (See FIG. 6). The Search page shall contain a Content Display window under the “Search” tab, and a Product Search section near the bottom. If the “Send to Friend” feature has been enabled, the system shall display the “Send to Friend” button at the bottom of the Search layout. As long as a desktop icon has been uploaded, and if the “Download” feature has been enabled, the system shall display the “Download” button at the bottom of the Search layout. The system shall display the “Buy Now” feature at the bottom of the Search layout if it is enabled and an associated link has been specified. The system shall display a default image supplied by the virtual kiosk owner in the Content Display window whenever the virtual kiosk is in an idle state. The Product Search section shall contain a “Search For:” textfield for the search criteria, a “By:” pull-down list for the search parameter, an “In:” pull-down list also for the search parameter, and a Search button. The user types the search criteria and selects the search parameters from the pull-down lists. The user can select from the following available parameters in the “By” pull-down list:

Universal Product Number

Product Descriptor

Trademark

Brand Name

Product Name. The user can also select from available product categories in the “In” pull-down list.

The user clicks the Search button to initiate the Product Search in the Vendor-Specific Virtual Kiosk. If a search criterion has been entered, the system shall initiate the search of all products associated with the Vendor-Specific Virtual Kiosk. If the system found results, the system shall display the “Results” tab to the right of the “Search” tab (See FIG. 7). The system shall return only active products associated with the Vendor-Specific Virtual Kiosk in the search results. The Results page shall contain a Content Display window near the top, and the search results in a tabular layout near the bottom. If there are more than 3 products to be displayed, the system page shall display the batch navigation bar below the search results table. If the “Send to Friend” feature has been enabled, the system shall display the “Send to Friend” button at the bottom of the Results layout. As long as a desktop icon has been uploaded, and if the “Download” feature has been enabled, the system shall display the “Download” button at the bottom of the Results layout. The system shall display the “Buy Now” feature at the bottom of the Results layout if it is enabled and an associated link has been specified. The system shall display a default image supplied by the virtual kiosk owner in the Content Display window whenever the virtual kiosk is in an idle state.

The User Clicks on a Specific Product in the Search Results

The user clicks on the “Results” tab at the top. The user clicks a link for a specific product on the Results page. The system shall check which display modes are valid for the Vendor-Specific Virtual Kiosk and the order of the display modes. The system shall determine which tabs should be visible. The “Home,” “Search,” and “Results” tabs should be visible. Based on which display modes are valid for the virtual kiosk and will display in the selected display mode order, the system shall display the “Ads,” “Promos,” and “Info” tabs to the right of the “Results” tab. Even if the kiosk has an Ad Mode, however, if the product does not have any advertisements, the system shall not display the “Ads” tab. Also, even if the kiosk has a Promo Mode, if the product does not have any promotions, the system shall not display the “Promos” tab. The system shall refresh the virtual kiosk with the correct tabs displayed along the top. The first tab following the “Results” tab will be shown in the selected state. The system shall cycle through the valid modes in the defined order. The virtual kiosk shall reset just as it did when the kiosk first opened, except that Ads, Promos, and BIN will be related to the selected product. The kiosk will cycle through the modes until the Brand Information Network display mode is reached. The system shall display the Brand Information Network for the selected product, initialized with links for that product. The system shall then wait for user input.

The Send to Friend Button is Clicked

If the user clicks the “Send to Friend” button, the system shall display a small form in the Content Display window that contains a “From:” section comprised of a “Name:” text field, an “E-mail:” text field, and a “Message” text area, a “To:” section comprised of an “E-mail1:” text field, an “E-mail2:” text field, an “E-mail3:” text field, an “E-mail4:” text field, an “E-mail5:” text field, a “Send” button, and a “Cancel” button (See FIG. 5). If the user fills the information on the form and clicks the “Send” button, the system shall send the message via the system SMTP server. The message is sent and the system shall replace the message form with a confirmation page. The confirmation page shall display the following message, “A link to this virtual kiosk has been sent, and a confirmation e-mail has also been sent to your e-mail address. Click here to re-launch this Virtual Kiosk.” If the user clicks the “Cancel” button, the system shall replace the message form with the contents of the previously selected tab. If the user clicks the link to re-launch the Virtual Kiosk, then the system shall reset the virtual kiosk to the original order while the system re-displays the “Loading . . . ” splash screen.

The Download Button is Clicked

TBD

The Buy Now Button is Clicked

If the user clicks the “Buy Now” button, the system shall open the “Buy Now” associated link in the parent window.

Requested Virtual Kiosk is not Active or Deployed and the Installed Virtual Kiosk is Active

The system shall display the following error message on the screen, “The requested Virtual Kiosk is no longer available from [Virtual Kiosk Sponsor's Name].”

The Launching Domain is a Forbidden Domain

The system shall display the following error message on the screen, “This website is not authorized to launch the requested Virtual Kiosk. Please contact admin@bksnetworks.com to inform them of any illegal use of the requested Virtual Kiosk. Thank you.”

One or More Visual Attributes of the Requested Virtual Kiosk are not Available

The system shall display the following error message on the screen, “The requested Virtual Kiosk is currently not available. Please try back again later.”

No Search Criteria are entered in the Vendor-Specific Virtual Kiosk Product Search page.

The system shall display the following error message on the screen, “A value must be entered in the Search Criteria in order to initiate the Product Search.”

No Search Results were returned from the Product Search in the Vendor-Specific Virtual Kiosk.

The system shall display the following error message on the screen, “No products were found matching your search criteria. Please try another search.”

These and all other such modifications and variations are deemed to be within the scope and spirit of the present invention as defined by the accompanying Claims to Invention.

What is claimed is:

1. An Internet-based brand marketing communication network comprising:
a brand command, control and communication architecture (BC3) providing brand owners full command and control over a wide range of brand-building assets, including brand messaging, advertisements and promotions distributed throughout the WWW, and how said brand-building assets are arranged in a choreographical manner and directly communicated to consumers over virtual brand marketing communication channels (VBMCCs) that are terminated in server-side driven Multi-Mode Virtual Kiosks (MMVKs) installed at diverse Web touch points where consumers are present.

2. The Internet-based brand management and marketing communication network of claim 1, wherein brand managers and their agents and trading partners can deliver rich brand experiences to consumers anywhere on the Web.

3. The Internet-based brand management and marketing communication network of claim 1, wherein brand owners display rich media advertisements, promotions, in-depth rich-media product information and other brand assets of their choice in said MMVKs, and provide quick, information-rich brand experiences to consumers at the point of sale and other critical Web touch points when they are making a buying decision.

4. The brand management and marketing communication network of claim 1, wherein said MMVKs are programmable through an ensemble of Web-based instruments that enables brand management teams to orchestrate, build and communicate said MMVKs installed along electronic streams of commerce.

5. The Internet-based brand management and marketing communication network of claim 3, wherein brand management teams perform real-time integration and delivery of complex, richly-associated networks of brand building assets, advertisements and promotions, to consumers via said MMVK.

6. The Internet-based brand marketing communication network of claim 1, wherein brand managers and their team members (including ad and promo agents) and retail trading partners as well, with minimal technical knowledge can easily create, install and modify Multi-Mode Virtual Kiosks from their own computers using:
a first subsystem supporting information services that allow brand owners to manage accounts, brands and user rights on said network for organizations;
a second subsystem supporting information services that allow users to choose the content and arrangement of brand information networks (BINs);
a third subsystem supporting information services that enables users to create and deploy Multi-Mode Virtual Kiosks (MMVKs), anywhere on the Web;
a fourth subsystem supporting information services that provide brand managers and their advertising agents with a collaborative online network to build, track and modify advertising campaigns run on subnetworks of said MMVKs; and
a fifth subsystem supporting information services that enables brand managers to create, monitor and modify their ever-changing promotional campaigns on subnetworks of said MMVKs, with promotional agents.

7. The Internet-based brand marketing communication network of claim 6, wherein brand management teams can deploy and install MMVKs at points of display and purchase on the Web, and wherein, with a few mouse clicks, brand managers can regulate the rights and privileges of team members and trading partners on said network.

8. The internet-based brand marketing communication network of claim 5, wherein brand management team members, agents and/or trading partners build said MMVKs; then brand management team members, as well as their agents and/or trading partners, program the multiple display modes of installed MMVKs, so that rich media advertising spots, promotional spots, and brand building resources are delivered to shoppers at points of consumer presence along the WWW, creating information-rich brand experiences as intended by brand owners, developing more consistent brand images across all e-tail marketing channels, while simultaneously creating great value and benefits for e-tailer trading partners, consumers and brand owners alike.

9. The Internet-based brand management and marketing communication network of claim 5, wherein brand management team members create a BIN for each product, service or corporate brand, which serves as an invisible, but critical foundation for all activities on said network, and a storehouse of links for the digital brand-building information assets that consumers view during the operation of each programmed MMVK.

10. The Internet-based brand management and marketing communication network of claim 5, wherein all brand marketing communications conducted through said network are indexed using brand-related information keys so that only specific brand-related content is communicated over said MMVKs characterized by the same brand-Related information keys; and such indexing of brand building information resources and MMVKs on the network helps to ensure that only brand marketing communications related to a particular product, service or brand gets delivered to consumers over MMVKs that are brand-keyed to such branded products and services, reducing clutter, and delivers clearer brand image building communications, with greater efficiency—increasing ROI on brand marketing communication expenditures.

11. The Internet-based brand management and marketing communication network of claim 5, wherein brand owners are provided with the ability to tightly control their online brand assets, effectively collaborate with their advertising and promotional agents and e-tail trading partners during online brand marketing campaigns, as well as directly communicate with online shoppers across multiple e-tail channels, both at points-of-sale and other places on the Web, resulting in consumers having information-rich brand experiences as intended by brand owners and developing more consistent brand images across all e-tail marketing channels, while great value and benefits are simultaneously created for e-tailer trading partners.

12. The Internet-based brand management and marketing communication network of claim 5, wherein said MMVKs can be deployed and installed on emerging e-commerce platforms offline as well as online, including a home computer, interactive television, mobile phone or ATM machine.

13. The Internet-based brand management and marketing communication network of claim 5, wherein graphical user interfaces on MMVKs are translatable so that marketers can communicate consistent brand messages and images across all Web-enabled offline platforms, independent of the footprint of the MMVK-supporting computing platform.

14. The Internet-based brand management and marketing communication network of claim 5, that provides brand managers with a new brand management and marketing communication media designed to serve as a central control center for managing and marketing their brands on the WWW.

15. An Internet-based brand marketing communication network, wherein brand managers can visualize the Brand Images projected by Brand Information Networks created by brand management team members, by automatically previewing brand assets in the brand information networks in an automated manner.

16. The Internet-based brand management and marketing communication network of claim 5, wherein brand managers can deliver more effective brand-building experiences to consumers by deploying MMVKs that provide non-intrusive, engaging online experiences that consumers launch when they are seeking more information about a brand, and wherein said MMVKs are activated by launch buttons that brand owners can strategically place at any Web touchpoint when consumers are likely to be open to information about a brand.

17. A Web-based Brand Information Network (BIN) that may be easily placed, via a Multi-Mode Virtual Kiosk (MMVK), at any Web-enabled consumer touch-point, comprising:
(i) basic information about the product or service which function as Brand Information Search Keys selected for the group consisting of Universal Product Number (USN); Trademark (TM); Product Descriptor (PD); Product Brand Name; and Product Category;
(ii) Web location or address (URL) of brand building assets at the brand owner's disposal; and
(iii) display attributes of the brand assets located at each node in said Web-based BIN.

18. The Web-based Brand Information Network (BIN) of claim 17, wherein said display attributes are selected from the group consisting of text for clickable links, icons displayed next to the links, sound files associated with the links and types of links.
